(19) United States
(12) Patent Application Publication
(10) Pub. No.: US 2010/0217491 A1
(43) Pub. Date: Aug. 26, 2010

(54) CAMBER ANGLE CONTROLLING DEVICE

(75) Inventors: Takashi Naito, Tokyo (JP); Masao Ando, Tokyo (JP); Masahiro Hasebe, Tokyo (JP); Munehisa Horiguchi, Tokyo (JP); Akira Mizuno, Tokyo (JP); Hitoshi Kamiya, Tokyo (JP); Michael Jones, Tokyo (JP)

Correspondence Address: BACON & THOMAS, PLLC, 625 SLATERS LANE, FOURTH FLOOR, ALEXANDRIA, VA, 22314-1176, US

(73) Assignee: Equos Research Co., Ltd., Tokyo (JP)

(21) Appl. No.: 12/667,362

(22) PCT Filed: Jul. 1, 2008
(86) PCT No.: PCT/JP2008/061930

§ 371 Date: Mar. 2, 2010

(30) Foreign Application Priority Data
Jul. 2, 2007 (JP) 2007-174636
Jul. 2, 2007 (JP) 2007-174663
Sep. 21, 2007 (JP) 2007-245175
Oct. 29, 2007 (JP) 2007-280891
Oct. 30, 2007 (JP) 2007-281639
Oct. 31, 2007 (JP) 2007-283898

(51) Int. Cl. G06F 19/00

(52) U.S. Cl. 701/49

(57) ABSTRACT

A camber angle applying device is controlled to adjust the camber angle of wheels to a predetermined value. Therefore, the characteristics (or a high gripping property) of a high gripping force and the characteristic (or a low rolling resistance) of a small rolling resistance can be separately used as the performance of the wheels. By utilizing the high gripping property of the wheels, therefore, a vehicle is enabled to reduce its energy consumption, while retaining its running characteristics (such as a turning performance, an accelerating performance or a braking performance), by utilizing the rolling resistance of the wheels. Moreover, the camber angle applying device is controlled to reduce the rolling resistance of the wheels, so that the energy loss to occur in the wheels during running can be reduced to further reduce the energy consumption of the vehicle.

### TECHNICAL FIELD

The present invention relates to a camber angle controlling device that controls a camber angle applying device applying camber angles to wheels of a vehicle, and particularly to a camber angle controlling device that is capable of reducing the energy consumption of a vehicle while ensuring the running performance thereof.

### BACKGROUND ART

It has been attempted to bring out the performance of a tire by setting a camber angle of a wheel (angle formed by a wheel center and a traveling road surface) to a value in the negative direction so as to ensure the running performance of a vehicle. The reason for this is that, if, for example, the camber angle is set to zero degrees, the wheel lifts from the road surface because a vehicle body rolls during turning, and thus the gripping force of the tire cannot be brought out sufficiently. Therefore, by setting the camber angle to a value in the negative direction in advance so as to prevent the wheel from lifting, the gripping force of the tire can be brought out sufficiently thereby ensuring the running performance (turning performance) (Patent Document 1).

Patent Document 1: Japanese Patent Application Publication No. JP-A-05-065010

### DISCLOSURE OF THE INVENTION

### Problem to be Solved by the Invention

However, in the related art technology, there has been a problem that, if the camber angle is set to a value in the negative direction, the rolling resistance of the wheel increases, thereby wastefully consuming energy to run the vehicle while ensuring the running performance.

That is, because the wheel encapsulates wires and so on inside thereof, the entire wheel repeats expansion and contraction if the wheel repeats contact and non-contact with the traveling road surface during running. More specifically, in the wheel during running, there are generated an energy loss on the wheel surface by the contact of the wheel with the traveling road surface and an energy loss inside the wheel by the repetition of expansion and contraction of the wheel. Consequently, as the two energy losses increase, the rolling resistance also increases. Moreover, if a camber angle in the negative direction or positive direction is applied to the wheel, particularly the energy loss inside the wheel increases. Therefore, in the related art technology, there has been a problem that the energy consumption due to the increase in the rolling resistance of the wheel cannot be reduced, although the running performance is ensured.

In order to solve the problem described above, it is an object of the present invention to provide a camber angle controlling device that is capable of reducing the energy consumption of a vehicle while ensuring the running performance thereof.

### Means for Solving the Problem

In order to solve this problem, a camber angle controlling device according to claim 1 of the present invention that controls a camber angle applying device applying a camber angle to a wheel of a vehicle includes traveling information acquiring means that acquires traveling information of the vehicle, and camber angle adjusting means that adjusts the camber angle of the wheel to a predetermined camber angle, in which the camber angle adjusting means controls the camber angle applying device based on the traveling information so as to make that the rolling resistance of the wheel smaller.

According to claim 2 of the present invention, the camber angle controlling device according to claim 1 further includes traveling road surface judging means that judges a road surface condition of a traveling road surface on which the vehicle runs, and required coefficient of friction calculating means that calculates a required coefficient of friction based on the road surface condition judged by the traveling road surface judging means, in which the camber angle adjusting means adjusts the camber angle of the wheel to a predetermined camber angle based on the required coefficient of friction.

According to claim 3 of the present invention, the camber angle controlling device according to claim 2 further includes coefficient of friction comparing means that compares a coefficient of friction achievable by the wheel with the required coefficient of friction, in which the camber angle adjusting means adjusts the camber angle of the wheel to a predetermined camber angle based on a result of comparison by the coefficient of friction comparing means.

According to claim 4 of the present invention, the camber angle controlling device according to claim 3 further includes a camber angle map that stores relations of the coefficient of friction and the rolling resistance of the wheel with the camber angle, in which the camber angle adjusting means calculates a minimum coefficient of friction and a maximum coefficient of friction achievable by the wheel based on the camber angle map, sets a predetermined camber angle to zero degrees when the required coefficient of friction is smaller than the minimum coefficient of friction, or calculates a camber angle corresponding to the required coefficient of friction based on the camber angle map and sets the predetermined camber angle to the calculated camber angle when the required coefficient of friction is larger than the minimum coefficient of friction and smaller than the maximum coefficient of friction, and thus adjusts the camber angle of the wheel.

According to claim 5 of the present invention, in the camber angle controlling device according to any one of claims 1 to 4, the traveling information acquiring means acquires a roll angle of the vehicle as the traveling information, and the camber angle adjusting means applies a camber angle of a value corresponding to the roll angle to the wheel so as to adjust the camber angle of the wheel to a predetermined camber angle.

According to claim 6 of the present invention, the camber angle controlling device according to any one of claims 1 to 5 further includes thrust force calculating means that calculates a theoretical thrust force acting on the wheel toward outside or inside of the vehicle, in which the traveling information acquiring means acquires an actual thrust force acting on the wheel toward outside or inside of the vehicle as the traveling information, and the camber angle adjusting means adjusts the camber angle of the wheel to a predetermined camber angle so as to make a gap between the theoretical thrust force and the actual thrust force smaller.

According to claim 7 of the present invention, in the camber angle controlling device according to any one of claims 1 to 6, the vehicle is capable of traveling by a driving force of a motor, the traveling information acquiring means acquires an electric current value conducted to the motor as the traveling information, and the camber angle adjusting means adjusts the camber angle of the wheel to a predetermined camber angle so as to make the electric current value smaller.

According to claim 8 of the present invention, in the camber angle controlling device according to any one of claims 1 to 6, the vehicle is capable of traveling by a driving force of an internal combustion engine, the traveling information acquiring means acquires a feed rate of fuel fed to the internal combustion engine as the traveling information, and the camber angle adjusting means adjusts the camber angle of the wheel to a predetermined camber angle so as to make the feed rate of the fuel smaller.

### EFFECTS OF THE INVENTION

With the camber angle controlling device according to claim 1, because the camber angle adjusting means controls the camber angle applying device, a camber angle in the negative direction or positive direction is applied to the wheel, and thereby the camber angle of the wheel is adjusted to the predetermined value. Consequently, it is possible to selectively use the characteristics (high gripping property) of a high gripping force and the characteristics (low rolling resistance) of a small rolling resistance, as a performance of the wheel.

Therefore, there is an effect that the energy consumption of the vehicle can be reduced by using the low rolling resistance of the wheel while ensuring the running performance (such as a turning performance, an accelerating performance or a braking performance) of the vehicle by using the high gripping property of the wheel.

In addition, according to the present invention, the camber angle controlling device includes the traveling information acquiring means that acquires the traveling information of the vehicle, and the camber angle adjusting means controls the camber angle applying device based on the traveling information acquired by the traveling information acquiring means so as to make the rolling resistance of the wheel smaller. Therefore, there is an effect that the energy loss generated in the wheel during running can be made smaller, thereby enabling to aim at a further reduction in the energy consumption of the vehicle.

Here, if the wheel is structured by arranging, in the direction of the width thereof, treads of two or more types, for example, of a first tread configured to have the characteristics (high gripping property) of a high gripping force and a second tread configured to have the characteristics (low rolling resistance) of a small rolling resistance, the ratio of ground contact area between the first tread and the second tread can be controlled by adjusting the camber angle of the wheel. Thus, it is possible to selectively use the high gripping property and the low rolling resistance so as to reduce the energy consumption of the vehicle while ensuring the running performance thereof.

In addition, if the wheel is composed of a tread of one type, it is also possible to selectively use the characteristics (high gripping property) of a high gripping force and the characteristics (low rolling resistance) of a small rolling resistance so as to reduce the energy consumption of the vehicle while ensuring the running performance thereof, by adjusting the camber angle of the wheel to control the amount of deformation of the wheel.

In addition to the effect achieved by the camber angle controlling device according to claim 1, the camber angle controlling device according to claim 2 further includes the required coefficient of friction calculating means that calculates the required coefficient of friction, and the camber angle adjusting means adjusts the camber angle of the wheel based on the required coefficient of friction calculated by the required coefficient of friction calculating means. Therefore, slip of the wheel can be suppressed. As a result, there is an effect that the wasteful consumption of energy associated with the slip of the wheel can be suppressed, thereby enabling to aim at a further reduction in the energy consumption of the vehicle. In addition, there is an effect that the running performance of the vehicle can be ensured in a reliable manner. Note that the required coefficient of friction refers to a coefficient of friction that is required so that the wheel does not slip.

In addition, according to the present invention, the camber angle controlling device includes the traveling road surface judging means that judges the road surface condition of the traveling road surface on which the vehicle runs, and the required coefficient of friction calculating means calculates the required coefficient of friction based on the road surface condition judged by the traveling road surface judging means. Therefore, the camber angle of the wheel can be adjusted depending on the road surface condition. Consequently, there is an effect that the slip of the wheel can be suppressed in a more reliable manner, thereby ensuring to reduce the energy consumption of the vehicle.

In addition to the effect achieved by the camber angle controlling device according to claim 2, the camber angle controlling device according to claim 3 further includes the coefficient of friction comparing means that compares the coefficient of friction achievable by the wheel with the required coefficient of friction, and the camber angle adjusting means adjusts the camber angle of the wheel based on the result of comparison by the coefficient of friction comparing means. Therefore, the slip of the wheel can be suppressed by making the wheel achieve a minimum required coefficient of friction. Consequently, there is an effect that the rolling resistance of the wheel can be made smaller while suppressing the slip of the wheel, thereby enabling to aim at a further reduction in the energy consumption of the vehicle.

In addition to the effect achieved by the camber angle controlling device according to claim 3, the camber angle controlling device according to claim 4 further includes the camber angle map that stores the relations of the coefficient of friction and the rolling resistance of the wheel with the camber angle. Also, the camber angle adjusting means calculates the minimum coefficient of friction and the maximum coefficient of friction achievable by the wheel based on the camber angle map, then sets the predetermined camber angle to zero degrees when the required coefficient of friction is smaller than the minimum coefficient of friction, or calculates a camber angle corresponding to the required coefficient of friction based on the camber angle map and sets the predetermined camber angle to the calculated camber angle when the required coefficient of friction is larger than the minimum coefficient of friction and smaller than the maximum coefficient of friction, and then adjusts the camber angle of the wheel to the predetermined camber angle. Therefore, the slip of the wheel can be suppressed by making the wheel achieve a minimum required coefficient of friction. Consequently, there is an effect that the rolling resistance of the wheel can be made smaller while suppressing the slip of the wheel, thereby enabling to aim at a further reduction in the energy consumption of the vehicle.

With the camber angle controlling device according to claim 5, in addition to the effect achieved by the camber angle controlling device according to any one of claims 1 to 4, the traveling information acquiring means acquires the roll angle of the vehicle as the traveling information, and the camber angle adjusting means applies the camber angle of a value corresponding to the roll angle to the wheel so as to adjust the camber angle of the wheel. Therefore, a change in the camber angle associated with the roll of the vehicle can be corrected. As a result, there is an effect that the rolling resistance of the wheel can be made smaller, thereby enabling to aim at a further reduction in the energy consumption of the vehicle.

In addition to the effect achieved by the camber angle controlling device according to any one of claims 1 to 5, the camber angle controlling device according to claim 6 further includes the thrust force calculating means that calculates the theoretical thrust force acting on the wheel toward outside or inside of the vehicle. Also, the traveling information acquiring means acquires the actual thrust force acting on the wheel toward outside or inside of the vehicle as the traveling information, and the camber angle adjusting means adjusts the camber angle of the wheel so as to make the gap between the theoretical thrust force and the actual thrust force smaller. Therefore, there is an effect that the rolling resistance of the wheel can be made smaller, thereby enabling to aim at a further reduction in the energy consumption of the vehicle.

With the camber angle controlling device according to claim 7, in addition to the effect achieved by the camber angle controlling device according to any one of claims 1 to 6, the vehicle is capable of traveling by the driving force of the motor, the traveling information acquiring means acquires the electric current value conducted to the motor as the traveling information, and the camber angle adjusting means adjusts the camber angle of the wheel so as to make the electric current value smaller. Therefore, there is an effect that the electric power consumption of the motor can be made smaller, thereby enabling to aim at a further reduction in the energy consumption of the vehicle.

With the camber angle controlling device according to claim 8, in addition to the effect achieved by the camber angle controlling device according to any one of claims 1 to 6, the vehicle is capable of traveling by the driving force of the internal combustion engine, the traveling information acquiring means acquires the feed rate of fuel fed to the internal combustion engine as the traveling information, and the camber angle adjusting means adjusts the camber angle of the wheel so as to make the feed rate of the fuel smaller. Therefore, there is an effect that the fuel consumption of the internal combustion engine can be made smaller, thereby enabling to aim at a further reduction in the energy consumption of the vehicle.

### BRIEF DESCRIPTION OF THE DRAWINGS

FIG. 1 is a schematic diagram schematically showing a top view of a vehicle equipped with a vehicular control device according to a first embodiment of the present invention.

FIG. 2A is a cross-sectional view of a wheel, and FIG. 2B is a schematic diagram schematically showing methods for adjusting a steer angle and a camber angle of the wheel.

FIG. 3 is a block diagram showing an electrical configuration of the vehicular control device.

FIG. 4 is a schematic diagram schematically illustrating a content of a coefficient of friction map.

FIG. 5 is a schematic diagram schematically illustrating a content of a camber angle map.

FIG. 6 is a schematic diagram schematically showing a top view of the vehicle.

FIG. 7 is a schematic diagram schematically illustrating a front view of the vehicle in the state in which camber angles in the negative direction are applied to the wheels.

FIG. 8 is a schematic diagram schematically illustrating a front view of the vehicle in the state in which camber angles in the positive direction are applied to the wheels.

FIGS. 9A and 9B show a flow chart of a camber control process.

FIG. 10 is a flow chart showing a roll control process.

FIG. 11 is a flow chart showing a thrust control process.

FIGS. 12A and 12B show a flow chart of a first energy control process.

FIG. 13 is a flow chart showing an average current calculation process.

FIGS. 14A and 14B show a flow chart of a second energy control process.

FIG. 15 is a top view of a wheel according to a second embodiment.

FIG. 16 is a schematic diagram schematically illustrating a content of a camber angle map according to the second embodiment.

FIGS. 17A and 17B show a flow chart of a camber control process according to the second embodiment.

FIG. 18 is a schematic diagram schematically showing a top view of a vehicle according to a third embodiment.

FIG. 19 is a block diagram showing an electrical configuration of a vehicular control device according to the third embodiment.

FIG. 20 is a flow chart showing an average fuel calculation process.

FIG. 21 is a block diagram showing an electrical configuration of a vehicular control device according to a fourth embodiment.

FIG. 22 is a flow chart showing a camber control process.

FIG. 23 is a flow chart showing a turning control process.

FIGS. 24A to 24D are schematic diagrams schematically illustrating vehicle's front views each of which showing a relation between a required coefficient of friction and wheels.

FIG. 25 is a top view of a wheel according to a fifth embodiment.

FIG. 26 is a schematic diagram schematically showing a front view of a vehicle in the left-turn state in which a steer angle for left turn is applied to left and right wheels, and a camber angle in the negative direction is applied to an outer wheel during turning whereas a camber angle in the positive direction is applied to an inner wheel during turning.

FIG. 27 is a schematic diagram schematically illustrating a content of a camber angle map according to the fifth embodiment.

FIG. 28 is a flow chart showing a camber control process according to the fifth embodiment.

FIG. 29 is a flow chart showing a turning control process according to the fifth embodiment.

FIGS. 30A to 30D are schematic diagrams schematically illustrating vehicle's front views each of which showing a relation between a required coefficient of friction and the wheels.

FIG. 31 is a schematic diagram schematically showing a vehicle equipped with a vehicular control device according to a sixth embodiment.

FIG. 32 is a block diagram showing an electrical configuration of the vehicular control device.

FIG. 33 is a schematic diagram schematically illustrating a content of a coefficient of friction map.

FIG. 34 is a schematic diagram schematically illustrating a content of a camber angle map.

FIG. 35 is a schematic diagram showing a correlation between an operating state of a brake pedal and a braking force.

FIGS. 36A and 36B show a flow chart of a camber control process.

FIG. 37 is a schematic diagram schematically showing a top view of a vehicle equipped with a control device according to a seventh embodiment.

FIG. 38 is a front view of a suspension system.

FIG. 39 shows front views of the suspension system.

FIG. 40 is a schematic diagram schematically showing a front view of the vehicle.

FIG. 41 is a schematic diagram schematically showing another front view of the vehicle.

FIG. 42 is a block diagram showing an electrical configuration of the control device.

FIGS. 43A and 43B show a flow chart of a slip control process.

FIG. 44 is a flow chart showing a slip cancellation detecting process.

FIG. 45 is a flow chart showing a camber cancellation process.

FIG. 46 is a block diagram showing an electrical configuration of a control device according to an eighth embodiment.

FIG. 47 is a flow chart showing a slip control process.

FIG. 48 is a flow chart showing the slip control process.

FIG. 49 is a flow chart showing a slip cancellation detecting process.

FIG. 50 is a schematic diagram schematically showing a top view of a vehicle equipped with a control device according to a ninth embodiment.

FIG. 51 is a front view of a suspension system.

FIG. 52 shows front views of the suspension system.

FIG. 53 is a schematic diagram schematically showing a top view of the vehicle.

FIG. 54 is a schematic diagram schematically showing a front view of the vehicle.

FIG. 55 is a schematic diagram schematically showing another front view of the vehicle.

FIG. 56 is a block diagram showing an electrical configuration of the control device.

FIG. 57 is a flow chart showing a camber control process.

FIG. 58A is a schematic diagram explaining a moment generated about a camber axis of a wheel along with generation of a centrifugal force, and FIG. 58B is a schematic diagram explaining a behavior of the wheel in the case that the camber control process has turned off the control of an actuator.

FIG. 59 is a schematic diagram schematically showing a top view of a vehicle equipped with a control device according to a tenth embodiment.

FIG. 60 is a block diagram showing an electrical configuration of the control device.

FIG. 61 is a flow chart showing a camber control process.

FIG. 62 is a flow chart showing a camber control device according to an eleventh embodiment.

### DESCRIPTION OF THE REFERENCE NUMERALS

100, 4100, 6100: vehicular control device (camber angle controlling device)
7100, 8200, 9100, 10100: control device (vehicular control device)
1, 201, 301, 4001, 5201, 6001, 7001, 9001, 10001: vehicle
2, 202, 5202, 9002: wheel
2FL, 202FL, 5202FL, 9002FL: left front wheel (wheel)
2FR, 202FR, 5202FR, 9002FR: right front wheel (wheel)
2RL, 202RL, 5202RL, 9002RL: left rear wheel (wheel)
2RR, 202RR, 5202RR, 9002RR: right rear wheel (wheel)
21, 5221: first tread, inner tread (second tread)
22: second tread, outer tread (first tread)
3: wheel driving mechanism (motor, regenerative device)
3FL, 3FR: FL motor, FR motor (motor, regenerative device)
3RL, 3RR: RL motor, RR motor (motor)
4: camber angle applying device, suspension system (camber angle adjusting device)
4FL-4RR: FL-RR actuators (camber angle applying device)
7043FL-7043RR: FL-RR actuators (camber angle adjusting device)
4a-4c: hydraulic cylinders (part of camber angle applying device)
4d: hydraulic pump (part of camber angle applying device)
72b, 4072b: camber angle map (storing means)
303: engine (internal combustion engine)
7082: ABS control device (slip suppression control means)
7083: traction control device (slip suppression control means)
8087: side-slip prevention control device (slip suppression control means)
31: acceleration sensor device (lateral acceleration measuring means, one of traveling mode detecting means)
31a: side-to-side acceleration sensor (lateral acceleration measuring means)
8086: rotational angular velocity sensor device (yaw rate measuring means)
9041: axle hub (part of camber angle changeable mechanism)
9042a-9042c: first to third arms (part of camber angle changeable mechanism)
9043FL-9043RR: FL-RR actuators (actuator)
9071a, 9071b: stopper (changeable range limiting means)
S9011: (computing means)
S9016, S9018: (camber angle control means)
S9017: (control stopping means)
10082: door sensor device (vehicle condition detecting means)
10083: hood sensor device (vehicle condition detecting means)
10084: trunk sensor device (vehicle condition detecting means)
10085: inter-vehicular distance sensor device (vehicle condition detecting means)

### BEST MODES FOR CARRYING OUT THE INVENTION

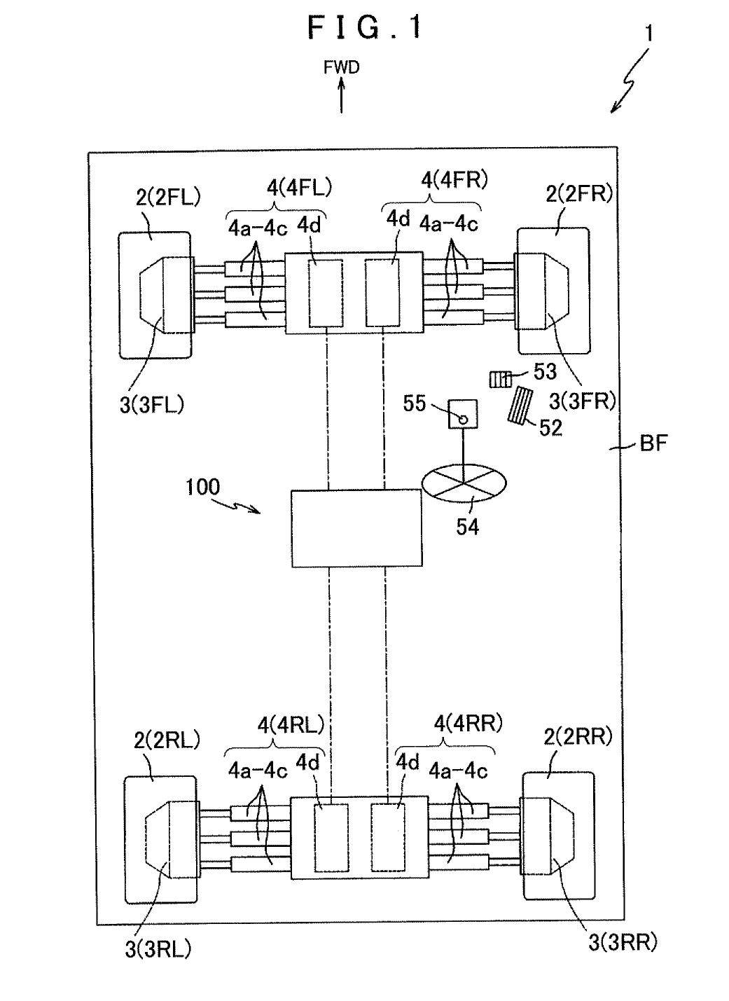

Preferred embodiments of the present invention will be described below with reference to the accompanying drawings. FIG. 1 is a schematic diagram schematically showing a top view of a vehicle 1 equipped with a vehicular control device 100 according to a first embodiment of the present invention. Note that an arrow FWD in FIG. 1 indicates the forward direction of the vehicle 1.

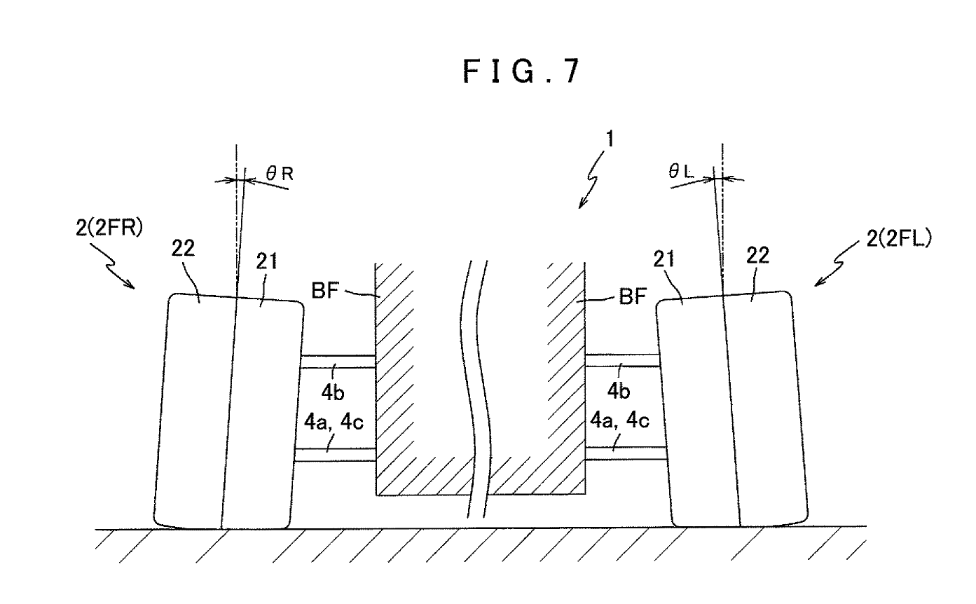

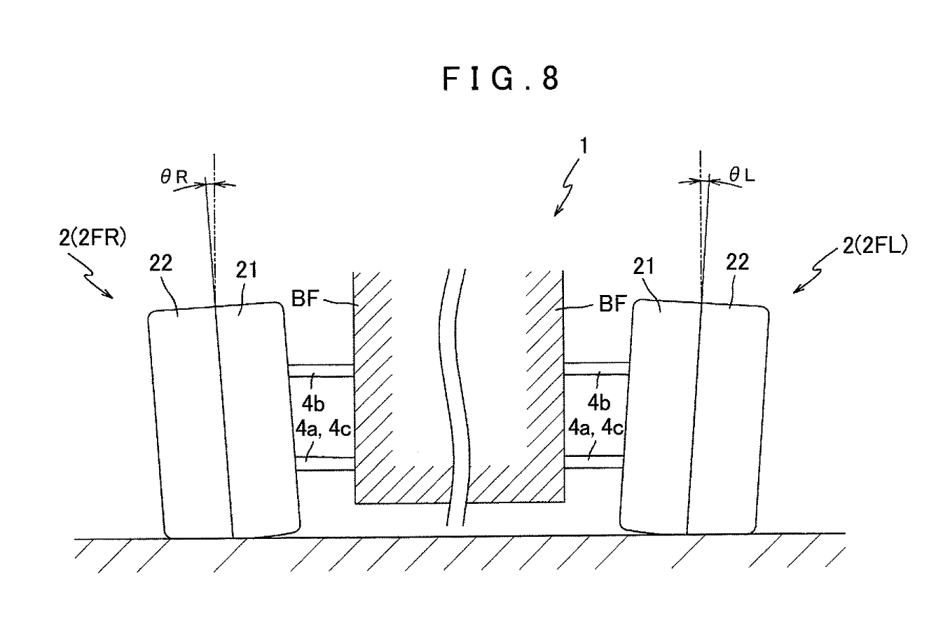

First of all, an outline structure of the vehicle 1 will be described. As shown in FIG. 1, the vehicle 1 is mainly provided with a vehicle body frame BF, a plurality of (four in the present embodiment) wheels 2 supported by the vehicle body frame BF, a wheel driving mechanism 3 that rotationally drives each of the wheels 2, and a camber angle applying device 4 that drives each of the wheels 2 for steering motion and camber angle adjustment thereof. The vehicle 1 is structured such that the vehicular control device 100 controls the operation of the camber angle applying device 4 to adjust the camber angles of the wheels 2 (refer to FIGS. 7 and 8) so as to be capable of reducing the energy consumption of the vehicle 1 while ensuring the running performance thereof by making selective use of the characteristics of the wheels 2.

Next, a detailed structure of each portion will be described. As shown in FIG. 1, the wheels 2 include four wheels consisting of left and right front wheels 2FL and 2FR located on the front side in the direction of travel, and of left and right rear wheels 2RL and 2RR located on the rear side in the direction of travel, of the vehicle 1. The wheels 2 are structured so as to be capable of being rotated by the wheel driving mechanism 3 independently from each other.

The wheel driving mechanism 3 is a device for rotationally driving the wheels 2, and, as shown in FIG. 1, a total of four electric motors (FL-RR motors 3FL to 3RR) are arranged in the wheels 2 (that is, as in-wheel motors).

For example, when a driver operates an accelerator pedal 52, the vehicular control device 100 controls the operation of the wheel driving mechanism 3 and each of the wheels 2 is rotationally driven at a rotational speed corresponding to an operating amount of the accelerator pedal 52.

The camber angle applying device 4 is a device for adjusting a steer angle and the camber angle of each of the wheels 2, and, as shown in FIG. 1, a total of four actuators (FL-RR actuators 4FL to 4RR) are arranged respectively corresponding to each of the wheels 2.

For example, when the driver operates a steering 54, the vehicular control device 100 controls the operation of a part (such as the FL actuator 4FL and the FR actuator 4FR) or the whole of the camber angle applying device 4, and each of the wheels 2 is driven to be steered at a steer angle corresponding to an operating amount of the steering 54.

In addition, the camber angle applying device 4 is controlled in operation by the vehicular control device 100 depending on a change in the state such as the traveling mode (for example, constant-speed running, acceleration, or deceleration mode, or straight running or turning mode) of the vehicle 1, or the state of a traveling road surface (for example, paved road or unpaved road surface), and adjusts the camber angle of each of the wheels 2.

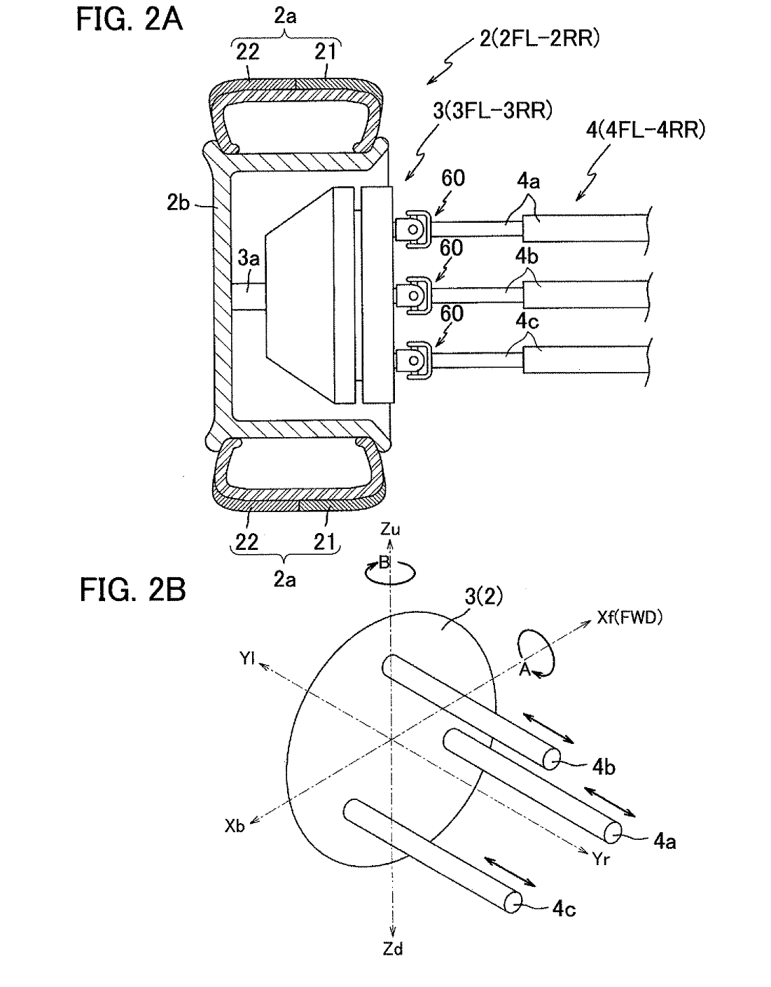

Here, detailed structures of the wheel driving mechanism 3 and the camber angle applying device 4 will be described with reference to FIG. 2. FIG. 2A is a cross-sectional view of the wheel 2, and FIG. 2B is a schematic diagram schematically showing methods for adjusting a steer angle and a camber angle of the wheel 2.

Note that wires and so on for supplying driving power to the wheel driving mechanism 3 are omitted from illustration in FIG. 2A. A virtual axis Xf-Xb, a virtual axis Yl-Yr, and a virtual axis Zu-Zd shown in FIG. 2B correspond to the fore-and-aft direction, the side-to-side direction, and the height direction, respectively, of the vehicle 1.

As shown in FIG. 2A, the wheel 2 is mainly structured by having a tire 2a composed of a rubber-like elastic material and a wheel 2b composed of an aluminum alloy or the like, and the wheel driving mechanism 3 (each of the FL-RR motors 3FL to 3RR) is arranged in the inner circumferential portion of the wheel 2b as an in-wheel motor.

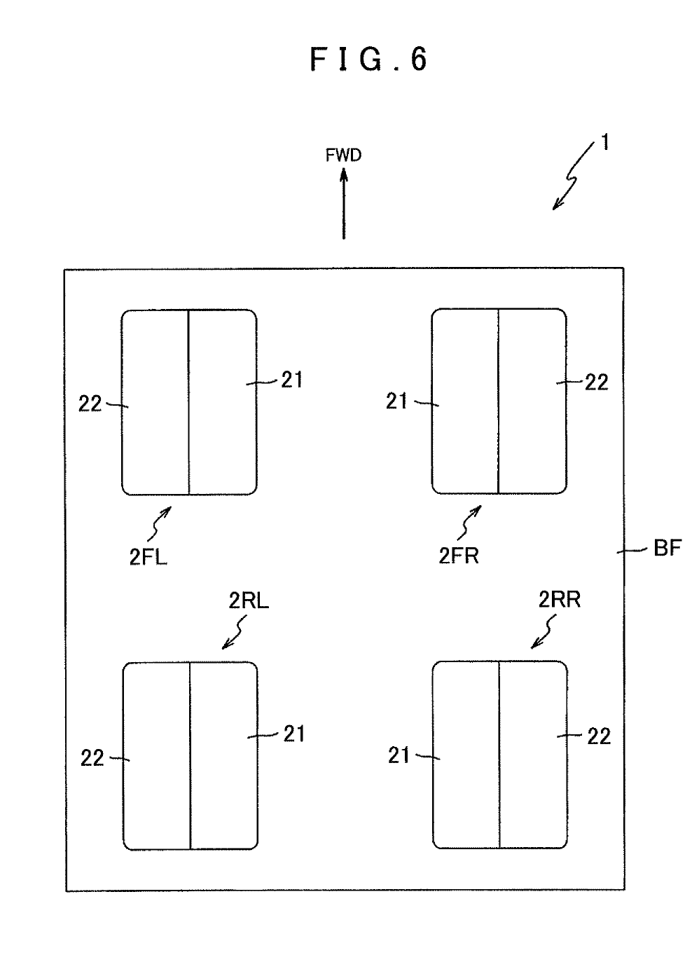

The tire 2a is provided with a first tread 21 arranged on the inner side (right side in FIG. 2A) of the vehicle 1 and a second tread 22 arranged on the outer side (left side in FIG. 2A) of the vehicle 1. The first tread 21 is configured to have the characteristics (higher gripping property) of a higher gripping force compared with the second tread 22, whereas the second tread 22 is configured to have the characteristics (lower rolling resistance) of a smaller rolling resistance compared with the first tread 21. A detailed structure of the wheels 2 (tires 2a) will be described later with reference to FIG. 6.

As shown in FIG. 2A, the wheel driving mechanism 3 is structured such that a drive axle 3a protruding toward the front side (left side in FIG. 2A) thereof is connected and fixed to the wheel 2b and a rotational driving force can be transmitted to the wheel 2 through the drive axle 3a. In addition, the camber angle applying device 4 (each of the FL-RR actuators 4FL to 4RR) is connected and fixed to the back side of the wheel driving mechanism 3.

The camber angle applying device 4 is provided with a plurality (three in the present embodiment) of hydraulic cylinders 4a to 4e, and rod portions of the three hydraulic cylinders 4a to 4c are connected and fixed to the back side (right side in FIG. 2A) of the wheel driving mechanism 3 through a joint portion (universal joint in the present embodiment) 60. Note that, as shown in FIG. 2B, the hydraulic cylinders 4a to 4c are arranged at substantially even intervals in the circumferential direction (that is, at intervals of 120 degrees in the circumferential direction), and one of the hydraulic cylinders 4b is arranged on the virtual axis Zu-Zd.

Consequently, when each of the hydraulic cylinders 4a to 4c drives to expand or contract each of the rods, respectively, by a predetermined length in a predetermined direction, the wheel driving mechanism 3 is driven to be swung around the virtual axes Xf-Xb and Zu-Zd serving as swing centers. As a result, a predetermined camber angle and a predetermined steer angle are applied to the wheel 2.

For example, as shown in FIG. 2B, when the rod portion of the hydraulic cylinder 4b is driven to be contracted and the rod portions of the hydraulic cylinders 4a and 4c are driven to be expanded in the state in which the wheel 2 is in the neutral position (straight running state of the vehicle 1), the wheel driving mechanism 3 is rotated around the virtual line Xf-Xb (arrow A in FIG. 2B), and thereby a camber angle (angle formed by a center line of the wheel 2 relative to the virtual line Zu-Zd) in the negative direction (negative camber direction) is applied to the wheel 2. On the other hand, when the hydraulic cylinder 4b and the hydraulic cylinders 4a and 4c are driven to be expanded and contracted, respectively, in the direction opposite to the above-described direction, a camber angle in the positive direction (positive camber direction) is applied to the wheel 2.

In addition, when the rod portion of the hydraulic cylinder 4a is driven to be contracted and the rod portion of the hydraulic cylinder 4c is driven to be expanded in the state in which the wheel 2 is in the neutral position (straight running state of the vehicle 1), the wheel driving mechanism 3 is rotated around the virtual line Zu-Zd (arrow B in FIG. 2B), and thereby a steer angle (angle that is formed by a center line of the wheel 2 relative to the virtual line Zu-Zd and determined independently of the direction of travel of the vehicle 1) of a toe-in is applied to the wheel 2. On the other hand, when the hydraulic cylinder 4a and the hydraulic cylinder 4c are driven to be expanded and contracted, respectively, in the direction opposite to the above-described direction, a steer angle of toe-out is applied to the wheel 2.

Note that, although the methods of driving of the hydraulic cylinders 4a to 4c exemplified here have been described in the case in which the hydraulic cylinders are driven from the state in which the wheel 2 is in the neutral position as described above, any camber angle or steer angle can be applied to the wheel 2 by controlling the drive for expansion and contraction of the hydraulic cylinders 4a to 4c by combining those methods.

In addition, in the present embodiment, description has been made of the case in which the hydraulic cylinders are used. However, the cylinders are not limited to the hydraulic cylinders of the present embodiment, but may be electric cylinders in which motors are used to move the cylinders, air cylinders in which pressure of compressed gas is used to move the cylinders, or cylinders moved by using thermal expansion of gas.

Description will be made referring back to FIG. 1. The accelerator pedal 52 and a brake pedal 53 are operating members operated by the driver. Depending on the state of depression (such as depression amount and depression speed) of the pedals 52 and 53, a vehicle speed and a braking force of the vehicle 1 are determined, and the wheel driving mechanism 3 is controlled in operation.

The steering 54 is an operating member operated by the driver. Depending on the operating state (such as rotational direction and rotation angle) of the steering 54, a turning direction and a turning radius of the vehicle 1 are determined, and the camber angle applying device 4 is controlled in operation.

Similarly, a road surface condition switch 55 is an operating member operated by the driver. Depending on the operating state (such as operating position) of the road surface condition switch 55, the camber angle applying device 4 is controlled in operation. Note that the road surface condition switch 55 is structured as a three-stage (three-position) rocker switch in which the first position, the second position, and the third position correspond to the state that a dry paved road is selected as the traveling road surface, the state that an unpaved road is selected as the traveling road surface, and the state that a wet paved road is selected as the traveling road surface, respectively.

The vehicular control device 100 is a control device for controlling each portion of the vehicle 1 structured as described above. For example, the vehicular control device 100 rotationally drives the wheels 2 by detecting the state of depression of the pedals 52 and 53 and then controlling the operation of the wheel driving mechanism 3 depending on the result of the detection, or drives the wheels 2 for steering motion and camber angle adjustment thereof by detecting the state of the steering 54 and then controlling the operation of the camber angle applying device 4 depending on the result of the detection.

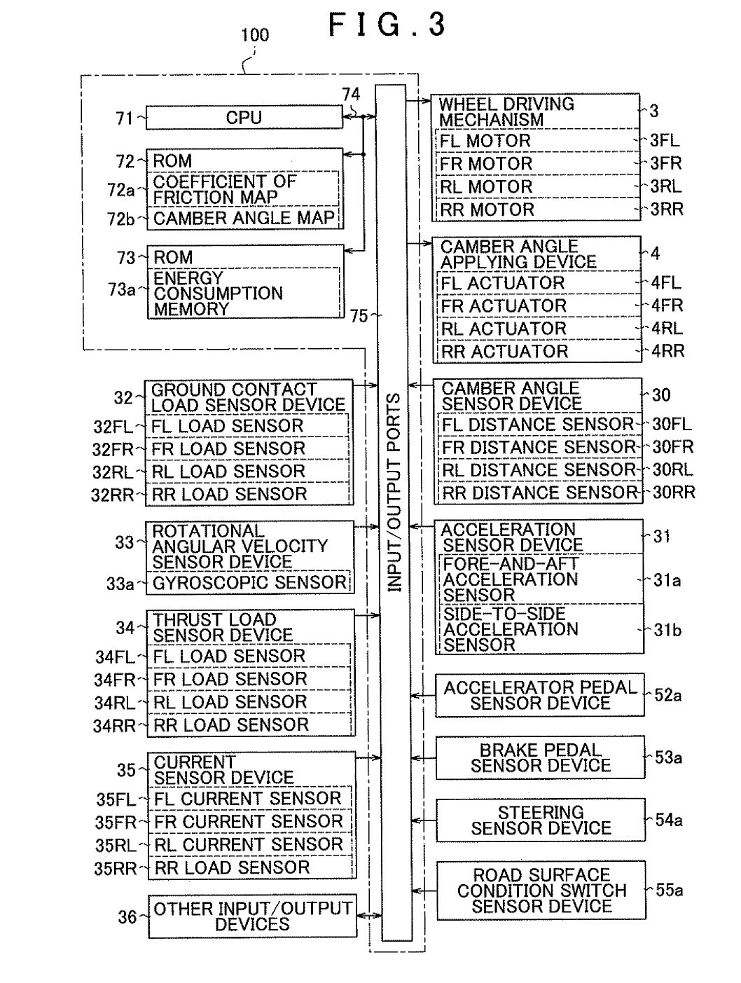

Here, a detailed structure of the vehicular control device 100 will be described with reference to FIG. 3. FIG. 3 is a block diagram showing an electrical configuration of the vehicular control device 100. As shown in FIG. 3, the vehicular control device 100 is provided with a CPU 71, a ROM 72, and a RAM 73 that are connected to input/output ports 75 through a bus line 74. In addition, a plurality of devices such as the wheel driving mechanism 3 are connected to the input/output ports 75.

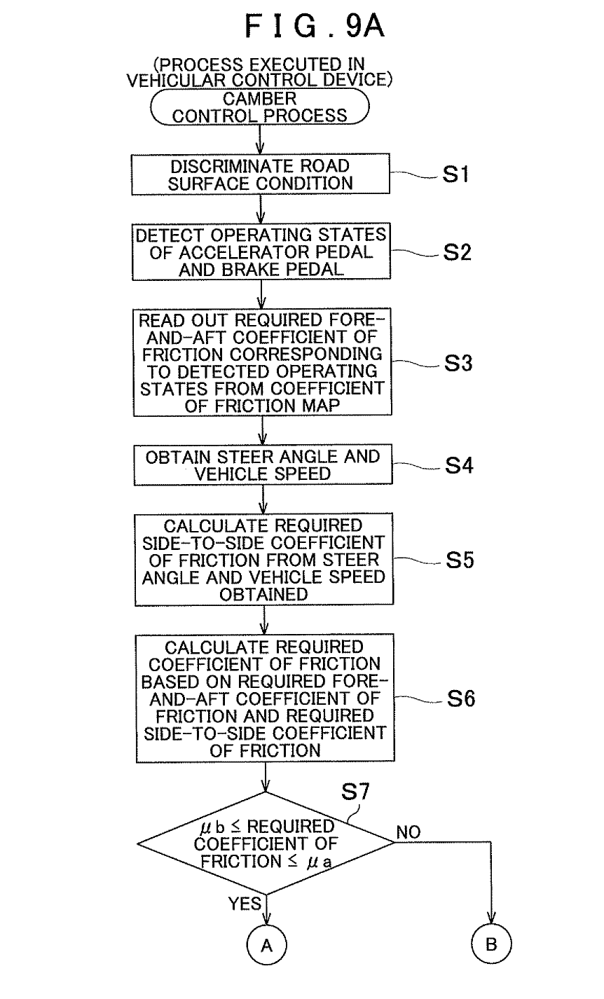

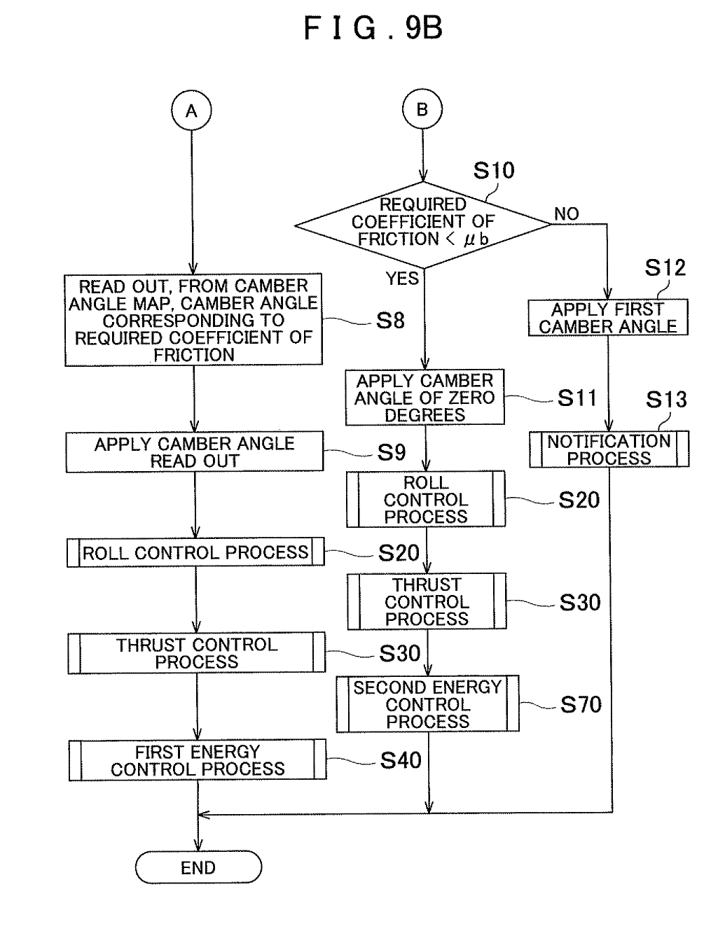

The CPU 71 is a computing device that controls each portion connected thereto through the bus line 74. The ROM 72 is a non-rewritable nonvolatile memory that stores control programs (such as the programs represented by flow charts illustrated in FIGS. 9 to 14) executed by the CPU 71, fixed value data, and others. In addition, the ROM 72 is provided with a coefficient of friction map 72a and a camber angle map 72b.

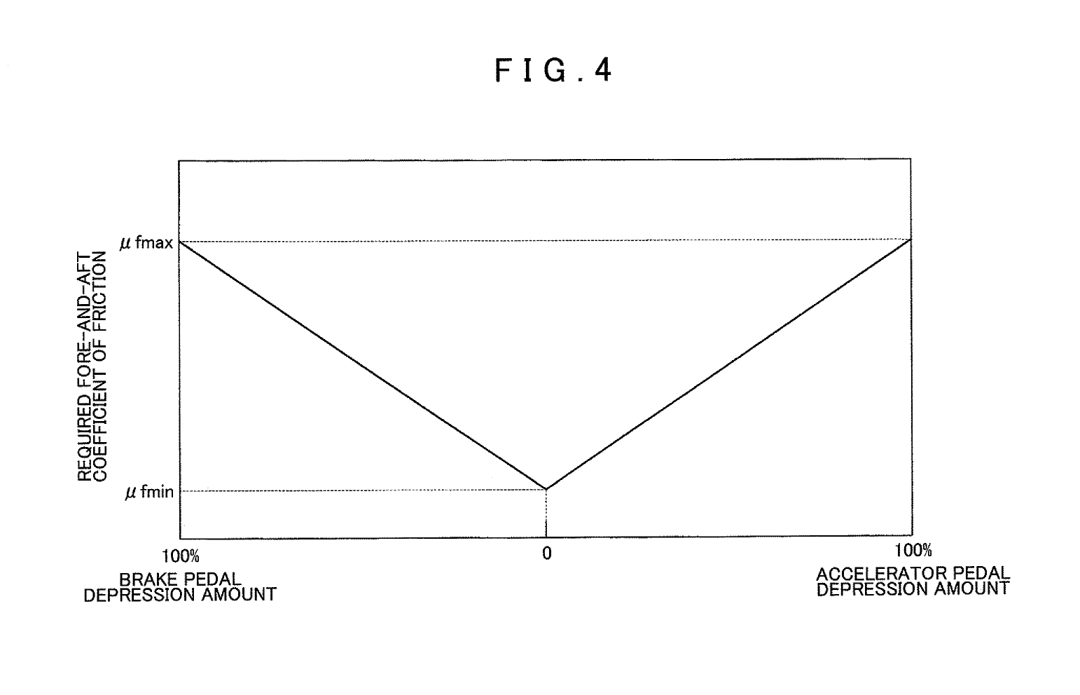

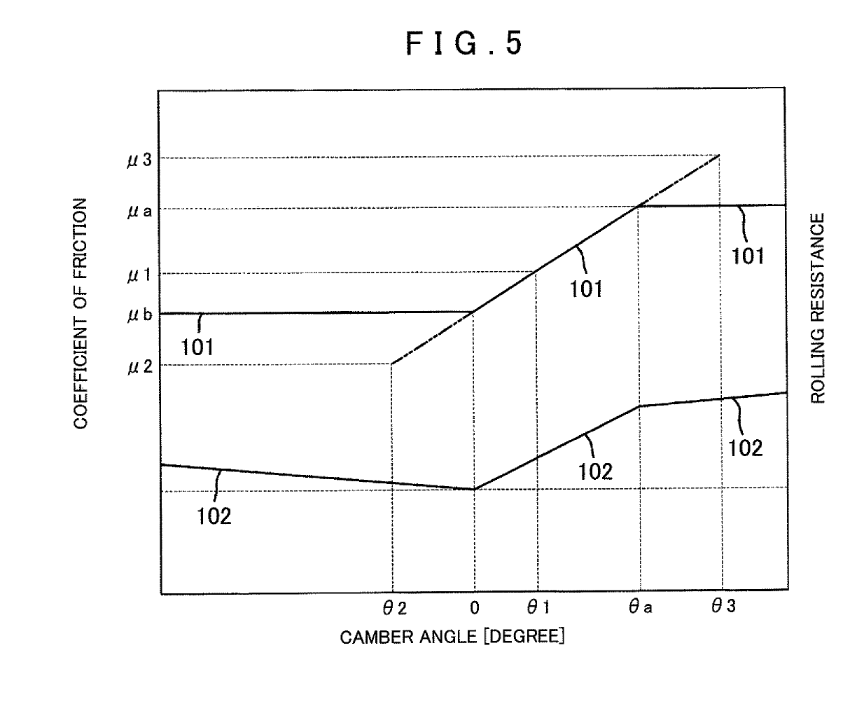

Here, the details of the coefficient of friction map 72a and the camber angle map 72b will be described with reference to FIGS. 4 and 5. FIG. 4 is a schematic diagram schematically illustrating a content of the coefficient of friction map 72a. The coefficient of friction map 72a is a map preliminarily storing a relation of the depression amount of the accelerator pedal 52 and the brake pedal 53 to a required fore-and-aft coefficient of friction.

Based on a content of this coefficient of friction map 72a, the CPU 71 obtains the required fore-and-aft coefficient of friction that is a coefficient of friction to be retained in the wheels 2 (that is, a minimum coefficient of friction required so as to prevent the wheels 2 from slipping relative to the traveling road surface) in the current traveling mode of the vehicle 1. Note that the required fore-and-aft coefficient of friction shown in the vertical axis represents the minimum coefficient of friction in the fore-and-aft direction of the vehicle 1, that is, the coefficient of friction in the direction FWD of travel of the vehicle 1 (refer to FIG. 1), required so as to prevent the wheels 2 from slipping.

According to this coefficient of friction map 72a, as shown in FIG. 4, the required fore-and-aft coefficient of friction is defined to have a minimum value μfmin in the state in which neither the accelerator pedal 52 nor the brake pedal 53 is depressed (depression amounts of the accelerator pedal 52 and the brake pedal 53=0), and then increasing linearly in proportion to the depression amount of the accelerator pedal 52 or the brake pedal 53, the required fore-and-aft coefficient of friction is defined to have a maximum value of μfmax in the state in which the accelerator pedal 52 or the brake pedal 53 is depressed to a maximum level (depression amount of the accelerator pedal 52 or the brake pedal 53=100%).

FIG. 5 is a schematic diagram schematically illustrating a content of the camber angle map 72b. The camber angle map 72b is a map preliminarily storing relations of the coefficient of friction and the rolling resistance of the wheels 2 with the camber angle, and represents the coefficient of friction achievable by the wheels 2, that is, the coefficient of friction that the wheels 2 can generate between themselves and the traveling road surface. Note that the camber angle map 72b is based on actual measurement values measured with respect to the wheels 2.

The CPU 71 determines a camber angle to be applied to the wheels 2 based on the content of this camber angle map 72b. Note that, in FIG. 5, solid lines 101 and 102 correspond to the coefficient of friction and the rolling resistance, respectively. In addition, the right side and the left side in FIG. 5 correspond to the negative direction and the positive direction, respectively, of the camber angle shown in the horizontal axis.

Here, although the camber angle map 72b stores three types of maps corresponding to the above-described three operating states of the road surface condition switch 55, FIG. 5 illustrates only one type of map (dry paved road map) as a representative example and omits illustration of other two types of maps in order to simplify the drawing so as to facilitate understanding.

That is, the camber angle map 72b stores three types of maps, that is, the dry paved road map, an unpaved road map, and a wet paved road map. The CPU 71 detects the operating state of the road surface condition switch 55, then reads out the dry paved road map if the dry paved road is selected as the traveling road surface, the unpaved road map if the unpaved road is selected as the traveling road surface, or the wet paved road map if the wet paved road is selected as the traveling road surface, and then determines the camber angle to be applied to the wheel 2 based on the content of the map. That is, the CPU 71 judges (discriminates) the road surface condition of the traveling road surface on which the vehicle 1 runs based on the operating state of the road surface condition switch 55, in traveling road surface judging means (refer to S1 in FIG. 9A).

Note that, although the road surface condition is judged by detecting the operating state of the road surface condition switch 55 in the present embodiment, the road surface condition may be judged by other methods. Examples of the other methods include use of an information terminal such as a navigation device installed in the vehicle, a network such as the Internet, or an operating condition of a vehicle wiper system or an ABS for emergency braking.

According to this camber angle map 72b, the coefficient of friction reaches a minimum value μb in the state in which the camber angle is zero degrees (that is, the first tread 21 and the second tread 22 are evenly in contact with the ground), as shown in FIG. 5. Note that the rolling resistance also reaches a minimum value in the same way.

When the camber angle changes in the negative direction from zero degrees (that is, the first tread 21 and the second tread 22 are evenly in contact with the ground), the ground contact area of the first tread 21 of a high gripping property gradually increases (the ground contact area of the second tread 22 of a low rolling resistance gradually decreases) along with the camber angle change. Accordingly, the coefficient of friction and the rolling resistance gradually increase.

Then, when the camber angle reaches θa (hereinafter called “first camber angle θa”), the second tread 22 lifts from the traveling road surface, resulting in the state in which only the first tread 21 is in contact with the ground and thereby the coefficient of friction reaches a maximum value μa.

Note that, because the second tread 22 has already lifted from the traveling road surface even if the camber angle further changes in the negative direction from the first camber angle θa, the coefficient of friction hardly changes and thus is maintained at the maximum value μa.

On the other hand, the change in the rolling resistance shows a gradual increase along with the change in the camber angle even after the camber angle has reached the first camber angle θa. That is, the rolling resistance gradually increases because the camber angle changes in the negative direction and a camber thrust gradually increases along with the camber angle change.

Here, after the camber angle has reached the first camber angle θa, the coefficient of friction is maintained constant while the rolling resistance increases. The reason for this is that, in general, the change in the coefficient of friction is more influenced by the high gripping property of the first tread 21 than by the camber thrust.

On the other hand, as shown in FIG. 5, in the range on the positive side of zero degrees, even if the camber angle changes in the positive direction from zero degrees (that is, the first tread 21 and the second tread 22 are evenly in contact with the ground), the coefficient of friction hardly changes and thus is maintained at the minimum value μb.

That is, the coefficient of friction is maintained at the minimum value μb although the camber angle changes in the positive direction from zero degrees and the ground contact area of the second tread 22 of a low rolling resistance gradually increases (the ground contact area of the first tread 21 of a high gripping property gradually decreases) along with the camber angle change.

The reason for this is that, in general, the ground contact of the second tread 22 prevents the ground contact of the first tread 21 from contributing to the high gripping property because the second tread 22 of a low rolling resistance is configured to have a higher hardness than that of the first tread 21 of a high gripping property.

On the other hand, the change in the rolling resistance shows a gradual increase along with the change in the camber angle. That is, the rolling resistance gradually increases because the camber angle changes in the positive direction and the camber thrust gradually increases along with the change.

Here, the coefficient of friction is maintained constant while the rolling resistance increases. The reason for this is that, in the same manner as described above, in general, the change in the coefficient of friction is more influenced by the low rolling resistance of the second tread 22 than by the camber thrust.

Here, the unpaved road map and the wet paved road map omitted from illustration in FIG. 5 are obtained by shifting the solid lines of the dry paved road map in a parallel manner in the direction in which the coefficient of friction and the rolling resistance decrease. In addition, in either of the maps, the coefficient of friction and the rolling resistance reach minimum values at a camber angle of zero degrees, and the coefficient of friction reaches a maximum value at a camber angle of the first camber angle θa.

Description will be made referring back to FIG. 3. The RAM 73 is a memory for storing various pieces of data in a rewritable manner while the control programs are executed. In addition, the RAM 73 is provided with an energy consumption memory 73a.

The an energy consumption memory 73a is a memory for storing detection results (electric current values) of current sensors 35FL to 35RR received from a current sensor device 35 to be described later to the CPU 71, and configured to be capable of storing results of a plurality of times (eight times in the present embodiment) of detection.

The CPU 71 is capable of calculating an average value (average current value) of the results of the plurality of times of detection based on a content of the energy consumption memory 73a. Note that the content of the energy consumption memory 73a is configured so that all of the data items (detection results) are cleared when the CPU 71 has calculated the average value.

The wheel driving mechanism 3 is a device for rotationally driving the wheels 2 (refer to FIG. 1) by supplying driving power from a battery (not shown), and mainly provided with the four FL-RR motors 3FL to 3RR that apply rotational driving forces to the wheels 2 and a control circuit (not shown) that controls the drive of the motors 3FL to 3RR based on commands from the CPU 71.

The camber angle applying device 4 is a device for adjusting the steer angle and the camber angle of each of the wheels 2, and mainly provided with the four FL-RR actuators 4FL to 4RR that apply driving forces for adjusting angles to the wheels 2 (wheel driving mechanism 3) and a control circuit (not shown) that controls the drive of the actuators 4FL to 4RR based on commands from the CPU 71.

Note that each of the FL-RR actuators 4FL to 4RR is mainly structured by having the three hydraulic cylinders 4a to 4c, a hydraulic pump 4d (refer to FIG. 1) that supplies oil (hydraulic pressure) to the hydraulic cylinders 4a to 4c, and solenoid valves (not shown) that switch the feeding direction of the oil supplied from the hydraulic pump to the hydraulic cylinders 4a to 4c.

When the control circuit of the camber angle applying device 4 controls the drive of the hydraulic pump based on a command from the CPU 71, the oil (hydraulic pressure) supplied from the hydraulic pump drives to expand or contract the hydraulic cylinders 4a to 4c. In addition, when the solenoid valves are switched on or off, the driving directions (expansion or contraction) of the hydraulic cylinders 4a to 4c are switched.

The control circuit of the camber angle applying device 4 monitors the steer angle and the camber angle of each of the wheels 2 by using a steering sensor device 54a and a camber angle sensor device 30 to be described later, and stops the drive for expansion or contraction of each of the hydraulic cylinders 4a to 4c when a target value (amount of expansion or contraction) indicated by the CPU 71 is attained. Note that results of detection by the steering sensor device 54a and the camber angle sensor device 30 are output to the CPU 71, and the CPU 71 is capable of obtaining the steer angle and the camber angle of each of the wheels 2 based on the detection results.

The camber angle sensor device 30 is a device for detecting the camber angles of the wheels 2 and then outputting the detection results to the CPU 71, and provided with four FL-RR distance sensors 30FL to 30RR that measure distances to objects and a processing circuit (not shown) that processes the detection results of the distance sensors 30FL to 30RR and outputs the processed results to the CPU 71.

Note that, in the present embodiment, the distance sensors 30FL to 30RR are structured as millimeter-wave radars that measure distances to objects based on the propagation time of millimeter wave or the frequency difference caused by Doppler effect. Each of these distance sensors 30FL to 30RR is arranged in the vehicle body frame BF (refer to FIG. 1), and measures the distance to the back side of each element of the wheel driving mechanism 3. Based on the detection results of the distance sensors 30FL to 30RR received from the camber angle sensor device 30, the CPU 71 calculates the camber angles of the corresponding wheels 2 as follows.

For example, focusing attention on the left front wheel 2FL, if a gap in the height direction of the vehicle 1 between the line (virtual line Xf-Xb in FIG. 2) that serves as a center of rotation of the wheel driving mechanism 3 when a camber angle is applied and the FL distance sensor 30FL is denoted as g, and if a distance detected by the FL distance sensor 30FL is denoted as d, the camber angle θFL of the left front wheel 2FL is represented as θFL=a tan (d/g).

An acceleration sensor device 31 is a device for detecting accelerations of the vehicle 1 (vehicle body frame BF) and then outputting the detection results to the CPU 71, and provided with fore-and-aft and side-to-side acceleration sensors 31a and 31b, and a processing circuit (not shown) that processes the detection results of the acceleration sensors 31a and 31b, and outputs the processed results to the CPU 71.

The fore-and-aft acceleration sensor 31a is a sensor that detects an acceleration of the vehicle body frame BF in the fore-and-aft direction of the vehicle 1, and the side-to-side acceleration sensor 31b is a sensor that detects an acceleration of the vehicle body frame BF in the side-to-side direction of the vehicle 1. Note that, in the present embodiment, these acceleration sensors 31a and 31b are configured as piezoelectric sensors using piezoelectric elements.

The CPU 71 integrates in time the detection results (acceleration values) of the acceleration sensors 31a and 31b received from the acceleration sensor device 31 to calculate velocities in two directions (fore-and-aft and side-to-side directions) and synthesizes the two directional components, thus being capable of obtaining the vehicle speed of the vehicle 1.

A ground contact load sensor device 32 is a device for detecting loads received by ground contact surfaces of the wheels 2 from the traveling road surface and then outputting the detection results to the CPU 71, and provided with FL-RR load sensors 32FL to 32RR that detect the loads received by the corresponding wheels 2 and a processing circuit (not shown) that processes the detection results of the load sensors 32FL to 32RR and outputs the processed results to the CPU 71.

Note that, in the present embodiment, the load sensors 32FL to 32RR are configured as piezoresistive three-axis load sensors. These load sensors 32FL to 32RR are arranged on suspension axes (not shown) of the corresponding wheels 2 and detect the loads received by the wheels 2 from the traveling road surface as three directional components in the fore-and-aft, side-to-side, and height directions of the vehicle 1.

Based on the detection results of the load sensors 32FL to 32RR received from the ground contact load sensor device 32, the CPU 71 estimates the coefficient of friction on the ground contact surface of each of the wheels 2 relative to the traveling road surface as follows.

For example, focusing attention on the left front wheel 2FL, if the loads in the fore-and-aft, side-to-side, and height directions of the vehicle 1 detected by the FL load sensor 32FL are denoted as Fx, Fy, and Fz, respectively, a coefficient of friction μx in the fore-and-aft direction of the vehicle 1 on the ground contact surface of the left front wheel 2FL relative to the traveling road surface is estimated to be Fx/Fz (μx=Fx/Fz) in the slip condition in which the left front wheel 2FL slips, and to be a value larger than Fx/Fz (μx>Fx/Fz) in the non-slip condition in which the left front wheel 2FL does not slip.

Note that, similarly in the case of a coefficient of friction μy in the side-to-side direction of the vehicle 1, the coefficient of friction μy is estimated as μy=Fy/Fz in the slip condition, and estimated to be a value larger than Fy/Fz in the non-slip condition. Moreover, it is obviously possible to estimate the coefficients of friction by other methods. Examples of the other methods include the related art technologies disclosed in Japanese Patent Application Publication Nos. JP-A-2001-315633 and JP-A-2003-118554.

A rotational angular velocity sensor device 33 is a device for detecting rotational angular velocities of the vehicle 1 (vehicle body frame BF) and then outputting the detection results to the CPU 71, and provided with a gyroscopic sensor 33a that detects rotational directions and rotational angular velocities about the fore-and-aft axis, side-to-side axis, and height axis passing through the center of the vehicle body frame BF and a processing circuit (not shown) that processes the detection results of the gyroscopic sensor 33a and outputs the processed results to the CPU 71.

Note that, in the present embodiment, the gyroscopic sensor is composed of an optical fiber gyroscope operating by using the principle of Sagnac effect. However, it is obviously possible to use other types of gyroscopic sensor. Examples of the other types of gyroscopic sensor include a mechanical gyroscopic sensor and a piezoelectric gyroscopic sensor.

The CPU 71 integrates in time the detection results (rotational angular velocity values) of the gyroscopic sensor 33a received from the rotational angular velocity sensor device 33 to calculate rotation angles in three directions (fore-and-aft, side-to-side, and height directions), thus being capable of obtaining a pitch angle, a roll angle, and a yaw angle of the vehicle 1.

A thrust load sensor device 34 is a device for detecting thrust loads acting on the wheels 2 in the side-to-side direction of the vehicle 1 and then outputting the detection results to the CPU 71, and provided with FL-RR load sensors 34FL to 34RR that detect the loads acting on the corresponding wheels 2 and a processing circuit (not shown) that processes the detection results of the load sensors 34FL to 34RR and outputs the processed results to the CPU 71. Note that, in the present embodiment, the load sensors 34FL to 34RR are configured as piezoelectric sensors using piezoelectric elements.

The CPU 71 is capable of obtaining the thrust forces acting on the wheels 2 in the side-to-side direction of the vehicle 1, based on the detection results of the load sensors 34FL to 34RR received from the thrust load sensor device 34.

The current sensor device 35 is a device for detecting electric current values conducted to the wheel driving mechanism 3 and then outputting the detection results to the CPU 71, and provided with the FL-RR current sensors 35FL to 35RR that detect the electric current values conducted to the FL-RR motors 3FL to 3RR, respectively, and a processing circuit (not shown) that processes the detection results of the current sensors 35FL to 35RR and outputs the processed results to the CPU 71.

The CPU 71 is capable of storing the detection results (electric current values) of the current sensors 35FL to 35RR received from the current sensor device 35 in the energy consumption memory 73a, and calculating the average value (average current value) of the results of the plurality of times (eight times in the present embodiment) of detection, based on the content of the energy consumption memory 73a.

An accelerator pedal sensor device 52a is a device for detecting the state of depression of the accelerator pedal 52 and then outputting the detection result to the CPU 71, and mainly provided with an angle sensor (not shown) that detects the depression amount of the accelerator pedal 52 and a processing circuit (not shown) that processes the detection result of the angle sensor and outputs the processed result to the CPU 71.

A brake pedal sensor device 53a is a device for detecting the state of depression of the brake pedal 53 and then outputting the detection result to the CPU 71, and mainly provided with an angle sensor (not shown) that detects the depression amount of the brake pedal 53 and a processing circuit (not shown) that processes the detection result of the angle sensor and outputs the processed result to the CPU 71.

The steering sensor device 54a is a device for detecting the operating state of the steering 54 and then outputting the detection result to the CPU 71, and mainly provided with an angle sensor (not shown) that detects the rotational direction and the rotation angle of the steering 54 and a processing circuit (not shown) that processes the detection result of the angle sensor and outputs the processed result to the CPU 71.

Note that, in the present embodiment, the angle sensors are configured as contact type potentiometers using electrical resistance. The CPU 71 obtains the depression amounts of the pedals 52 and 53, and the rotation angle of the steering 54 based on the detection results of the angle sensors received from the sensor devices 52a, 53a, and 54a, and differentiates in time the detection results, thus being capable of calculating the depression speeds of the pedals 52 and 53, and a rotational speed of the steering 54. The CPU 71 is also capable of obtaining the steer angle of the wheels 2 based on the detection result of the angle sensor received from the steering sensor device 54a.

A road surface condition switch sensor device 55a is a device for detecting the operating state of the road surface condition switch 55 and then outputting the detection result to the CPU 71, and provided with a positioning sensor (not shown) that detects the operating position of the road surface condition switch 55 and a processing circuit (not shown) that processes the detection result of the positioning sensor and outputs the processed result to the CPU 71.

The CPU 71 is capable of judging (discriminating) the state of the traveling road surface (dry paved road, unpaved road, or wet paved road) based on the operating state of the road surface condition switch 55 received from the road surface condition switch sensor device 55a.

Examples of other input/output devices 36 shown in FIG. 3 include a device for detecting rotational speeds of the wheels 2.

Next, a detailed structure of the wheels 2 will be described with reference to FIGS. 6 to 8. FIG. 6 is a schematic diagram schematically showing a top view of the vehicle 1. FIGS. 7 and 8 are schematic diagrams schematically showing front views of the vehicle 1. FIG. 7 illustrates the state in which camber angles in the negative direction are applied to the wheels 2, and FIG. 8 illustrates the state in which camber angles in the positive direction are applied to the wheels 2.

As described above, each of the wheels 2 is provided with the two types of treads, that is, the first tread 21 and the second tread 22. In each of the wheels 2, the first tread 21 is arranged on the inner side of the vehicle 1, and the second tread 22 is arranged on the outer side of the vehicle 1, as shown in FIG. 6. Note that, in the present embodiment, both treads 21 and 22 are configured to have the same width (right-left dimension in FIG. 6) as each other.

Here, for example, as shown in FIG. 7, when the camber angle applying device 4 is controlled in operation to apply camber angles θL and θR in the negative direction to the wheels 2, the ground contact area of the first tread 21 arranged on the inner side of the vehicle 1 increases, and the ground contact area of the second tread 22 arranged on the outer side of the vehicle 1 decreases. With this operation, the high gripping property of the first tread 21 can be used to ensure the running performance (such as a turning performance, an accelerating performance or a braking performance) of the vehicle 1.

On the other hand, as shown in FIG. 8, when the camber angle applying device 4 is controlled in operation to apply camber angles θL and θR in the positive direction to the wheels 2, the ground contact area of the first tread 21 arranged on the inner side of the vehicle 1 decreases, and the ground contact area of the second tread 22 arranged on the outer side of the vehicle 1 increases. With this operation, the low rolling resistance of the second tread 22 can be used to reduce the energy consumption of the vehicle 1.

Next, a camber control process will be described with reference to FIGS. 9A and 9B. FIGS. 9A and 9B show a flow chart of the camber control process. This process is a process executed repeatedly (for example, at intervals of 0.2 ms) by the CPU 71 while the vehicular control device 100 is powered on.

With respect to the camber control process, the CPU 71 first discriminates the road surface condition (state of the traveling road surface) (S1). This process is accomplished by detecting the operating state of the road surface condition switch 55 with the road surface condition switch sensor device 55a (refer to FIG. 3). That is, as described above, the CPU 71 judges the road surface condition as that of the dry paved road if the operating position of the road surface condition switch 55 is the first position, or as that of the unpaved road in the case of the second position, or discriminates the road surface condition as that of the wet paved road in the case of the third position.

Next, the accelerator pedal sensor device 52a and the brake pedal sensor device 53a detect the operating states of the accelerator pedal 52 and the brake pedal 53, respectively (S2), and then the CPU 71 reads out the required fore-and-aft coefficient of friction corresponding to the detected operating states from the coefficient of friction map 72a (refer to FIG. 4) (S3). With these processes, it is possible to obtain the minimum required coefficient of friction in the fore-and-aft direction of the vehicle 1 so as to prevent the wheels 2 from slipping relative to the traveling road surface.

Next, the CPU 71 obtains the steer angle of the wheels 2 and the vehicle speed of the vehicle 1 (S4), and calculates a required side-to-side coefficient of friction from the steer angle and the vehicle speed thus obtained (S5). Note that, as described above, the CPU 71 obtains the steer angle of the wheels 2 and the vehicle speed of the vehicle 1, based on the detection result of the angle sensor received from the steering sensor device 54a and the detection results of the acceleration sensors 31a and 31b received from the acceleration sensor device 31.

Here, the required side-to-side coefficient of friction is a minimum required coefficient of friction in the side-to-side direction of the vehicle 1 so as to prevent the wheels 2 from slipping relative to the traveling road surface while the vehicle 1 is turning, and calculated as follows. That is, first of all, the relation among the steer angle a of the wheels 2, an Ackermann turning radius R0, and a wheelbase L can be represented as tan σ=L/R0. If the steer angle a is a small angle, this relational expression can be approximated as σ=L/R0. By transforming this expression with respect to the Ackermann turning radius R0, the expression R0=L/σ can be obtained.

On the other hand, the relation between an actual turning radius R and a vehicle speed V of the vehicle 1 can be represented as R/R0=1+K·V2 by using a stability factor K that has been measured with respect to the vehicle 1. By transforming this expression with respect to the actual turning radius R and substituting the Ackermann turning radius R0 obtained above, the expression R=L(1+K·V2)/σ can be obtained.

Here, by denoting a weight of the vehicle 1 as M, a centrifugal force F acting on the vehicle 1 during turning is represented as F M·V2/R, and by substituting the actual turning radius R obtained above into this expression, the expression F=M·V2·σ/(L(1+K·V2)) can be obtained. Because the coefficient of friction for avoiding the wheels 2 from slipping in the lateral direction (side-to-side direction of the vehicle 1) should only have a value larger than this centrifugal force F, the required side-to-side coefficient of friction μw can be represented as μw=F/M=V2·σ/(L(1+K·V2)) by dividing the centrifugal force F by the weight M.

After obtaining the required fore-and-aft coefficient of friction and the required side-to-side coefficient of friction in the processes of S3 and S5, the CPU 71 calculates the required coefficient of friction based on the required fore-and-aft coefficient of friction and the required side-to-side coefficient of friction (that is, as a resultant of vectors oriented in the fore-and-aft and side-to-side directions of the vehicle 1) (S6).

Next, the CPU 71 compares the required coefficient of friction calculated in the process of S6 with the maximum value μa and the minimum value μb of the coefficient of friction achievable by the wheels 2, and judges whether or not the required coefficient of friction is at the minimum value μb or more and the maximum value μa or less (S7).

Note that, as described above, the maximum value μa and the minimum value μb of the coefficient of friction achievable by the wheels 2 are read out from the camber angle map 72h (refer to FIG. 5). In addition, in this case, the CPU 71 selects from the three types of maps a map corresponding to the road surface condition discriminated in the process of S1, and reads out the maximum value μa and the minimum value μb based on the content of the map thus selected.

If it is judged that the required coefficient of friction is at the minimum value μb or more and the maximum value μa or less as a result of the process of S7 (S7: Yes), the CPU 71 reads out, from the camber angle map 72b, a camber angle corresponding to the required coefficient of friction (that is, providing the same coefficient of friction as the required coefficient of friction) (S8), then applies the camber angle thus read out to the wheels 2 (S9), and then proceeds to a roll control process (S20).

Specifically, for example, if the required coefficient of friction calculated in the process of S6 is μ1, the relation μb≦μ1≦μa is satisfied (S7: Yes) based on the camber angle map 72b shown in FIG. 5. Therefore, the CPU 71 reads out the camber angle corresponding to the required coefficient of friction μ1 as θ1 (S8), and applies the camber angle θ1 thus read out to the wheels 2 (S9).

With these processes, the slip of the wheels 2 can be suppressed by making the wheels 2 achieve the minimum required coefficient of friction. Consequently, the rolling resistance of the wheels 2 can be made smaller while suppressing the slip of the wheels 2, thereby enabling to aim at a further reduction in the energy consumption of the vehicle 1.

On the other hand, if it is judged that the required coefficient of friction is not between the minimum value μb and the maximum value μa, inclusive, as a result of the process of S7 (S7: No), the CPU 71 judges whether or not the required coefficient of friction is less than the minimum value μb (S10). As a result of the judgment, if it is judged that the required coefficient of friction is less than the minimum value μb (S10: Yes), the CPU 71 applies a camber angle of zero degrees to the wheels 2 (S11), and then proceeds to the roll control process (S20).

Specifically, for example, if the required coefficient of friction calculated in the process of S6 is μ2, the relation μ2<μb is satisfied (S10: Yes) based on the camber angle map 72b shown in FIG. 5. Therefore, the CPU 71 does not read out the camber angle corresponding to the required coefficient of friction μ2 as θ2, but determines the camber angle to be applied to the wheels 2 as zero degrees, and applies the camber angle thus determined to the wheels 2 (S11).

That is, if the required coefficient of friction calculated in the process of S6 is less than the minimum value μb of the coefficient of friction achievable by the wheels 2, the CPU 71 judges that applying a camber angle on the positive side of zero degrees to the wheels 2 does not provide a prospect for further reduction in the rolling resistance (reduction in energy consumption), and, as a result, determines the camber angle to be applied to the wheels 2 as zero degrees. Consequently, the rolling resistance of the wheels 2 is not increased in an unnecessary manner, thereby enabling to aim at a further reduction in the energy consumption of the vehicle 1.

On the other hand, if it is judged that the required coefficient of friction is not less than the minimum value μb, that is, if it is judged that the required coefficient of friction is larger than the maximum value μa, as a result of the process of S10 (S10: No), the CPU 71 applies the first camber angle θa to the wheels 2 (S12), then executes a notification process (S13), and then terminates the camber control process.

Specifically, for example, if the required coefficient of friction calculated in the process of S6 is μ3, the relation μa<μ3 is satisfied (S10: No) based on the camber angle map 72b shown in FIG. 5. Therefore, the CPU 71 does not read out the camber angle corresponding to the required coefficient of friction μ3 as θ3, but determines the camber angle to be applied to the wheels 2 as the first camber angle θa, and applies the camber angle θa thus determined to the wheels 2 (S12).

That is, if the required coefficient of friction calculated in the process of S6 is more than the maximum value μa of the coefficient of friction achievable by the wheels 2, the CPU 71 judges that applying a camber angle on the negative side of the first camber angle θa to the wheels 2 does not provide a prospect for further increase in the coefficient of friction (improvement in running performance), and, as a result, determines the camber angle to be applied to the wheels 2 as the first camber angle θa. Consequently, the rolling resistance of the wheels 2 is not increased in an unnecessary manner, thereby enabling to aim at a further reduction in the energy consumption of the vehicle 1.

Here, the notification process (S13) notifies the driver that the wheels 2 are slipping (or likely to slip) due to quick acceleration or the like by issuing the information via a speaker (not shown) or the like and showing the information on a display (not shown) or the like. Note that, if the vehicle 1 is in the accelerated state, the process of S13 may execute a step (for example, to reduce the rotational driving force of the wheel driving mechanism 3) to reduce the vehicle speed of the vehicle 1.

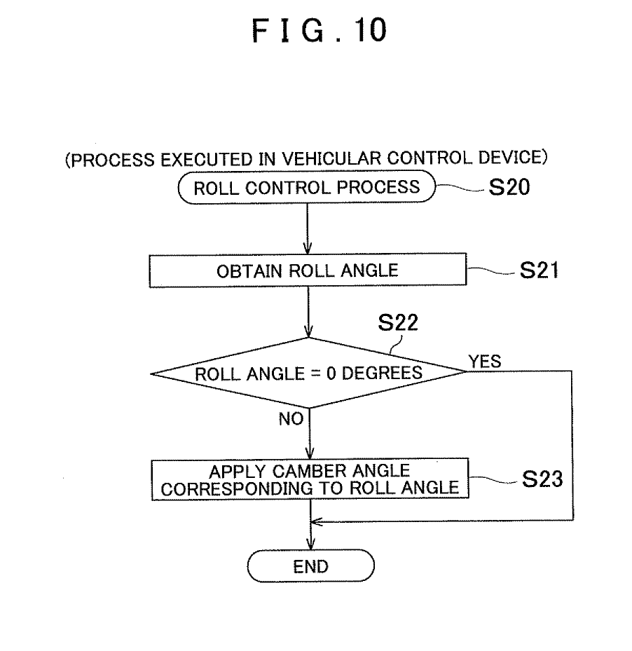

After executing the process of S9 or S11, the CPU 71 executes the roll control process (S20). Here, the roll control process (S20) will be described with reference to FIG. 10. FIG. 10 is a flow chart showing the roll control process (S20).

With respect to the roll control process (S20), the CPU 71 first obtains the roll angle of the vehicle 1 (S21), and judges whether or not the vehicle 1 rolls, that is, whether or not the roll angle is zero degrees or not (S22). Note that, as described above, the CPU 71 obtains the roll angle of the vehicle 1, based on the detection result of the gyroscopic sensor 33a received from the rotational angular velocity sensor device 33.

As a result of the judgment, if it is judged that the roll angle is zero degrees (S22: Yes), the CPU 71 skips the process of S23, and terminates the roll control process (S20). On the other hand, if it is judged that the roll angle is not zero degrees as a result of the process of S22 (S22: No), the vehicle 1 is judged as rolling. Therefore, the CPU 71 applies a camber angle corresponding to the roll angle obtained in the process of S21 to the wheels 2 (S23) so that the camber angle changes in the direction opposite to the direction of roll of the vehicle 1 (that is, in the rightward direction of the vehicle 1 when rolling in the leftward direction of the vehicle 1, and in the leftward direction of the vehicle 1 when rolling in the rightward direction of the vehicle 1), and then terminates the roll control process (S20).

With these processes, the change in the camber angle associated with the roll of the vehicle 1 can be corrected. As a result, the rolling resistance of the wheels 2 can be made smaller, thereby enabling to aim at a further reduction in the energy consumption of the vehicle 1. That is, for example, in the case in which the vehicle 1 receives a wind gust at an exit of a tunnel or a side wind on a bridge along a coast, in which the vehicle 1 receives a centrifugal force during turning, or in which the vehicle 1 is loaded with a cargo on a position biased to the right or left, the gap between the camber angle read out from the camber angle map 72b (refer to FIG. 5) and the camber angle actually formed by the wheels 2 relative to the traveling road surface can be eliminated. As a result, it is possible to aim at a further reduction in the energy consumption of the vehicle 1.

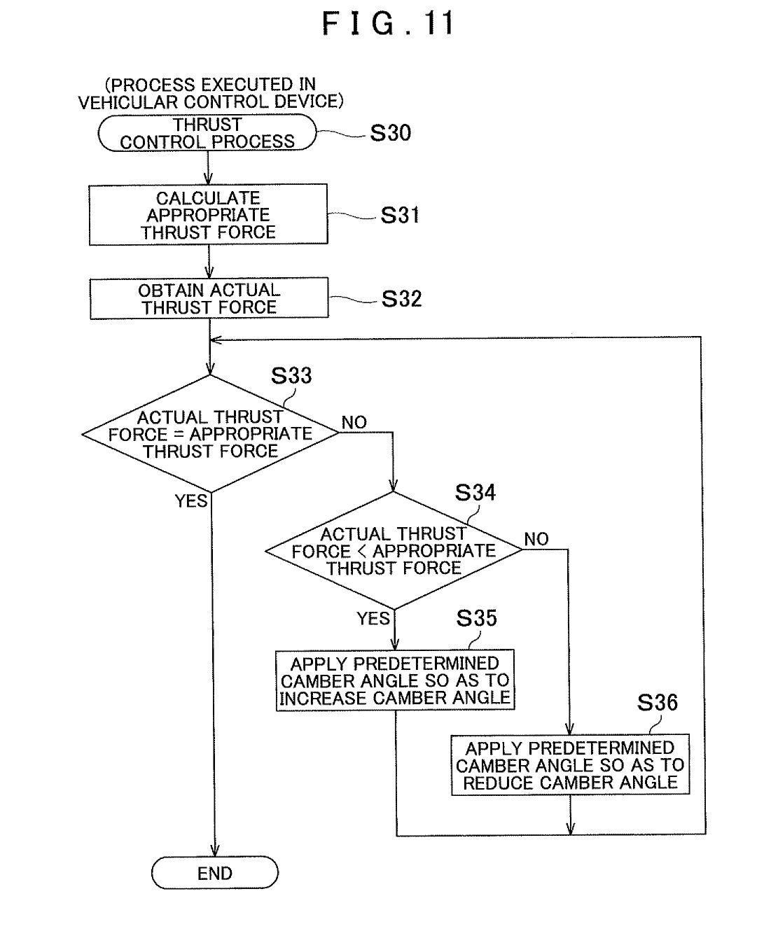

Description will be made referring back to FIGS. 9A and 9B. After executing the roll control process (S20), the CPU 71 subsequently executes a thrust control process (S30). Here, the thrust control process (S30) will be described with reference to FIG. 11. FIG. 11 is a flow chart showing the thrust control process (S30). Note that, instead of executing the thrust control process (S30), the camber angle may be controlled based on the amount of energy consumption such as electric power consumption or fuel consumption, in order to reduce the energy consumption.

With respect to the thrust control process (S30), the CPU 71 first calculates an appropriate thrust force (S31). Here, the appropriate thrust force is a theoretical thrust force in the side-to-side direction of the vehicle 1 to act on the wheels 2 in the current traveling mode of the vehicle 1. By denoting a cornering stiffness of the wheels 2 as C, a slip angle as β, the steer angle as δ, the camber angle as θ, an effective radius as r, a ground contact length as l, the wheelbase of the vehicle 1 as L, a yaw rate as γ, and the vehicle speed as V, the appropriate thrust force Fs is represented as Fs=−C(β+L·γ/2·V−δ−1·θ/R).

After executing the process of S31, the CPU 71 obtains an actual thrust force acting actually on the wheels 2 in the side-to-side direction of the vehicle 1 (S32), and judges whether or not the actual thrust force thus obtained equals the appropriate thrust force calculated in the process of S31 (S33). Note that, as described above, the CPU 71 obtains the actual thrust force acting on the wheels 2 in the side-to-side direction of the vehicle 1, based on the detection results of the load sensors 34FL to 34RR received from the thrust load sensor device 34.

As a result of the judgment, if it is judged that the actual thrust force equals the appropriate thrust force (S33: Yes), the CPU 71 skips the processes of S34 to S36, and terminates the thrust control process (S30).

On the other hand, if it is judged that the actual thrust force differs from the appropriate thrust force as a result of the process of S33 (S33: No), it is judged that a gap has occurred between the actual thrust force and the appropriate thrust force. Therefore, the CPU 71 judges whether or not the actual thrust force is smaller than the appropriate thrust force (S34).

As a result of the judgment, if it is judged that the actual thrust force is smaller than the appropriate thrust force (S34: Yes), the CPU 71 applies a predetermined camber angle (0.1 degree in the present embodiment) to the wheels 2 so that the camber angle increases (S35), and returns to the process of S33.

That is, the CPU 71 repeatedly executes the processes of S33 to S35 so as to reduce the gap between the actual thrust force and the appropriate thrust force by increasing the camber angle of the wheels 2 in increments of the predetermined camber angle (0.1 degree in the present embodiment) until the process of S33 judges that the actual thrust force equals the appropriate thrust force (S33: Yes).

With these processes, the rolling resistance of the wheels 2 can be made smaller, thereby enabling to aim at a further reduction in the energy consumption of the vehicle 1. That is, in the same manner as in the case of the roll control process (S20), the gap between the camber angle read out from the camber angle map 72b (refer to FIG. 5) and the camber angle actually formed by the wheels 2 relative to the traveling road surface can be eliminated. As a result, it is possible to aim at a further reduction in the energy consumption of the vehicle 1.

On the other hand, if it is judged that the actual thrust force is larger than the appropriate thrust force as a result of the process of S34 (S34: No), the CPU 71 applies the predetermined camber angle (0.1 degree in the present embodiment) to the wheels 2 so that the camber angle decreases (S36), and returns to the process of S33.

That is, the CPU 71 repeatedly executes the processes of S33, S34 and S36 so as to reduce the gap between the actual thrust force and the appropriate thrust force by reducing the camber angle of the wheels 2 in decrements of the predetermined camber angle (0.1 degree in the present embodiment) until the process of S33 judges that the actual thrust force equals the appropriate thrust force (S33: Yes).

With these processes, the rolling resistance of the wheels 2 can be made smaller, thereby enabling to aim at a further reduction in the energy consumption of the vehicle 1. That is, in the same manner as in the case of the roll control process (S20), the gap between the camber angle read out from the camber angle map 72b and the camber angle actually formed by the wheels 2 relative to the traveling road surface can be eliminated. As a result, it is possible to aim at a further reduction in the energy consumption of the vehicle 1.

Moreover, by executing the thrust control process (S30) in addition to the roll control process (S20), the energy consumption of the vehicle 1 can be reduced in a reliable manner.

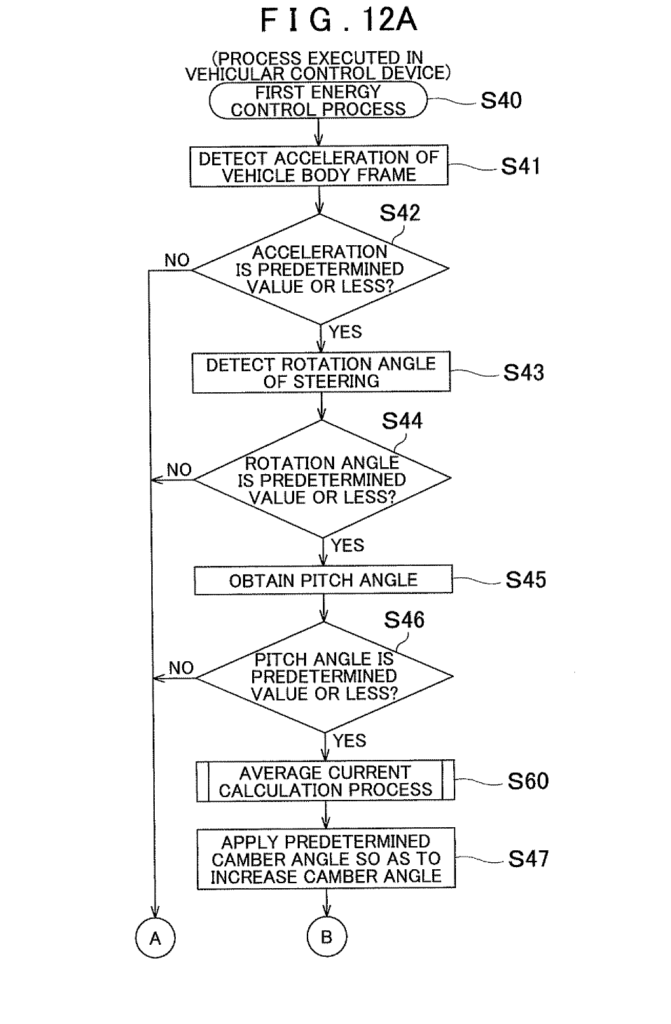

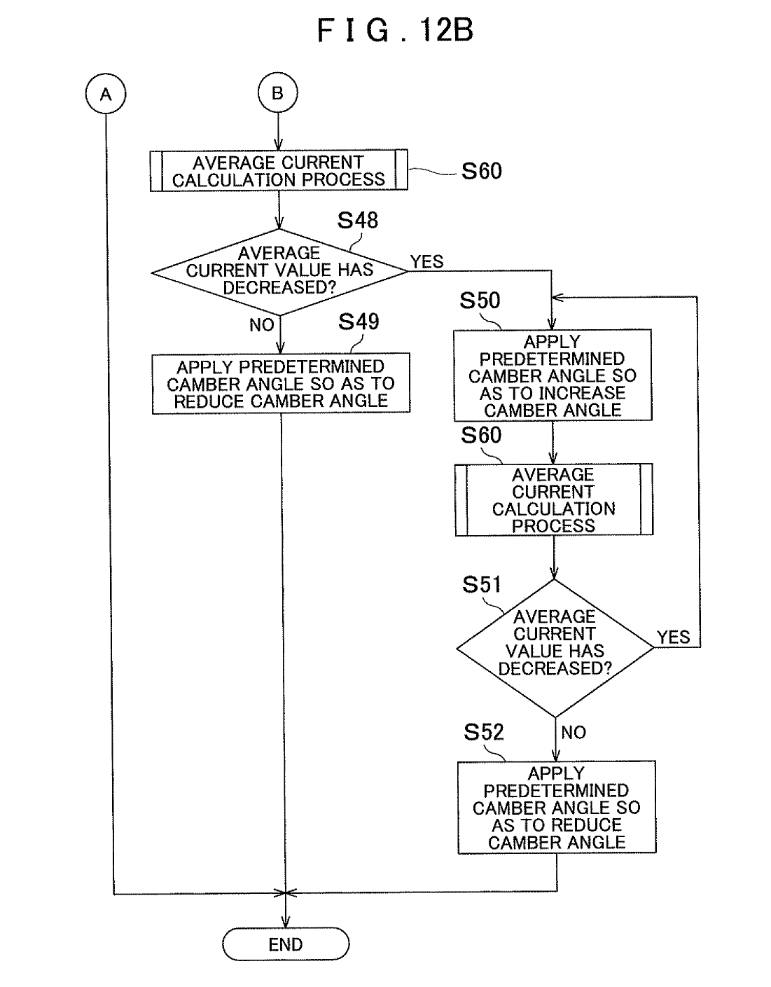

Description will be made referring back to FIGS. 9A and 9B. After executing the process of S9 applying the camber angle to the wheels 2, then the roll control process (S20) and the thrust control process (S30), the CPU 71 executes a first energy control process (S40), and terminates the camber control process. Here, the first energy control process (S40) will be described with reference to FIGS. 12A and 12B. FIGS. 12A and 12B show a flow chart of the first energy control process (S40).

With respect to the first energy control process (S40), the CPU 71 first detects the acceleration of the vehicle body frame BF in the fore-and-aft direction of the vehicle 1 with the acceleration sensor device 31 (S41), and judges whether or not the acceleration thus detected is a predetermined value or less (S42). Note that the process of S42 is executed by comparing the detected acceleration with a content of memory (not shown) storing threshold values that is provided in the ROM 72.

As a result of the judgment, if it is judged that the acceleration exceeds the predetermined value (S42: No), the CPU 71 terminates the first energy control process (S40). On the other hand, if it is judged that the acceleration is the predetermined value or less (S42: Yes), it is presumed that the vehicle 1 is running at a constant speed with almost no influence by wind or the like. Therefore, the CPU 71 subsequently detects the rotation angle of the steering 54 with the steering sensor device 54a (S43), and judges whether or not the rotation angle thus detected is a predetermined value or less (S44). Note that the process of S44 is executed by comparing the detected rotation angle with the content of memory (not shown) storing threshold values that is provided in the ROM 72.

As a result of the judgment, if it is judged that the rotation angle exceeds the predetermined value (S44: No), the CPU 71 terminates the first energy control process (S40). On the other hand, if it is judged that the rotation angle is the predetermined value or less (S44: Yes), it is presumed that the vehicle 1 is running straight ahead or turning along a mild curve. Therefore, the CPU 71 subsequently obtains the pitch angle of the vehicle 1 (S45), and judges whether or not the pitch angle thus obtained is a predetermined value or less (S46). Note that, as described above, the CPU 71 obtains the pitch angle of the vehicle 1, based on the detection result of the gyroscopic sensor 33a received from the rotational angular velocity sensor device 33. In addition, the process of S46 is executed by comparing the detected pitch angle with the content of memory (not shown) storing threshold values that is provided in the ROM 72.

As a result of the judgment, if it is judged that the pitch angle exceeds the predetermined value (S46: No), the CPU 71 terminates the first energy control process (S40). On the other hand, if it is judged that the pitch angle is the predetermined value or less (S46: Yes), it is presumed that the vehicle 1 is running on a flat road, and neither on an uneven road nor on a steep uphill or downhill road. Therefore, the CPU 71 subsequently executes an average current calculation process (S60).

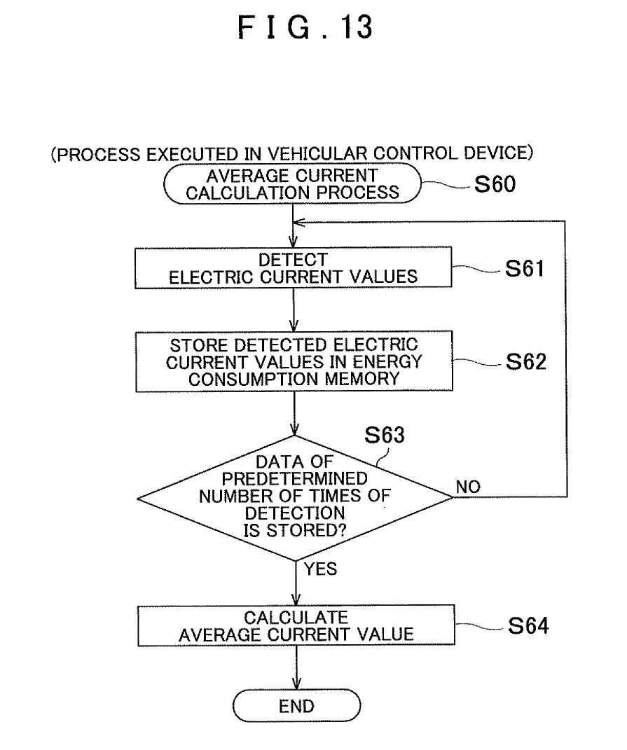

Here, the average current calculation process (S60) will be described with reference to FIG. 13. FIG. 13 is a flow chart showing the average current calculation process (S60). With respect to the average current calculation process (S60), the CPU 71 first detects the electric current values conducted to the FL-RR motors 3FL to 3RR with the current sensor device 35 (S61), and stores the detection results (electric current values) in the energy consumption memory 73a (S62).

Next, the CPU 71 judges whether or not the data (detection results) of a predetermined number of times (eight times in the present embodiment) of detection are stored in the energy consumption memory 73a (S63). As a result of the judgment, if it is judged that the data of the predetermined number of times of detection are not stored (S63: No), the CPU 71 returns to the process of S61.

That is, the CPU 71 repeatedly executes the processes of S61 to S63 so as to store the detection results in the energy consumption memory 73a at intervals of a predetermined time until the process of S63 judges that the data of the predetermined number of times of detection are stored (S63: Yes).

On the other hand, if it is judged that the data of the predetermined number of times of detection are stored as a result of the process of S63 (S63: Yes), the CPU 71 calculates the average current value based on the content of the energy consumption memory 73a (S64), and terminates the average current calculation process (S60).

Description will be made referring back to FIGS. 12A and 12B. After executing the average current calculation process (S60), the CPU 71 applies the predetermined camber angle (0.1 degree in the present embodiment) to the wheels 2 so that the camber angle increases (S47), then executes the average current calculation process (S60) again, and then judges whether or not the average current value calculated by the average current calculation process (S60) just executed has decreased from the average current value calculated by the average current calculation process (S60) before executing the process of S47 (S48).

As a result of the judgment, if it is judged that the average current value has increased (S48: No), the CPU 71 applies the predetermined camber angle (0.1 degree in the present embodiment) to the wheels 2 so that the camber angle decreases (S49), then terminates the first energy control process (S40).

On the other hand, if it is judged that the average current value has decreased as a result of the process of S48 (S48: Yes), the CPU 71 applies the predetermined camber angle (0.1 degree in the present embodiment) to the wheels 2 so that the camber angle increases (S50), then executes the average current calculation process (S60) again, and then judges whether or not the average current value calculated by the average current calculation process (S60) just executed has decreased from the average current value calculated by the average current calculation process (S60) before executing the process of S50 (S51).

As a result of the judgment, if it is judged that the average current value has decreased (S51: Yes), the CPU 71 returns to the process of S50. That is, the CPU 71 repeatedly executes the processes of S50, S60, and S51 so as to further reduce the average current value by increasing the camber angle of the wheels 2 in increments of the predetermined camber angle (0.1 degree in the present embodiment) until the process of S51 judges that the average current value has increased (S51: No).

On the other hand, if it is judged that the average current value has increased as a result of the process of S51 (S51: No), the CPU 71 applies the predetermined camber angle (0.1 degree in the present embodiment) to the wheels 2 so that the camber angle decreases (S52), then terminates the first energy control process (S40).

With these processes, the electric power consumption of the FL-RR motors 3FL to 3RR can be made smaller, thereby enabling to aim at a further reduction in the energy consumption of the vehicle 1. In addition, because the camber angle is increased to aim at reducing the energy consumption, the running performance of the vehicle 1 can be ensured in a reliable manner without reducing the coefficient of friction achieved by the wheels 2.

In addition, because the camber angle is corrected only if all of the acceleration of the vehicle body frame BF in the fore-and-aft direction of the vehicle 1, the rotation angle of the steering 54, and the pitch angle of the vehicle 1 are judged to be the corresponding predetermined values or less (S42: Yes, S44: Yes, and S46: Yes), the reduction in the energy consumption of the vehicle 1 can be achieved with high accuracy without being influenced by change in the traveling mode of the vehicle 1.

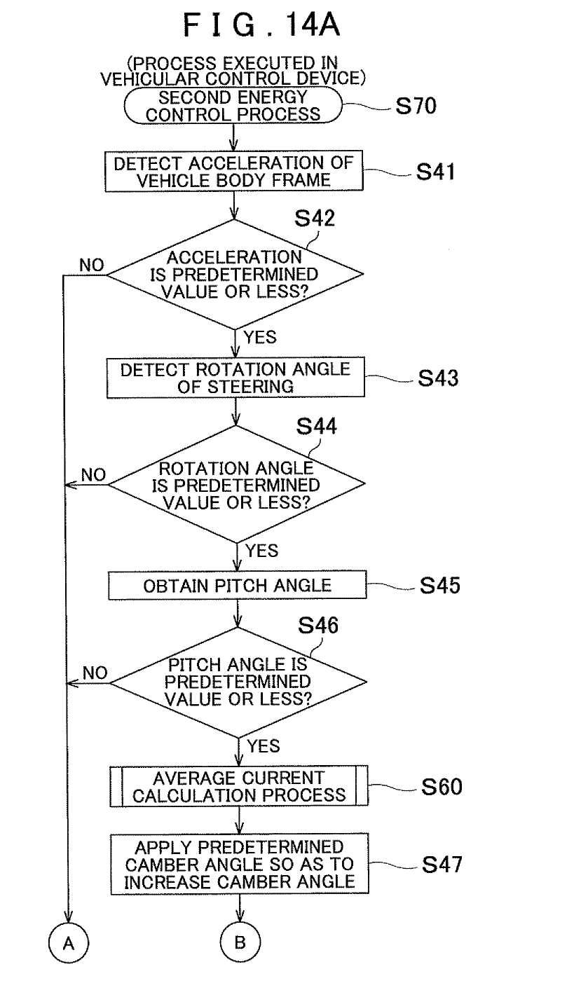

Description will be made referring back to FIGS. 9A and 9B. After executing the process of S11 applying the camber angle to the wheels 2, then the roll control process (S20), and then the thrust control process (S30), the CPU 71 executes a second energy control process (S70), and then terminates the camber control process. Here, the second energy control process (S70) will be described with reference to FIGS. 14A and 14B. FIGS. 14A and 14B show a flow chart of the second energy control process (S70). Note that, in the second energy control process (S70), the same parts as those of the first energy control process (S40) will be given the same reference numerals, and the description thereof will be omitted.

In the second energy control process (S70), after executing the process of S49, the CPU 71 executes the average current calculation process (S60), and then judges whether or not the average current value calculated by the average current calculation process (S60) just executed has decreased from the average current value calculated by the average current calculation process (S60) before executing the process of S49 (S71).

As a result of the judgment, if it is judged that the average current value has decreased (S71: Yes), the CPU 71 returns to the process of S49. That is, the CPU 71 repeatedly executes the processes of S49, S60, and S71 so as to further reduce the average current value by reducing the camber angle of the wheels 2 in decrements of the predetermined camber angle (0.1 degree in the present embodiment) until the process of S71 judges that the average current value has increased (S71: No).

On the other hand, if it is judged that the average current value has increased as a result of the process of S71 (S71: No), the CPU 71 applies the predetermined camber angle (0.1 degree in the present embodiment) to the wheels 2 so that the camber angle increases (S72), then terminates the second energy control process (S70).

With these processes, the electric power consumption of the FL-RR motors 3FL to 3RR can be made smaller, thereby enabling to aim at a further reduction in the energy consumption of the vehicle 1. In addition, because the camber angle is increased or reduced to aim at reducing the energy consumption, the energy consumption of the vehicle 1 can be reduced while ensuring the running performance thereof.

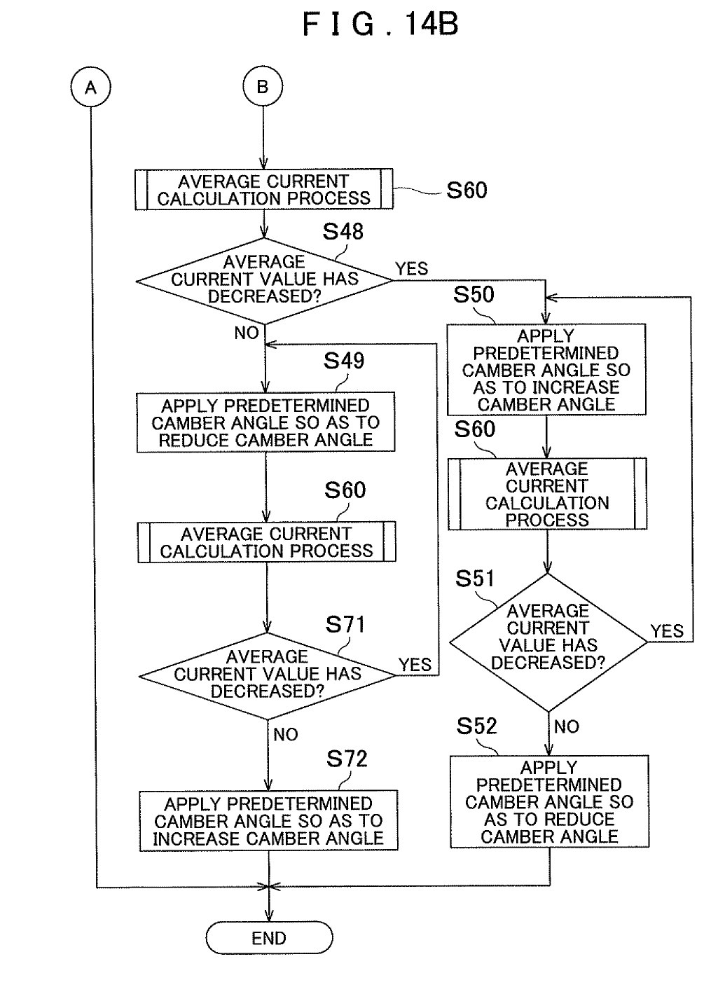

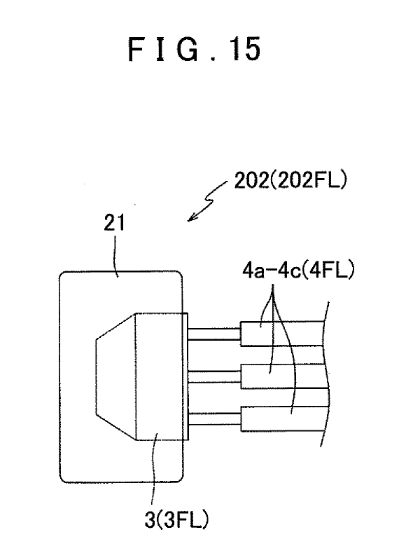

Next, a second embodiment will be described with reference to FIGS. 15 to 17. FIG. 15 is a top view of a wheel 202 according to the second embodiment. Whereas the first embodiment has been described of the case in which the wheel 2 is composed of the two types of treads (the first tread 21 and the second tread 22), the wheel 202 is composed of only one type of tread (first tread 21) in the second embodiment. Note that the same parts as those of the first embodiment will be given the same reference numerals, and the description thereof will be omitted.

As shown in FIG. 15, the wheel 202 according to the second embodiment is composed of only the first tread 21. Note that the wheel 202 is not necessarily composed of only the first tread 21 but may be composed of only the second tread 22.

Next, a camber angle map according to the second embodiment will be described with reference to FIG. 16. FIG. 16 is a schematic diagram schematically illustrating a content of the camber angle map according to the second embodiment. Note that the camber angle map shown in FIG. 16 is based on actual measurement values measured with respect to the wheel 202.

The CPU 71 determines a camber angle to be applied to the wheel 202 based on the content of this camber angle map. Note that, in FIG. 16, solid lines 201 and 202 correspond to the coefficient of friction and the rolling resistance, respectively. Although the camber angle map stores three types of maps corresponding to the three operating states of the road surface condition switch 55, FIG. 16 illustrates only one type of map (dry paved road map) as a representative example and omits illustration of other two types of maps in order to simplify the drawing so as to facilitate understanding.

According to this camber angle map, the coefficient of friction reaches a minimum value μb in the state in which the camber angle is zero degrees, as shown in FIG. 16. Note that the rolling resistance also reaches a minimum value in the same way.

When the camber angle changes in the negative direction from zero degrees, the camber thrust gradually increases as a portion of the wheel 202 on the inner side of a vehicle 201 is gradually deformed along with the camber angle change. Accordingly, the coefficient of friction and the rolling resistance gradually increase.

Then, when the camber angle reaches a maximum camber angle θal (hereinafter called “second camber angle θal”) that can be applied by the camber angle applying device 4, the coefficient of friction reaches a maximum value μa. The rolling resistance also reaches a maximum value at the second camber angle θal, in the same way.

In the same way, as shown in FIG. 16, when the camber angle changes in the positive direction from zero degrees, the camber thrust gradually increases as a portion of the wheel 202 on the outer side of the vehicle 201 is gradually deformed along with the camber angle change. Accordingly, the coefficient of friction and the rolling resistance gradually increase.

Then, when the camber angle reaches a maximum camber angle θbl (hereinafter called “third camber angle θbl”) that can be applied by the camber angle applying device 4, the coefficient of friction reaches a maximum value μa. The rolling resistance also reaches a maximum value at the third camber angle θbl, in the same way.

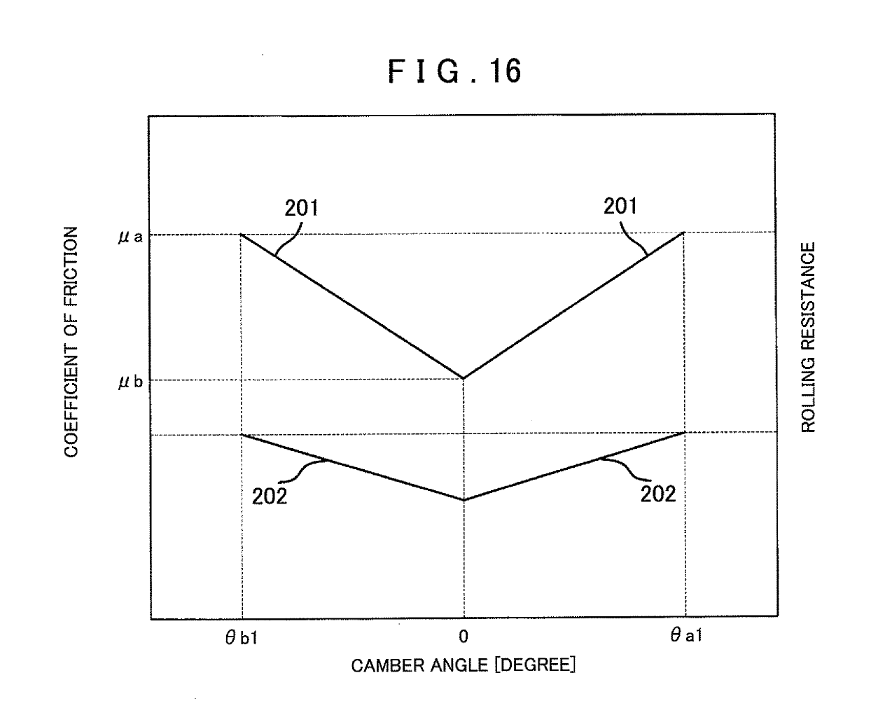

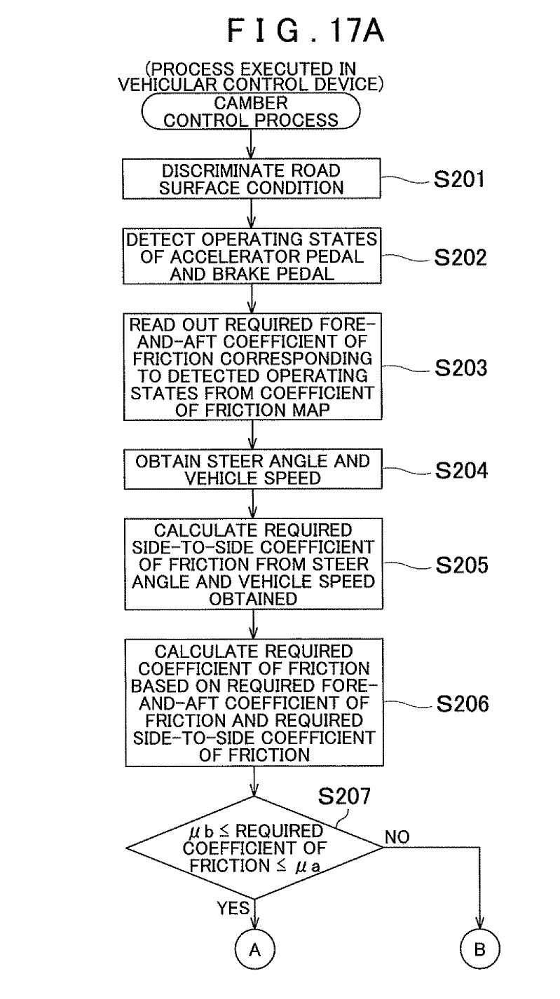

Next, a camber control process according to the second embodiment will be described with reference to FIGS. 17A and 17B. FIGS. 17A and 17B show a flow chart of the camber control process according to the second embodiment. This process is a process executed repeatedly (for example, at intervals of 0.2 ms) by the CPU 71 while the vehicular control device 100 is powered on.

With respect to the camber control process, in the same way as the first embodiment, the CPU 71 first discriminates the road surface condition (S201), then detects the operating states of the accelerator pedal 52 and the brake pedal 53 with the accelerator pedal sensor device 52a and the brake pedal sensor device 53a, respectively (S202), and then reads out the required fore-and-aft coefficient of friction corresponding to the detected operating states from the coefficient of friction map 72a (refer to FIG. 4) (S203).

Next, the CPU 71 obtains the steer angle of the wheels 202 and the vehicle speed of the vehicle 201 (S204), then calculates the required side-to-side coefficient of friction from the steer angle and the vehicle speed thus obtained (S205), then calculates the required coefficient of friction (S206), and subsequently judges whether or not the required coefficient of friction thus calculated is at the minimum value μb or more and the maximum value μa or less (S207).

As a result of the judgment, if it is judged that the required coefficient of friction is at the minimum value μb or more and the maximum value μa or less (S207: Yes), the CPU 71 reads out, from the camber angle map (refer to FIG. 16), camber angles corresponding to the required coefficient of friction (that is, providing the same coefficient of friction as the required coefficient of friction) on the negative side for the outer wheel during turning and on the positive side for the inner wheel during turning (S208), then applies the camber angles thus read out to the wheels 202 (S209), and then proceeds to the roll control process (S20).

With these processes, in the same way as the first embodiment, the slip of the wheels 202 can be suppressed by making the wheels 202 achieve the minimum required coefficient of friction. Consequently, the rolling resistance of the wheels 202 can be made smaller while suppressing the slip of the wheels 202, thereby enabling to aim at a further reduction in the energy consumption of the vehicle 201.

In addition, with the camber control process according to the present invention, because the camber angles are applied so that both the left and the right wheels 202 incline toward the inside of a turn, the camber thrusts generated on the left and the right wheels 202 can be used as a turning force, thereby enabling to ensure the turning performance of the vehicle 201 in a reliable manner.

On the other hand, if it is judged that the required coefficient of friction is not between the minimum value μb and the maximum value μa, inclusive, as a result of the process of 5207 (S207: No), the CPU 71 judges whether or not the required coefficient of friction is less than the minimum value μb (S210). As a result of the judgment, if it is judged that the required coefficient of friction is less than the minimum value μb (S210: Yes), the CPU 71 applies a camber angle of zero degrees to the wheels 202 (S211), and then proceeds to the roll control process (S20).

On the other hand, if it is judged that the required coefficient of friction is not less than the minimum value μb, that is, if it is judged that the required coefficient of friction is larger than the maximum value μa, as a result of the process of 5210 (S210: No), the CPU 71 applies the second camber angle Gal to the outer wheel during turning and the third camber angle θbl to the inner wheel during turning (S212), then executes a notification process (S13), and then terminates the camber control process.

After executing the process of 5209 or 5211, the CPU 71 executes the roll control process (S20), then the thrust control process (S30), then the first energy control process (S40), and subsequently terminates the camber control process.

With these processes, in the same way as the first embodiment, the gaps between the camber angles read out from the camber angle map (refer to FIG. 16) and the camber angles actually formed by the wheels 202 relative to the traveling road surface can be eliminated. In addition, the electric power consumption of the FL-RR motors 3FL to 3RR can be reduced, and, as a result, it is possible to aim at a further reduction in the energy consumption.

Consequently, in the same way as the first embodiment, the change in the camber angles associated with the roll of the vehicle 201 can be corrected. As a result, the rolling resistance of the wheels 202 can be made smaller, thereby enabling to aim at a further reduction in the energy consumption of the vehicle 201. In addition, the electric power consumption of the FL-RR motors 3FL to 3RR can be made smaller, thereby enabling to aim at a further reduction in the energy consumption of the vehicle 201.

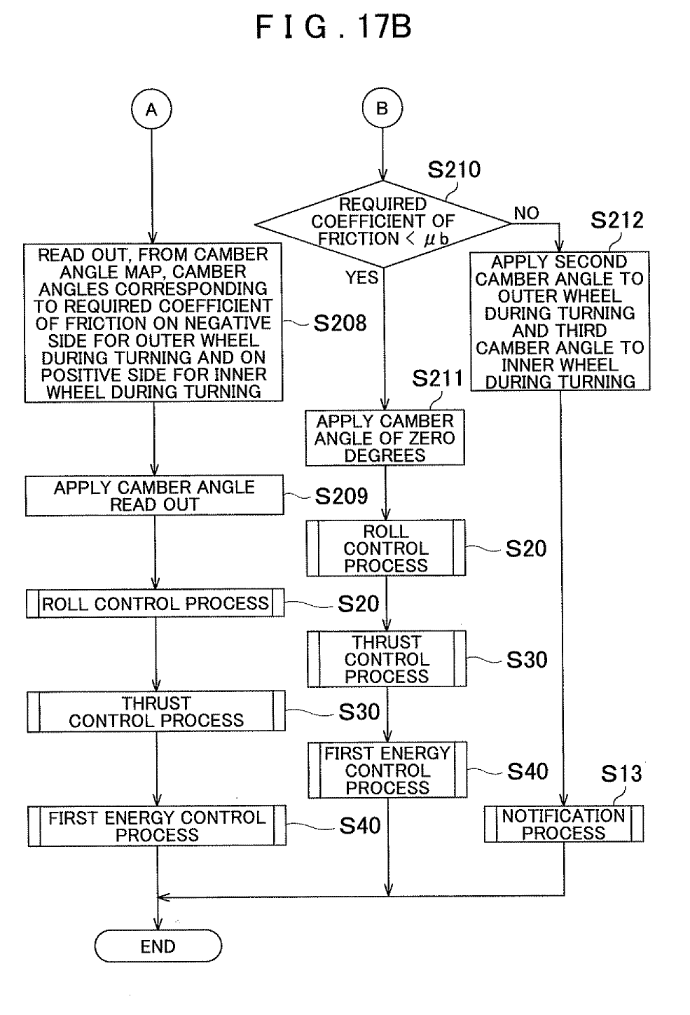

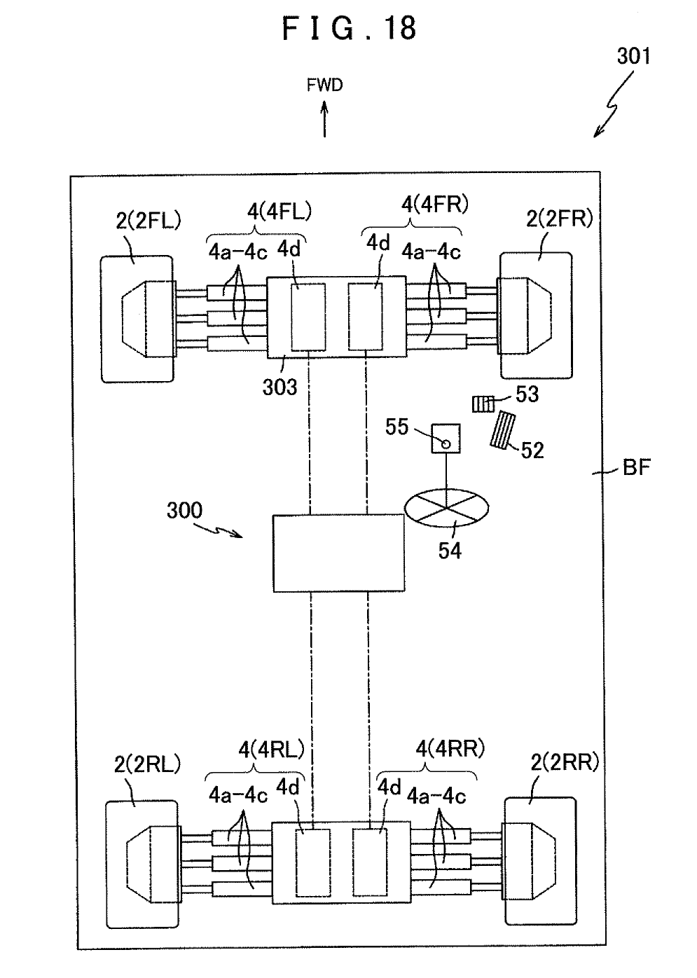

Next, a third embodiment will be described with reference to FIGS. 18 to 20. FIG. 18 is a schematic diagram schematically showing a top view of a vehicle 301 according to the third embodiment. Note that an arrow FWD in FIG. 18 indicates the forward direction of the vehicle 301.

Whereas the first embodiment has been described of the case in which the wheels 2 are rotationally driven by the rotational driving mechanism 3, the wheels 2 are structured to be rotationally driven by an engine 303 in the third embodiment. Note that the same parts as those of the embodiments described above will be given the same reference numerals, and the description thereof will be omitted.

As shown in FIG. 18, the vehicle 301 according to the third embodiment is provided with the engine 303 that rotationally drives some or all of the wheels 2 (left front wheel 2FL and right front wheel 2FR in the present embodiment).

The engine 303 is an engine for burning fuel such as gasoline or diesel oil and converting the thermal energy thus generated to power, and structured so as to be capable of applying the power to the wheels 2 (left front wheel 2FL and right front wheel 2FR) through drive shafts (not shown). A vehicular control device 300 feeds the fuel to the engine 303.

Next, a detailed structure of the vehicular control device 300 will be described with reference to FIG. 19. FIG. 19 is a block diagram showing an electrical configuration of the vehicular control device 300. As shown in FIG. 19, the vehicular control device 300 is provided with a fuel feeding device 336 and a fuel sensor device 335.

The fuel feeding device 336 is a device for feeding fuel (such as gasoline or diesel oil) to the engine 303 and controlling a feed rate thereof, and mainly provided with a feed section (not shown) that mixes the fuel with air and feeds the mixture to the engine 303, and a control section (not shown) that controls the feed rate of the fuel fed from the feed section to the engine 303 based on commands from the CPU 71.

The fuel sensor device 335 is a device for detecting the feed rate of the fuel fed to the engine 303 and outputting the detection result to the CPU 71, and provided with a fuel sensor 335a that detects the feed rate of the fuel fed to the engine 303 and a processing circuit (not shown) that processes the detection result of the fuel sensor 335a and outputs the processed result to the CPU 71.

The CPU 71 is capable of storing the detection result (fuel feed rate) of the fuel sensor 335a received from the fuel sensor device 335 in the energy consumption memory 73a, and calculating the average value (average fuel feed rate) of the results of a plurality of times (eight times in the present embodiment) of detection, based on the content of the energy consumption memory 73a.

Next, a description is given of a camber control process according to a third embodiment. It is to be noted that, in the camber control process according to the third embodiment, the same reference numerals are used for the same parts as in the camber control process (refer to FIGS. 9A and 9B) in the first embodiment, and the description thereof is not repeated.

In the camber control process of the third embodiment, an average fuel calculation process (S360) is executed in place of the average current calculation process (S60) executed in the first energy control process (S40) and the second energy control process (S70) executed in the first embodiment.

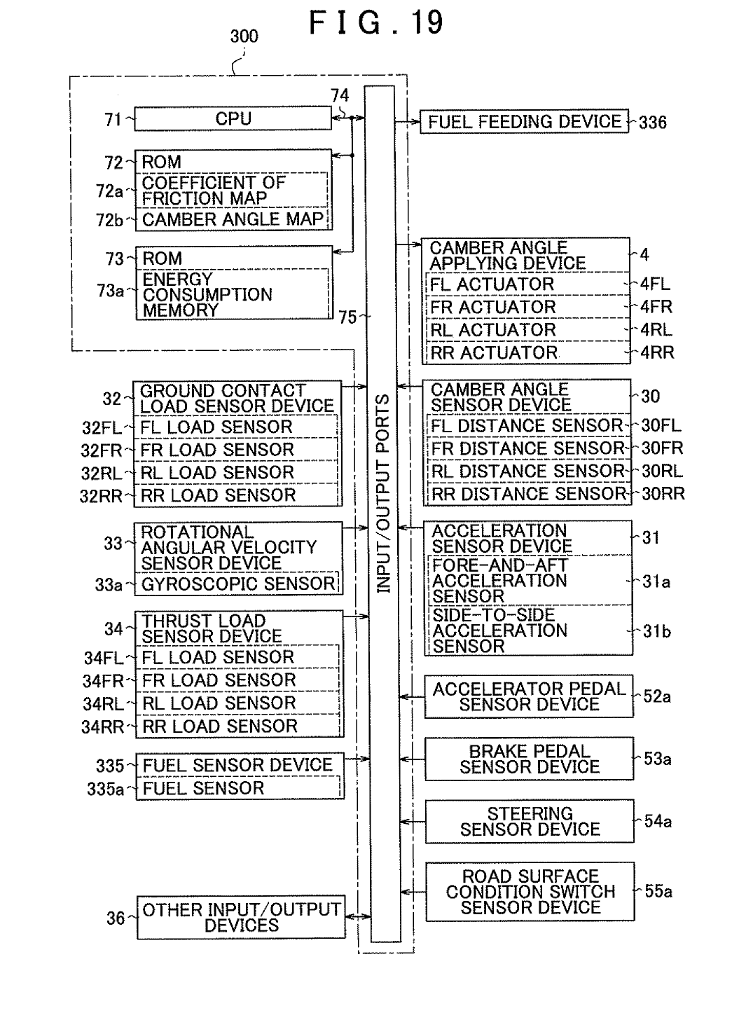

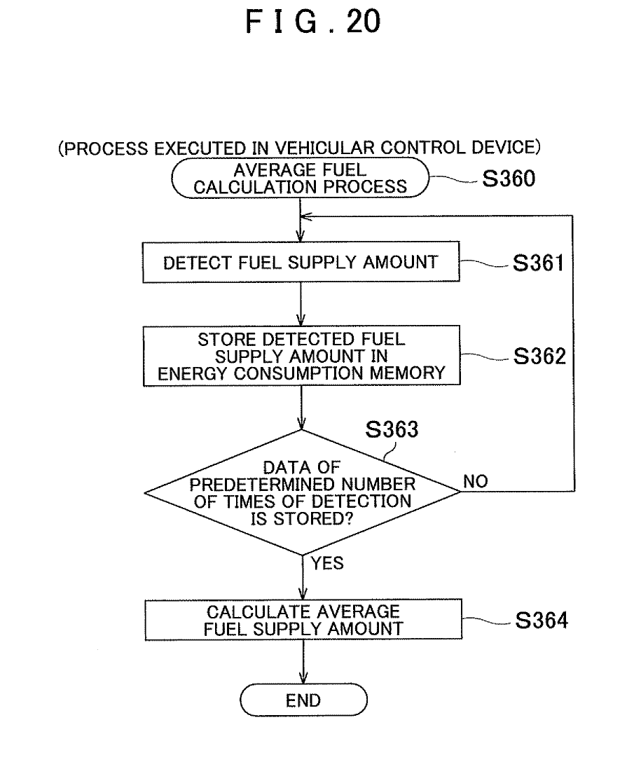

Here, referring to FIG. 20, a description is given of the average fuel calculation process (S360). FIG. 20 is a flow chart showing the average fuel calculation process (S360). In connection with the average fuel calculation process (S360), the CPU 71 first detects the amount of fuel supplied to the engine 303 by the fuel sensor device 335 (S361), and stores the detection result (the fuel supply amount) in the energy consumption memory 73a (S362).

Next, whether or not the data (detection result) for prescribed counts (eight counts in the present embodiment) is stored in the energy consumption memory 73a is judged (S363). As a result of the judgment, if it is judged that the data for the prescribed counts is not stored (S363: No), the control returns to S361,

That is, until it is judged that the data for the prescribed counts is stored in the process in step S363 (S363: Yes), the processes in steps S361 to S363 are repeatedly executed, and the detection result is stored in the energy consumption memory 73a at every prescribed time interval.

On the other hand, as a result of the process in step S363, if it is judged that the data for the prescribed counts is stored (S363: Yes), an average fuel supply amount is calculated based on the contents of energy consumption memory 73a (S364), and the average fuel calculation process (S360) ends.

Thus, as in the first embodiment, with a further reduction in the fuel consumption of the engine 303, the energy consumption of the vehicle 301 can further be reduced.

Here, in the flow charts of FIGS. 9 and 17 (the camber control process), the processes in steps S9, S11, S12, S209, S211, and S212 correspond to the camber angle adjusting means in claim 1, the processes in steps S1 and S201 correspond to traveling road surface judging means in claim 2, the processes in steps S6 and S206 correspond to the required coefficient of friction calculating means, and the processes in steps S7, S10, S207, and S210 correspond to coefficient of friction comparing means in claim 3.

Further, in the flow chart of FIG. 10 (the roll control process), the process in step S21 corresponds to the traveling information acquiring means in claim 1, and the process in step S23 corresponds to the camber angle adjusting means.

Still further, in the flow chart of FIG. 11 (the thrust control process), the process in step S32 corresponds to the traveling information acquiring means in claim 1, the processes in steps S35 and S36 correspond to the camber angle adjusting means, and the process in step S31 corresponds to the thrust force calculating means in claim 6.

Still further, in the flow chart of FIGS. 12A and 12B (the first energy control process), the process in step S50 corresponds to the camber angle adjusting means in claim 1. In the flow chart of FIG. 13 (the average current calculation process), the processes in steps S61 and S64 correspond to the traveling information acquiring means in claim 1. In the flow chart of FIGS. 14A and 14B (the second energy control process), the processes in steps S49 and S50 correspond to the camber angle adjusting means in claim 1.

Still further, in the flow chart of FIG. 20 (the average fuel calculation process), the processes in steps S361 and S364 correspond to the traveling information acquiring means in claim 1.

Next, referring to FIGS. 21 to 24, a description is given of a fourth embodiment. It is to be noted that, a vehicle in which a vehicular control device 4100 according to the fourth embodiment is installed is similarly structured as the vehicle 1 in the first embodiment and, therefore, the description thereof is not repeated. Similarly, the same reference numerals are used for the same parts as in the foregoing embodiments, and the description thereof is not repeated.

FIG. 21 is a block diagram showing the electrical structure of the vehicular control device 4100 according to the fourth embodiment. As shown in FIG. 21, the vehicular control device 4100 includes the CPU 71, ROM 4072 and the RAM 73 that are connected to the input/output ports 75 via the bus line 74. A plurality of devices, such as the wheel driving mechanism 3, is also connected to the input/output ports 75.

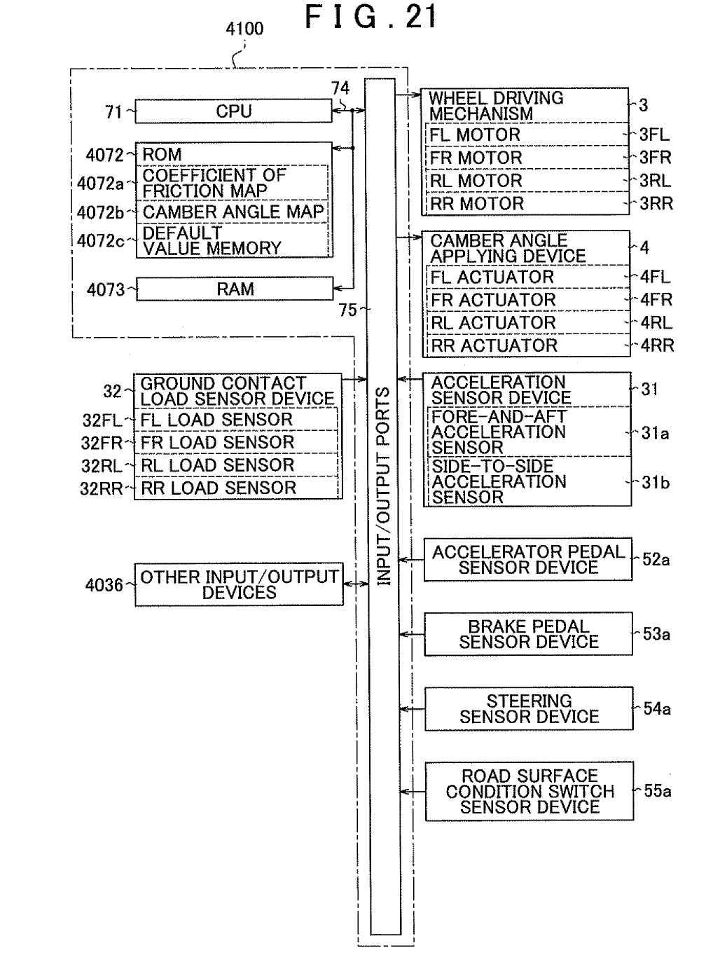

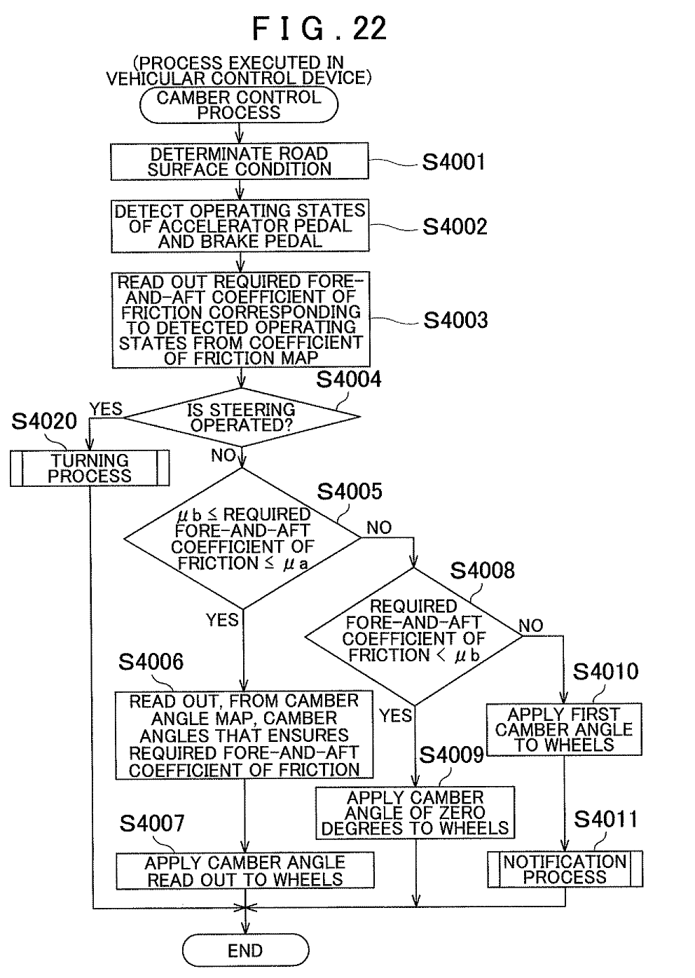

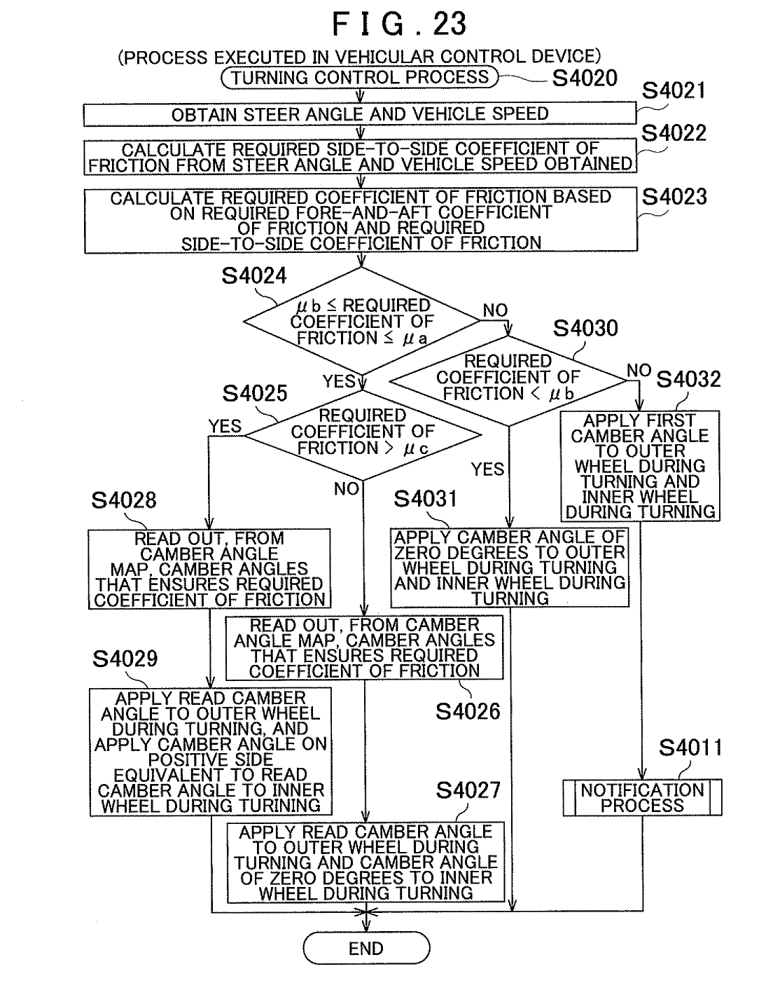

The CPU 71 is a computing device that controls those constituents connected by the bus line 74. The ROM 4072 is non-rewritable non-volatile memory storing therein control programs executed by the CPU 71 (such as programs shown in the flow charts of FIGS. 22 and 23), fixed value data and the like. The RAM 73 is memory for rewritably storing various data when the control programs are executed. The ROM 4072 is provided with a coefficient of friction map 4072a, a camber angle map 4072b and default value memory 4072c.

Here, the coefficient of friction map 4072a and the camber angle map 4072b are similarly structured as the coefficient of friction map 72a and the camber angle map 72b (refer to FIGS. 4 and 5) in the first embodiment and, therefore, the description thereof is not repeated.

The default value memory 4072c is memory storing therein a default value μs of the required coefficient of friction. In a turning control process (refer to FIG. 23) described later, the CPU 71 performs case analysis as to a camber angle to be applied to the wheels 2 based on the contents of the default value memory 4072c (see S4025 in FIG. 23).

Specifically, when the required coefficient of friction is not greater than μs, the CPU 71 applies a camber angle read from the camber angle map 4072b to the outer wheels during turning, and applies the camber angle of zero degrees to the inner wheels during turning (see S4027 in FIG. 23). On the other hand, when the required coefficient of friction is larger than μs, the CPU 71 applies a camber angle read from camber angle map 4072b to the outer wheels during turning, and applies a positive direction (negative camber side) camber angle that is equal to the read camber angle to the inner wheels during turning (see S4029 in FIG. 23). Thus, an improvement in the fuel-saving performance is attained.

In the present embodiment, the default value μs is set to a value half as great as the sum of the minimum value μb and the maximum value μa of the coefficient of friction that the wheels 2 can exert (i.e., an average value of the minimum value μb and the maximum value μa). It is to be noted that, the default value us is not limited to the value half as great as the sum of the minimum coefficient of friction μb and the maximum coefficient of friction μa, and a value falling within a range between the minimum value μb and the maximum value μa suffices.

An example of other input/output devices 4036 shown in FIG. 21 is a device for detecting the rotation speed of each wheel 2.

Next, referring to FIG. 22, a description is given of the camber control process. FIG. 22 is a flow chart showing the camber control process. The process is repeatedly executed by the CPU 71 (for example, at 0.2 ms intervals) while the vehicular control device 4100 is powered on.

In connection with the camber control process, the CPU 71 first determines the road surface condition (S4001). The process is performed by detecting the operating state of the road surface condition switch 55 by the road surface condition switch sensor device 55a (refer to FIG. 21). That is, as in the foregoing description, when the operated position of the road surface condition switch 55 is detected as the first position, the CPU 71 determines that the road surface condition is the dry paved road; when detected as the second position, the CPU 71 determines that it is the unpaved road; and when detected as the third position, the CPU 71 determines that it is the wet paved road.

Next, the operating state of the accelerator pedal 52 and that of the brake pedal 53 are detected respectively by the accelerator pedal sensor device 52a and the brake pedal sensor device 53a (S4002), and a required fore-and-aft coefficient of friction corresponding to the detected operating states is read from the coefficient of friction map 4072a (refer to FIG. 4) (S4003). Thus, the coefficient of friction in the fore-and-aft direction of the vehicle 4001 (top-bottom direction in FIG. 1) that must be ensured for the wheels 2 (that is, the coefficient of friction in the fore-and-aft direction of the vehicle 4001 that is required between the wheels 2 and the road surface in order for the wheels 2 not to slip) can be obtained.

Next, whether or not the steering 54 is operated is determined (S4004). When it is determined that the steering 54 is operated (S4004: Yes), the turning control process (S4020) is executed, and the camber control process ends.

On the other hand, when the process in step S4004 results in a determination that the steering 54 is not operated (S4004: No), which means that the vehicle 4001 is in the straight-traveling mode, the required fore-and-aft coefficient of friction obtained in the process in step S4003 is compared against the maximum value pa and the minimum value μb of the coefficient of friction that the wheels 2 can exert (that is, the coefficient of friction that the wheels 2 can produce between the road surface and the wheels 2), and whether or not the required fore-and-aft coefficient of friction is not smaller than the minimum value μb nor greater than the maximum value μa is determined (S4005).

It is to be noted that the maximum value μa and the minimum value gb of the coefficient of friction that the wheels 2 can exert are read from the camber angle map 4072b (refer to FIG. 5) as described in the foregoing. In this case, the CPU 71 selects a map corresponding to the road surface condition determined in the process in step S4001 out of the three types of map, and reads the maximum value μa and the minimum value μb based on the contents of the selected map.

When the process in step S4005 results in a determination that the required fore-and-aft coefficient of friction is not smaller than the minimum value μb nor greater than the maximum value μa (S4005: Yes), a camber angle that ensures the required fore-and-aft coefficient of friction (i.e., at which the coefficient of friction becomes equivalent to the required fore-and-aft coefficient of friction) is read from the camber angle map 4072b (S4006). The read camber angle is applied to the wheels 2 (S4007), and the camber control process ends.

Specifically, for example, if the required fore-and-aft coefficient of friction obtained in the process in step S4003 is μ1, then based on the camber angle map 4072b shown in FIG. 5, the relationship μb≦μ1≦μa is satisfied (S4005: Yes). Accordingly, a camber angle corresponding to the required fore-and-aft coefficient of friction μ1 is read as θ1 (S4006), and the read camber angle θ1 is applied to the wheels 2 (S4007).

Thus, the wheels 2 are allowed to exert the minimum required coefficient of friction so as to avoid slipping. As a result, while the acceleration performance and the braking performance of the vehicle 4001 is fully ensured, the rolling resistance of the wheels 2 can further be reduced so as to reduce the travel resistance thereof. Accordingly, the fuel-saving performance can be improved.

On the other hand, when the process in step S4005 results in a determination that the required fore-and-aft coefficient of friction does not satisfy the condition of being not smaller than the minimum value μb nor greater than the maximum value μa (S4005: No), whether or not the required coefficient of friction is smaller than the minimum value μb is determined (S4008). As a result, when it is determined that the required fore-and-aft coefficient of friction is smaller than the minimum value μb (S4008: Yes), the camber angle of 0 degrees is applied to the wheels 2 (S4009), and the camber control process ends.

Specifically, for example, if the required fore-and-aft coefficient of friction obtained in the process in step S4003 is μ2, then based on the camber angle map 4072b shown in FIG. 5, the relationship μ2<μb is satisfied (S4008: Yes). Accordingly, instead of reading a camber angle corresponding to the required fore-and-aft coefficient of friction μ2 as θ2, it is determined that the camber angle to be applied to the wheels 2 is 0 degrees, and the 0 degree-angle is applied to the wheels 2 (S4009).

That is, when the required fore-and-aft coefficient of friction obtained in the process in step S4003 is under the minimum value μb of the coefficient of friction that the wheels 2 can exert, it is determined that a further reduction in the rolling resistance (improvement in the fuel-saving performance) cannot be expected even if a camber angle on the positive direction (positive camber side) relative to 0 degrees is applied to the wheels 2. As a result, the camber angle to be applied to the wheels 2 is set to zero degrees. Thus, the rolling resistance of the wheels 2 can be minimized, so as to reduce the travel resistance thereof. Accordingly, the fuel-saving performance can be improved.

On the other hand, when the process in step S4008 results in a determination that the required fore-and-aft coefficient of friction is not smaller than the minimum value μb, that is, when it is determined that the required fore-and-aft coefficient of friction is larger than the maximum value a (S4008: No), the first camber angle θa is applied to the wheels 2 (S4010), and a notification process is executed (S4011). Then, the camber control process ends.

Specifically, for example, if the required fore-and-aft coefficient of friction obtained in the process in step S4003 is μ3, then based on the camber angle map 4072b shown in FIG. 5, the relationship μa<μ3 is satisfied (S4008: No). Accordingly, instead of reading a camber angle corresponding to the required fore-and-aft coefficient of friction μ3 as θ3, it is determined that the camber angle to be applied to the wheels 2 is the first camber angle θa, and it is applied to the wheels 2 (S4010).

That is, when the required fore-and-aft coefficient of friction obtained in the process in step S4003 exceeds the maximum value μa of the coefficient of friction that the wheels 2 can exert, it is determined that a further increase in the coefficient of friction (improvement in the traveling performance) cannot be expected even if a camber angle in the negative direction (negative camber side) relative to the first camber angle θa is applied to the wheels 2. As a result, the camber angle to be applied to the wheels 2 is set to the first camber angle θa. Thus, an unnecessary increase in the rolling resistance of the wheels 2 can be avoided, so as to reduce the travel resistance thereof. Accordingly, the fuel-saving performance can be improved.

Here, in the notification process (S4011), the driver is notified that the wheels 2 are slipping (or in danger of slipping) because of quick acceleration or the like, for example by a speaker (not shown) output and a display (not shown) indication. It is to be noted that, if the vehicle 4001 is under acceleration, any measure to decelerate the vehicle 4001 (for example, reducing the rotational driving force of the wheel driving mechanism 3) may be carry out in the process in step S4011.

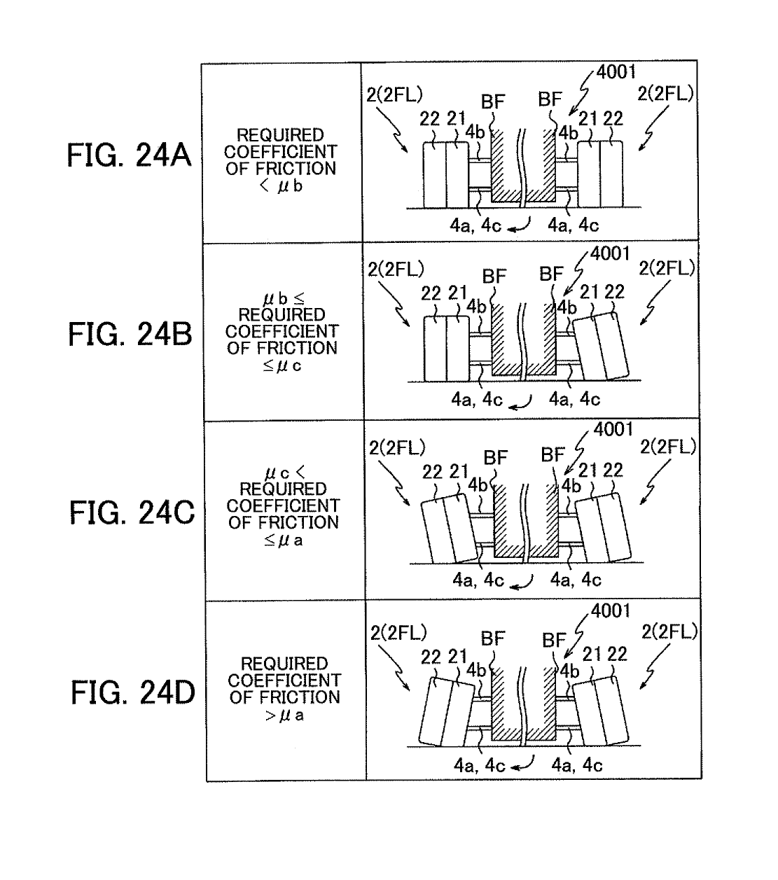

As in the foregoing description, when the process in step S4004 results in a determination that the steering 54 is operated (S4004: Yes), which means that the vehicle 4001 is in the turning mode, the turning control process is executed (S4020). Here, referring to FIG. 23, a description is given of the turning control process (S4020). FIG. 23 is a flow chart showing the turning control process (S4020). In explaining FIG. 23, FIG. 24 is referred to as appropriate. FIGS. 24A to 24D are schematic diagrams schematically illustrating the front view of the vehicle 4001, showing the relationship between the required coefficient of frictions and the states of the wheels 2, the required coefficient of friction being classified under four respective ranges. FIG. 24 shows the vehicle 4001 in the right turning mode, and the left front wheel 2FL corresponds to an outer wheel during turning while the right front wheel 2FR corresponds to an inner wheel during turning.

In connection with the turning control process (S4020), the CPU 71 first obtains the steer angle of the wheels 2 and the vehicle speed of the vehicle 4001 (S4021), and calculates a required lateral coefficient of friction based on the obtained steer angle and the vehicle speed (S4022). As in the foregoing description, the CPU 71 obtains the steer angle of the wheels 2 based on the detection result of the angle sensor received from the steering sensor device 54a, and obtains the vehicle speed of the vehicle 4001 based on the detection result of the acceleration sensors 31a and 31b received from the acceleration sensor device 31.

Here, the required lateral coefficient of friction is a frictional coefficient in the side-to-side direction of the vehicle 4001 (side-to-side direction in FIG. 1) making a turn that is required between the wheels 2 and the road surface in order for the wheels 2 not to slip, and is calculated as follows. That is, the relationship among a steer angle σ of the wheels 2, an Ackerman turning radius R0, and a wheelbase L of the vehicle 4001 can be represented as tan σ=L/R0. This relational expression can be approximated as σ=L/R0 when the steer angle σ is a minute angle. By modifying this to represent the Ackerman turning radius R0, R0=L/σ can be obtained.

On the other hand, the relationship between an actual turning radius R of the vehicle 4001 and a vehicle speed V of the vehicle 4001 is represented as R/R0=1+K·V2 from the steering characteristic of the vehicle 4001 using a stability factor K measured for the vehicle 4001. By modifying this to represent the actual turning radius R and substituting the obtained Ackerman turning radius R0 thereinto, R=L(1+K·V2)/σ can be obtained.

Here, a centrifugal force F applied to the vehicle 4001 during the turn is represented as F=M·V2/R, where M is the weight of the vehicle 4001. By substituting the obtained actual turning radius R thereinto, F=M·V2·σ/(L(1+K·V2)) can be obtained. Because a value greater than the centrifugal force F suffices as the friction force for preventing the wheels 2 from slipping in the lateral direction (side-to-side direction of the vehicle 4001), a required lateral coefficient of friction μw can be represented as μw=F/M=V2·σ/(L(1+K·V2)), dividing the centrifugal force F by the weight M.

Next, based on the required fore-and-aft coefficient of friction and the required lateral coefficient of friction obtained in the processes in steps S4003 and S4022 (that is, as a resultant force of vectors in the fore-and-aft direction and the side-to-side direction of the vehicle 4001), the required coefficient of friction is calculated (S4023).

Next, the required coefficient of friction calculated in the process in step S4023 is compared against the maximum value μa and the minimum value μb of the coefficient of friction that the wheels 2 can exert (that is, the coefficient of friction that the wheels 2 can produce between the road surface and the wheels 2), and whether or not the required coefficient of friction is not smaller than the minimum value μb nor greater than the maximum value μa is determined (S4024).

It is to be noted that the maximum value μa and the minimum value μb of the coefficient of friction that the wheels 2 can exert are read from the camber angle map 4072b (refer to FIG. 5) as described in the foregoing. In this case, the CPU 71 selects the map corresponding to the road surface condition determined in the process in step S4001 out of the three types of map, and reads the maximum value μa and the minimum value μb based on the contents of the selected map.

When the process in step S4024 results in a determination that the required coefficient of friction is not smaller than the minimum value μb nor greater than the maximum value μa (S4024: Yes), whether or not the required coefficient of friction is larger than the default value us stored in the default value map 4072c is determined (S4025). As a result, when it is determined that the required coefficient of friction is not larger than the default value μs, that is when it is determined that the required coefficient of friction is not greater than the default value μs (S4025: No), a camber angle that ensures the required coefficient of friction (that is, at which the coefficient of friction becomes equivalent to the required coefficient of friction) is read from the camber angle map 4072b (S4026). The read camber angle is applied to the outer wheels during turning and the zero-degree camber angle is applied to the inner wheels during turning (S4027). Then, the turning control process (S4020) ends.

In this case, the wheels 2 enter the state shown in FIG. 24B. Thus, the outer wheels during turning are allowed to exert the minimum required coefficient of friction, so as to avoid slipping. As a result, while the turning performance of the vehicle 4001 is fully ensured, the rolling resistance of the outer wheels during turning can further be reduced, so as to reduce the travel resistance thereof. Further, the rolling resistance of the inner wheels during turning can be minimized, so as to reduce the travel resistance thereof. Accordingly, the fuel-saving performance can be improved.

As described above, when the required coefficient of friction is not smaller than the minimum coefficient of friction μb nor greater than the maximum coefficient of friction μa, it is expected that the required coefficient of friction required for the inner wheels during turning is not as great as the required coefficient of friction required for the outer wheels during turning by the roll of the vehicle 4001, and the process in step S4027 is executed. Thus, the fuel-saving performance can further be improved.

On the other hand, when the process in step S4025 results in a determination that the required coefficient of friction is larger than the default value μs (S4025: Yes), a camber angle that ensures the required coefficient of friction is read from the camber angle map 4072b (S4028). The read camber angle is applied to the outer wheels during turning, and the camber angle on the positive direction (positive camber side) equivalent to the read camber angle to the inner wheels during turning (S4029), and the turning control process (S4020) ends.

In this case, the wheels 2 enter the state shown in FIG. 24C. Thus, the outer wheels during turning are allowed to exert the minimum required coefficient of friction, so as to avoid slipping. As a result, while the turning performance of the vehicle 4001 is fully ensured, the rolling resistance of the outer wheels during turning can further be reduced, so as to reduce the travel resistance thereof. Further, utilizing the low rolling resistance by the second tread 22 of the inner wheels during turning, the travel resistance thereof can be reduced. Accordingly, the fuel-saving performance can be improved.

Further, in this case, the inner wheels during turning can be tilted toward the inner side of the turn. Therefore, even when the required coefficient of friction is larger than the default value μs and it is expected that the degree of the turn is great, the turning performance can be enhanced by generating camber thrust at the inner wheels during turning and utilizing the camber thrust as the turning force.

When the process in step S4024 results in a determination that the required coefficient of friction does not satisfy the condition of being not smaller than the minimum value μb nor greater than the maximum value μa (S4024: No), whether or not the required coefficient of friction is smaller than the minimum value μb is determined (S4030). As a result, when it is determined that the required coefficient of friction is smaller than the minimum value μb (S4030: Yes), the zero-degree camber angle is applied to the outer wheels during turning and the inner wheels during turning (S4031), and the turning control process ends (S4020).

In this case, the wheels 2 enter the state shown in FIG. 24A. Thus, similarly to the process in step S4009, the rolling resistance of the wheels 2 (the outer wheels during turning and the inner wheels during turning) can be minimized, so as to reduce the travel resistance thereof. Accordingly, the fuel-saving performance can be improved.

On the other hand, when the process in step S4030 results in a determination that the required coefficient of friction is not smaller than the minimum value μb, that is, when it is determined that the required coefficient of friction is larger than the maximum value μa (S4030: No), the first camber angle θa is applied to the outer wheels during turning and the inner wheels during turning (S4032), and the notification process is executed (S4011). Then, the turning control process (S4020) ends.

In this case, the wheels 2 enter the state shown in FIG. 24D. Thus, similarly to the process in step S4010, an unnecessary increase in the rolling resistance of the wheels 2 (the outer wheels during turning and the inner wheels during turning) can be avoided, so as to reduce the travel resistance thereof. Accordingly, the fuel-saving performance can be improved.

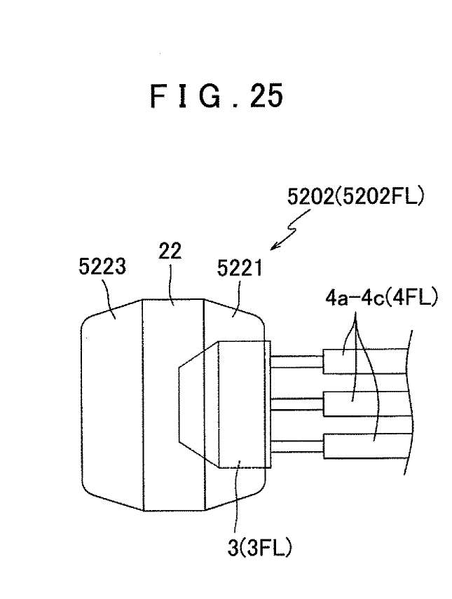

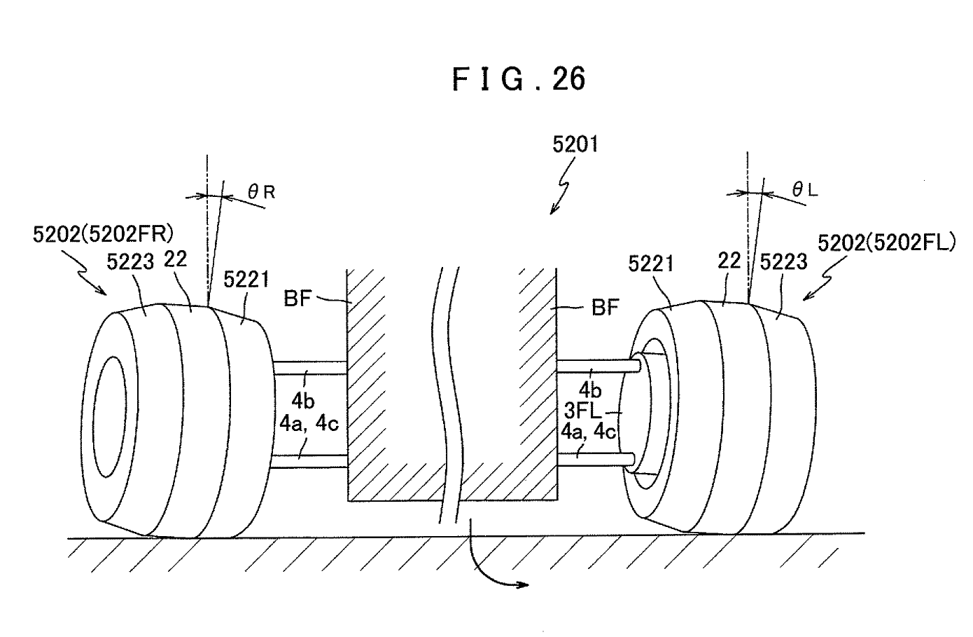

Next, referring to FIGS. 25 to 30, a description is given of a fifth embodiment. FIG. 25 is a top view of one of wheels 5202 in the fifth embodiment. FIG. 26 is a schematic diagram schematically showing the front view of a vehicle 5201 in the left turning mode, illustrating the state where steer angles for a left turn are applied to the left and right wheels 5202; a camber angle in the negative direction (negative camber side) is applied to the outer wheel during turning (right front wheel 5202FR); and a camber angle in the positive direction (positive camber side) is applied to the inner wheel during turning (left wheel 5202FL).

In the fourth embodiment, the description has been given of the case where the wheels 2 are each provided with two types of tread, namely the first tread 21 and the second tread 22, whose respective outer diameters are constant in the width direction. On the other hand, the wheels 5202 of the fifth embodiment are each provided with three types of tread, namely a first tread 5221, the second tread 22, and an added third tread 5223. The outer diameter of the first tread 5221 and the outer diameter of the third tread 5223 are structured to be gradually decreased. It is to be noted that the same reference numerals are used for the same parts as in the foregoing embodiments, and the description thereof is not repeated.

Further, in the fifth embodiment, a description is given of an exemplary case where the vehicle 5201 is controlled by the vehicular control device 1 (refer to FIG. 1) of the fourth embodiment. However, the fifth embodiment is different from the fourth embodiment in the configuration of the camber angle map, as will be described later.

As shown in FIG. 25, the wheels 5202 of the fifth embodiment each include the first tread 5221, the second tread 22, and the third tread 5223. The first tread 5221 is arranged on the inner side in connection with the vehicle 5201 (right side in FIG. 25, and the third tread 5223 is arranged on the outer side in connection with the vehicle 5201 (left side in FIG. 25), with the second tread 22 being arranged between the first tread 5221 and the third tread 5223.

The first tread 5221 is structured to have a higher gripping force property (higher gripping performance) compared to the second tread 22, and the third tread 5223 is structured to have a higher gripping force property at least compared to the second tread 22.

Further, as shown in FIG. 25, the first tread 5221 is structured such that its outer diameter is gradually decreased from the second tread 22 side (left side in FIG. 25) toward the inner side of the vehicle 5201 (right side in FIG. 25), and the third tread 5223 is structured such that its outer diameter is gradually decreased from the second tread 22 side (right side in FIG. 25) toward the outer side of the vehicle 5201 (left side in FIG. 25).

Thus, as shown in FIG. 26, even when a great camber angle is not applied to the wheels 5202 (for example, even when the camber angle is 0°), the second tread 22 can solely be caused to contact the ground while the first tread 5221 and the third tread 5223 are away from the road surface. As a result, the rolling resistance of the wheels 5202 as a whole can further be reduced, whereby the fuel-saving performance can be improved.

At the same time, owing to the fact that the first tread 5221 and the third tread 5223 are not caused to contact the ground and that the second tread 22 is allowed to contact the ground at a smaller camber angle, the wear of the treads 5221, 22, and 5223 can be suppressed, whereby a higher lifetime of the wheels 5202 can be attained.

Further, as shown in FIG. 26, when a camber angle in the negative direction (negative camber side) is applied to the wheels 5202 to thereby bring the first tread 5221 into contact with the ground, the ground contact of the first tread 5221 can be equalized in the entire width directional area because the outer diameter of the first tread 5221 is gradually decreased. Thus, uneven wear can be suppressed, whereby a higher lifetime can be attained.

On the other hand, when a camber angle in the positive direction (positive camber side) is applied to the wheels 5202 to thereby bring the third tread 5223 into contact with the ground, the ground contact of the third tread 5223 can be equalized in the entire width directional area, because the outer diameter of the third tread 5223 is gradually decreased. Thus, uneven wear can be suppressed, whereby a higher lifetime can be attained.

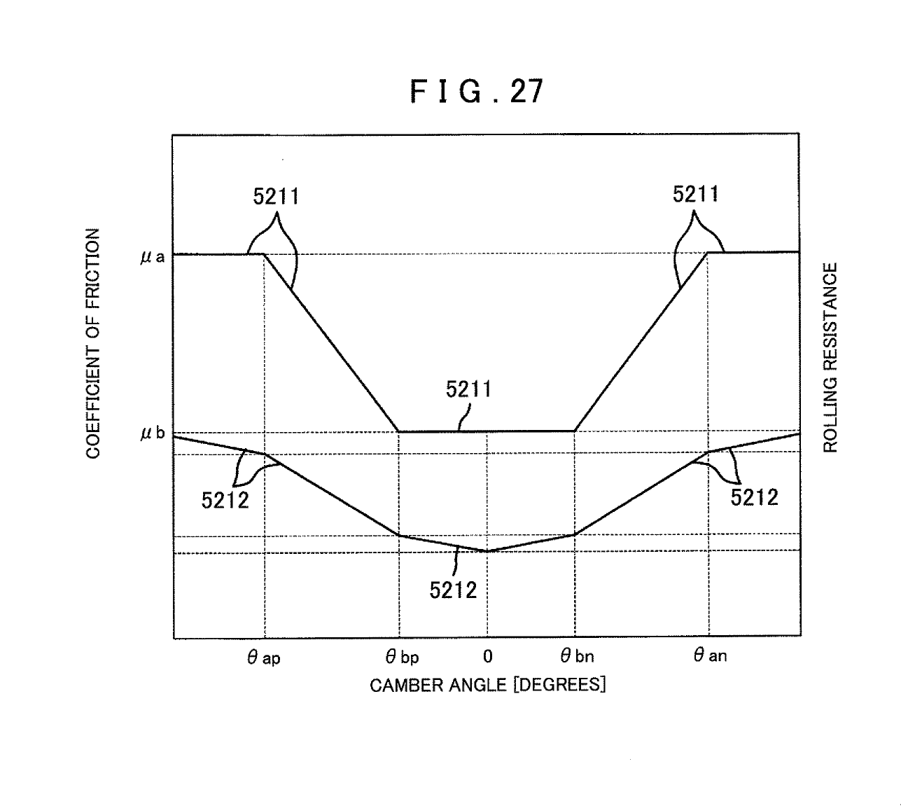

FIG. 27 is a schematic diagram schematically showing the contents of the camber angle map of the fifth embodiment. It is to be noted that the camber angle map shown in FIG. 27 is based on measured values actually measured using the wheels 5202. As in the fourth embodiment, the CPU 71 determines the camber angle to be applied to the wheels 5202 based on the contents of the camber angle map. It is to be noted that, in FIG. 27, a solid line 5211 corresponds to the coefficient of friction, and a solid line 5212 corresponds to the rolling resistance. As to the camber angles represented on the horizontal axis, the right side in FIG. 27 corresponds to the negative direction (negative camber side), and the left side in FIG. 27 corresponds to the positive direction (positive camber side).

While the camber angle map of the fifth embodiment stores three types of map corresponding to three operating states of the road surface condition switch 55 as in the fourth embodiment, FIG. 27 shows only one type of the map (dry paved road map) as a representative example and the other two types are not shown so as to be simplified for the sake of easier understanding.

According to the camber angle map of the fifth embodiment, as shown in FIG. 27, when the camber angle changes from zero degrees (i.e., at which only the second tread 22 contacts the ground and the first tread 5221 and the third tread 5223 are away from the road surface) toward the negative direction (negative camber side), the coefficient of friction stays at the minimum value μb until the camber angle reaches θbn, because only the second tread 22 contacts the ground while the first tread 5221 (and the third tread 5223) are away from the road surface. On the other hand, the rolling resistance assumes the minimum value when the camber angle is zero degrees, and gradually increases according to the change in the camber angle until the camber angle reaches θbn. That is, as the camber angle changes toward the negative direction (negative camber side), the change causes a gradual increase in the camber thrust, which then brings about a gradual increase in the rolling resistance.

When the camber angle changes from θbn toward the negative direction (negative camber side), the change causes a gradual increase in the ground contact (ground pressure or ground contact area) of the first tread 5221 with high gripping performance, which then brings about gradual increases in the coefficient of friction and the rolling resistance.

Then, when the camber angle reaches θan (hereafter referred to as “the second camber angle θan”), the second tread 22 separates from the road surface and only the first tread 5221 contacts the ground, whereby the coefficient of friction reaches the maximum value μa. It is to be noted that even if the camber angle further changes from the second camber angle θan toward the negative direction (negative camber side), the coefficient of friction barely changes and stays at the maximum value to because the second tread 22 is already away from the road surface.

On the other hand, after the camber angle reaches the second camber angle θan, the rolling resistance gradually increases according to the change in the camber angle although its change (gradient) becomes small. That is, as described in the foregoing, as the camber angle changes toward the negative direction (negative camber side), the change causes a gradual increase in the camber thrust, which then brings about a gradual increase in the rolling resistance.

Similarly, as shown in FIG. 27, when the camber angle changes from zero degrees (i.e., at which only the second tread 22 contacts the ground and the first tread 5221 and the third tread 5223 are away from the road surface) toward the positive direction (positive camber side), the coefficient of friction stays at the minimum value μb until the camber angle reaches θbp, because only the second tread 22 contacts the ground while the third tread 5223 (and the first tread 5221) are away from the road surface. On the other hand, the rolling resistance assumes the minimum value when the camber angle is zero degrees, and gradually increases according to the change in the camber angle until the camber angle reaches θbp. That is, as in the foregoing description, as the camber angle changes toward the positive direction (positive camber side), the change causes a gradual increase in the camber thrust, which then brings about a gradual increase in the rolling resistance.

When the camber angle changes from θbp toward the positive direction (positive camber side), the change causes a gradual increase in the ground contact (ground pressure or ground contact area) of the third tread 5223 with high gripping performance, which then brings about gradual increases in the coefficient of friction and the rolling resistance.

Then, when the camber angle reaches θap (hereafter referred to as “the third camber angle θap”), the second tread 22 separates from the road surface and only the third tread 5223 contacts the ground, whereby the coefficient of friction reaches the maximum value μa. It is to be noted that even if the camber angle further changes from the third camber angle θap toward the positive direction (positive camber side), the coefficient of friction barely changes and stays at the maximum value μa because the second tread 22 is already away from the road surface.

On the other hand, after the camber angle reaches the third camber angle θap, the rolling resistance gradually increases according to the change in the camber angle although its change (gradient) becomes small. That is, as described in the foregoing, as the camber angle changes toward the positive direction (positive camber side), the change causes a gradual increase in the camber thrust, which then brings about a gradual increase in the rolling resistance.

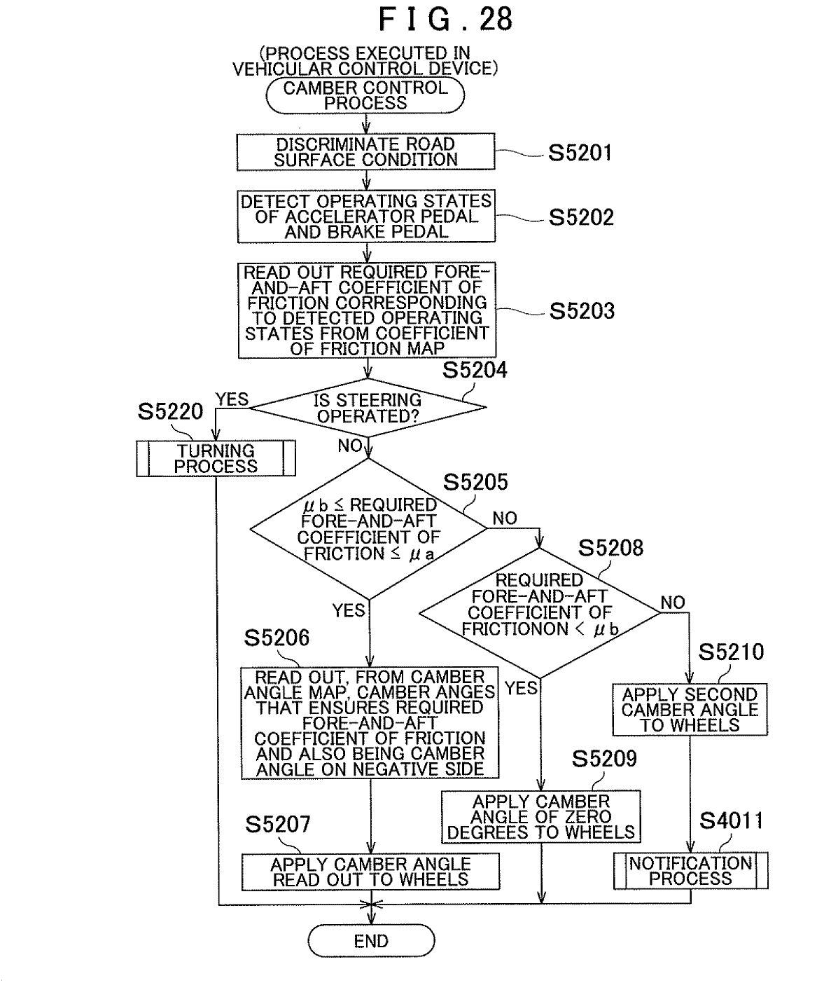

Next, referring to FIG. 28, a description is given of a camber control process according to the fifth embodiment. FIG. 28 is a flow chart showing the camber control process of the fifth embodiment. The process is repeatedly executed by the CPU 71 (for example, at 0.2 ms intervals) while the vehicular control device 4100 is powered on.

In the fifth embodiment, in connection with the camber control process, as in the fourth embodiment, the CPU 71 determines the road surface condition (S5201), and thereafter detects the operating states of the accelerator pedal 52 and the brake pedal 53 (S55202). Then, a required fore-and-aft coefficient of friction corresponding to the detected operating states is read from the coefficient of friction map 4072a (refer to FIG. 4) (S5203).

Next, whether or not the steering 54 is operated is determined (S5204). When it is determined that the steering 54 is operated (S5204: Yes), a turning control process (S5220) is executed, and the camber control process ends.

On the other hand, when the process in step S5204 results in a determination that the steering 54 is not operated (S5204: No), whether or not the required fore-and-aft coefficient of friction obtained in the process in step S5203 is not smaller than the minimum value μb nor greater than the maximum value μa is determined (S5205). It is to be noted that the maximum value μa and the minimum value μb are read from the camber angle map shown in FIG. 27.

As a result, when it is determined that the required fore-and-aft coefficient of friction is not smaller than the minimum value μb nor greater than the maximum value pa (S5205: Yes), a camber angle that ensures the required fore-and-aft coefficient of friction (i.e., at which the coefficient of friction becomes equivalent to the required fore-and-aft coefficient of friction) and that is at the same time a camber angle in the negative direction (negative camber side) is read from the camber angle map shown in FIG. 27 (S5206). The read camber angle is applied to the wheels 5202 (S5207), and the camber control process ends.

Thus, as in the fourth embodiment, the wheels 5202 are allowed to exert the minimum required coefficient of friction, so as to avoid slipping. As a result, while the acceleration performance and the braking performance of the vehicle 5201 is fully ensured, the rolling resistance of the wheels 5202 can further be reduced, so as to reduce the travel resistance thereof. Accordingly, the fuel-saving performance can be improved.

On the other hand, when the process in step S5205 results in a determination that the required fore-and-aft coefficient of friction does not satisfy the condition of being not smaller than the minimum value μb nor greater than the maximum value ma (S5205: No), whether or not the required coefficient of friction is smaller than the minimum value μb is determined (S5208). As a result, when it is determined that the required fore-and-aft coefficient of friction is smaller than the minimum value μb (S5208: Yes), the camber angle of zero degrees is applied to the wheels 5202 (S5209), and the camber control process ends.

That is, when the required fore-and-aft coefficient of friction obtained in the process in step S5203 is under the minimum value μb of the coefficient of friction that the wheels 5202 can exert, it is determined that a further reduction in the rolling resistance (improvement in the fuel-saving performance) cannot be expected even if a camber angle other than zero degrees is applied to the wheels 5202. As a result, the camber angle to be applied to the wheels 5202 is set to zero degrees. Thus, as in the fourth embodiment, the rolling resistance of the wheels 5202 can be minimized, so as to reduce the travel resistance thereof. Accordingly, the fuel-saving performance can be improved.

On the other hand, when the process in step S5208 results in a determination that the required fore-and-aft coefficient of friction is not smaller than the minimum value μb, that is, when it is determined that the required fore-and-aft coefficient of friction is larger than the maximum value μa (S5208: No), the second camber angle θan is applied to the wheels 5202 (S5210), and the notification process is executed (S4011). Then, the camber control process ends.

That is, when the required fore-and-aft coefficient of friction obtained in the process in step S5203 exceeds the maximum value μa of the coefficient of friction that the wheels 5202 can exert, it is determined that a further increase in the coefficient of friction (improvement in the traveling performance) cannot be expected even if a camber angle in the negative direction (negative camber side) relative to the second camber angle θan is applied to the wheels 5202. As a result, the camber angle to be applied to the wheels 5202 is set to the second camber angle θan. Thus, as in the fourth embodiment, an unnecessary increase in the rolling resistance of the wheels 5202 can be avoided, so as to reduce the travel resistance thereof. Accordingly, the fuel-saving performance can be improved.

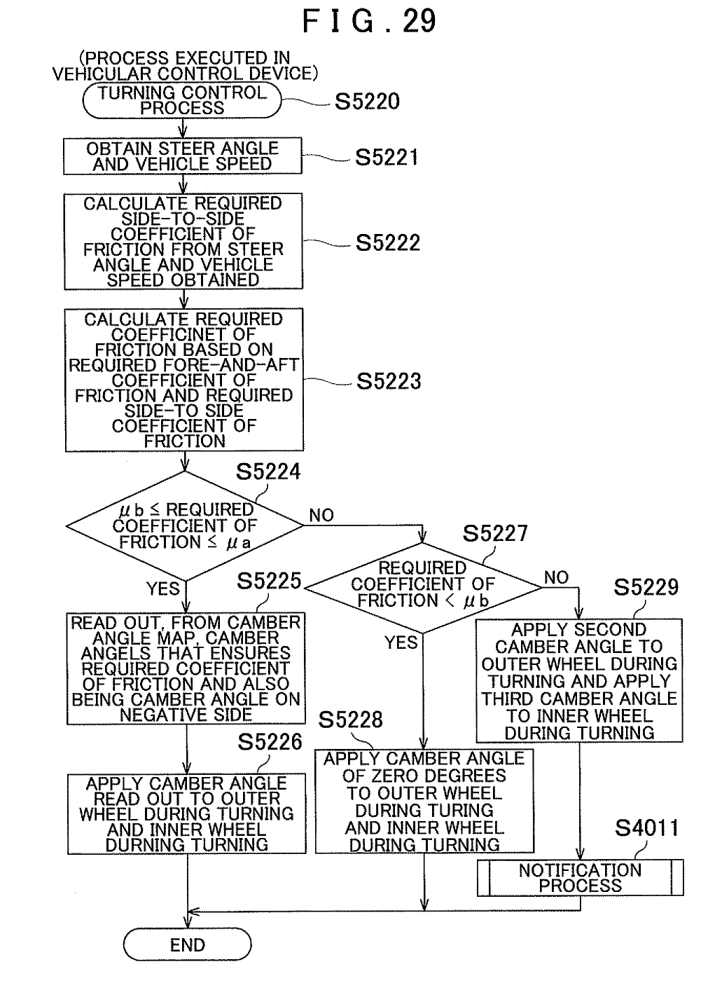

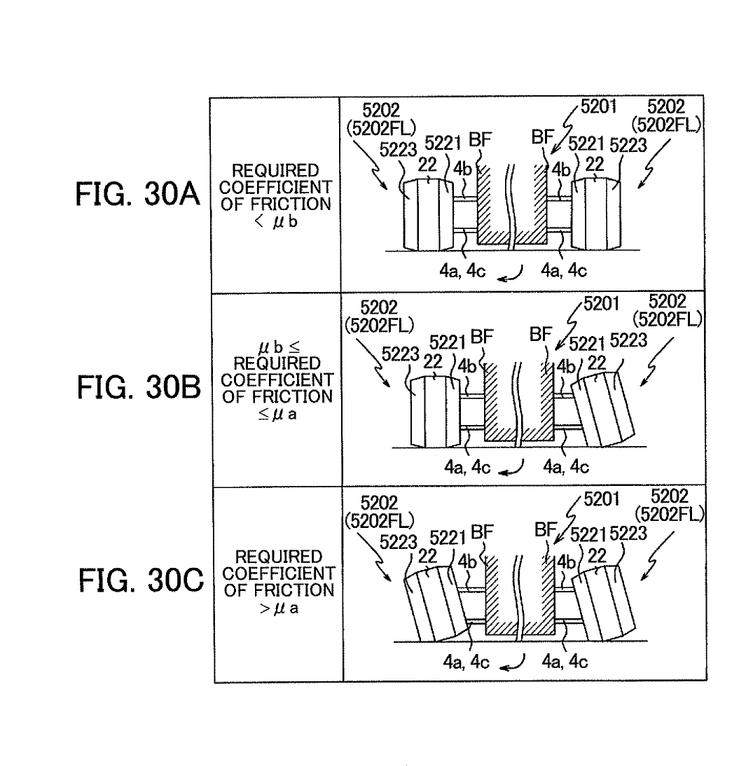

As in the foregoing description, when the process in step S5204 results in a determination that the steering 54 is operated (S5204: Yes), the turning control process is executed (S5220). Here, referring to FIG. 29, a description is given of the turning control process according to the fifth embodiment (S5220). FIG. 29 is a flow chart showing the turning control process of the fifth embodiment (S5220). In explaining FIG. 29, FIG. 30 is referred to as appropriate. FIGS. 30A to 30C are schematic diagrams schematically illustrating the front view of the vehicle 5201, showing the relationship between the required coefficient of friction and the states of the wheels 5202, the required coefficient of friction being classified under three respective ranges. FIG. 30 shows the vehicle 5201 in the right turning mode, and the left front wheel 5202FL corresponds to the outer wheel during turning while the right front wheel 5202FR corresponds to the inner wheel during turning.

In the fifth embodiment, as in the fourth embodiment, in connection with the turning control process (S5220), the CPU 71 obtains the steer angle of the wheels 5202 and the vehicle speed of the vehicle 5201 (S5221), and calculates a required lateral coefficient of friction based on the obtained steer angle and the vehicle speed (S5222).

Next, based on the required fore-and-aft coefficient of friction and the required lateral coefficient of friction obtained in the processes in steps S5203 and S5222 (that is, as a resultant force of vectors in the fore-and-aft direction and the side-to-side direction of the vehicle 4001), the required coefficient of friction is calculated (S5223). Then, whether or not the calculated required coefficient of friction is not smaller than the minimum value μb nor greater than the maximum value μa is determined (S5224). It is to be noted that the maximum value to and the minimum value μb are read from the camber angle map shown in FIG. 27.

As a result, when it is determined that the required coefficient of friction is not smaller than the minimum value μb nor greater than the maximum value μa (S5224: Yes), a camber angle that ensures the required coefficient of friction (that is, at which the coefficient of friction becomes equivalent to the required coefficient of friction) and that is at the same time a camber angle in the negative direction (negative camber side) is read from the camber angle map shown in FIG. 27 (S5225). The read camber angle is applied to the outer wheels during turning and the zero-degree camber angle is applied to the inner wheels during turning (S5226). Then turning control process (S5220) ends.

In this case, the wheels 5202 enter the state shown in FIG. 30B. Thus, as in the fourth embodiment, the outer wheels during turning are allowed to exert the minimum required coefficient of friction, so as to avoid slipping. As a result, while the turning performance of the vehicle 5201 is fully ensured, the rolling resistance of the outer wheel during turning can further be reduced, so as to reduce the travel resistance thereof. Further, the rolling resistance of the inner wheel during turning can be minimized, so as to reduce the travel resistance thereof. Accordingly, the fuel-saving performance can be improved.

On the other hand, when the process in step S5224 results in a determination that the required coefficient of friction does not satisfy the condition of being not smaller than the minimum value μb nor greater than the maximum value μa (S5224: No), whether or not the required coefficient of friction is smaller than the minimum value μb is determined (S5227). As a result, when it is determined that the required coefficient of friction is smaller than the minimum value jib (S5227: Yes), the zero-degree camber angle is applied to the outer wheels during turning and the inner wheels during turning (S5228), and the turning control process (S5220) ends.

In this case, the wheels 5202 enter the state shown in FIG. 30A. Thus, as in the fourth embodiment, the rolling resistance of the wheels 5202 (the outer wheel during turning and the inner wheel during turning) can be minimized, so as to reduce the travel resistance thereof. Accordingly, the fuel-saving performance can be improved.

On the other hand, when the process in step S5227 results in a determination that the required coefficient of friction is not smaller than the minimum value μb, that is, when it is determined that the required coefficient of friction is larger than the maximum value μa (S5227: No), the second camber angle θan is applied to the outer wheels during turning while the third camber angle θap is applied to the inner wheels during turning (S5229), and the notification process is executed (S4011). Then, the turning control process (S5220) ends.

In this case, the wheels 5202 enter the state shown in FIG. 30C. Thus, similarly to the fourth embodiment, an unnecessary increase in the rolling resistance of the wheels 5202 (the outer wheel during turning and the inner wheel during turning) can be avoided, so as to reduce the travel resistance thereof. Accordingly, the fuel-saving performance can be improved.

Further, as shown in FIG. 30C, the right and left wheels 5202 can both be tilted toward the inner side of the turn (left side in FIG. 30C) and, therefore, the turning performance can be improved by generating camber thrust at the right and left wheels 5202 and utilizing the camber thrust as the turning force.

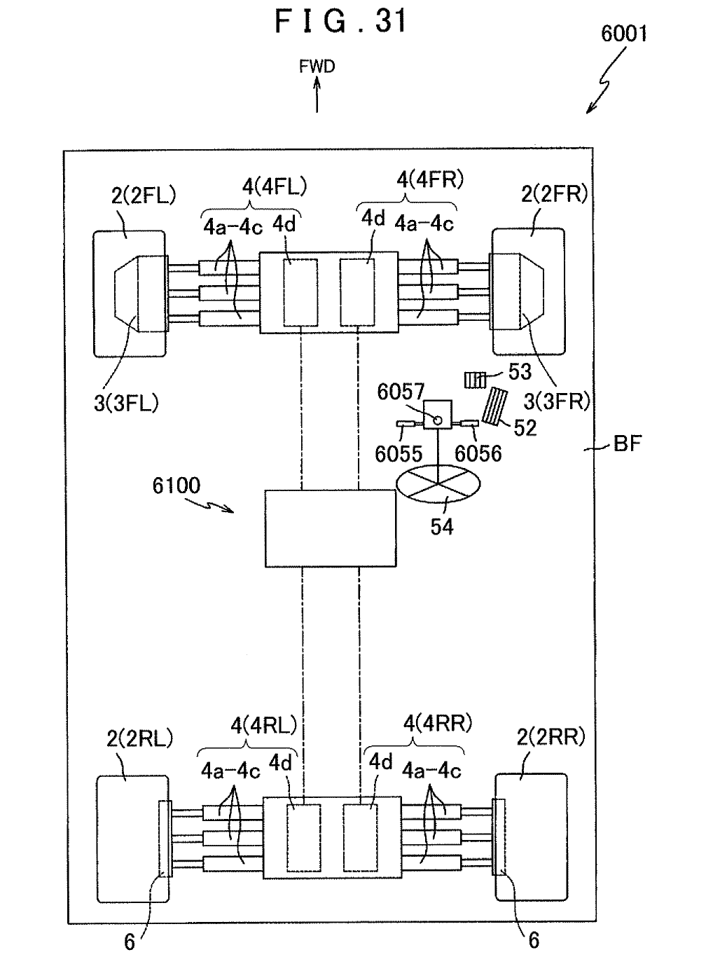

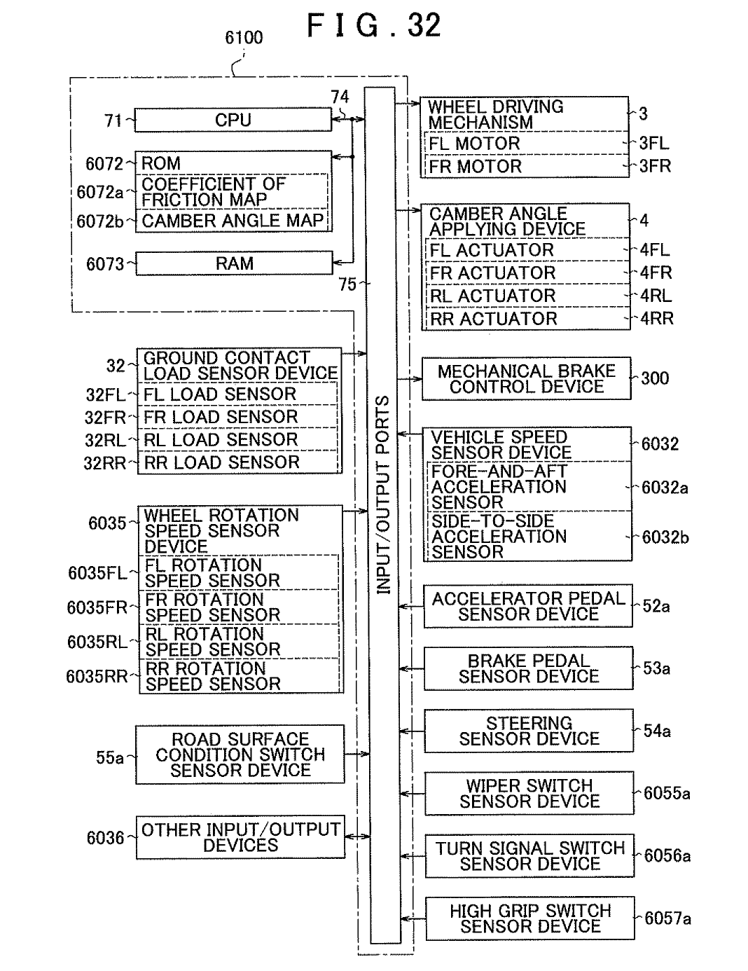

Next, referring to FIGS. 31 to 36, a description is given of a sixth embodiment. The same reference numerals are used for the same parts as in the foregoing embodiments, and the description thereof is not repeated. FIG. 31 is a schematic diagram schematically showing a vehicle 6001 in which a vehicular control device 6100 according to the sixth embodiment is installed. In FIG. 31, an arrow FWD represents the forward direction of the vehicle 6001.

As shown in FIG. 31, the vehicle 6001 principally includes a body frame BF, a plurality of (four in the present embodiment) wheels 2 supported by the body frame BF, the wheel driving mechanism 3 that rotates part of the wheels 2 (in the present embodiment, the right and left front wheels 2FR and 2FL) independently of each other, and the camber angle changing device 4 that exerts steering, camber angle adjustment and the like for the wheels 2. The vehicle 6001 is structured such that two types of tread provided on the wheels 2 are selectively used (refer to FIGS. 5 and 6) by the control of the camber angle of the wheels 2 exerted by the vehicular control device 6100, so that improvements in the traveling performance and the fuel saving can be attained.

A wiper switch 6055 is an operational member for the driver to operate, and the actuation of a wiper (not shown) is controlled by the operating state (such as operated position) of the wiper switch 6055. Similarly, a turn signal switch 6056 and a high gripping switch 6057 are operational members for the driver to operate, and the actuation of a turn signal lamp (not shown) and the camber angle changing device 4 is controlled by the operating state (such as operated position) of the turn signal switch 6056 and the high gripping switch 6057, respectively.

It is to be noted that a state where the high gripping switch 6057 is on corresponds to a state where high gripping performance is selected as the characteristic of the wheels 2, whereas a state where the high gripping switch 6057 is off corresponds to a state where low rolling resistance is selected as the characteristic of the wheels 2. However, in the present embodiment, the camber angle of the wheels 2 is automatically adjusted by the CPU 71 (refer to FIG. 32) irrespective of the operating state of the high gripping switch 6057.

The vehicular control device 6100 is a vehicular control device for controlling constituents of the vehicle 6001 structured as above. For example, the vehicular control device 6100 detects the operating state for each pedal 52 and 53, and actuates the wheel driving mechanism 3 according to the detection result, so as to control the rotation speed of the wheels 2.

Alternatively, the vehicular control device 6100 detects the operating state of the accelerator pedal 52, the brake pedal 53, the steering 54 or the like and actuates the camber angle changing device 4 according to the detection result so as to adjust the camber angle of the wheels, thereby selectively using the two types of tread 21 and 22 provided on the wheels 2 (refer to FIGS. 5 and 6) in order to improve the traveling performance and to achieve the fuel saving. Here, referring to FIG. 32, a description is given of the vehicular control device 6100.

FIG. 32 is a block diagram showing the electrical structure of the vehicular control device 6100. As shown in FIG. 32, the vehicular control device 6100 includes the CPU 71, ROM 6072 and RAM 6073 that are connected to the input/output ports 75 via the bus line 74. A plurality of devices, such as the wheel driving mechanism 3, is also connected to the input/output ports 75.

The CPU 71 is a computing device that controls those constituents connected by the bus line 74. The ROM 6072 is non-rewritable non-volatile memory storing therein control programs executed by the CPU 71, fixed value data and the like. The RAM 6073 is memory for rewritably storing various data when the control programs are executed.

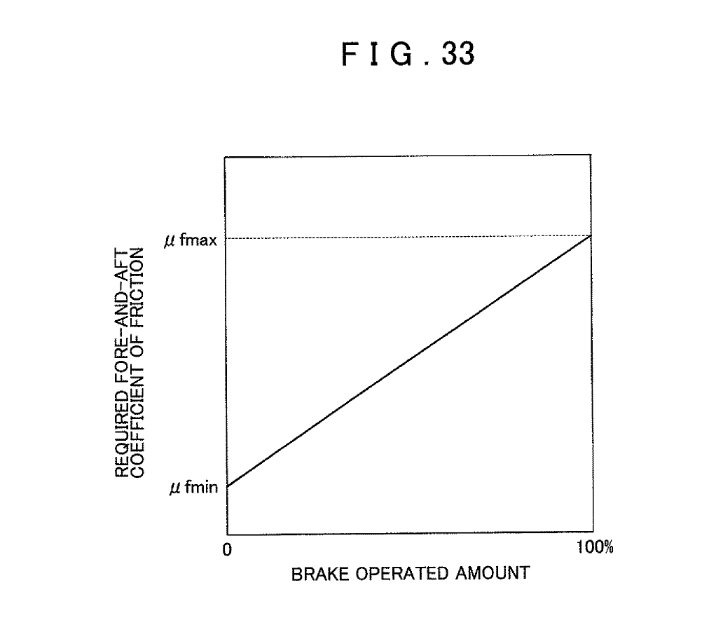

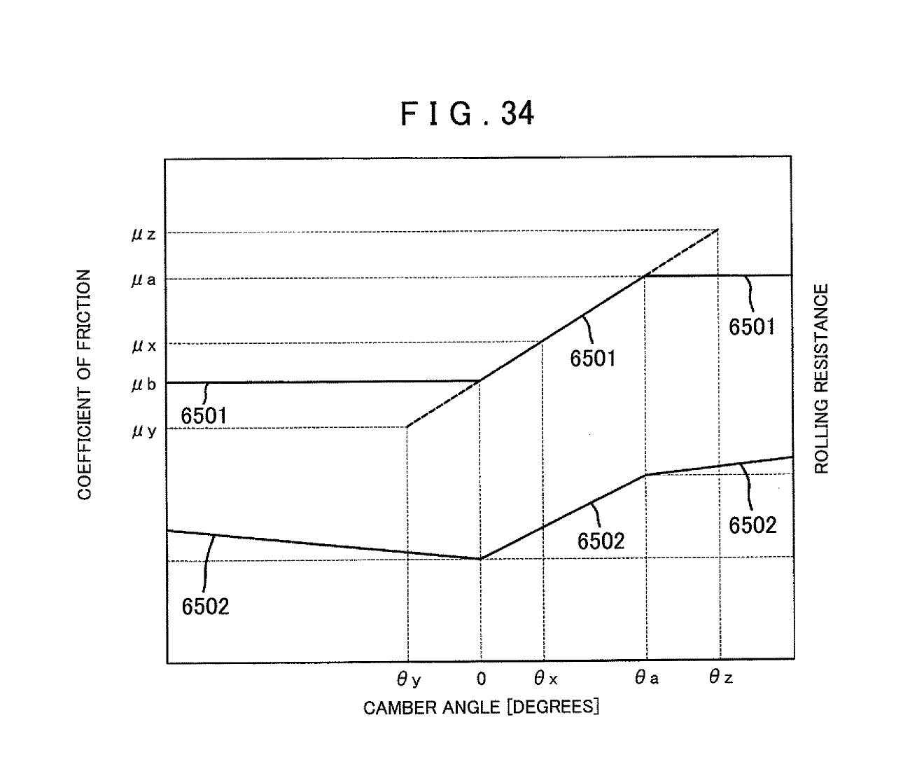

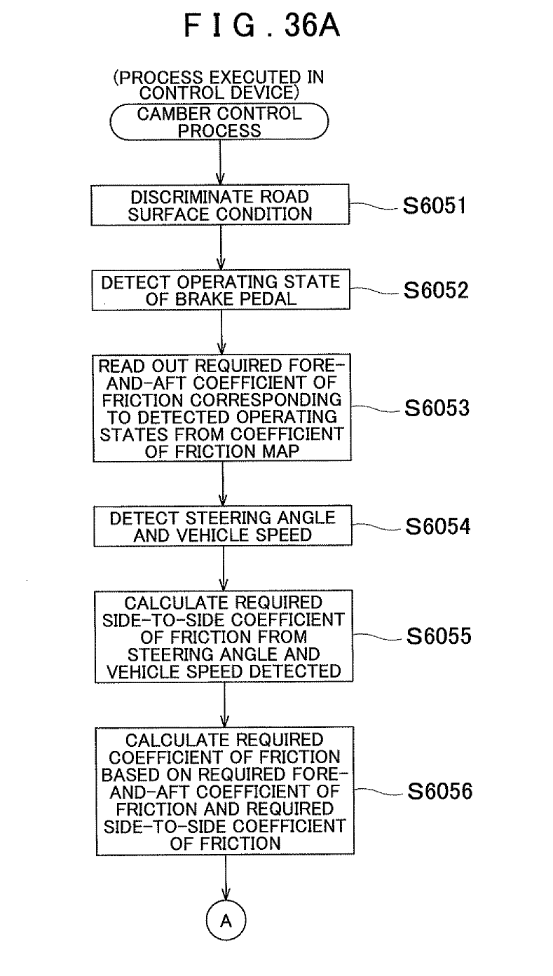

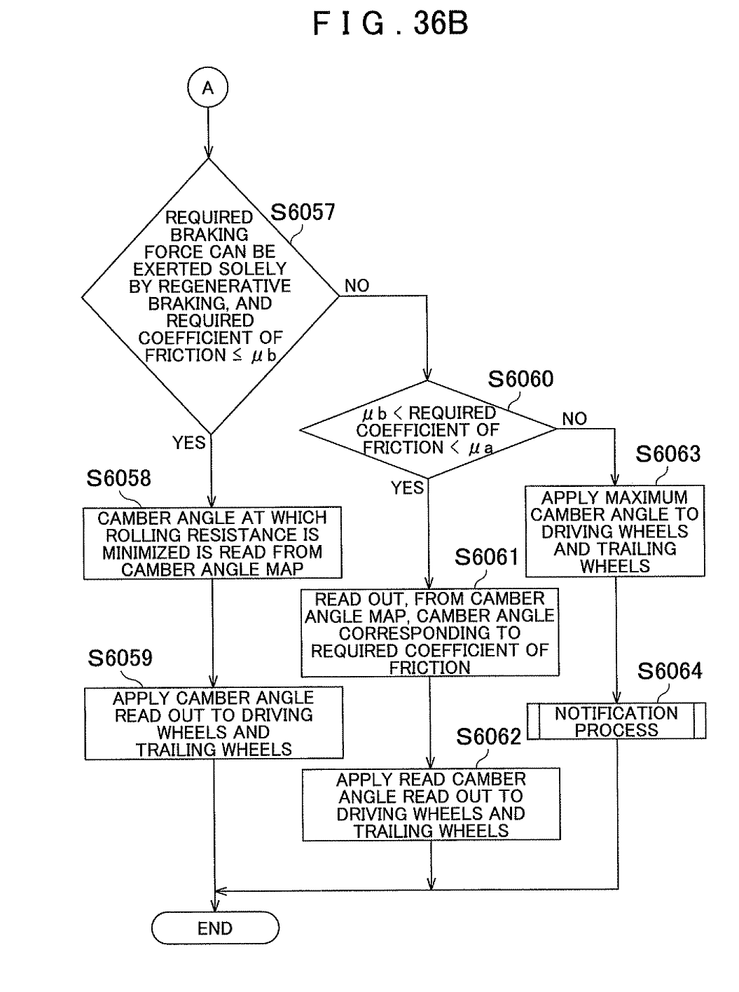

The ROM 6072 is provided with a coefficient of friction map 6072a shown in FIG. 33 and a camber angle map 6072b shown in FIG. 34. In the ROM 6072, a program shown in the flow chart of FIGS. 36A and 36B (camber control process) is stored.

Here, referring to FIGS. 33 and 34, a description is given of the coefficient of friction map 6072a and the camber angle map 6072b. FIG. 33 is a schematic diagram schematically showing the contents of the coefficient of friction map 6072a. The coefficient of friction map 6072a is a map storing the relationship between the depression amount (operating amount) of the brake pedal 53 and the required fore-and-aft coefficient of friction.

Based on the contents of the coefficient of friction map 6072a, the CPU 71 calculates a coefficient of friction that should be exerted by the wheels 2 in the current traveling mode of the vehicle 6001 (that is, a coefficient of friction required in order for the wheels 2 not to slip or lock up). The required fore-and-aft coefficient of friction represented on the vertical axis is the coefficient of friction in the fore-and-aft direction of the vehicle (top-bottom direction in FIG. 31) required in order for the wheels 2 not to slip or lock up.

According to the coefficient of friction map 6072a, as shown in FIG. 33, it is defined such that: the required fore-and-aft coefficient of friction assumes the minimum value μfmin in a state where the brake pedal 53 is not operated (brake operating amount=0); the required fore-and-aft coefficient of friction linearly changes in proportion to the operating amount (depression amount) of the brake pedal 53; and that the required fore-and-aft coefficient of friction assumes the maximum value μfmax in a state where the operating amount of the brake pedal 53 is maximum (brake operating amount=100%).

FIG. 34 is a schematic diagram schematically showing the contents of the camber angle map 6072b. The camber angle map 6072b is a map storing the relationship among the coefficient of friction, the rolling resistance, and the camber angle of the wheels 2, representing the coefficient of friction that the wheels 2 can exert. It is to be noted that the camber angle map 6072b is based on measured values actually measured using the wheels 2.

The CPU 71 determines the camber angle to be applied to the wheels 2 based on the contents of the camber angle map 6072b. In FIG. 34, a solid line 6501 corresponds to the coefficient of friction and a solid line 6502 corresponds to the rolling resistance.

As to the camber angles represented on the horizontal axis, the right side in FIG. 34 (θa side relative to the zero degrees) corresponds to the negative camber (that is, the side on which the ground contact (ground pressure or ground contact area) of the first tread 21 with high gripping performance increases, refer to FIG. 5), and the left side in FIG. 34 (θy side relative to the zero degrees) corresponds to the positive camber (that is, the side on which the ground contact (ground pressure or ground contact area) in the second tread 22 with low rolling resistance increases, refer to FIG. 6).

While the camber angle map 6072b stores three types of map corresponding to three operating states of the road surface condition switch, which will be described later, FIG. 34 shows only one of the maps (dry paved road map) as a representative example and the other two types are not shown so as to be simplified for the sake of easier understanding.

That is, the camber angle map 6072b stores three types of map, namely the dry paved road map, unpaved road map, and a wet paved road map. The CPU 71 detects the operating state of the road surface condition switch (road surface condition switch sensor device 55a), and reads the dry paved road map when the dry paved road is indicated, reads the unpaved road map when the unpaved road is indicated, or reads the wet paved road map when the unpaved road is indicated. Based on the contents thereof, the CPU 71 controls the actuation of the camber angle changing device 4.

According to the camber angle map 6072b, as shown in FIG. 34, the coefficient of friction assumes the minimum value μb when the camber angle is 0 degrees (that is, at which the first tread 21 and the second tread 22 contact the ground equivalently). The same holds true for the rolling resistance, i.e., it assumes the minimum value.

It is defined such that, when the camber angle changes from 0 degrees (that is, at which the first tread 21 and the second tread 22 contact the ground equivalently) toward the negative camber side (θa side), the change causes a gradual increase in the ground contact (ground pressure or ground contact area) of the first tread 21 with high gripping performance (i.e., a gradual reduction in the ground contact (ground pressure or ground contact area) of the second tread 22 with low rolling resistance), which then brings about a gradual increase in the coefficient of friction (and the rolling resistance).

Then, when the camber angle reaches θa (hereafter referred to as “the first camber angle θa”), the second tread 22 is separated from the traveling road surface, and only the first tread 21 contacts the traveling road surface, whereby the coefficient of friction reaches the maximum value μa.

It is to be noted that even if the camber angle further changes from the second camber angle θa toward the negative camber side, the coefficient of friction barely changes and stays at the maximum value μa because the second tread 22 is already separated from the traveling road surface.

It is to be noted that, after the camber angle reaches the first camber angle θa, the rolling resistance gradually increases according to the change in the camber angle although its change (gradient) becomes small. That is, as the camber angle changes toward the negative camber side, the change causes a gradual increase in the camber thrust, which then brings about a gradual increase in the rolling resistance.

Here, the reason why the coefficient of friction stays constant in spite of the increase in the rolling resistance after the camber angle reaches the first camber angle θa is that the change in the coefficient of friction is generally more susceptible to the high gripping performance of the first tread 21 than to the camber thrust.

On the other hand, as shown in FIG. 34, on the positive camber side relative to 0 degrees (left side in FIG. 34), even if the camber angle further changes from 0 degrees (that is, at which the first tread 21 and the second tread 22 contact the ground equivalently) toward the positive camber side, the coefficient of friction barely changes and stays at the minimum value μb.

That is, despite of the fact that, as the camber angle changes from 0 degrees toward the positive direction, the change causes a gradual increase in the ground contact (ground pressure or ground contact area) of the second tread 22 with low rolling resistance) (i.e., a gradual decrease in the ground contact (ground pressure or ground contact area) of the first tread 21 with high gripping performance), the coefficient of friction stays at the minimum value μb.

This is because the ground contact of the second tread 22 inhibits the contribution from the ground contact of the first tread 21 to the high gripping performance owing to the fact that the second tread 22 with low rolling resistance is generally structured to have higher hardness than the first tread 21 with the high gripping performance.

On the other hand, the rolling resistance gradually increases according to the change in the camber angle. That is, as the camber angle changes toward the positive camber side, the change causes a gradual increase in the camber thrust, which then brings about a gradual increase in the rolling resistance.

Here, the reason why the coefficient of friction stays constant in spite of the increase in the rolling resistance is that, as described above, the change in the coefficient of friction is generally more susceptible to the low rolling resistance characteristic of the second tread 22 than to the camber thrust.

Here, the unpaved road map and the wet paved road map not shown in FIG. 34 are formed such that the solid lines in the dry paved road map are translated in the direction in which the coefficient of friction and the rolling resistance are reduced. In both of the maps, the camber angle at which the coefficient of friction and the rolling resistance each assume the minimum value is 0 degrees, and the camber angle at which the coefficient of friction assumes the maximum value is the first camber angle θa.

The description is continued referring back to FIG. 32.

A mechanical brake control device 300 is a control device for providing the wheels 2FL to 2RR with the braking force from a mechanical brake that corresponds to the state of the brake pedal 53 (the depression amount, the depression speed and the like) as being operated by the driver. It is to be noted that, the mechanical brake of the present embodiment is structured as a friction brake that attains the braking force by hydraulically pressing (i.e., by fluid pressure) brake pads against a brake disc. Further, the mechanical brake corresponds to the mechanical brake control device as described as vehicular control device F4, F5 or F7.

When the state of the brake pedal 53 as being operated by the driver (that is, the driver's demand for deceleration (deceleration demand)) is detected by the brake pedal sensor device 53a, the detection result is output to the CPU 71. Based on the detection result, the CPU 71 sets an application amount (fluid pressure) of the mechanical brake (including the case where no fluid pressure is applied to the mechanical brake, which will be described later), and provides the application amount to the mechanical brake control device 300.

Based on the application amount, the mechanical brake control device 300 controls the fluid pressure applied to brake actuators (not shown) for the respective wheels 2FL to 2RR. As a result, the braking force from the mechanical brake corresponding to the operating state of the brake pedal 53 is applied to the wheels 2FL to 2RR.

On the other hand, the FR motor 3FR and the FL motor 3FL respectively driving the right and left front wheels 2FR and 2FL constitute, together with regenerative circuitry (not shown), a regenerative braking device and function as regenerative motors. In this case, the FR motor 3FR and the FL motor 3FL actuate as regenerative brake that rotates the right and left front wheels 2FR and 2FL so as to regenerate the rotational energy of the right and left front wheels 2FR and 2FL into electrical energy, and inhibits rotation of the right and left front wheels 2FR and 2FL so as to reduce the vehicle speed.

The regenerative circuitry (not shown) has a built-in inverter converting alternating current into direct current. The regenerative circuitry allows the motors 3FR and 3FL to function as the regenerative motors based on a control signal from the CPU 71 so as to regenerate the rotational energy of the right and left front wheels 2FR and 2FL into electrical energy, and supplies the power generated at the FR and FL motors 3FR and 3FL by the regeneration to a battery (not shown) serving as an electric power storage device. It is to be noted that, while the description is given in the present embodiment of the battery, which is an accumulator, as an exemplary electric power storage device, other device capable of storing the electrical energy such as a capacitor may be used.

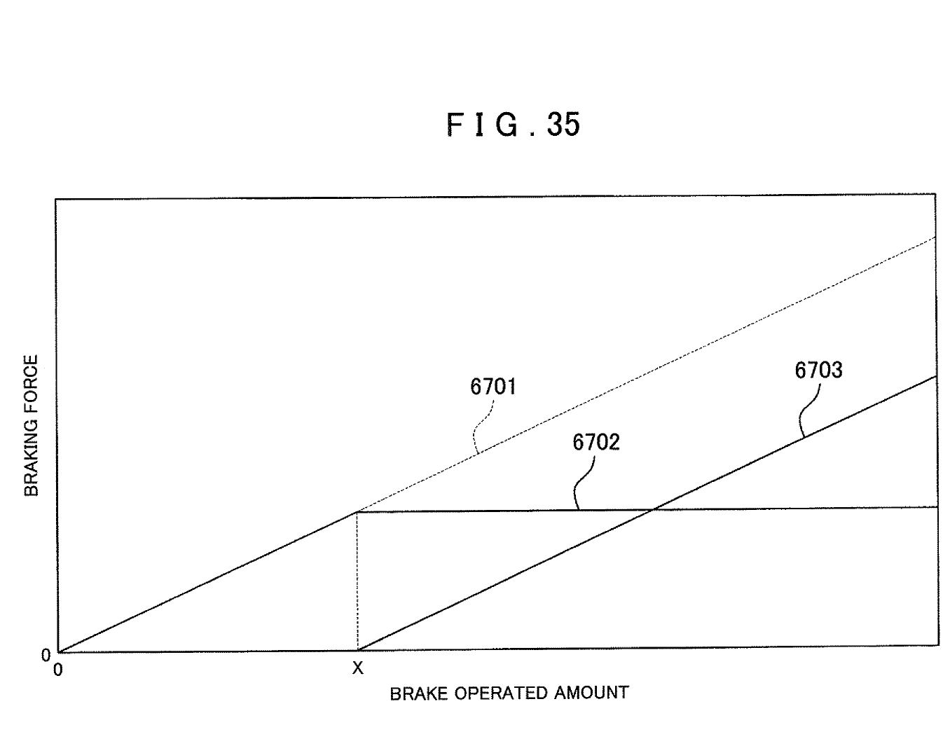

That is, the vehicle 6001 of the present embodiment is a vehicle that exerts cooperative braking control with the regenerative brake attained by the FR and FL motors 3FR and 3FL and the mechanical brake. Here, referring to FIG. 35, a braking method that is performed with the cooperation between the regenerative brake and the mechanical brake.

FIG. 35 is a schematic diagram showing correlation between the operating state of the brake pedal 53 and the braking force. In the schematic diagram of FIG. 35, the horizontal axis represents the operating amount of the brake pedal 53 detected by the brake pedal sensor device 53a, and the operating amount of the brake pedal 53 becomes greater toward the right side in the figure. On the other hand, the vertical axis represents the braking force applied to the vehicle 6001, and the braking force applied to the vehicle 6001 becomes greater toward the top of the figure.

Here, in FIG. 35, a dotted line 6701 corresponds to entire braking force. As shown in FIG. 35, the entire braking force is 0 when the brake pedal 53 is not operated and it linearly increases when the brake pedal 53 is operated by the driver, in proportion to the operating amount of the brake pedal 53.

Further, in FIG. 35, a solid line 6702 corresponds to the braking force by the regenerative brake, and a solid line 6703 corresponds to the braking force by the mechanical brake. As shown in FIG. 35, when the driver starts to depress the brake pedal 53 until the operating amount of the brake pedal 53 reaches “X”, the entire braking force is satisfied solely by the braking force by the regenerative brake.

Accordingly, when the CPU 71 determines that the amount of the brake pedal 53 being operated by the driver, in other words, the braking force required for deceleration of the vehicle that the driver demands (required braking force), can be obtained (achieved) by actuating the regenerative brake, solely the regenerative brake is actuated to decelerate the vehicle. The determination is made depending on whether the required braking force is yet to reach the preset braking threshold value “X” (smaller than the braking threshold value “X”).

Therefore, in the range where the operating amount of the brake pedal 53 is equal to or greater than “0” and smaller than “X”, the CPU 71 outputs a control signal to the wheel driving mechanism 3 (the FR and FL motors 3FR and 3FL), so as to obtain the braking force corresponding to the operating amount of the brake pedal 53 solely by the regenerative brake. While the braking threshold value “X” in the present embodiment is a value predetermined by experimental data for every vehicle or the like, it may be changed as appropriate depending on the traveling mode of the vehicle, the road surface condition such as a rough road, or traveling environment such as weather.

Then, as the amount of the brake pedal 53 being operated by the driver further increases and the operating amount of the brake pedal 53 becomes not smaller than “X”, cooperative braking with the regenerative brake and the mechanical brake is performed. Accordingly, when the amount of the brake pedal 53 being operated by the driver, in other words, the braking force required for deceleration of the vehicle that the driver demands (required braking force) cannot be obtained (achieved) by actuating the regenerative brake, that is, when the CPU 71 determines that it can be obtained (achieved) by actuating both the regenerative brake and the mechanical brake as a mechanical braking device, both the regenerative brake and the mechanical brake are actuated to decelerate the vehicle. The determination is made depending on whether the required braking force has already reached the preset braking threshold value “X” (equal to or greater than braking threshold value “X”).

Accordingly, in the range where the operating amount of the brake pedal 53 is not smaller than “X”, the CPU 71 sets an application amount (braking force) of the regenerative brake and an application amount (braking force) of the mechanical brake corresponding to the operating amount of the brake pedal 53, and provides the set braking force to the wheel driving mechanism 3 (the FR and FL motors 3FR and 3FL) and the brake mechanical brake control device 30. Accordingly, the braking by the mechanical brake for the right and left rear wheels 2RR and 2RL being the trailing wheels starts when the operating amount of the brake pedal 53 becomes equal to or greater than “X”.

It is to be noted that the process of determining the relationship between the operating amount of the brake pedal 53 and the braking threshold value “X”, that is, the process of determining whether the operating amount of the brake pedal 53 is smaller than the braking threshold value “X”, or is equal to or greater than the braking threshold value “X” corresponds to the required braking force calculating means according to claims 3 and 7.

The description is continued referring back to FIG. 32. A vehicle speed sensor device 6032 is a device for detecting a ground speed (absolute value and proceeding direction) of the vehicle 6001 with respect to the road surface G and providing the detection result to the CPU 71, and principally includes a fore-and-aft acceleration sensor 6032a, a side-to-side acceleration sensor 6032b, and control circuitry (not shown) that processes the detection result of the acceleration sensors 6032a and 6032b and provides the processed result to the CPU 71.

The fore-and-aft acceleration sensor 6032a is a sensor that detects fore-and-aft direction (top-bottom direction in FIG. 31) acceleration of the vehicle 6001 (body frame BF), and the side-to-side acceleration sensor 6032b is a sensor that detects side-to-side (side-to-side direction in FIG. 31) acceleration of the vehicle 6001 (body frame BF). In the present embodiment, the acceleration sensors 6032a and 6032b are structured as piezoelectric sensors using a piezoelectric element.

The CPU 71 time-integrates the detection result (acceleration values) of the acceleration sensors 6032a and 6032b received from the control circuitry of the vehicle speed sensor device 6032, thereby calculating the speeds of the two directions (the fore-and-aft direction and the side-to-side direction). Then, the CPU 71 combines the two directional components to obtain the ground speed (absolute value and proceeding direction) of the vehicle 6001.

A wheel rotation speed sensor device 6035 is a device for detecting the rotation speeds of the wheels 2 and providing the detection result to the CPU 71. The wheel rotation speed sensor device 6035 includes four rotation sensors, namely FL to RR rotation speed sensors 6035FL to 6035RR that respectively detect the rotation speeds of the wheels 2, and processing circuitry (not shown) that processes the detection result of the rotation speed sensors 6035FL to 6035RR and provides the processed result to the CPU 71.

It is to be noted that, in the present embodiment, the rotation speed sensors 6035FL to 6035RR are respectively provided to the wheels 2 to detect angular velocity thereof as rotation speed. That is, the rotation speed sensors 6035FL to 6035RR are structured as electromagnetic pickup sensors each including a rotation body that rotates in association with the corresponding wheel 2 and a pickup electromagnetically detecting the presence of a multitude of teeth formed around the circumference of the rotation body.

The CPU 71 can obtain the actual circumferential velocity of each wheel 2 based on the rotation speed of each wheel 2 received from the wheel rotation speed sensor device 6035 and the outer diameter of each wheel 2 in the ROM 6072 stored in advance. Then, by comparing the circumferential velocity and the traveling speed (ground speed) of the vehicle 6001, the CPU 71 can determine whether or not each wheel 2 is slipping.

A wiper switch sensor device 6055a is a device for detecting the operating state of the wiper switch 6055 and providing the detection result to the CPU 71, and principally includes a positioning sensor (not shown) detecting the operating state (operated position) of the wiper switch 6055 and control circuitry (not shown) processing the detection result of the positioning sensor and providing the processed result to the CPU 71.

A turn signal switch sensor device 6056a is a device for detecting the operating state of the turn signal switch 6056 and providing the detection result to the CPU 71, and principally includes a positioning sensor (not shown) detecting the operating state (operated position) of the turn signal switch 6056 and control circuitry (not shown) processing the detection result of the positioning sensor and providing the processed result to the CPU 71.

A high gripping switch sensor device 6057a is a device for detecting the operating state of the high gripping switch 6057 and providing the detection result to the CPU 71, and principally includes a positioning sensor (not shown) detecting the operating state (operated position) of the high gripping switch 6057 and control circuitry (not shown) processing the detection result of the positioning sensor and providing the processed result to the CPU 71.

It is to be noted that, in the present embodiment, the angle sensors are configured as contact-type potentiometers using electrical resistance. The CPU 71 can obtain the depression amount of each of the pedals 52 and 53 and the operated angle of the steering 54 based on the detection result received from the control circuitry of the respective sensor devices 52a to 54a. Then, by time-differentiating the detection result, the CPU 71 can obtain the depression speed (operated speed) for each of the pedals 52 and 53 and the rotation speed (operated speed) of the steering 54.

An example of other input/output devices 6036 shown in FIG. 32 is a rainfall sensor detecting the rainfall, or an optical sensor detecting the condition of the road surface G in a noncontact manner.

Next, referring to FIGS. 36A and 36B, a description is given of a camber control process. FIGS. 36A and 36B show a flow chart of the camber control process. The process is repeatedly executed by the CPU 71 (for example, at 0.2 ms intervals) while the vehicular control device 6100 is powered on, to adjust the camber angle applied to the wheels 2 so that an improvement is attained both in the regenerative energy recovery efficiency and the fuel-saving performance when braking.

In connection with the camber control process, the CPU 71 first determines the road surface condition (S6051). The process is performed by recognizing the detection result of the road surface condition switch sensor device 55a (refer to FIG. 32), and obtaining the state of the road surface condition switch as being operated by the driver. That is, as in the foregoing description, when the operated position of the road surface condition switch is recognized as the first position, the CPU 71 determines that the road surface condition is the dry road surface; when recognized as the second position, the CPU 71 determines that the road surface condition is the unpaved road surface; when recognized as the third position, the CPU 71 determines that the road surface condition is the wet paved road surface.

Next, in the process in step S6052, the operating state of the brake pedal 53 is detected (S6052), and a required fore-and-aft coefficient of friction corresponding to the detected operating state is read from the coefficient of friction map 6072a (refer to FIG. 33) (S6053). Thus, the coefficient of friction in the fore-and-aft direction of the vehicle (top-bottom direction in FIG. 31) required in order for the wheels 2 not to slip or lock up can be obtained.

Next, in the process in step S6054, the steer angle of the wheels 2 and the ground speed of the vehicle 6001 (vehicle speed) are detected (S6054). Based on the detected steer angle and the vehicle speed, the required lateral coefficient of friction is calculated (S6055). It is to be noted that, as in the foregoing description, the CPU 71 detects the steer angle of the wheels 2 and the ground speed of the vehicle 6001 based on the detection result of the steering sensor device 54a and the vehicle speed sensor device 6032.

Here, the required lateral coefficient of friction is a frictional coefficient in the side-to-side direction (side-to-side direction in FIG. 31) of the vehicle 6001 making a turn that is required in order for the wheels 2 not to slip, and is calculated as follows.

That is, the relationship among a steer angle a of the wheels 2, an Ackerman turning radius R0, and a wheelbase I of the vehicle 6001 can be represented as tan σ=I/R0. This relational expression can be approximated as σ=I/R0 in the case where the steer angle σ is a minute angle. By modifying this to represent the Ackerman turning radius R0, R0=I/σ can be obtained.

On the other hand, the relationship between an actual turning radius R of the vehicle 6001 and a ground speed (vehicle speed) v of the vehicle 6001 is represented as R/R0=1+K·v2 from the steering characteristic of the vehicle 6001 using a stability factor K measured for the vehicle 6001. By modifying this to represent the actual turning radius R and substituting the obtained Ackerman turning radius R0 thereinto, R=I(1+K·v2)/σ can be obtained.

Here, a centrifugal force F applied to the vehicle 6001 during the turn is represented as F=m·v2/R, where m is the weight of the vehicle 6001. By substituting the obtained actual turning radius R thereinto, F=m·V2·σ/(I(1+K·v2)) can be obtained. Because a value greater than the centrifugal force F suffices as the friction force for preventing the wheels 2 from slipping in the lateral direction (side-to-side direction of the vehicle 6001), a required lateral coefficient of friction μw can be represented as μw=F/m=V2·σ/(I(1+K·v2)), dividing the centrifugal force F by the weight m.

After the required fore-and-aft coefficient of friction and the required lateral coefficient of friction are obtained in the processes in steps S6053 and S6055, based on the required fore-and-aft coefficient of friction and the required lateral coefficient of friction (that is, as a resultant force of vectors in the fore-and-aft direction and the side-to-side direction of the vehicle 6001), the required coefficient of friction is calculated (S6056), and then the control proceeds to the process in step S6057.

In the process in step S6057, whether or not the required braking force can be exerted solely by the regenerative braking is determined, and the required coefficient of friction calculated in the process in step S6056 is compared against the minimum value μb of the coefficient of friction that the wheels 2 can exert, to determine whether or not the required coefficient of friction is equal to or smaller than the minimum value μb (S6057).

That is, whether the operating amount of the brake pedal 53 is smaller than “X” being the boundary value of actuating the mechanical brake “X” (brake operating amount<X, refer to FIG. 35) is checked based on the detection result of S6052. As a result, when the brake operating amount<X, it is determined that the braking force corresponding to the operating amount of the brake pedal 53 can entirely be exerted (satisfied) solely by the regenerative braking.

It is to be noted that the minimum value μb of the coefficient of friction that the wheels 2 can exert is read from the camber angle map 6072b (refer to FIG. 34) as described in the foregoing. In this case, the CPU 71 selects a map corresponding to the road surface condition discriminated in the process in step S6051 out of the three types of map, and reads the minimum value μb based on the contents of the selected map.

As a result of determination in S6057, when it is determined that the required braking force can be exerted solely by the regenerative braking and the required coefficient of friction is not greater than the minimum value μb (S6057: Yes), a camber angle at which the rolling resistance is minimized is read as a prescribed camber angle from the camber angle map 6072b (refer to FIG. 34) (S6058), and the camber angle is adjusted to the read camber angle (prescribed camber angle), whereby the prescribed camber angle is applied to the wheels 2 (driving wheels and trailing wheels) (S6059), and then the camber control process ends.

Specifically, for example, in such a case where the required coefficient of friction calculated in the process in step S6056 is μy and the relationship μy≦μb is satisfied (S6057: Yes), the camber angle at which the rolling resistance is minimized in a range where the coefficient of friction is not greater than μb (in the present embodiment, “0” degrees based on the camber angle map 6072b in FIG. 34) is read as a prescribed camber angle (S6058), and the read camber angle (“0” degrees) is applied to the driving wheels and the trailing wheels as the prescribed camber angle (adjust the camber angle to the read camber angle) (S6059). That is, such processes of reading a camber angle corresponding to the required coefficient of friction μy as θy from the camber angle map 6072b shown in FIG. 34 and applying the read camber angle θy to wheels 2 (the driving wheels and the trailing wheels) are not performed herein.

Thus, in the present embodiment, as shown in FIG. 34, when the required coefficient of friction, μy calculated in the process in step S6056 is under the minimum value μb of the coefficient of friction that the wheels 2 can exert, a reduction in the rolling resistance (achievement of fuel-saving traveling) cannot be expected even if a camber angle whose absolute value is greater than “0” degrees is applied to the wheels 2 and, therefore, the angle smallest in a range where the minimum value μb can be exerted (“0” degrees) is applied to the wheels 2 as the prescribed angle.

That is, in the present embodiment, when the wheel driving mechanism 3 (regenerative devices) regenerates, the camber angle of the wheels 2 (the driving wheels and the trailing wheels) can be adjusted such that the rolling resistance of the wheels 2 is minimized.

Thus, conversion loss (the rolling resistance (deformation hysteresis loss) of the wheels 2) that occurs when kinetic energy of the traveling vehicle 6001 is converted into electrical energy can be minimized, so as to achieve a reduction in the conversion loss. Therefore, an improvement in the regenerative energy recovery efficiency commensurate thereto can be achieved, and the fuel-saving performance can be attained.

On the other hand, when it is determined in the process in step S6057 that the required braking force cannot be exerted solely by the regenerative braking, or that the required coefficient of friction is greater than μb (S6057: No), then whether or not the required coefficient of friction is greater than the minimum value μb and not greater than the maximum value μa is determined (S6060). As in the foregoing description, the maximum value μa of the coefficient of friction that the wheels 2 can exert is read from the camber angle map 6072b (refer to FIG. 34).

As a result of determination in S6060, when it is determined that the required coefficient of friction is greater than the minimum value μb and not greater than the maximum value μa (S6060: Yes), a camber angle that corresponds to the required coefficient of friction (that is, at which the coefficient of friction becomes equivalent to the required coefficient of friction) for each of the wheels 2 (driving wheels and trailing wheels) is read from the camber angle map 6072b (S6061), and the read camber angle is applied to each of the wheels 2 (driving wheels and trailing wheels) (i.e., the camber angle of each of the wheels 2 is adjusted to the read camber angle) as the prescribed camber angle (S6062), and then the camber control process ends.

Specifically, in this case, for example, the relationship μb<μx<μa is satisfied for one wheel 2, where μx is the required coefficient of friction calculated in the process in step S6056 (S6060: Yes), and accordingly, a camber angle corresponding to the required coefficient of friction μx is read as θx from the camber angle map 6072b shown in FIG. 34 (S6061). Then the camber angle of the wheel 2 is adjusted employing the read camber angle θx as the prescribed camber angle, whereby the read camber angle is applied to the wheel 2 (S6062). These processes are performed for each one of the wheels 2.

Thus, in the present embodiment, the wheels 2 are allowed to exert the minimum required coefficient of friction in order not to slide (slip or lock up), and therefore the kinetic (rotational) energy of the wheels 2 can surely be converted into electrical energy. Accordingly, a reduction in the recovery energy recovery efficiency associated with sliding of the wheels 2 can be suppressed, so as to improve the fuel-saving performance. At the same time, acceleration/braking performance and turning performance can be ensured.

Further, the camber angle of the wheels 2 is adjusted so that the rolling resistance of the wheels 2 is further reduced while sliding (slipping or locking up) of the wheels 2 is suppressed. This suppresses the conversion loss (deformation hysteresis loss of the wheels 2) that occurs when the kinetic energy is converted into electrical energy, to improve the regenerative energy recovery efficiency. This brings about a commensurate improvement in the fuel-saving performance.

On the other hand, when it is determined in the process in step S6060 that the required coefficient of friction does not satisfy the condition of being greater than the minimum value μb and not greater than the maximum value μa (S6060: No), this means that the required coefficient of friction is not smaller than the maximum value μa and, therefore, in this case (S6060: No), the maximum camber angle (that is, the first camber angle θa, refer to FIG. 34) is applied to the wheels 2 (driving wheels and the trailing wheels) (S6063). Then, a notification process (S6064) is executed and the camber control process ends.

Specifically, in this case, the required coefficient of friction μz calculated in the process in step S6056 is not smaller than the maximum value μa (μb≦μz) (S6060: No). However, instead of reading a camber angle corresponding to the required coefficient of friction μz as, for example, θz from the camber angle map 6072b shown in FIG. 34 as in the case described above, in this case the camber angle applied to the wheels 2 is determined as the first camber angle θa and it is applied to the wheels 2 (S6063).

Thus, in the present embodiment, as shown in FIG. 34, when the required coefficient of friction μz calculated in the process in step S6056 exceeds the maximum value μa of the coefficient of friction that the wheels 2 can exert, it is determined that a further increase in the coefficient of friction (improvement in the gripping performance) cannot be expected even if a camber angle whose absolute value is greater than the first camber angle θa is applied to the wheels 2, and accordingly, the angle smallest in a range where the maximum value μa can be exerted (the degree that is close to 0 degrees), i.e., the first camber angle θa, is applied to the wheels 2. Thus, an unduly great camber angle can be avoided, so as to ensure the traveling stability of the vehicle 6001. At the same time, the conversion loss occurring when braking can be suppressed, so that the regenerative energy recovery efficiency is improved. This brings about a commensurate improvement in the fuel-saving performance.

In the notification process (S6064), the driver is notified that the wheels 2 are slipping or locked up (or in danger thereof) because of quick braking or the like, for example by a speaker output and a indication on a monitoring device. This contributes to improve the safety.

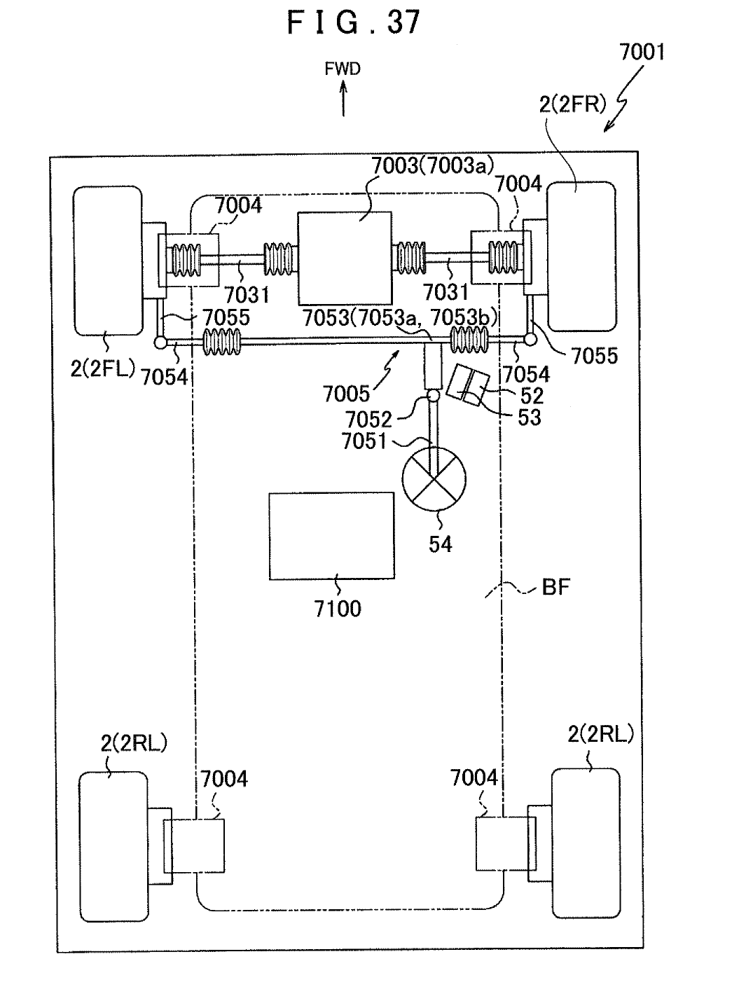

Next, referring to FIGS. 37 to 45, a description is given of a seventh embodiment. The same reference numerals are used for the same parts as in the foregoing embodiments, and the description thereof is not repeated. FIG. 37 is a schematic diagram schematically showing a top view of a vehicle 7001 in which a vehicular control device 7100 according to the seventh embodiment is installed. In FIG. 37, an arrow FWD represents the forward direction of the vehicle 7001.

First, a description is given of the schematic structure of the vehicle 7001. As shown in FIG. 37, the vehicle 7001 principally includes a body frame BF, a plurality of (four in the present embodiment) wheels 2 supported by the body frame BF, a wheel driving mechanism 7003 that rotates part of the wheels 2 (in the present embodiment, right and left front wheels 2FR and 2FL), suspension devices 7004 that suspend the wheels 2 on the body frame BF and adjust the camber angle of the respective wheels 2 independently of one another, and a steering device 7005 that steers part of the wheels 2 (in the present embodiment, the right and left front wheels 2FR and 2FL) according to the operation of the steering 54.

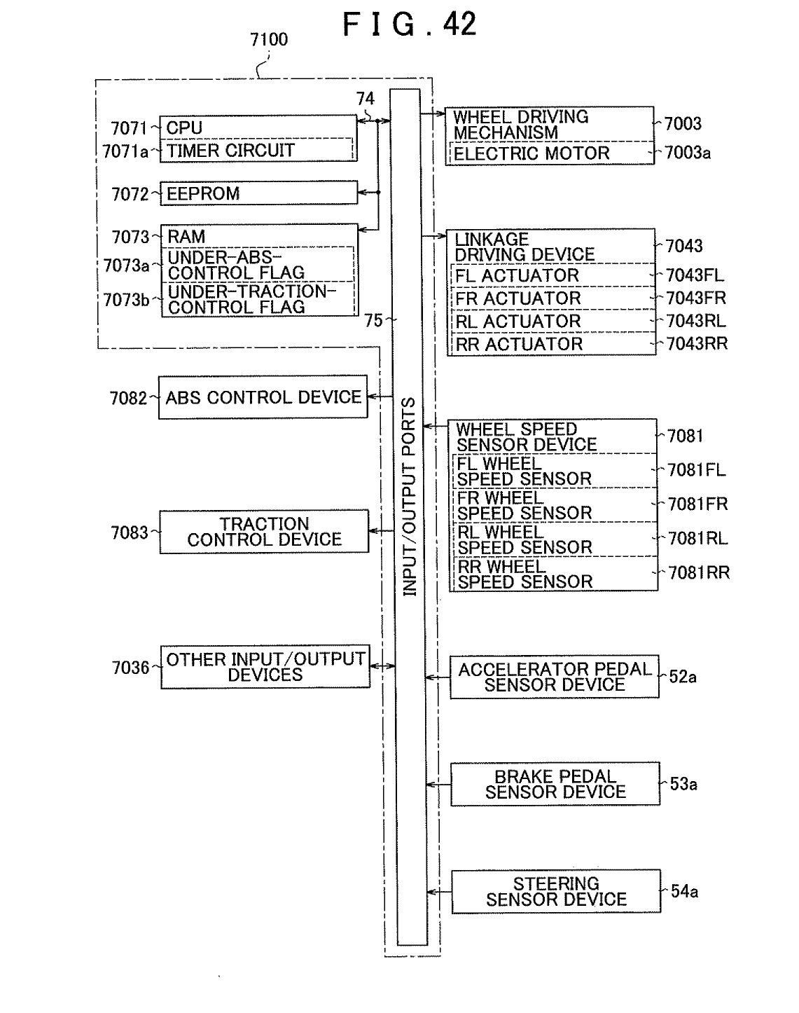

The vehicle 7001 further includes an ABS control device 7082 and a traction control device 7083 (refer to FIG. 42) that control braking force or driving force provided to the wheels 2 so as to suppress slipping of the wheels 2, and is structured to be capable of avoiding the actuation of the ABS control device 7082 or the traction control device 7083 as much as possible when the wheels 2 enter a prescribed slipping state, so as to suppress the slipping while suppressing sense of strangeness or discomfort caused by the ABS control device 7082 or the traction control device 7083.

Next, a description is given of the detailed structure of the constituents. The body frame BF is a structure forming the framework of the vehicle 7001 for mounting the various devices (such as the wheel driving mechanism 7003) thereon, and supported by the suspension devices 7004.

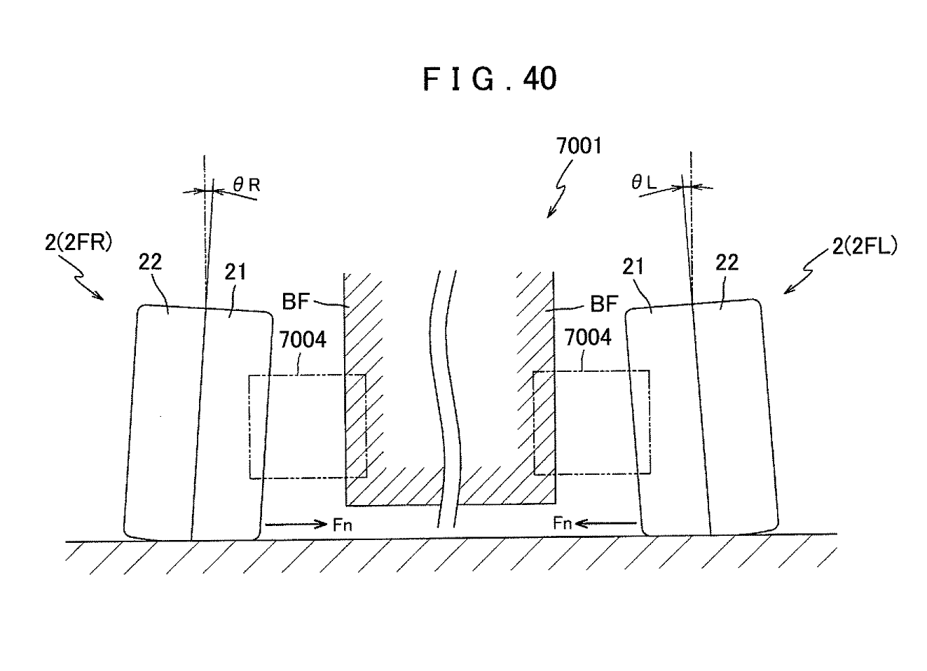

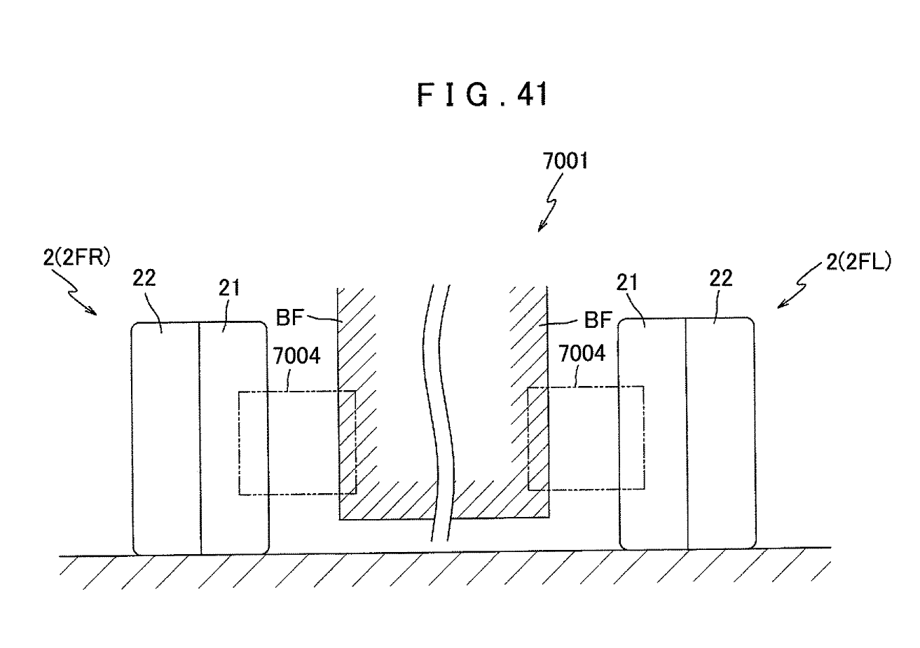

As shown in FIG. 37, the wheels 2 are constituted by four wheels, namely the right and left front wheels 2FR and 2FL arranged on the front side (the side pointed by an arrow FWD) of the body frame BF and right and left rear wheels 2RR and 2RL arranged on the rear side (the side opposite to the arrow FWD) of the body frame BF. The right and left front wheels 2FR and 2FL are structured as the driving wheels that are rotated by the rotational driving force provided by the wheel driving mechanism 7003, whereas the right and left rear wheels 2RR and 2RL are structured as the trailing wheels that trail in accordance with the traveling of the vehicle 7001. It is to be noted that the detailed structure of the wheels 2 will be described later referring to FIGS. 40 and 41.

As in the foregoing description, the wheel driving mechanism 7003 is a device for providing rotational driving force to the right and left front wheels 2FR and 2FL so as to rotate them, and structured with an electric motor 7003a (refer to FIG. 42). As shown in FIG. 37, the electric motor 7003a is connected to the right and left front wheels 2FR and 2FL via a differential gear (not shown) and a pair of drive shafts 7031.

When the driver operates the accelerator pedal 52, rotational driving force is provided from the wheel driving mechanism 7003 to the right and left front wheels 2FR and 2FL so that the right and left front wheels 2FR and 2FL are rotated at the rotation speed corresponding to the depressing state of the accelerator pedal 52. It is to be noted that the difference in rotation between the right and left front wheels 2FR and 2FL is absorbed by the differential gear.

The suspension devices 7004 are the devices that function as a so-called suspension, and are arranged corresponding to the respective wheels 2 as shown in FIG. 37. Further, as in the foregoing description, the suspension devices 7004 of the present embodiment also function as the camber angle adjusting devices that adjust camber angle of the wheels 2.

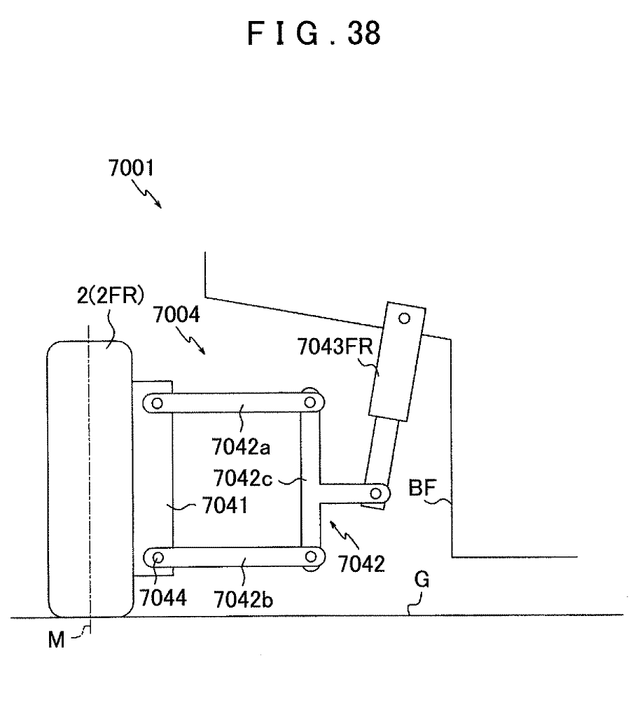

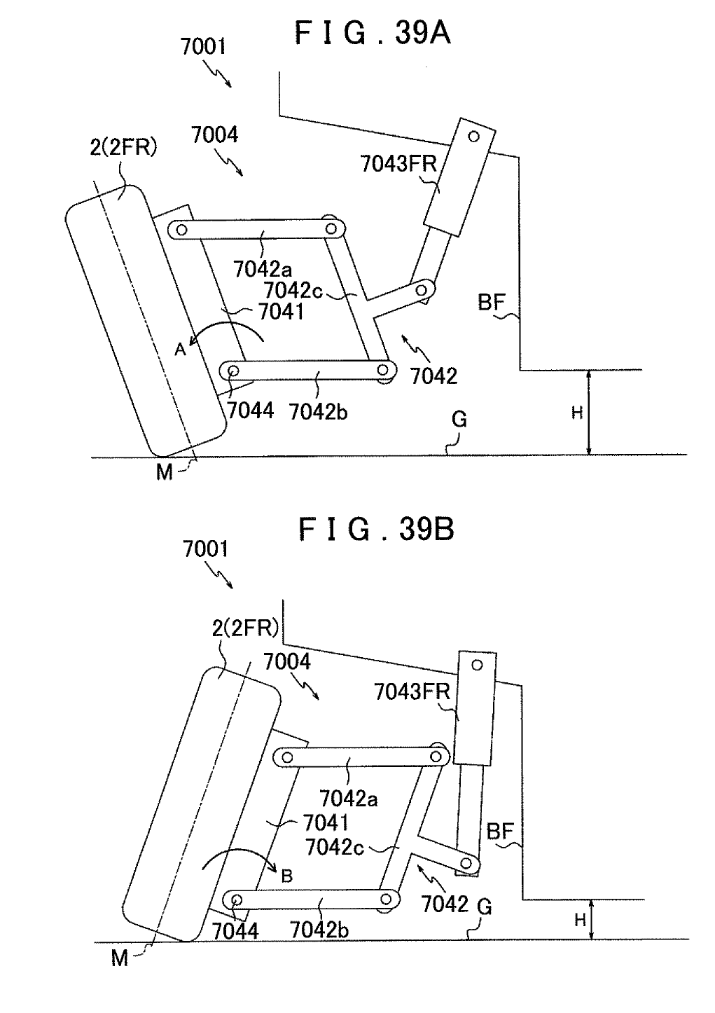

Here, referring to FIGS. 38 and 39, a description is given of the detailed structure of the suspension devices 7004. FIGS. 38 and 39 show a front view of one of the suspension devices 7004. FIG. 39A shows a state where the camber angle of one of the wheels 2 is adjusted in the positive direction, whereas FIG. 39B shows a state where the camber angle of one wheel 2 is adjusted in the negative direction. It is to be noted that, FIGS. 38 and 39 are simplified by not showing the constituents such as the drive shafts 7031 for easier understanding of the invention. Further, because the suspension devices 7004 are similarly structured, the suspension device 7004 corresponding to the right front wheel 2FR is shown in FIGS. 38 and 39 as a representative example, and the other suspension devices 7004 corresponding to the other wheels 2 (left front wheel 2FL, right and left rear wheels 2RR and 2RL) are not shown nor described herein.

As shown in FIG. 38, the suspension device 7004 is structured with a double wishbone type mechanism, and principally includes an axle hub 7041, a suspension arm 7042, and an FR actuator 7043FR.

The axle hub 7041 rotatably supports the wheel 2. As shown in FIG. 38, the axle hub 7041 supports the wheel 2 from the inner side in connection with the vehicle 7001 (right side in FIG. 38) and is coupled to the FR actuator 7043FR via the suspension arm 7042. The suspension arm 7042 couples the axle hub 7041 to the FR actuator 7043FR, and includes a first to a third arms 7042a to 7042c.

The first and second arms 7042a and 7042b have their one ends (left side in FIG. 38) shaft-supported on the upper portion (top side in FIG. 38) and the lower portion (bottom side in FIG. 38) of the axle hub 7041, respectively, and have their other ends (right side in FIG. 38) shaft-supported on the top end (top side in FIG. 38) and the bottom end (bottom side in FIG. 38) of the third arm 7042c, respectively. The first and second arms 7042a and 7042b are arranged to be oppose to each other, and the third arm 7042c is arranged to be oppose to the axle hub 7041. Thus, a four-bar linkage mechanism is structured by the axle hub 7041 and the suspension arm 7042 (the first to third arms 7042a to 7042c).

It is to be noted that a coil spring that absorbs the shock transferred from the road surface G to the body frame BF and a shock absorber that attenuates the vibration of the coil spring (both not shown) are attached to the suspension arm 7042.

The FR actuator 7043FR couples the suspension arm 7042 and the body frame BF to each other and supports the body frame BF, and is structured with a hydraulic cylinder. As shown in FIG. 38, the FR actuator 7043FR has its body (top side in FIG. 38) shaft-supported on the body frame BF, and has its rod portion (bottom side in FIG. 38) shaft-supported on the third arm 7042c.

Here, the second arm 7042b is shaft-supported on the axle hub 7041 via a camber axis 7044. When the FR actuator 7043FR is caused to extend/contract, a linkage mechanism (hereafter simply referred to as “the linkage mechanism”) structured with the axle hub 7041 and the suspension arm 7042 flexes, and the wheel 2 is caused to swing about the camber axis 7044 as the central axis (refer to FIG. 39).

That is, as the wheel 2 normally does not slide relative to the road surface G owing to the friction between the road surface G and the wheel 2, the linkage mechanism flexes with the camber axis 7044 closest to the ground contact surface of the wheel 2 serving as a fixed axis. As a result, the wheel 2 is caused to swing about the camber axis 7044 as a central axis.

Additionally, as the axle hub 7041 is structured to support the wheel 2 on the inner side in connection with the vehicle 7001, the camber axis 7044 is arranged on the inner side (right side in FIG. 38) in connection with the vehicle 7001 than the central line M of the wheel 2 is, as viewed from the front side of the vehicle 7001.

According to the suspension devices 7004 structured as above, as shown in FIG. 39, when the FR actuator 7043FR is caused to extend/contract from the state shown in FIG. 38, the linkage mechanism flexes and the wheel 2 is caused to swing about the camber axis 7044 as the central axis, whereby the camber angle of the wheel 2 is adjusted. Further, when the FR actuator 7043FR is caused to extend/contract, the linkage mechanism flexes and the wheel 2 is caused to swing about the camber axis 7044 as the central axis, the body frame BF supported on the suspension device 7004 (FR actuator 7043FR) moves up or down. That is, as the FR actuator 7043FR is caused to extend/contract, the camber angle of the wheel 2 is adjusted and at the same time the body frame BF moves up or down.

Here, in the present embodiment, as in the foregoing description, the camber axis 7044 is structured to be arranged on the inner side in connection with the vehicle 7001 than the central line M of the wheel 2 is, as viewed from the front side of the vehicle 7001. Therefore, as shown in FIG. 39A, when the FR actuator 7043FR is caused to contract, the wheel 2 is caused to swing in the arrow A direction about the camber axis 7044 as the central axis, and the camber angle of the wheel 2 is adjusted in the positive direction. At the same time, the body frame BF moves up (that is, the distance H between the body frame BF and the road surface G is increased).

On the other hand, as shown in FIG. 39B, when the FR actuator 7043FR is extended, the wheel 2 is caused to swing in the arrow B direction about the camber axis 7044 as the central axis, and the camber angle of the wheel 2 is adjusted in the negative direction. At the same time, the body frame BF moves down (that is, the distance H between the body frame BF and the road surface G is reduced).

The description is continued referring back to FIG. 37. The steering device 7005 is structured with a rack and pinion mechanism, and principally includes a steering shaft 7051, a hook joint 7052, a steering gear 7053, tie rods 7054, and knuckles 7055.

According to the steering device 7005, the operation of the steering 54 by the driver is first transferred to the hook joint 7052 via the steering shaft 7051, and thereafter being subjected to an angular change by the hook joint 7052, then transferred to a pinion 7053a of the steering gear 7053 as rotational movement. Then, the rotational movement transferred to the pinion 7053a is converted into linear movement of a rack 7053b. This linear movement of the rack 7053b causes the tie rods 7054 connected to the opposite ends of the rack 7053b to move and to push or pull the knuckles 7055, whereby the steer angle of the wheels 2 (the right and left front wheels 2FR and 2FL) is adjusted.

The accelerator pedal 52 and the brake pedal 53 are operational members operated by the driver. In accordance with the depressing state (depression amount, depression speed and the like) of the pedals 52 and 53, the traveling speed and the braking force of the vehicle 7001 is determined, and the control over the wheel driving mechanism 7003 is exerted. The steering 54 is an operational member operated by the driver. According to its operation, the wheels 2 are steered by the steering device 7005.

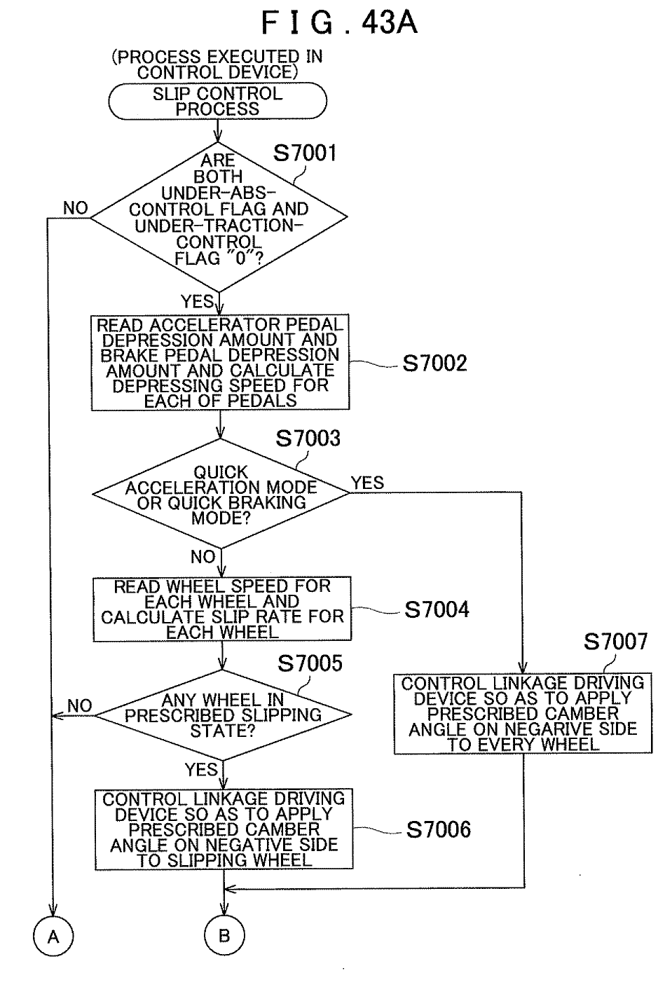

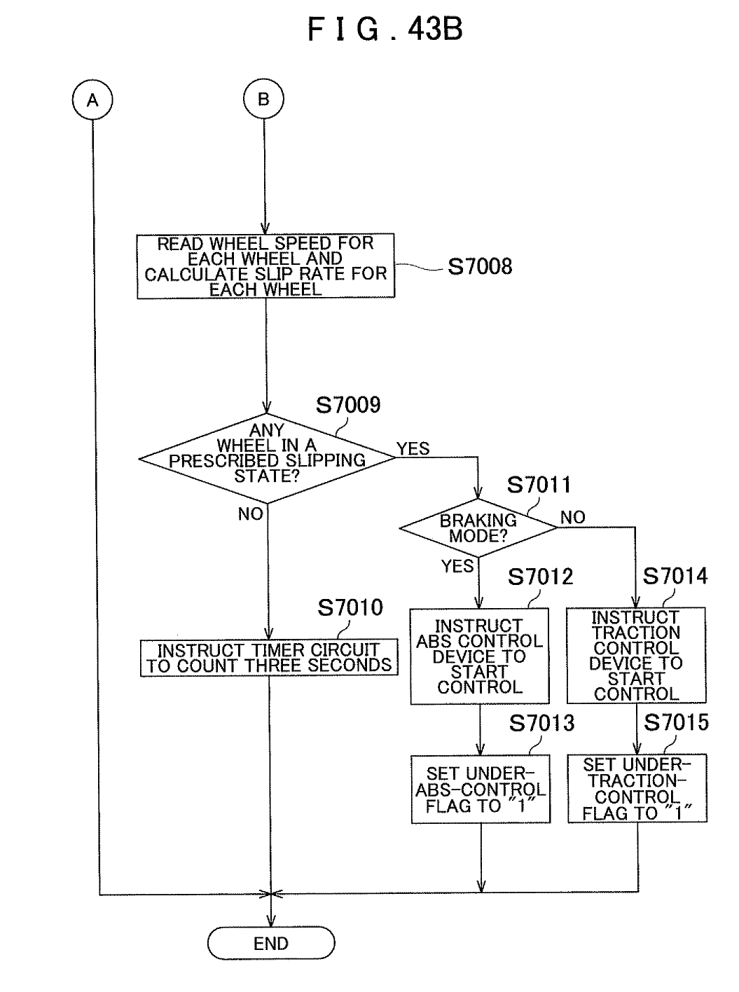

The control device 7100 is a device for controlling the constituents of the vehicle 7001 structured as described above, and rotates the wheels 2 by, for example, detecting the depressing state of the pedals 52 and 53 and controlling the wheel driving mechanism 7003 in accordance with the detection result. Alternatively, when it is determined that a prescribed slipping state is occurring at any wheel 2 in a slip control process (refer to FIGS. 43A and 43B), which will be described later, the control device 7100 adjusts the camber angle of the wheel 2 in the negative direction so that it attains a prescribed camber angle, by a controlling linkage driving device 7043 (an FL actuator 7043FL to an RR actuator 7043RR, refer to FIG. 42) described later. It is to be noted that the detailed structure of the control device 7100 will be described later referring to FIG. 42.

Next, referring to FIGS. 40 and 41, a description is given of the detailed structure of the wheels 2. FIGS. 40 and 41 are schematic diagrams schematically showing the front view of the vehicle 7001. FIG. 40 shows a state where the camber angle of the wheels 2 is adjusted in the negative direction, whereas FIG. 41 shows the state where the camber angle of the wheels 2 is adjusted to 0 degrees.

The wheels 2 are each provided with two types of tread, namely an inner tread 21 and an outer tread 22. In each wheel 2, the inner tread 21 is arranged on the inner side in connection with the vehicle 7001, whereas the outer tread 22 is arranged on the outer side in connection with the vehicle 7001 (refer to FIG. 6). The wheels 2 are so structured that the inner tread 21 and the outer tread 22 are different from each other in characteristic, i.e., the inner tread 21 is structured to be softer (lower in rubber hardness) as compared to the outer tread 22. It is to be noted that, in the present embodiment, the treads 21 and 22 are structured to be identical in the width dimension (side-to-side direction in FIG. 6).

According to the wheels 2 structured as in the foregoing description, as shown in FIG. 40, when the linkage driving device 7043 (the FL actuator 7043FL to the RR actuator 7043RR, refer to FIG. 42) is controlled so that the camber angles θL and θR of the wheels 2 are adjusted in the negative direction, camber thrust Fn is generated at the wheels 2 toward the inner side in connection with the vehicle 7001.

Additionally, the adjustment of the camber angles θL and θR of the wheels 2 in the negative direction brings about an increase in the ground contact area (ground contact ratio) of the inner tread 21 arranged on the inner side in connection with the vehicle 7001, and a reduction in the ground contact area (ground contact ratio) of the outer tread 22 arranged on the outer side in connection with the vehicle 7001. Thus, the ground contact ratio of the inner tread 21 and the outer tread 22 can be changed and, accordingly, the effect of the characteristic of the tread with high ground contact ratio, i.e., the inner tread 21, can be increased so as to allow the wheels 2 to exert the performance derived from the characteristic of the inner tread 21.

Here, in the present embodiment, the inner tread 21 can achieve higher gripping performance as compared to the outer tread 22, because the wheels 2 are structured such that the inner tread 21 is structured to be softer (lower in rubber hardness) as compared to the outer tread 22 as in the foregoing description. Accordingly, when it is determined that a prescribed slipping state is occurring at any wheel 2, by adjusting the camber angle of the wheel 2 in the negative direction to be a prescribed camber angle, it becomes possible to allow the high gripping performance of the inner tread 21 to be exerted, so as to further suppress the slip occurring at the wheel 2.

It is to be noted that the term “prescribed camber angle” used herein refers to a preset angle at which the camber angle of the wheels 2 provides the ground contact ratio of the inner tread 21 being not smaller than a prescribed ratio.

On the other hand, as shown in FIG. 41, when the linkage driving device 7043 is controlled so that the camber angle of the wheels 2 is adjusted to be 0 degrees, the inner tread 21 and the outer tread 22 become approximately equal to each other in the ground contact ratio. Thus, an increase in the rolling resistance of the wheels 2 due to the high gripping performance exhibited by the softer property (lower rubber hardness property) of the inner tread 21 can be avoided, because the ground contact ratio of the inner tread 21 can be reduced. As a result, a reduction in the fuel efficiency can be suppressed, and so the fuel efficiency performance can be improved. Further, the camber thrust is not generated at the wheels 2 because the camber angle of the wheels 2 is adjusted to 0 degrees, which brings about a commensurate further improvement in the fuel efficiency performance.

It is to be noted that, in the present embodiment, the camber angle of the wheels 2 is adjusted to be 0 degrees when an ignition switch (not shown) is turned on. Additionally, the camber angle of any wheel 2 having been applied in the negative direction based on the determination that a prescribed slipping state has occurred at the wheel 2 is returned to 0 degrees when it is determined that the prescribed slipping state is resolved. Thus, the fuel efficiency performance of the vehicle 7001 can be improved.

Next, referring to FIG. 42, a description is given of the detailed structure of the control device 7100. FIG. 42 is a block diagram showing the electrical structure of the control device 7100. As shown in FIG. 42, the control device 7100 includes a CPU (Central Processing Unit) 7071, EEPROM (Electronically Erasable and Programmable Read Only Memory) 7072 and RAM (Random Access Memory) 7073 that are connected to the input/output ports 75 via the bus line 74. To the input/output ports 75, the wheel driving mechanism 7003, the linkage driving device 7043, a wheel speed sensor device 7081, the accelerator pedal sensor device 52a, the brake pedal sensor device 53a, the steering sensor device 54a, an anti-lock braking system control device 7082 (hereafter referred to as “the ABS control device 7082”), the traction control device 7083, and other input/output devices 7036 are connected.

The CPU 7071 is a computing device that controls those constituents connected by the bus line 74, and includes a timer circuit 7071a. The timer circuit 7071a is a known circuit that has an internal clock clocking the current time, and upon receipt of an instruction to count from the CPU 7071, it counts the instructed time and reports the completion of counting the time to the CPU 7071 by an interrupt.

The EEPROM 7072 is non-volatile memory that rewritably stores control programs executed by the CPU 7071 (for example, the programs shown in the flow charts of FIGS. 43 to 45), fixed value data and the like, and that is capable of retaining the contents after power-off.

The RAM 7073 is memory for rewritably storing various data when the control programs are executed. In the RAM 7073, an under-ABS-control flag 7073a and an under-traction-control flag 7073b are stored.

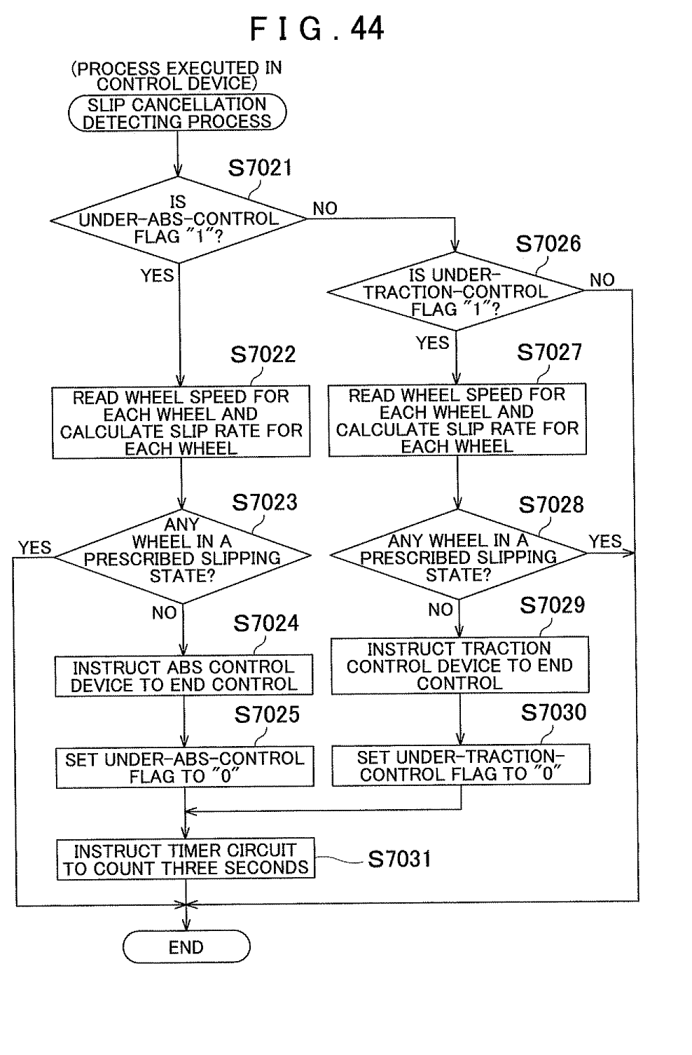

The under-ABS-control flag 7073a is a flag indicating whether or not ABS control is exerted by the ABS control device 7082. The ABS control flag 7073a is set to “1” indicating that the ABS control is exerted when an instruction to start the ABS control is provided to the ABS control device 7082 in the slip control process (refer to FIGS. 43A and 43B) described later. Further, the ABS control flag 7073a is set to “0” indicating that the ABS control is not exerted when an instruction to end the ABS control is provided to the ABS control device 7082 in a slip cancellation detecting process (refer to FIG. 44) described later.

The under-traction-control flag 7073b is a flag indicating whether or not traction control is exerted by the traction control device 7083. The under-traction-control flag 7073b is set to “1” indicating that the traction control is exerted when an instruction to start the traction control is provided to the traction control device 7083 in the slip control process (refer to FIGS. 43A and 43B) described later. Further, the under-traction-control flag 7073b is set to “0” indicating that the traction control is not exerted when an instruction to end the traction control is provided to the traction control device 7083 in the slip cancellation detecting process (refer to FIG. 44) described later.

The CPU 7071 can determine whether or not the ABS control is exerted by the ABS control device 7082, based on the contents of the under-ABS-control flag 7073a. The CPU 7071 can determine whether or not the traction control is exerted by the traction control device 7083, based on the contents of the under-traction-control flag 7073b.

Further, during execution of the slip control process (refer to FIGS. 43A and 43B) described later, when it is determined that the ABS control is not exerted by the ABS control device 7082 nor is the traction control exerted by the traction control device 7083 based on the contents of the under-ABS-control flag 7073a and the under-traction-control flag 7073b, if it is estimated that the vehicle 7001 is in a quick acceleration mode or braking mode or that any wheel 2 is in a prescribed slipping state, the CPU 7071 can control the linkage driving device 7043 so that a prescribed camber angle is applied in the negative direction to the wheel 2 to allow it to exert the high gripping performance.

Further, when it is estimated that the prescribed slipping state is still occurring at any wheel 2 even after the linkage driving device 7043 is controlled so that the prescribed camber angle is applied in the negative direction to the wheel 2, the CPU 7071 can provide an instruction to start the ABS control or the traction control to the ABS control device 7082 or the traction control device 7083.

On the other hand, during execution of the slip cancellation detecting process (refer to FIG. 44) described later, when it is determined that the ABS control is exerted by the ABS control device 7082 based on the contents of the under-ABS-control flag 7073a, and if the prescribed slipping state occurred at the wheel 2 is resolved, then the CPU 7071 can provide an instruction to end the ABS control to the ABS control device 7082, and an instruction to count three seconds to the timer circuit 7071a in order to adjust the camber angle of the wheels 2 to be 0 degrees after a lapse of a prescribed time (in the present embodiment, after a lapse of three seconds).

Further, when it is determined that the traction control is exerted by the traction control device 7083 based on the contents of the under-traction-control flag 7073b, and if the prescribed slipping state occurred at the wheel 2 is resolved, the CPU 7071 can provide an instruction to end the traction control to the traction control device 7083, and an instruction to count three seconds to the timer circuit 7071a in order to adjust the camber angle of the wheel 2 to be 0 degrees after a lapse of a prescribed time (in the present embodiment, after a lapse of three seconds).

It is to be noted that, when the ignition switch (not shown) is turned on (that is, when the control device 7100 is powered on), the vehicle 7001 does not exert the ABS control nor the traction control. Therefore, the under-ABS-control flag 7073a and the under-traction-control flag 7073b are both set to “0” as the initial value.

The wheel driving mechanism 7003 is a device for rotating the right and left front wheels 2FR and 2FL (refer to FIG. 37) as in the foregoing description, and principally includes the electric motor 7003a that provides rotational driving force to the right and left front wheels 2FR and 2FL, and control circuitry (not shown) that controls the electric motor 7003a based on a command from the CPU 7071.

The linkage driving device 7043 is a device for causing the linkage mechanisms (refer to FIGS. 38 and 39) to flex, and principally includes four actuators, namely the FL actuator 7043FL to the RR actuator 7043RR, that provide linkage mechanism with the driving force to flex, and control circuitry (not shown) that controls the actuators 7043FL to 7043RR based on a command from the CPU 7071.

As in the foregoing description, the FL actuator 7043FL to the RR actuator 7043RR are structured with the hydraulic cylinders, and each structured to principally include a hydraulic pump (not shown) supplying oil (oil pressure) to the hydraulic cylinder (the FL actuator 7043FL to the RR actuator 7043RR), and an electromagnetic valve (not shown) that switches the supply direction of the oil supplied from the hydraulic pump to the hydraulic cylinder.

When the control circuitry of the linkage driving device 7043 exerts control to drive the hydraulic pumps based on an instruction from the CPU 7071, the respective hydraulic cylinders are driven for extension/contraction by the oil (oil pressure) supplied from the hydraulic pumps. When the electromagnetic valves are turned on or off, the driven direction (extension or contraction) of the respective hydraulic cylinders is switched.

The control circuitry of the linkage driving device 7043 monitors extension/contraction amount of each hydraulic cylinder by an extension/contraction sensor (not shown). The hydraulic cylinder that reaches a target value (extension/contraction amount) instructed by the CPU 7071 is caused to stop its extension/contraction. The detection result obtained by the extension/contraction sensor is provided from the control circuit to the CPU 7071, and the CPU 7071 can obtain a camber angle of each wheel 2 based on the detection result.

The wheel speed sensor 7081 is a device for detecting the rotation speed (wheel speed) of the wheels 2FL to 2RR, and providing the detection result to the CPU 7071, and includes an FL wheel speed sensor 7081 FL detecting the wheel speed of the left front wheel 2FL, an FR wheel speed sensor 7081FR detecting the wheel speed of the right front wheel 2FR, an RL wheel speed sensor 7081 RL detecting the wheel speed of the left rear wheel 2RL, and an RR wheel speed sensor 7081 RR detecting the wheel speed of the right rear wheel 2RR, and processing circuitry (not shown) processing the detection result of the wheel speed sensors 7081 FL to 7081 RR and providing the processed result to the CPU 7071. It is to be noted that, in the present embodiment, the wheel speed sensors 7081 FL to 7081 RR are each structured as an electromagnetic sensor that detects variations in the magnetic field of a center rotor (not shown) rotating with the wheel 2 using a Hall element (not shown).

Based on the detection result (the wheel speed of the wheels 2FL to 2RR) of the wheel speed sensors 7081FL to 7081RR received from the wheel speed sensor device 7081, the CPU 7071 can calculate an estimated vehicle body speed (vehicle speed) of the vehicle 7001, and based on the estimated wheel speed and each wheel speed of the wheels 2FL to 2RR, the CPU 7071 can calculate a slip rate for each of the wheels 2FL to 2RR. Then, comparing respective calculated slip rates of the wheels 2FL to 2RR with one another, when there is a wheel whose slip rate is abnormally greater than the other wheels, it can be determined that a prescribed slipping state is occurring at the wheel.

The accelerator pedal sensor device 52a is a device for detecting a depressing state of the accelerator pedal 52 and providing the detection result to the CPU 7071. The accelerator pedal sensor device 52a includes an angle sensor (not shown) that detects a depression amount of the accelerator pedal 52, and processing circuitry (not shown) that processes the detection result of the angle sensor and provides the processed result to the CPU 7071.

The brake pedal sensor device 53a is a device for detecting a depressing state of the brake pedal 53 and providing the detection result to the CPU 7071. The brake pedal sensor device 53a includes an angle sensor (not shown) that detects the depression amount of the brake pedal 53, and processing circuitry (not shown) that processes the detection result of the angle sensor and provides the processed result to the CPU 7071.

The steering sensor device 54a is a device for detecting an operating state of the steering 54 and providing the detection result to the CPU 7071. The steering sensor device 54a includes an angle sensor (not shown) detecting the rotation angle of the steering 54 in association with the rotation direction, and processing circuitry (not shown) that processes the detection result of the angle sensor and provides the processed result to the CPU 7071.

It is to be noted that, in the present embodiment, the angle sensors are configured as contact-type potentiometers using electrical resistance. The CPU 7071 can obtain the depression amount of each of the pedals 52 and 53 and the rotation angle of the steering 54 based on the detection result of the angle sensors received from the respective sensor devices 52a, 53a, and 54a. Then, by time-differentiating the detection result, the CPU 7071 can obtain the depression speed of each of the pedals 52 and 53 and the rotation speed of the steering 54.

Thus, the CPU 7071 can determine that the vehicle 7001 is in a quick acceleration mode or a quick braking mode when depression speed of the pedals 52 or 53 is greater than a prescribed speed. Additionally, the CPU 7071 can determine that the vehicle 7001 is in a sharp turning mode when the rotation speed of the steering 54 is greater than a prescribed rotation speed.

The ABS control device 7082 is a known device that controls (ABS controls), in a braking mode, the braking force provided to the wheels 2 in order for the slip rate of each wheel 2 not to exceed a prescribed range, so as to prevent the slip rate of each wheel 2 from becoming 100% (locked up).

The traction control device 7083 is a known device that controls (traction controls), in a driving (starting or acceleration) mode, the rotational driving force provided from the wheel driving mechanism 7003 (electric motor 7003a) to the driving wheels (the right and left front wheels 2FL and 2RR) in order for the slip rate of each of the driving wheels (the right and left front wheels 2FR and 2FL) not to exceed a prescribed range, so as to prevent slipping of the driving wheels (the right and left front wheels 2FL and 2RR).

In the present embodiment, it is so defined that, as in the foregoing description, when it is determined in the slip control process (refer to FIGS. 43A and 43B) that the vehicle 7001 is in a quick braking mode or a quick acceleration mode, or it is determined that there is a wheel 2 at which a prescribed slipping state is occurring, the linkage driving device 7043 is controlled so that a prescribed camber angle is applied in the negative direction to the wheel 2. Then, when it is estimated after such control that a prescribed slipping state is still occurring at any wheel 2, the ABS control by the ABS control device 7082 or the traction control by the traction control device 7083 starts.

An example of other input/output devices 7036 shown in FIG. 42 is an optical sensor that measures an attitude (such as inclination) of the vehicle 7001 (body frame BF) relative to the road surface in a noncontact manner.

Next, referring to FIGS. 43A and 43B, a description is given of the slip control process. FIGS. 43A and 43B show a flow chart of the slip control process. This process is intended for suppressing slipping of the wheels 2 when it is determined that the vehicle 7001 is in a quick braking mode or a quick acceleration mode or when it is determined that a prescribed slipping state is occurring at any wheel 2. The process is repeatedly executed by the CPU 7071 (for example, at 0.2 ms intervals) while the control device 7100 is powered on.

In connection with the slip control process, the CPU 7071 first determines whether or not the contents of the under-ABS-control flag 7073a stored in the RAM 7073 is “0” and the contents of the under-traction-control flag 7073b is also “0” (S7001). As a result, when it is determined that the contents of one of the under-ABS-control flag 7073a and the under-traction-control flag 7073b is “1” (S7001: No), it can be determined that the control for suppressing slipping (the ABS control or the traction control) has already been exerted, and therefore, the slip control process ends.

On the other hand, when the process in step S7001 results in a determination that the contents of the under-ABS-control flag 7073a is “0” and the contents of the under-traction-control flag 7073b is also “0” (S7001: Yes), it can be determined that the ABS control and the traction control are not exerted. Therefore, subsequently, the detection result (the depression amount of the accelerator pedal 52 and the depression amount of the brake pedal 53) is read from the accelerator pedal sensor device 52a and the brake pedal sensor device 53a. Then, by time-differentiating the read depression amount for each of the pedals 52 and 53, the depression speed for each of the pedals 52 and 53 is calculated (S7002).

Then, whether or not the vehicle 7001 is in a quick acceleration mode or a quick deceleration mode is determined, based on the calculated depression speed for each of the pedals 52 and 53 (S7003). As a result, when it is determined that the vehicle 7001 is not in a quick acceleration mode nor is it in a quick deceleration mode (S7003: No), subsequently, the detection result (the wheel speed for each of the wheels 2FL to 2RR) of the wheel speed sensor device 7081 (FL wheel speed sensor 7081 FL to RR wheel speed sensor 7081RR) is read in order to determine the slipping state of the wheels 2FL to 2RR. Then, the slip rate for each of the wheels 2FL to 2RR is calculated based on the read wheel speed for each of the wheels 2FL to 2RR (S7004).

Then, comparing the calculated slip rate for each of the wheels 2FL to 2RR against one another, whether or not there is any wheel 2 whose slip rate is abnormally greater than the other wheels, that is, whether or not there is any wheel 2 in a prescribed slipping state among the wheels 2FL to 2RR is determined (S7005). As a result, when it is determined that there are no wheels 2 in a prescribed slipping state (S7005: No), it means that there is no need to exert any control for suppressing slipping because the vehicle 7001 is not in a quick acceleration mode nor is it in a quick braking mode, and a prescribed slipping state is occurring at none of the wheels 2FL to 2RR. Accordingly, the slip control process ends.

On the other hand, when the process in step S7005 results in a determination that there is any wheel 2 in a prescribed slipping state (S7005: Yes), the linkage driving device 7043 (the FL actuator 7043FL to RR actuator 7043RR) is controlled so that a prescribed camber angle is applied in the negative direction to the slipping wheel 2 (S7006), and then the control proceeds to the process in step S7008.

Thus, it becomes possible to increase the ground contact ratio of the inner tread 21 of the wheel 2 determined as being in a prescribed slipping state and, therefore, it becomes possible to increase the effect of the soft property of the inner tread 21 so as to allow the wheel 2 to exert the performance derived from the characteristic of the inner tread 21, that is, the high gripping performance. Accordingly, the slip occurring at the wheel 2 can be suppressed because the gripping force of the wheel 2 can be enhanced.

On the other hand, when the process in step S7003 results in a determination that the vehicle 7001 is in a quick acceleration mode or in a quick braking mode (S7003: Yes), the linkage driving device 7043 (the FL actuator 7043FL to the RR actuator 7043RR) is controlled so that a prescribed camber angle is applied in the negative direction to every one of the wheels 2FL to 2RR (S7007), and then the control proceeds to the process in step S7008.

In this manner, when it is determined that the vehicle 7001 is in a quick braking mode or a quick acceleration mode, irrespective of whether or not there is any wheel 2 in a prescribed slipping state, the ground contact ratio of the second tread can immediately be increased for every one of the wheels 2FL to 2RR. Accordingly, under circumstances such as a quick braking mode or a quick acceleration mode where a prescribed slipping state may highly possibly occur at the wheels 2, the gripping performance of the wheels 2 can immediately and surely be enhanced.

Next, in order to further determine the slipping state of the wheels 2FL to 2RR after applying a prescribed camber angle in the negative direction to all of or any of the wheels 2FL to 2RR, in the process in step S7008, the detection result (wheel speed for each of wheels 2FL to 2RR) of the wheel speed sensor device 7081 (the FL wheel speed sensor 7081 FL to the RR wheel speed sensor 7081RR) is read to calculate the slip rate for each of the wheels 2FL to 2RR, as in the process in step S7004 (S7008).

Then, similarly to the process in step S7005, comparing the calculated slip rate for each of the wheels 2FL to 2RR against one another, whether or not there is any wheel 2 in a prescribed slipping state among the wheels 2FL to 2RR is determined (S7009).

As a result, when it is determined that there are no wheels 2 in a prescribed slipping state (S7009: No), it is determined that the wheels 2 are provided with adequate gripping force by the prescribed camber angle applied on the negative direction and that the prescribed slipping state is suppressed (or resolved) at the wheel(s) 2. Accordingly, an instruction to count three seconds is provided to the timer circuit 7071a (S7010), and the slip control process ends.

Since in this manner the linkage driving device 7043 is controlled so that the ground contact ratio of the inner tread 21 is increased for the wheel 2 determined as being in a prescribed slipping state or for all of the wheels 2, and thereafter it can be determined that the prescribed slipping state is suppressed (or resolved) at the wheel(s) 2, it becomes possible to avoid exertion of the ABS control or the traction control by the ABS control device 7082 or the traction control device 7083. Accordingly, the frequency of exerting the ABS control or the traction control can be reduced.

Accordingly, the sense of strangeness or discomfort that the passenger may otherwise feel due to vibrations or noises associated with the ABS control or lack of acceleration associated with the traction control can be suppressed. Therefore, when any wheel 2 slips, the slip can be suppressed while suppressing the sense of strangeness or discomfort associated with the ABS control or the traction control.

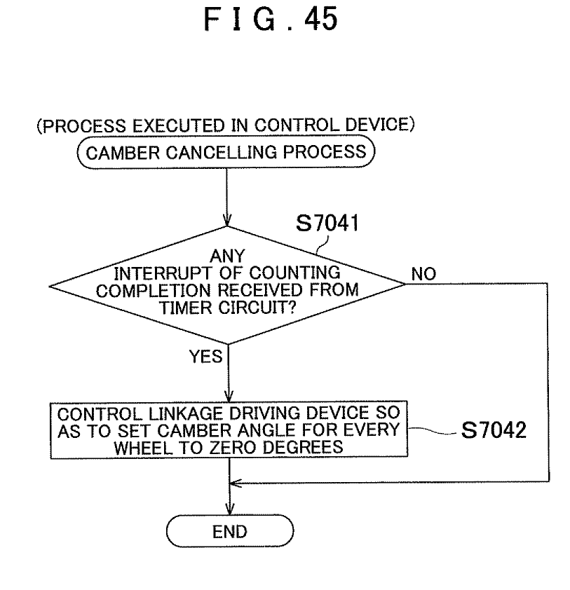

Further, as a result of the process in step S7010, the timer circuit 7071a is instructed to count three seconds. Thus, it becomes possible to adjust the camber angle to 0 degrees for every one of the wheels 2FL to 2RR after the timer circuit 7071a counts three seconds in a camber cancelling process (refer to FIG. 45), which will be described later.

On the other hand, when the process in step S7009 results in a determination that there is any wheel 2 in a prescribed slipping state (S7009: Yes), whether or not the vehicle 7001 is in a braking mode is determined based on the output result (depression amount of the brake pedal 53) of the brake pedal sensor device 53a (S7011). As a result, when it is determined that the vehicle 7001 is in a braking mode (S7011: Yes), an instruction to start the ABS control is provided to the ABS control device 7082 (S7012). Then, the under-ABS-control flag 7073a in the RAM 7073 is set to “1” (S7013), and the slip control process ends.

On the other hand, when it is determined that the vehicle 7001 is not in a braking mode (S7011: No), an instruction to start the traction control is provided to the traction control device 7083 (S7014). Then, under-traction-control flag 7073b in the RAM 7073 is set to “1” (S7015), and the slip control process ends.

Thus, when there is still any wheel 2 in a prescribed slipping state despite the enhanced gripping performance of the wheel(s) 2 achieved by increasing the ground contact ratio of the inner tread 21 in the process in step S7006 or S7007, by executing the ABS control or the traction control that exert control over the braking force or the driving force applied to the wheels 2, the slipping can be suppressed. Accordingly, the safety of the vehicle 7001 can be improved.

Further, as a result of the process in step S7013, the under-ABS-control flag 7073a is set to “1”. Therefore, in the slip cancellation detecting process (refer to FIG. 44) described later, when the prescribed slipping state occurred at the wheel(s) 2 is resolved, an instruction to end the ABS control can be provided to the ABS control device 7082, and an instruction to count three seconds can be provided to the timer circuit 7071a in order for the camber angle of the wheels 2 to be adjusted to 0 degrees after a lapse of three seconds.

Still further, as a result of the process in step S7015, the under-traction-control flag 7073b is set to “1”. Therefore, in the slip cancellation detecting process (refer to FIG. 44) described later, when the prescribed slipping state occurred at the wheel(s) 2 is resolved, an instruction to end the traction control can be provided to the traction control device 7083, and an instruction to count three seconds can be provided to the timer circuit 7071a in order for the camber angle of the wheels 2 to be adjusted to 0 degrees after a lapse of three seconds.

Next, referring to FIG. 44, a description is given of the slip cancellation detecting process. FIG. 44 is a flow chart showing the slip cancellation detecting process. This process is intended such that when the ABS control or the traction control has been started in the slip control process, whether or not the prescribed slipping state occurred at the wheel(s) 2 is resolved is determined, and if it is, the ABS control or the traction control is terminated. The process is repeatedly executed by the CPU 7071 (for example, at 0.2 ms intervals) while the control device 7100 is powered on.

In connection with the slip cancellation detecting process, the CPU 7071 first determines whether or not the contents of the under-ABS-control flag 7073a is “1” (S7021). As a result, when it is determined that the contents of the under-ABS-control flag 7073a is “1” (S7021: Yes), it can be determined that the ABS control is exerted by the ABS control device 7082. Accordingly, in order to determine whether or not prescribed slipping state occurred at the wheel(s) 2 is resolved by the ABS control, subsequently, the detection result (wheel speed for each of wheels 2FL to 2RR) of the wheel speed sensor device 7081 (the FL wheel speed sensor 7081 FL to the RR wheel speed sensor 7081RR) is read. Then, the slip rate for each of the wheels 2FL to 2RR is calculated based on the read wheel speed for each of the wheels 2FL to 2RR (S7022).

Then, comparing the calculated slip rate for each of the wheels 2FL to 2RR against one another, whether or not there is any wheel 2 whose slip rate is abnormally greater than the other wheels, that is, whether or not there is any wheel 2 in a prescribed slipping state among the wheels 2FL to 2RR is determined (S7023).

As a result, when it is determined that there are no wheels 2 in a prescribed slipping state (S7023: No), it can be determined that the prescribed slipping state occurred at the wheel(s) 2 is resolved by the ABS control. Accordingly, an instruction to end the ABS control is provided to the ABS control device 7082 (S7024). Thus, the ABS control by the ABS control device 7082 ends.

Subsequently, the under-ABS-control flag 7073a is set to “0” (S7025). This allows the CPU 7071 to determine that the ABS control is not exerted, and to monitor, in the slip control process (refer to FIGS. 43A and 43B), whether or not the vehicle 7001 is again in a quick acceleration mode or in a quick braking mode, and whether or not there is any wheel 2 at which a prescribed slipping state is occurring.

On the other hand, when the process in step S7023 results in a determination that there is any wheel 2 in a prescribed slipping state (S7023: Yes), the processes in step S7024 and the following steps are skipped, and the slip cancellation detecting process ends. In this manner, the ABS control by the ABS control device 7082 is continuously exerted until the prescribed slipping state occurred in the wheel(s) 2 is resolved. Accordingly, the safety of the vehicle can be ensured.

On the other hand, when the process in step S7021 results in a determination that the contents of the under-ABS-control flag 7073a is not “1”, that is, it is “0” (S7021: No), it can be determined that the ABS control by the ABS control device 7082 is not exerted. Therefore, subsequently, whether or not the contents of the under-traction-control flag 7073b is “1” is determined (S7026).

As a result, when it is determined that the contents of the under-traction-control flag 7073b is not “1”, that is, it is “0” (S7026: No), it can be determined that the traction control by the traction control device 7083 is not exerted either. Therefore, the slip cancellation detecting process ends.

On the other hand, when the process in step S7026 results in a determination that the contents of the under-traction-control flag 7073b is “1” (S7026: Yes), it can be determined that the traction control is exerted by the traction control device 7083. Accordingly, in order to determine whether or not the prescribed slipping state occurred at the wheel(s) 2 is resolved by the traction control, as in the process in step S7022, the detection result (wheel speed for each of wheels 2FL to 2RR) of the wheel speed sensor device 7081 (the FL wheel speed sensor 7081 FL to the RR wheel speed sensor 7081 RR) is read, to calculate the slip rate for each of the wheels 2FL to 2RR (S7027).

Then, as in the process in step S7023, comparing the calculated slip rate for each of the wheels 2FL to 2RR against one another, whether or not there is any wheel 2 in a prescribed slipping state among the wheels 2FL to 2RR is determined (S7028).

As a result, when it is determined that there is any wheel 2 in a prescribed slipping state, (S7028: Yes), the processes in step S7029 and the following steps are skipped, and the slip cancellation detecting process ends. In this manner, the traction control by the traction control device 7083 is continuously exerted until the prescribed slipping state occurred at the wheel(s) 2 is resolved. Accordingly, the safety of the vehicle can be ensured.

On the other hand, when the process in step S7028 results in a determination that there are no wheels 2 in a prescribed slipping state (S7028: No), it can be determined that the prescribed slipping state occurred at the wheel(s) 2 is resolved by the traction control, an instruction to end the traction control is provided to the traction control device 7083 (S7029). This terminates the traction control by the traction control device 7083.

Subsequently, the under-traction-control flag 7073b is set to “0” (S7030). This allows the CPU 7071 to determine that the traction control is not exerted, and to monitor, in the slip control process (refer to FIGS. 43A and 4313), whether or not the vehicle 7001 is again in a quick acceleration mode or in a quick braking mode, and whether or not there is any wheel 2 at which a prescribed slipping state is occurring.

After the processes in steps S7025 and S7030, an instruction to count three seconds is provided to the timer circuit 7071a (S7031), and the slip cancellation detecting process ends. Thus, it becomes possible to adjust the camber angle to 0 degrees for every one of the wheels 2FL to 2RR after the timer circuit 7071a counts three seconds in the camber cancelling process (refer to FIG. 45) described later.

Next, referring to FIG. 45, a description is given of the camber cancelling process. FIG. 45 is a flow chart showing the camber cancelling process. This process is intended to adjust the camber angle to 0 degrees for all of the wheels 2FL to 2RR, when an interrupt reporting the completion of counting three seconds, which has been instructed to the timer circuit 7071a in the slip control process (refer to FIGS. 43A and 43B) and the slip cancellation detecting process (refer to FIG. 44), is detected. The process is repeatedly executed by the CPU 7071 (for example, at 0.2 ms intervals) while the control device 7100 is powered on.

In connection with the camber cancelling process, the CPU 7071 first determines whether or not an interrupt of counting completion is received from the timer circuit 7071a (S7041). As a result, when it is determined that there are no interrupt of counting completion (S7041: No), it can be determined that the counting of three seconds is not completed by the timer circuit 7071a. Accordingly, the following processes are skipped and the camber cancelling process ends.

On the other hand, when the process in step S7041 results in a determination that there is an interrupt of counting completion (S7041: Yes), it can be determined that the counting of three seconds is completed by the timer circuit 7071a. Accordingly, the linkage driving device 7043 (the FL actuator 7043FL to the RR actuator 7043RR) is controlled so that the camber angle is adjusted to 0 degrees for all of the wheels 2FL to 2RR (S7042) and the camber cancelling process ends.

Because in this manner the camber angle is adjusted to 0 degrees for every one of the wheels 2FL to 2RR, as in the foregoing description, it becomes possible to lower the ground contact ratio of the inner tread 21 of the wheels 2, so as to avoid an increase in the rolling resistance of the wheels 2. This suppresses reduction in the fuel efficiency, so that the fuel efficiency performance can be improved. Further, the camber thrust is not generated at the wheels 2 because the camber angle of the wheels 2 is adjusted to 0 degrees and, therefore, a commensurate further improvement in the fuel efficiency performance can be achieved.

Still further, when it is determined that the prescribed slipping state occurred at the wheel(s) 2 is resolved in the slip control process (refer to FIGS. 43A and 43B) or in the slip cancellation detecting process (refer to FIG. 44), three seconds are counted by the timer means 7071a, and after that counting has completed, the camber angle of the wheels 2 is adjusted to 0 degrees. Therefore, the high gripping performance can be retained even after the prescribed slipping state is resolved at least for the three seconds.

In this manner, in the three seconds, the slip rate for each of the wheels 2 can further be reduced by the gripping force generated at the wheels 2. Accordingly, when the camber angle of the wheels 2 is adjusted to 0 degrees so as to reduce the ground contact ratio of the inner tread 21, the gripping performance of the wheels 2 is reduced. Accordingly, another occurrence of a prescribed slipping state at the wheels 2 can be suppressed.

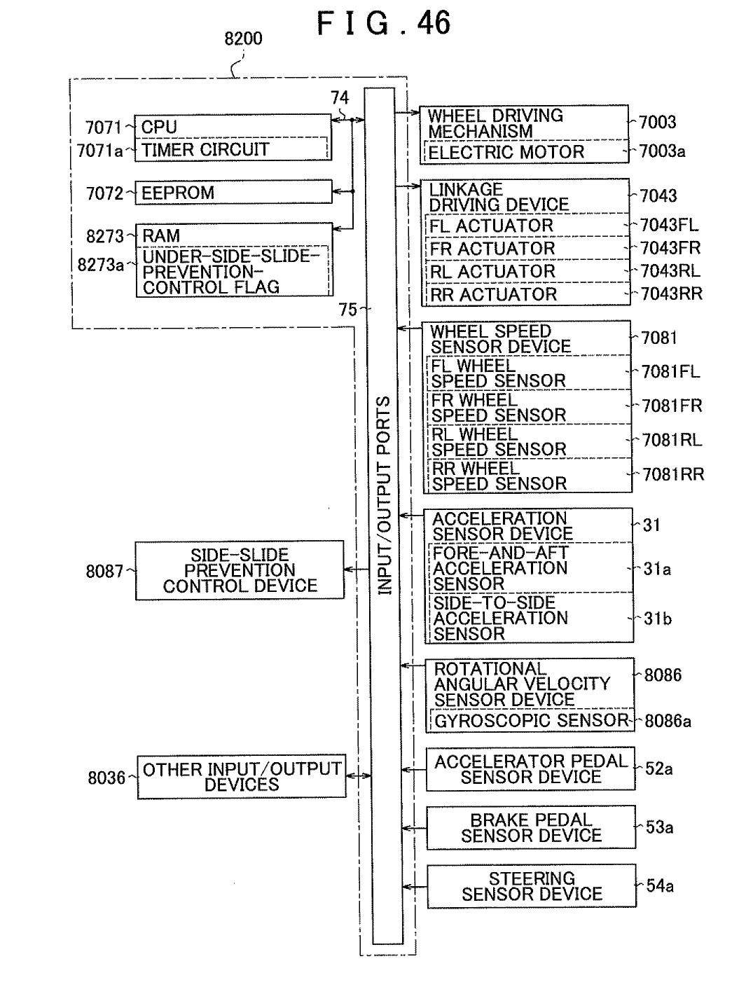

Next, referring to FIGS. 46 to 49, a description is given of an eighth embodiment. In the seventh embodiment, the description has been given of a case where the ABS control device 7082 and the traction control device 7083 for suppressing the slipping of the wheels 2 (refer to FIG. 42) are included, and of the control device 7100 that is capable of, in a case where a prescribed slipping state occurred at the wheels 2, suppressing the slip while avoiding the actuation of the ABS control device 7082 or the traction control device 7083 as much as possible, so as to suppress the sense of strangeness or discomfort caused by the ABS control device 7082 or the traction control device 7083. Whereas in the eighth embodiment, a description is given of a case where a side-slip prevention control device 8087 (refer to FIG. 46) that suppresses a lateral direction (side-to-side direction of the vehicle 7001) slip of the wheels 2 is included, and of a control device 8200 that is capable of in a case where a prescribed slipping state occurred in the lateral direction (side-to-side direction of the vehicle 7001) at the wheels 2, suppressing the slip in the lateral direction (side-to-side direction of the vehicle 7001) while avoiding the actuation of the side-slip prevention control device 8087 as much as possible, so as to suppress the sense of strangeness or discomfort caused by the side-slip prevention control device 8087.

It is to be noted that, in the present embodiment, the same reference numerals are used for the same parts as in the foregoing embodiments, and the description thereof is not repeated. In the present embodiment, the description is given on the precondition that the vehicle 7001 of the seventh embodiment is controlled by the control device 8200.

FIG. 46 is a block diagram showing the electrical structure of the control device 8200 of the eighth embodiment. The control device 8200 of the eighth embodiment is different from the control device 7100 of the seventh embodiment (refer to FIG. 42) in that: RAM 8273 is provided in place of the RAM 7073; and to the input/output ports 75, the acceleration sensor device 31, a rotational angular velocity sensor device 8086, and the side-slip prevention control device 8087 are connected in place of the ABS control device 7082 and the traction control device 7083.

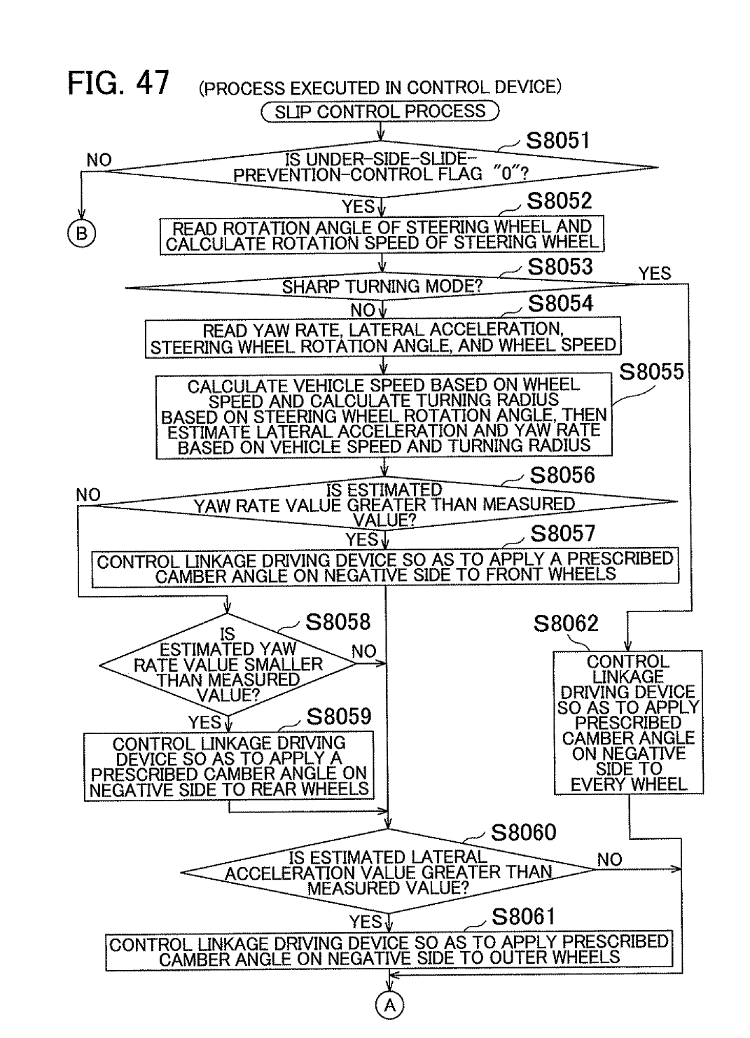

In the EEPROM 7072, the programs shown in the flow charts of FIGS. 47 to 49 are stored in place of the programs shown in the flow charts of FIGS. 43 and 44.

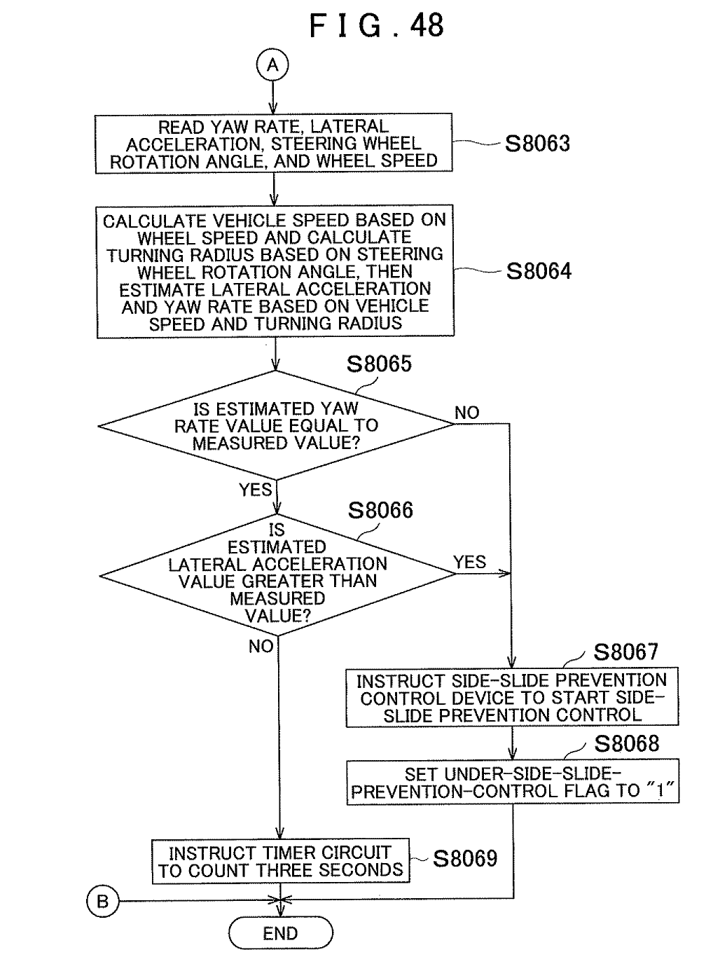

It is to be noted that the program shown in the flow chart of FIG. 45 (camber cancelling process) is stored in the EEPROM 7072 in the control device 8200 of the present embodiment also, is repeatedly executed by the CPU 7071 (for example, at 0.2 ms intervals) while the control device 8200 is powered on. By the camber cancelling process, when an interrupt reporting completion of the three-second count instructed to the timer circuit 7071a is detected in a slip control process (refer to FIGS. 47 and 48) and a slip cancellation detecting process (refer to FIG. 48) of the eighth embodiment described later, the camber angle is adjusted to 0 degrees for all of the wheels 2FL to 2RR.

The RAM 8273 is memory for rewritably storing various data when the control programs are executed. In the RAM 8273, an under-side-slip-prevention-control flag 8273a is stored.

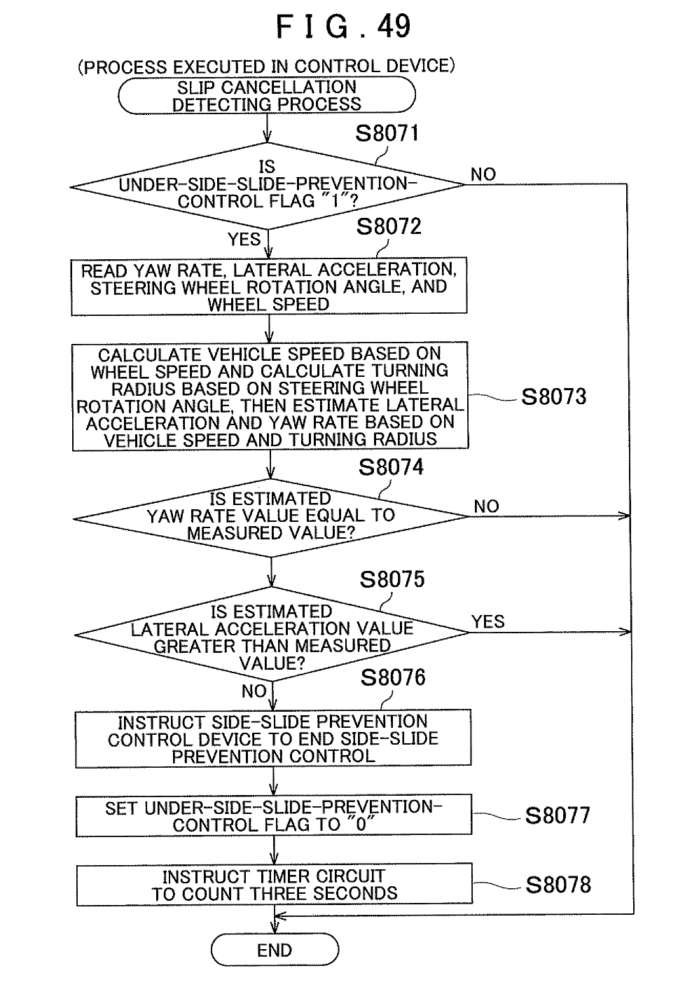

The under-side-slip-prevention-control flag 8273a is a flag indicating whether or not side-slip prevention control is exerted by the side-slip prevention control device 8087. The under-side-slip-prevention-control flag 8273a is set to “1” indicating that the side-slip prevention control is exerted when an instruction to start the side-slip prevention control is provided to the side-slip prevention control device 8087 in the slip control process (refer to FIGS. 47 and 48) described later. Further, the under-side-slip-prevention-control flag 8273a is set to “0” indicating that the side-slip prevention control is not exerted when an instruction to end the side-slip prevention control is provided to the side-slip prevention control device 8087 in the slip cancellation detecting process (refer to FIG. 49) described later.

The CPU 7071 can determine whether or not the side-slip prevention control is exerted by the side-slip prevention control device 8087, based on the contents of the under-side-slip-prevention-control flag 8273a. Further, during execution of the slip control process (refer to FIG. 47 or 48) described later, when it is determined that the side-slip prevention control by the side-slip prevention control device 8087 is not exerted based on the contents of the under-side-slip-prevention-control flag 8273a, if the vehicle 7001 is in a sharp turning mode or if a prescribed slipping state in the lateral direction (side-to-side direction of the vehicle 7001) is occurring at any wheel 2, the CPU 7071 controls the linkage driving device 7043 so that a prescribed camber angle is applied in the negative direction to the wheel 2 to allow it to exert the high gripping performance.

Further, when it is estimated that the prescribed slipping state in the lateral direction (side-to-side direction of the vehicle 7001) is still occurring at any wheel 2 even after the linkage driving device 7043 is controlled so that the prescribed camber angle is applied in the negative direction to the wheel 2, the CPU 7071 can provide an instruction to start the side-slip prevention control to the side-slip prevention control device 8087.

On the other hand, during execution of the slip cancellation detecting process (refer to FIG. 49) described later, when it is determined that the side-slip prevention control by the side-slip prevention control device 8087 is exerted, and if the prescribed slipping state in the lateral direction (side-to-side direction of the vehicle 7001) occurred at the wheel 2 is resolved, then the CPU 7071 can provide an instruction to end the side-slip prevention control to the side-slip prevention control device 8087 and provide an instruction to count three seconds to the timer circuit 7071a in order to adjust the camber angle of the wheels 2 to be 0 degrees after a lapse of a prescribed time (in the present embodiment, after a lapse of three seconds).

It is to be noted that, when the ignition switch (not shown) is turned on (that is, when the control device 7100 is powered on), the vehicle 7001 does not exert the side-slip prevention control. Therefore, the under-side-slip-prevention-control flag 8273a is set to “0” as the initial value.

The acceleration sensor device 31 is a device for detecting the acceleration of the vehicle 7001 and providing the detection result to the CPU 7071. The acceleration sensor device 31 includes the fore-and-aft acceleration sensor 31a, the side-to-side acceleration sensor 31b and processing circuitry (not shown) that processes the detection result of the acceleration sensors 31a and 31b and provides the processed result to the CPU 7071.

The fore-and-aft acceleration sensor 31a is a sensor detecting the acceleration in the fore-and-aft direction (top-bottom direction in FIG. 37) of the body frame BF (refer to FIG. 37), whereas the side-to-side acceleration sensor 31b is a sensor detecting the side-to-side acceleration (side-to-side direction in FIG. 37) (lateral acceleration) of the body frame BF. It is to be noted that, in the present embodiment, the acceleration sensors 31a and 31b are each structured as a piezoelectric sensor using a piezoelectric element. The acceleration in the fore-and-aft direction of the body frame BF detected by the fore-and-aft acceleration sensor 31a is detected as a positive value when the vehicle 7001 is in an acceleration mode, and detected as a negative value negative value when the vehicle 7001 is in a deceleration mode.

During execution of the slip control process (refer to FIGS. 47 and 48) and the slip cancellation detecting process (FIG. 49) described later, the CPU 7071 compares the detection result (measured lateral acceleration value) of the side-to-side acceleration sensor 31b against an estimated lateral acceleration value separately calculated. When the estimated lateral acceleration value is greater than the measured value, it can be determined that the wheels 2 positioned on the outer side in connection with the turning direction of the vehicle 7001 (outer wheels) slip sideways to laterally slide, i.e., they are in a laterally sliding condition.

It is to be noted that the CPU 7071 can obtain an estimated lateral acceleration value A as follows. First, an estimated vehicle body speed (vehicle speed) V of the vehicle 7001 is calculated based on the detection result (wheel speed for each of wheels 2FL to 2RR) of the wheel speed sensor device 7081 (the FL wheel speed sensor 7081 FL to the RR wheel speed sensor 7081 RR). Further, steer angle of the wheels 2 is calculated based on the detection result (rotation angle of the steering 54) of the steering sensor device 54a, and based on the steer angle of the wheels 2, the turning radius R of the vehicle 7001 is calculated. Then, using the estimated vehicle body speed (vehicle speed) V of the vehicle 7001 and the turning radius R, the estimated lateral acceleration value A can be calculated by the following equation (1).

A=V̂2/R (1)

The rotational angular velocity sensor device 8086 is a device for detecting the rotational angular velocities of the vehicle 7001 and providing the detection result to the CPU 7071. The rotational angular velocity sensor device 8086 includes a gyroscopic sensor 8086a that detects rotational angular velocities (pitch rate, roll rate, yaw rate) of the body frame BF rotating about three axes as central axes, namely an axis that passes through the center of the vehicle 7001 and extends in the fore-and-aft direction of the vehicle 7001, an axis extending side-to-side, and an axis extending in the height direction, in association with their rotation direction, and processing circuitry (not shown) that processes the detection result of the gyroscopic sensor and provides the processed result to the CPU 7071.

In the present embodiment, the gyroscopic sensor 8086a is structured with a fiber optic gyroscope that operates exploiting the theory of the Sagnac effect. It is to be noted that other types of gyroscopic sensor can naturally be used. An example of other types of gyroscopic sensor is a mechanical gyroscope, piezoelectric gyroscope or the like.

During execution of the slip control process (refer to FIGS. 47 and 48) and the slip cancellation detecting process (FIG. 49) described later, the CPU 7071 compares a measured yaw rate value read from the detection result (rotational angular velocities) of the gyroscopic sensor 8086a against an estimated yaw rate value separately calculated. When the estimated yaw rate value is greater than the measured value, it can be determined as being in an understeer condition in which the wheels 2 positioned on the front side in the forward direction (the side pointed by the arrow FWD in FIG. 37) of the vehicle 7001 (the right and left front wheels 2FR and 2FL) slip out resulting in a circular path of a great radius.

When the estimated yaw rate value is smaller than the measured value, it can be determined as being in an oversteer condition in which the wheels 2 positioned on the rear side in the forward direction (the side opposite to the arrow FWD in FIG. 37) of the vehicle 7001 (right and left rear wheels 2RR and 2RL) slip out resulting in a circular path of a small radius.

The CPU 7071 can calculate an estimated yaw rate value w, using the estimated vehicle body speed (vehicle speed) V of the vehicle 7001 calculated from the detection result (wheel speed for each of wheels 2FL to 2RR) of the wheel speed sensor device 7081 (the FL wheel speed sensor 7081 FL to the RR wheel speed sensor 7081 RR), and the turning radius R calculated based on the detection result (rotation angle of the steering 54) of the steering sensor device 54a, by the following equation (2).

ω=V/R (2)

The side-slip prevention control device 8087 is a known device that controls (side-slip prevention controls), in a turning mode, the driving force and the braking force applied to the wheels 2 in order for the wheels 2 not to slip in the lateral direction (side-to-side direction of the vehicle 7001), which may otherwise cause the vehicle 7001 to enter the understeer condition, the oversteer condition, or the laterally sliding condition.

It is so defined in the present embodiment that, as in the foregoing description, when it is determined in the slip control process (refer to FIGS. 47 and 48) described later, the vehicle 7001 is determined as being in a sharp turning mode, or it is determined that a prescribed slipping state in the lateral direction (side-to side direction of the vehicle 7001) is occurring at any wheel 2, the linkage driving device 7043 is controlled so that a prescribed camber angle is applied in the negative direction to the wheel 2. Then, when it is estimated after such control that a prescribed slipping state in the lateral direction (side-to-side direction of the vehicle 7001) is still occurring at any wheel 2, the side-slip prevention control by the side-slip prevention control device 8087 starts.

Next, referring to FIGS. 47 and 48, a description is given of the slip control process according to the eighth embodiment. FIGS. 47 and 48 are flow charts showing the slip control process. This process is intended for suppressing slipping of the wheels 2 when it is determined that the vehicle 7001 is in a sharp turning mode, or when it is determined that a prescribed slipping state in the lateral direction (side-to-side direction of the vehicle 7001) is occurring at any wheel 2. The process is repeatedly executed by the CPU 7071 (for example, at 0.2 ms intervals) while the control device 8200 is powered on.

It is to be noted that the FIG. 47 shows processes in steps S8051 to S8062 of the slip control process and FIG. 48 shows processes in steps S8063 to S8069 in the slip control process.

Now, referring to FIG. 47, in connection with the slip control process, the CPU 7071 first determines whether or not the contents of the under-side-slip-prevention-control flag 8273a stored in the RAM 8273 is “0” (S8051). As a result, when it is determined that the contents of the under-side-slip-prevention-control flag 8273a is not “0”, that is, it is “1” (S8051: No), it can be determined that the control for preventing slipping in the lateral direction (side-to-side direction of the vehicle 7001) (the side-slip prevention control) has already been exerted, and therefore, the slip control process ends (refer to FIG. 48).

On the other hand, when the process in step S8051 results in a determination that the contents of the under-side-slip-prevention-control flag 8273a is “0” (S8051: Yes), it can be determined that the side-slip prevention control is not exerted. Therefore, subsequently, the detection result (the rotation angle of the steering 54) of the steering sensor device 54a is read. By time-differentiating the read rotation angle of the steering 54, the rotation speed of the steering 54 is calculated (S8052).

Then, whether or not the vehicle 7001 is in a sharp turning mode is determined based on the calculated rotation speed of the steering 54 (S8053). As a result, when it is determined that the vehicle 7001 is not in a sharp turning mode (S8053: No), subsequently, in order to determine the slipping state in the lateral direction (side-to-side direction of the vehicle 7001) of the wheels 2FL to 2RR, the detection result (measured yaw rate value) of the rotational angular velocity sensor device 8086 (the gyroscopic sensor 8086a), the detection result (measured lateral acceleration value) of the acceleration sensor device 31 (side-to-side acceleration sensor 31b), the detection result (rotation angle of the steering 54) of the steering sensor device 54a, and the detection result (wheel speed for each of wheels 2FL to 2RR) of the wheel speed sensor device 7081 (the FL wheel speed sensor 7081FL to the RR wheel speed sensor 7081RR) are read (S8054).

Then, based on the read wheel speed for each of the wheels 2FL to 2RR, the estimated vehicle body speed (vehicle speed) V of the vehicle 7001 is calculated, and based on the rotation angle of the steering 54, the turning radius R of the vehicle 7001 is calculated. Then, by the equations (1) and (2), the lateral acceleration (A) and the yaw rate (ω) are estimated (S8055).

Then, whether or not the estimated yaw rate value obtained in the process in step S8055 is greater than the measured yaw rate value read in the process in step S8054 is determined (S8056). It is to be noted that, in the present embodiment, considering the detection error of the sensor devices and the calculation error of the CPU 7071, when the difference between the estimated yaw rate value and the measured value falls within 5%, it is assumed that the estimated value and the measured value are equal to each other, and so the No branch is taken in the process in step S8056. Similarly, in the processes in steps S8058 and S8065, and in the process in step S8074 in the slip cancellation detecting process shown in FIG. 49, each described later, when the difference between the estimated yaw rate value and the measured value falls within 5%, it is assumed that the estimated value and the measured value are equal to each other.

When the process in step S8056 results in a determination that the estimated yaw rate value is greater than the measured value (S8056: Yes), it is determined that a prescribed slipping state (slipping in the lateral direction (side-to-side direction of the vehicle 7001)) is occurring at the right and left front wheels 2FR and 2FL, and the vehicle 7001 is in an understeer condition. Accordingly, the linkage driving device 7043 (the FL actuator 7043FL and the FR actuator 7043FR) is controlled so that a prescribed camber angle is applied in the negative direction to the right and left front wheels 2FR and 2FL (S8057). Then, the control proceeds to the process in step S8060.

In this manner, the ground contact ratio of the inner tread 21 can be increased for the right and left front wheels 2FR and 2FL causing the understeer so as to increase the effect of the soft property of the inner tread 21, thereby allowing the front wheels 2FL and 2RR to exert the high gripping performance attained by the characteristic of the inner tread 21. Accordingly, the lateral direction (side-to-side direction of the vehicle 7001) slip occurred at the front wheels 2FL and 2FR can be suppressed because the gripping force of the front wheels 2FL and 2FR can be enhanced. Accordingly, the understeer can be suppressed.

On the other hand, when the process in step S8056 results in a determination that the estimated yaw rate value is not greater than the measured value (S8056: No), subsequently, whether or not the estimated yaw rate value obtained in the process in step S8055 is smaller than the measured yaw rate value read in the process in step S8054 is determined (S8058). As a result, when it is determined that the estimated yaw rate value is smaller than the measured value (S8058: Yes), it is determined that a prescribed slipping state (slipping in the lateral direction (side-to-side direction of the vehicle 7001)) is occurring at the right and left rear wheels 2RR and 2RL and that the vehicle 7001 is in an oversteer condition. Accordingly, the linkage driving device 7043 (the RL actuator 7043RL and the RR actuator 7043RR) is controlled so that a prescribed camber angle is applied in the negative direction to the right and left rear wheels 2RR and 2RL (S8059). Then, the control proceeds to the process in step S8060.

In this manner, the ground contact ratio of the inner tread 21 can be increased for the right and left rear wheels 2RR and 2RL causing the oversteer so as to increase the effect of the soft property of the inner tread 21, thereby allowing the rear wheels 2RL and 2RR to exert the high gripping performance attained by the characteristic of the inner tread 21. Accordingly, the lateral direction (side-to-side direction of the vehicle 7001) slip occurred at the rear wheels 2RL and 2RR can be suppressed because the gripping force of the rear wheels 2RL and 2RR can be enhanced. Accordingly, the oversteer can be suppressed.

On the other hand, when the process in step S8058 results in a determination that the estimated yaw rate value is not smaller than the measured value (S8058: No), it can be determined that the vehicle 7001 is neither in an understeer condition nor in an oversteer condition. Accordingly, without adjusting the camber angle of the wheels 2FL to 2RR, the control proceeds to the process in step S8060.

Next, in the process in step S8060, whether or not the estimated lateral acceleration value obtained in the process in step S8055 is greater than the measured lateral acceleration value read in the process in step S7054 is determined (S8060). It is to be noted that, in the present embodiment, considering the detection error of the sensor devices and the calculation error of the CPU 7071, when the difference between the estimated lateral acceleration value and the measured value falls within 5%, it is assumed that the estimated value and the measured value are equal to each other, and so the No branch is taken in the process in step S8060. Similarly, in the process in step S8066 and in the process in step S8075 in the slip cancellation detecting process shown in FIG. 49 each described later, when the difference between the estimated lateral acceleration value and the measured value falls within 5%, it is assumed that the estimated value and the measured value are equal to each other.

When the process in step S8060 results in a determination that the estimated lateral acceleration value is greater than the measured value (S8060: Yes), it is determined that a prescribed slipping state (slipping in the lateral direction (side-to-side direction of the vehicle 7001)) is occurring at the wheels 2 positioned on the outer side in connection with the turning direction of the vehicle 7001 (outer wheels), and that the vehicle 7001 is in a laterally sliding condition. Accordingly, the linkage driving device 7043 (the FL actuator 7043FL to the RR actuator 7043RR) is controlled so that a prescribed camber angle is applied in the negative direction to the wheels 2 (outer wheels) (S8061). Then, the control proceeds to the process shown in FIG. 39.

In this manner, the ground contact ratio of the inner tread 21 can be increased for the wheels 2 (outer wheels) causing the side-sliding, so as to increase the effect of the soft property of the inner tread 21, thereby allowing the wheels 2 (outer wheels) to exert the high gripping performance attained by the characteristic of the inner tread 21. Accordingly, the lateral direction (side-to-side direction of the vehicle 7001) slip occurred at the wheels 2 (outer wheels) can be suppressed because the gripping force of the wheels 2 (outer wheels) can be enhanced. Accordingly, the side-sliding can be suppressed.

On the other hand, when the process in step S8060 results in a determination that the estimated lateral acceleration value is not greater than the measured value (S8060: No), it can be determined that the vehicle 7001 is not in a laterally sliding condition. Accordingly, without adjusting the camber angle of the wheels 2FL to 2RR, the control proceeds to the process in step S8063 shown in FIG. 39.

On the other hand, when the process in step S8053 results in a determination that the vehicle 7001 is in a sharp turning mode (S8053: Yes), the linkage driving device 7043 (the FL actuator 7043FL to the RR actuator 7043RR) is controlled so that a prescribed camber angle applied in the negative direction to every one of the wheels 2FL to 2RR (S8062). Then, the control proceeds to the process in step S8063 shown in FIG. 39.

In this manner, when it is determined that the vehicle 7001 is in a sharp turning mode, irrespective of whether or not there is any wheel 2 in a prescribed slipping state in the lateral direction (side-to-side direction of the vehicle 7001), the ground contact ratio of the second tread can immediately be increased for every one of the wheels 2FL to 2RR. Accordingly, under circumstances such as a sharp turning mode where a prescribed slipping state may highly possibly occur in the lateral direction (side-to-side direction of the vehicle 7001) at the wheels 2, the gripping performance of the wheels 2 can immediately and surely be enhanced.

Next, referring to FIG. 48, in order to further determine the lateral direction (side-to-side direction of the vehicle 7001) slipping state of the wheels 2FL to 2RR after applying a prescribed camber angle in the negative direction to all of or any of the wheels 2FL to 2RR, in the process in step S8063, similarly to the process in step S8054 (refer to FIG. 47), the measured yaw rate value, the measured lateral acceleration value, the rotation angle of the steering 54, and the wheel speed for each of the wheels 2FL to 2RR are read from respective sensor devices (S8063).

Then, similarly to the process in step S8055 (refer to FIG. 47), an estimated vehicle body speed (vehicle speed) V of the vehicle 7001 and the turning radius R of the vehicle 7001 are calculated. Then, by the equations (1) and (2), the lateral acceleration (A) and the yaw rate (w) are estimated (S8064).

Then, whether or not the estimated yaw rate value obtained in the process in step S8064 is equal to the measured yaw rate value read in the process in step S8063 (the difference between the estimated value and the measured value falls within 5%) is determined (S8065). As a result, when it is determined that the estimated yaw rate value is equal to the measured value (S8065: Yes), subsequently, whether or not the estimated lateral acceleration value obtained in the process in step S8064 is greater than the measured lateral acceleration value read in the process in step S8063 is determined (S8066).

As a result, when it is determined that the estimated lateral acceleration value is not greater than the measured value (S8066: No), it can be determined that the adequate gripping force of the wheels 2 obtained by the prescribed camber angle applied in the negative direction has suppressed (or resolved) the prescribed slipping state in the lateral direction (side-to-side direction of the vehicle 7001) at the wheels 2FL to 2RR, and so the understeer, the oversteer, and the side-sliding are suppressed. Accordingly, an instruction to count three seconds is subsequently provided to the timer circuit 7071a (S8069), and the slip control process ends.

Because in this manner the linkage driving device 7043 is controlled so that the ground contact ratio of the inner tread 21 is increased for the wheel 2 determined as being in a prescribed slipping state in the lateral direction (side-to-side direction of the vehicle 7001), or for all of the wheels 2, and thereafter it can be determined that the prescribed slipping state is suppressed (or resolved) at the wheel(s) 2, it becomes possible to avoid exertion of the side-slip prevention control by the side-slip prevention control device 8087. As a result, the frequency of exerting the side-slip prevention control can be reduced.

Accordingly, the sense of strangeness or discomfort that the passenger may otherwise feel due to vibrations, noises, or lack of acceleration associated with the side-slip prevention control can be suppressed. Therefore, when a lateral direction (side-to-side direction of the vehicle 7001) slip occurs at any wheel 2, the understeer, the oversteer, and the side-sliding in the vehicle 7001 can be suppressed, while the slip in the lateral direction (side-to-side direction of the vehicle 7001) is suppressed while the sense of strangeness or discomfort associated with the side-slip prevention control is suppressed.

Further, as a result of the process in step S8069, the timer circuit 7071a is instructed to count three seconds. Accordingly, in the camber cancelling process shown in FIG. 45, after the timer circuit 7071a counts three seconds, the camber angle can be adjusted to 0 degrees for all of the wheels 2FL to 2RR.

On the other hand, when the process in step S8065 results in a determination that the estimated yaw rate value is not equal to the measured value (S8065: No), and when the process in step S8066 results in a determination that the estimated lateral acceleration value is greater than the measured value (S8066: Yes), it can be determined that, despite the performed adjustment of the linkage driving device 7043 (the FL actuator 7043FL to the RR actuator 7043RR) for applying the prescribed camber angle in the negative direction to any or all of the wheels 2, a prescribed slipping state in the lateral direction (side-to-side direction of the vehicle 7001) is occurring at any wheel 2 and the vehicle 7001 is in an understeer condition, an oversteer condition, or a laterally sliding condition. Accordingly, an instruction to start the side-slip prevention control is provided to the side-slip prevention control device 8087 (S8067).

In this manner, despite the enhanced gripping performance of the wheels 2 achieved by an increase in the ground contact ratio of the inner tread 21, when there is any wheel 2 in a prescribed slipping state in the lateral direction (side-to-side direction of the vehicle 7001), the slipping state can be suppressed by exerting side-slip prevention control that controls the braking force or the driving force applied to the wheels 2. Thus, the safety of the vehicle 7001 can be improved.

After the process in step S8067, the under-side-slip-prevention-control flag 8273a in the RAM 8273 is set to “1” (S8068), and the slip control process ends. Therefore, in the slip cancellation detecting process (refer to FIG. 49) described later, when the prescribed slipping state in the lateral direction (side-to-side direction of the vehicle 7001) occurred at the wheel(s) 2 is resolved, an instruction to end the side-slip prevention control can be provided to the side-slip prevention control device 8087, and an instruction to count three seconds can be provided to the timer circuit 7071a in order for the camber angle of the wheels 2 to be adjusted to 0 degrees after a lapse of three seconds.

Next, referring to FIG. 49, a description is given of the slip cancellation detecting process according to the eighth embodiment. FIG. 49 is a flow chart showing the slip cancellation detecting process. This process is intended for, when the side-slip prevention control has been started in the slip control process, determining whether or not the prescribed slipping state in the lateral direction (side-to-side direction of the vehicle 7001) occurred at the wheel(s) 2 is resolved, and if it is, ending the side-slip prevention control. The process is repeatedly executed by the CPU 7071 (for example, at 0.2 ms intervals) while the control device 8200 is powered on.

In connection with the slip cancellation detecting process, the CPU 7071 first determines whether or not the contents of the under-side-slip-prevention-control flag 8273a is “1” (S8071). As a result, when it is determined that the contents of the under-side-slip-prevention-control flag 8273a is not “1”, that is, it is “0” (S8071: No), it can be determined that the side-slip prevention control by the side-slip prevention control device 8087 is not exerted, and it can accordingly be estimated that a prescribed slipping state in the lateral direction (side-to-side direction of the vehicle 7001) is not occurring at any wheel 2. Therefore, the slip cancellation detecting process ends.

On the other hand, when the process in step S8071 results in a determination that the contents of the under-side-slip-prevention-control flag 8273a is “1” (S8071: Yes), it can be determined that the side-slip prevention control by the side-slip prevention control device 8087 is exerted. Then, for the purpose of determining whether or not the prescribed slipping state in the lateral direction (side-to-side direction of the vehicle 7001) occurred at the wheel(s) 2 is resolved by the side-slip prevention control, subsequently, in order to determine the lateral direction (side-to-side direction of the vehicle 7001) slip condition at the wheels 2FL to 2RR, the detection result (measured yaw rate value) of the rotational angular velocity sensor device 8086 (the gyroscopic sensor 8086a), the detection result (measured lateral acceleration value) of the acceleration sensor device 31 (the side-to-side acceleration sensor 31b), the detection result (rotation angle of the steering 54) of the steering sensor device 54a, and the detection result (wheel speed for each of wheels 2FL to 2RR) of the wheel speed sensor device 7081 (the FL wheel speed sensor 7081FL to the RR wheel speed sensor 7081RR) are read (S8072).

Then, based on the read wheel speed for each of the wheels 2FL to 2RR, the estimated vehicle body speed (vehicle speed) V of the vehicle 7001 is calculated, and based on the rotation angle of the steering 54, the turning radius R of the vehicle 7001 is calculated. Then, by the equations (1) and (2), the lateral acceleration (A) and the yaw rate (ω) are estimated (S8073).

Then, whether or not the estimated yaw rate value obtained in the process in step S8073 is equal to the measured yaw rate value read in the process in step S8072 (the difference between the estimated value and the measured value falls within 5%) is determined (S8074). As a result, when it is determined that the estimated yaw rate value is equal to the measured value (S8074: Yes), subsequently, whether or not the estimated lateral acceleration value obtained in the process in step S8073 is greater than the measured lateral acceleration value read in the process in step S8072 is determined (S8075).

As a result, when it is determined that the estimated lateral acceleration value is not greater than the measured value (S8075: No), it can be determined that the side-slip prevention control has resolved the prescribed slipping state in the lateral direction (side-to-side direction of the vehicle 7001) at the wheels 2FL to 2RR, and so the understeer, the oversteer, and side-sliding in the vehicle 7001 has been suppressed. Accordingly, an instruction to end the side-slip prevention control is provided to the side-slip prevention control device 8087 (S8076). Thus, the side-slip prevention control by the side-slip prevention control device 8087 ends.

Then, the under-side-slip-prevention-control flag 8273a is set to “0” (S8077). This allows the CPU 7071 to determine that the side-slip prevention control is not exerted, and to monitor, in the slip control process (refer to FIGS. 47 and 48), whether or not the vehicle 7001 is again in a sharp turning mode, and whether or not there is any wheel 2 at which a prescribed slipping state in the lateral direction (side-to-side direction of the vehicle 7001) is occurring.

Then, an instruction to count three seconds is provided to the timer circuit 7071a (S8078), and the slip cancellation detecting process ends. Thus, it becomes possible to adjust the camber angle to 0 degrees for every one of the wheels 2FL to 2RR after the timer circuit 7071a counts three seconds in the camber cancelling process shown in FIG. 45.

On the other hand, when the process in step S8074 results in a determination that the estimated yaw rate value is not equal to the measured value (S8074: No), and when the process in step S8075 results in a determination that the estimated lateral acceleration value is greater than the measured value (S8075: Yes), it can be determined that a prescribed slipping state in the lateral direction (side-to-side direction of the vehicle 7001) is occurring at any wheel 2, and that the vehicle 7001 is still in the understeer condition, the oversteer condition, or the laterally sliding condition. Accordingly, the following processes are skipped and the slip cancellation detecting process ends.

In this manner, the side-slip prevention control by the side-slip prevention control device 8087 is continuously exerted until the prescribed slipping state in the lateral direction (side-to-side direction of the vehicle 7001) occurred at the wheel(s) 2 is resolved. Accordingly, the safety of the vehicle can be ensured.

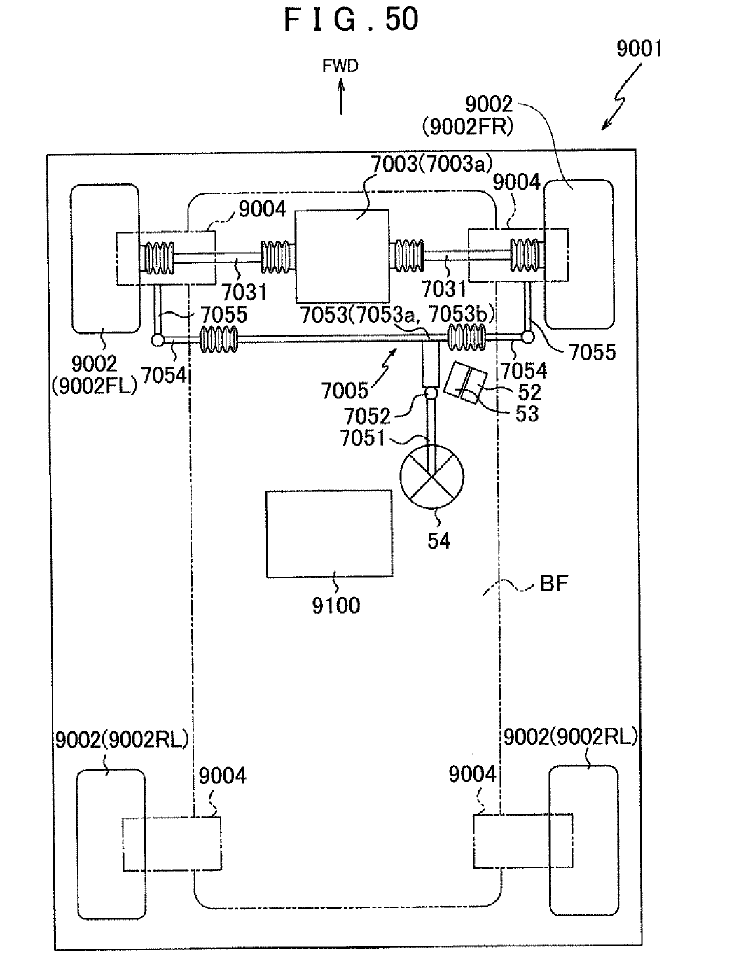

Next, referring to FIGS. 50 to 58, a description is given of a ninth embodiment. The same reference numerals are used for the same parts as in the foregoing embodiments, and the description thereof is not repeated. FIG. 50 is a schematic diagram schematically showing a top view of a vehicle 9001 in which a control device 9100 according to the ninth embodiment is installed. In FIG. 50, an arrow FWD represents the forward direction of the vehicle 9001.

First, a description is given of the schematic structure of the vehicle 9001. As shown in FIG. 50, the vehicle 9001 principally includes the body frame BF, a plurality of (four in the present embodiment) wheels 9002 supported by the body frame BF, the wheel driving mechanism 7003 that rotates part of the wheels 9002 (in the present embodiment, right and left front wheels 9002FR and 9002FL), suspension devices 9004 that suspend the wheels 9002 on the body frame BF and adjust the camber angle of the respective wheels 9002 independently of one another, and a steering device 7005 that steers part of the wheels 9002 (in the present embodiment, the right and left front wheels 2FR and 9002FL) according to the operation of the steering 54. The vehicle 9001 is structured to be capable of improving the acceleration/deceleration performance and the braking performance, by adjusting the camber angle of the wheels 9002 so as to suppress variations in the attitude of the body frame BF in an acceleration/deceleration mode or a braking mode.

Next, a description is given of the detailed structure of the constituents. The body frame BF is a structure forming the framework of the vehicle 9001 for mounting the various devices (such as the wheel driving mechanism 7003) thereon, and supported by the suspension devices 9004.

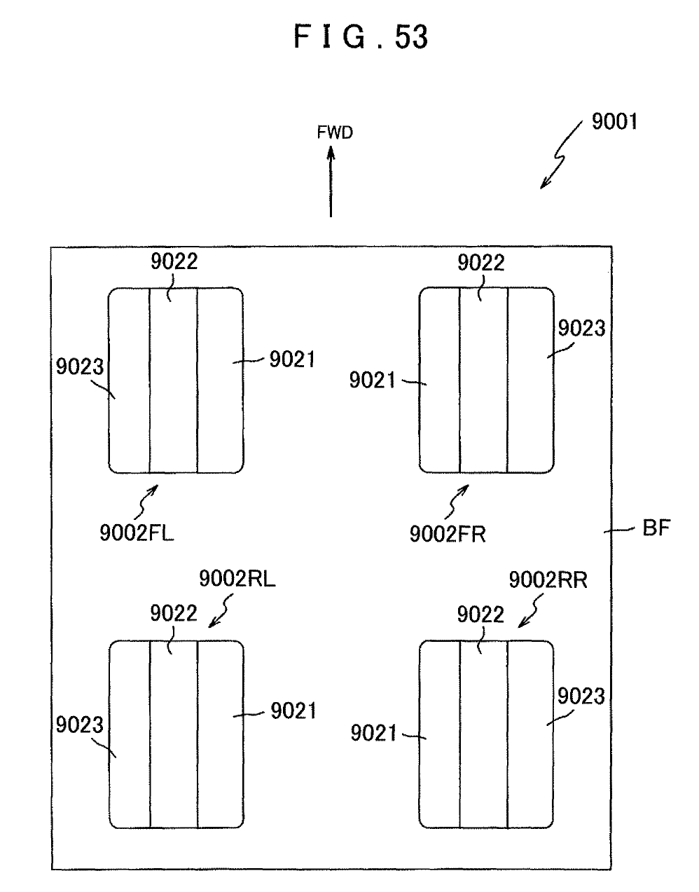

As shown in FIG. 50, the wheels 9002 are constituted by four wheels, namely the right and left front wheels 2FR and 9002FL arranged on the front side (the side pointed by the arrow FWD) of the body frame BF and right and left rear wheels 9002RR and 9002RL arranged on the rear side (the side opposite to the arrow FWD) of the body frame BF. The right and left front wheels 2FR and 9002FL are structured as the driving wheels that are rotated by the rotational driving force provided by the wheel driving mechanism 7003, whereas the right and left rear wheels 9002RR and 9002RL are structured as the trailing wheels that trail in accordance with the traveling of the vehicle 9001. It is to be noted that the detailed structure of the wheels 9002 will be described later referring to FIG. 53.

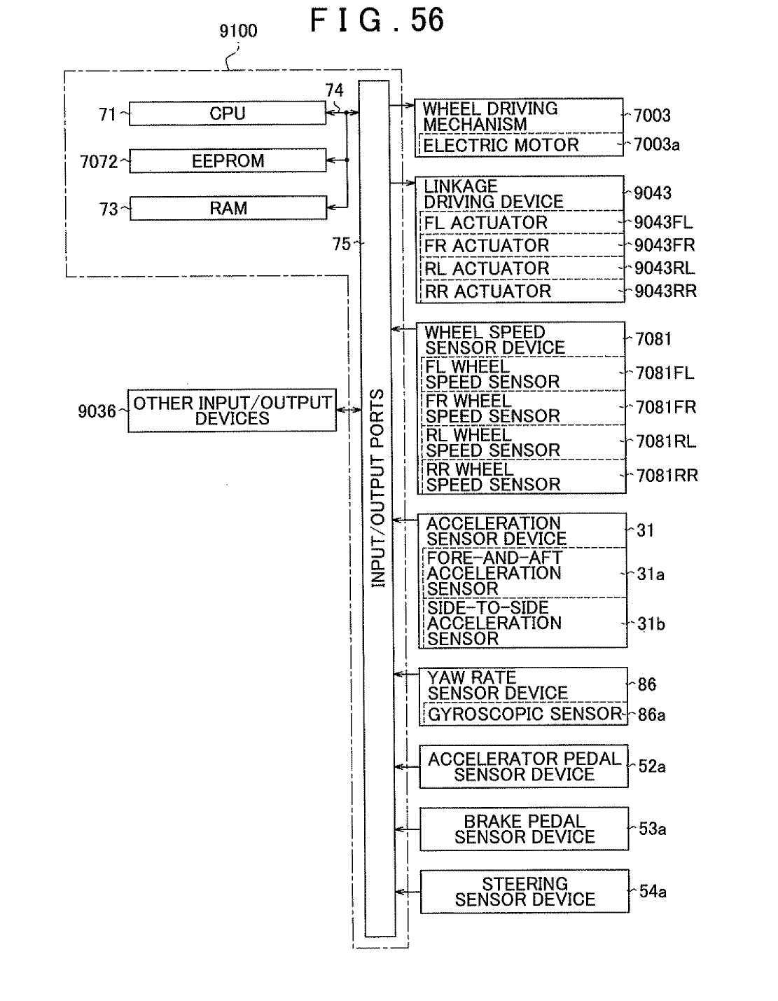

As in the foregoing description, the wheel driving mechanism 7003 is a device for providing rotational driving force to the right and left front wheels 2FR and 9002FL so as to rotate them, and structured with an electric motor 7003a (refer to FIG. 56) as will be described later. As shown in FIG. 50, the electric motor 7003a is connected to the right and left front wheels 2FR and 9002FL via a differential gear (not shown) and a pair of drive shafts 7031.

When the driver operates the accelerator pedal 52, rotational driving force is provided from the wheel driving mechanism 7003 to the right and left front wheels 2FR and 9002FL so that the right and left front wheels 2FR and 9002FL are rotated at the rotation speed corresponding to the depressing state of the accelerator pedal 52. It is to be noted that the difference in rotation between the right and left front wheels 2FR and 9002FL is absorbed by the differential gear.

The suspension devices 9004 are the devices that function as so-called suspensions, and are arranged corresponding to respective wheels 9002 as shown in FIG. 50. Further, as in the foregoing description, the suspension devices 9004 of the present embodiment also function as the camber angle adjusting devices that adjust camber angle of the wheels 9002.

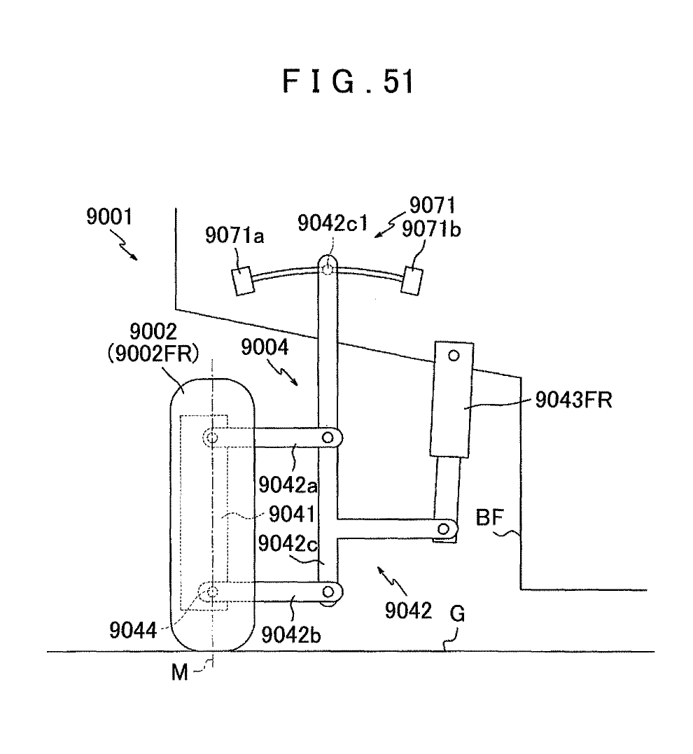

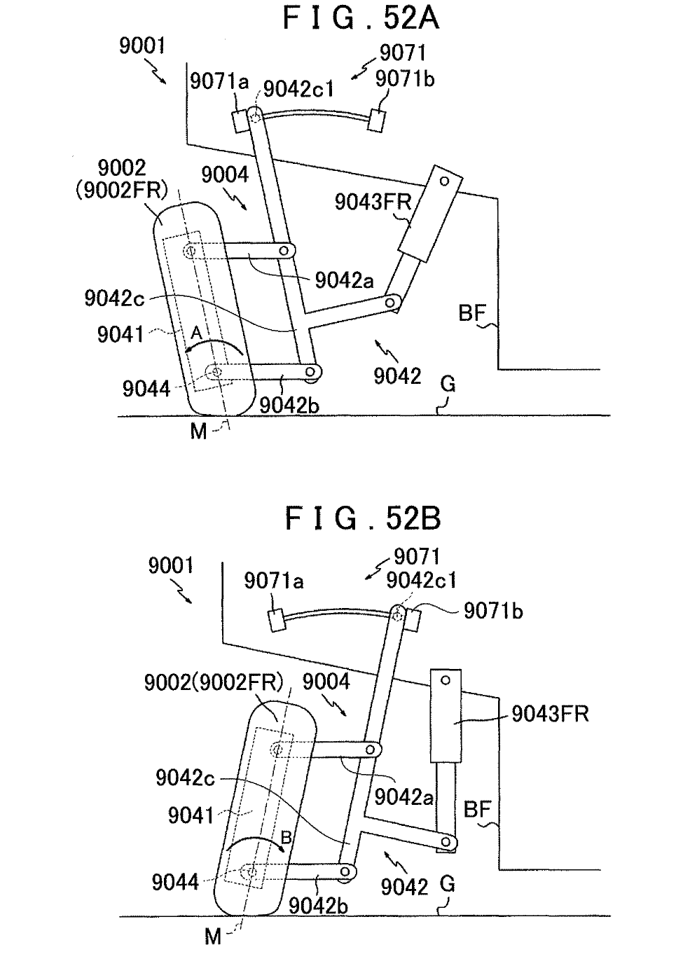

Here, referring to FIGS. 51 and 52, a description is given of the detailed structure of the suspension devices 9004. FIGS. 51 and 52 a front view of one of the suspension devices 9004. FIG. 52A shows a state where the camber angle of one of the wheels 9002 is adjusted in the positive direction, whereas FIG. 5213 shows a state where the camber angle of one wheel 9002 is adjusted in the negative direction. It is to be noted that, FIGS. 51 and 52 are simplified by not showing the constituents such as the drive shafts 7031 for easier understanding of the invention. Further, since the suspension devices 9004 are similarly structured, the suspension device 9004 corresponding to the right front wheel 9002FR is shown in FIGS. 51 and 52 as a representative example.

As shown in FIG. 51, the suspension device 9004 is structured with a double wishbone mechanism, and principally includes an axle hub 9041, a suspension arm 9042, and an FR actuator 9043FR.

The axle hub 9041 rotatably supports the wheel 9002. As shown in FIG. 51, the axle hub 9041 supports the wheel 9002 and is coupled to the FR actuator 9043FR via the suspension arm 9042. The suspension arm 9042 couples the axle hub 9041 to the FR actuator 9043FR, and includes a first to a third arms 9042a to 9042c.

The first and second arms 9042a and 9042b have their one ends (left side in FIG. 51) shaft-supported on the upper portion (top side in FIG. 51) and the lower portion (bottom side in FIG. 51) of the axle hub 9041, respectively, and have their other ends (right side in FIG. 51) shaft-supported on the top end (top side in FIG. 51) and the bottom end (bottom side in FIG. 51) of the third arm 9042c, respectively. The first and second arms 9042a and 9042b are arranged to be oppose to each other, and the third arm 9042c is arranged to be oppose to the axle hub 9041. Thus, a four-bar linkage mechanism (camber angle changeable mechanism) is structured by the axle hub 9041 and the suspension arm 9042 (the first to third arms 9042a to 9042c). Additionally, a tip 9042c1 of the third arm 9042c on the first arm 9042a side is coupled to a slider 9071.

It is to be noted that a coil spring that absorbs the shock transferred from the road surface G to the body frame BF and a shock absorber that attenuates the vibration of the coil spring (both not shown) are attached to the suspension arm 9042.

The FR actuator 9043FR couples the suspension arm 9042 and the body frame 13F to each other and supports the body frame BF, and is structured with a hydraulic cylinder. As shown in FIG. 51, the FR actuator 9043FR has its body (top side in FIG. 51) shaft-supported on the body frame BF, and has its rod portion (bottom side in FIG. 51) shaft-supported on the third arm 9042c.

Here, the second arm 9042b is shaft-supported on the axle hub 9041 via a camber axis 9044. When the FR actuator 9043FR is caused to extend/contract, a linkage mechanism (hereafter simply referred to as “the linkage mechanism”) structured with the axle hub 9041 and the suspension arm 9042 flexes, and the wheel 9002 is caused to swing about the camber axis 9044 as the central axis (refer to FIG. 52).

That is, as the wheel 9002 normally does not slide relative to the road surface G owing to the friction between the road surface G and the wheel 9002, the linkage mechanism flexes with the camber axis 9044 closest to the ground contact surface of the wheel 9002 serving as a fixed axis. As a result, the wheel 9002 is caused to swing about the camber axis 9044 as a central axis.

According to the suspension device 9004 structured as above, as shown in FIG. 52, when the FR actuator 9043FR is caused to extend/contract from the state shown in FIG. 51, the linkage mechanism flexes and the wheel 9002 is caused to swing about the camber axis 9044 as the central axis, whereby the camber angle of the wheel 9002 is adjusted.

Specifically, as shown in FIG. 52A, when the FR actuator 9043FR is caused to contract, the wheel 9002 is caused to swing in the arrow A direction about the camber axis 9044 as a central axis, whereby the camber angle of the wheel 9002 is adjusted in the positive direction. On the other hand, as shown in FIG. 52B, when the FR actuator 9043FR is extended, the wheel 9002 is caused to swing in the arrow B direction about the camber axis 9044 as the central axis, whereby the camber angle of the wheel 9002 is adjusted in the negative direction.

As the camber angle of the wheel 9002 is adjusted by the flex movement of the linkage mechanism, the tip 9042c1 of the third arm 9042c moves along the slider 9071. The slider 9071 is provided with stoppers 9071a and 9071b at its opposite ends as changeable range limiting means. Accordingly, the maximum camber angle and the camber angle changeable range that can be applied to the wheel 9002 are mechanically limited by the stoppers 9071a and 9071b.

That is, a state where the third arm 9042c contacts the stopper 9071a (FIG. 52A) forms the maximum camber angle at which the wheel 9002 can be adjusted in the positive direction, and a state where the third arm 9042c contacts the stopper 9071b (FIG. 52B) forms the maximum camber angle at which the wheel 9002 can be adjusted in the negative direction.

As will be described in detail later, in the present embodiment, when the lateral force occurring at the wheel(s) 9002 is not lower than a prescribed level, the power supply to the actuators 9043FL to 9043FR that flex the linkage mechanism is stopped, and using the moment generated at the camber axis 9044 by the lateral force, a camber angle is passively applied to the wheel(s) 9002. Here, owing to the fact that the range of camber angle applicable to the wheel(s) 9002 is mechanically limited by the stoppers 9071a and 9071b of the slider 9071, the camber angle control as in the present embodiment can be realized. Further, the termination of the power supply to the actuators 9043FL to 9043FR so as to retain the camber angle by the stoppers 9071a and 9071b as the changeable range limiting means realizes reduction in the capacity of the actuators 9043.

The description is continued referring back to FIG. 50. The steering device 7005 is structured with a rack and pinion mechanism, and principally includes the steering shaft 7051, the hook joint 7052, the steering gear 7053, the tie rods 7054, and the knuckles 7055.

According to the steering device 7005, the operation of the steering 54 by the driver is first transferred to the hook joint 7052 via the steering shaft 7051, and being subjected to the angle change by the hook joint 7052, and it is transferred to a pinion 7053a of the steering gear 7053 as rotational movement. Then, the rotational movement transferred to the pinion 7053a is converted into linear movement of a rack 7053b. This linear movement of the rack 7053b causes the tie rods 7054 connected to the opposite ends of the rack 7053b to move and to push or pull the knuckles 7055, whereby the steer angle of the wheels 9002 is adjusted.

The accelerator pedal 52 and the brake pedal 53 are operational members operated by the driver. In accordance with the depressing state (depression amount, depression speed and the like) of the pedals 52 and 53, the traveling speed and the braking force of the vehicle 9001 is determined, and the control over the wheel driving mechanism 7003 is exerted. The steering 54 is an operational member operated by the driver. According to its operation, the wheels 9002 are steered by the steering device 7005.

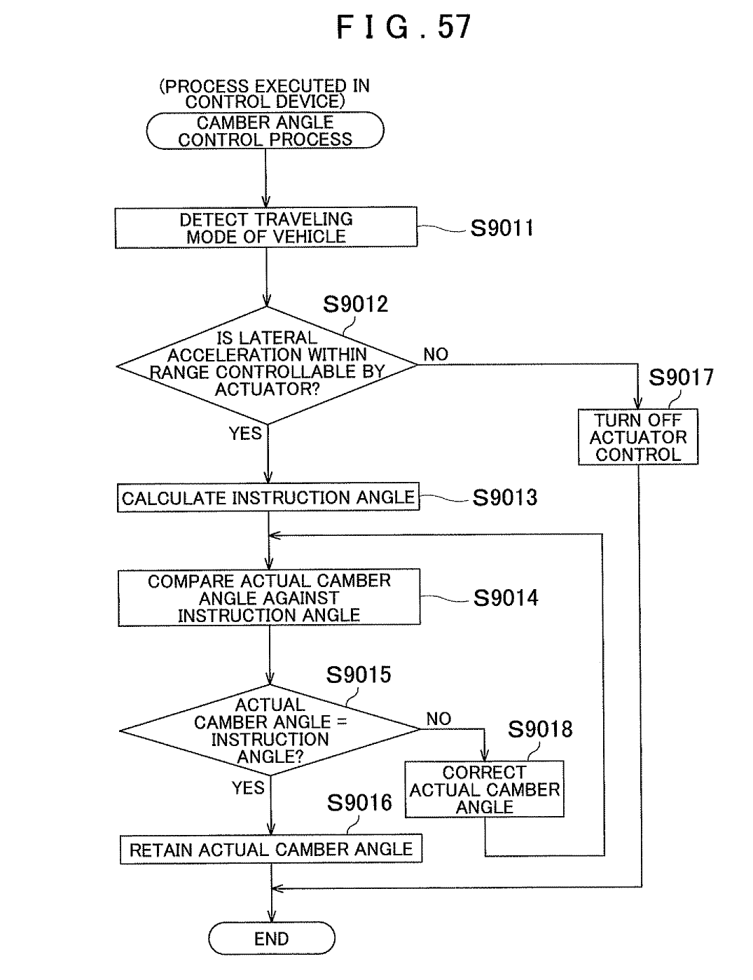

The control device 9100 is a device for controlling the constituents of the vehicle 9001 structured as described above, and rotates the wheels 9002 by, for example, detecting the depressing state of the pedals 52 and 53 and controlling the wheel driving mechanism 7003 in accordance with the detection result. Alternatively, the control device 9100 controls the linkage driving device 9043 in accordance with the traveling mode of the vehicle 9001 in a camber control process (refer to FIG. 57), which will be described later. The detailed structure of the control device 9100 will be described later referring to FIG. 56.

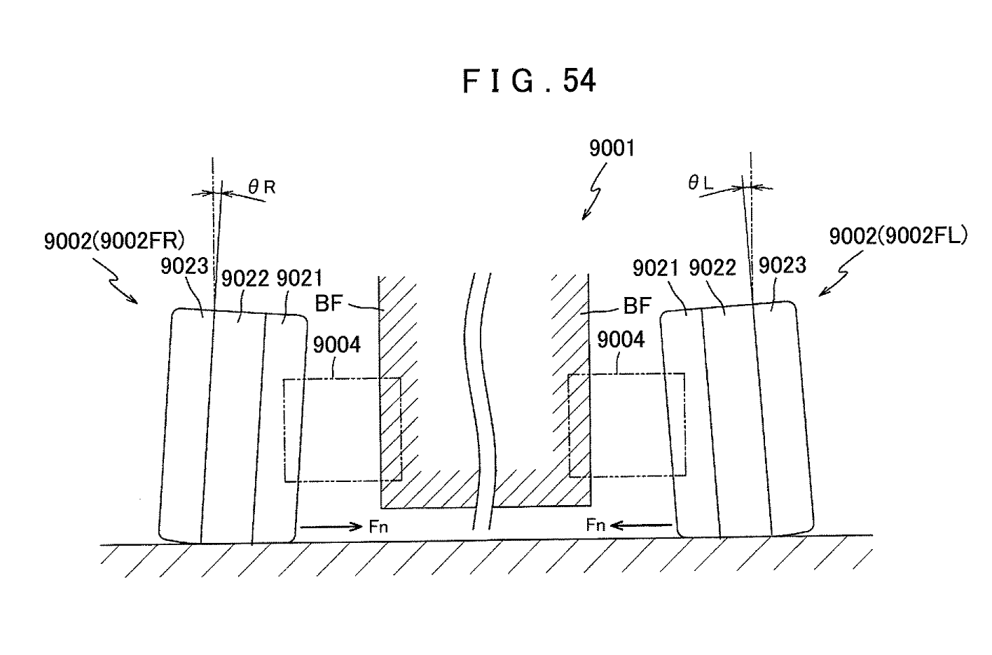

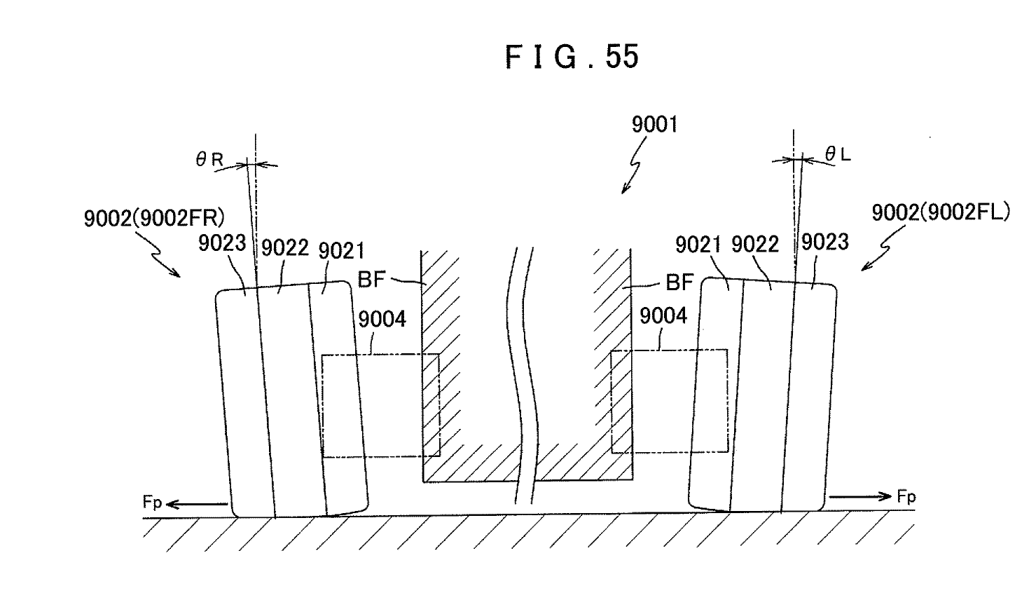

Next, referring to FIGS. 53 to 55, a description is given of the detailed structure of the wheels 9002. FIG. 53 is a schematic diagram schematically showing the top view of the vehicle 9001, whereas FIGS. 54 and 55 are schematic diagrams schematically showing the front view of the vehicle 9001. FIG. 54 shows a state where the camber angle of the wheels 9002 is adjusted in the negative direction, whereas FIG. 55 shows a state where the camber angle of the wheels 9002 is adjusted in the positive direction.

As shown in FIG. 53, the wheels 9002 are each provided with three types of tread, namely a first tread 9021, a second tread 9022 and a third tread 9023. In each wheel 9002, the first tread 9021 is arranged on the inner side in connection with the vehicle 9001, the third tread 9023 is arranged on the outer side in connection with the vehicle 9001, and the second tread 9022 is arranged between the first tread 9021 and the third tread 9023.

The wheels 9002 are so structured that the first tread 9021 and the second tread 9022 are different from each other in characteristic, i.e., the first tread 9021 is structured to have higher gripping force property as compared to the second tread 9022. The third tread 9023 is structured to have higher gripping force property at least as compared to the second tread 9022. It is to be noted that, in the present embodiment, the treads 9021, 9022 and 9023 are structured to be identical in the width dimension (side-to-side direction in FIG. 54).

According to the wheels 9002 structured as in the foregoing description, as shown in FIG. 54, when the linkage driving device 9043 (refer to FIG. 56) is controlled so that the camber angles θL and θR of the wheels 9002 are adjusted in the negative direction, camber thrust Fn is generated at the wheels 9002 toward the inner side in connection with the vehicle 9001.

Additionally, the adjustment of the camber angles θL and θR of the wheels 9002 in the negative direction brings about an increase in the ground contact (ground contact area) of the first tread 9021 arranged on the inner side in connection with the vehicle 9001, and a reduction in the ground contact (ground contact area) of the second tread 9022 and the third tread 9023 arranged on the outer side than the first tread 9021 in connection with the vehicle 9001. Thus, the ground contact ratio of the treads 9021, 9022 and 9023 can be changed and, accordingly, the effect of the characteristic of the tread with high ground contact ratio, i.e., the first tread 9021, can be increased so as to allow the wheels 9002 to exert the performance obtained by the characteristic of the first tread 9021.

Here, in the present embodiment, as in the foregoing description, the wheels 9002 are structured such that the first tread 9021 is higher than the second tread 9022 in the gripping force property. Allowing the high gripping force property to be exerted, a further improvement in the traveling performance of the vehicle 9001 can be attained.

On the other hand, as shown in FIG. 55, when the camber angles θL and θR of the wheels 9002 are adjusted in the positive direction, camber thrust Fp is generated at the wheels 9002 toward the outer side in connection with the vehicle 9001.

Additionally, the adjustment of the camber angles θL and θR of the wheels 9002 in the positive direction brings about an increase in the ground contact (ground contact area) of the third tread 9023 arranged on the outer side in connection with the vehicle 9001, and a reduction in the ground contact (ground contact area) of the first tread 9021 and the second tread 9022 arranged on the inner side than the third tread 9023 in connection with the vehicle 9001. Thus, the ground contact ratio of the third tread 9023 can be increased so as to allow the third tread 9023 to exert its high gripping force property. In this manner, a further improvement in the traveling performance of the vehicle 9001 can be attained.

Next, referring to FIG. 56, a description is given of the detailed structure of the control device 9100. FIG. 56 is a block diagram showing the electrical structure of the control device 9100. As shown in FIG. 56, the control device 9100 includes the CPU 71, the EEPROM 7072 and the RAM 73 that are connected to the input/output ports 75 via the bus line 74. A plurality of devices, such as the wheel driving mechanism 7003, is connected to the input/output ports 75.

The CPU 71 is a computing device that controls those constituents connected by bus line 74. The ROM 7072 is non-rewritably non-volatile memory for storing any control program executed by the CPU 71 (for example, a program of a camber angle control process shown in FIG. 57), fixed value data and the like, and the RAM 73 is memory for rewritably storing various data when the control program is executed.

The linkage driving device 9043 is a device for causing the linkage mechanism (refer to FIGS. 51 and 52) to flex, and principally includes four actuators, namely the FL actuator 9043FL to the RR actuator 9043RR, that provide linkage mechanism with the driving force to flex, and control circuitry (not shown) that controls the actuators 9043FL to 9043RR based on a command from the CPU 71.

As in the foregoing description, the FL actuator 9043FL to the RR actuator 9043RR are structured with the hydraulic cylinders, and each structured to principally include a hydraulic pump (not shown) supplying oil (oil pressure) to the hydraulic cylinder (the FL actuator 9043FL to the RR actuator 9043RR), and an electromagnetic valve (not shown) that switches the supply direction of the oil supplied from the hydraulic pump to the hydraulic cylinder.

When the control circuitry of the linkage driving device 9043 exerts control to drive the hydraulic pumps based on an instruction from the CPU 71, the respective hydraulic cylinders are driven for extension/contraction by the oil (oil pressure) supplied from the hydraulic pumps. When the electromagnetic valves are turned on or off, the driven direction (extension or contraction) of each hydraulic cylinder is switched.

The control circuitry of the linkage driving device 9043 monitors extension/contraction amount of each hydraulic cylinder by an extension/contraction sensor (not shown). The hydraulic cylinder that reaches a target value (extension/contraction amount) instructed by the CPU 71 is caused to stop its extension/contraction. The detection result obtained by the extension/contraction sensor is provided from the control circuit to the CPU 71, and the CPU 71 can obtain a camber angle of each wheel 9002 based on the detection result.

A yaw rate sensor device 86 is a device that detects the yaw rate (produced direction and an absolute value) of the vehicle 9001 (body frame BF) and provides the detection result to the CPU 71. The yaw rate sensor device 86 principally includes a gyroscopic sensor 86a detecting the yaw rate of the vehicle and processing circuitry (not shown) processing the detection result of the gyroscopic sensor 86a and providing the processed result to the CPU 71.

In the present embodiment, the gyroscopic sensor 86a is structured with a fiber optic gyroscope that operates exploiting the theory of the Sagnac effect. It is to be noted that other types of gyroscopic sensor can naturally be used. An example of other types of gyroscopic sensor is a mechanical gyroscope, piezoelectric gyroscope or the like.

An example of other input/output devices 9036 shown in FIG. 53 is an optical sensor that measures an attitude (such as inclination) of the vehicle 9001 (body frame BF) relative to the road surface in a noncontact manner.

Next, referring to FIG. 57, a description is given of the camber angle control process executed by the control device 9100 (CPU 71) structured as in the foregoing description. FIG. 57 is a flow chart showing the camber angle control process. The camber angle control process is repeatedly executed by the CPU 71 (for example, at 0.2 ms intervals) while the control device 9100 is powered on.

As shown in FIG. 57, in the camber angle control process, firstly, the traveling mode of the vehicle 9001 is detected (S9011). Specifically, the output values of various sensor devices (such as the wheel speed sensor device 7081, the acceleration sensor device 31, the yaw rate sensor device 86, the accelerator pedal sensor device 52a, the brake pedal sensor device 53a, and the steering wheel sensor device) that are traveling mode detecting means are obtained. At the same time, as to parameters that are obtained indirectly based on the obtained output values of the respective sensor devices, e.g., moment generated at the camber axis 9044, or index values for the moment generated at the camber axis 9044 such as centrifugal force or lateral force are calculated by computation based on the obtained values of the respective sensor devices. It is to be noted that the step S9011 corresponds to the computing means of the present invention (the vehicle I1 or the controlling device I2).

After the process in step S9011, whether the lateral acceleration of the vehicle 9001 (that is, the detection result from the side-to-side acceleration sensor 31b) falls within a range controllable by the actuators 9043FL to 9043RR is checked (S9012). When the lateral acceleration of the vehicle 9001 falls within a range controllable by the actuators 9043FL to 9043RR (S9012: Yes), a camber angle instruction value that corresponds to the traveling mode detected in the process in step S9011 (S9013).

It is to be noted that, in the present embodiment, an optimum camber angle map (not shown) is stored in the EEPROM 7072 in which a traveling mode and a camber angle optimum for the traveling mode are associated to each other. In the process in step S9013, a camber angle instruction value corresponding to the traveling mode is calculated referring to the optimum camber angle map.

After the process in step S9013, the camber angle actually applied to the wheels 9002 (actual camber angle) is compared against the calculated instruction angle (S9014). The actual camber angle can be measured by, for example, a gyroscopic sensor (not shown) provided at each wheel 9002.

As a result of the check in the process in step S9015, when it turns out that there is any wheel 9002 whose actual camber angle and the instruction angle are not equal (S9015: No), the actuator (the actuators 9043FL to 9043RR) of the wheel 9002 whose actual camber angle and the instruction angle are not equal is driven so as to correct the actual camber angle (S9018), and the control returns to the process in step S9014.

As a result of the check in the process in step S9015, when it turns out that the actual camber angle and the instruction angle are equal to each other at every one of the wheels 9002 (S9015: Yes), the actual camber angle is retained by the driving force (thrust) of the actuators 9043FL to 9043RR (S9016), and the camber angle control process ends.

On the other hand, as a result of the check in the process in step S9012, when it turns out that the lateral acceleration of the vehicle 9001 is beyond the range controllable by the actuators 9043FL to 9043RR, the control of the actuators 9043FL to 9043RR is turned off (that is, the power consumption is set to zero) (S9017), and the camber angle control process ends.

As the control of the actuators 9043FL to 9043RR is turned off as a result of the process in step S9017, the driving force of the actuators 9043FL to 9043RR becomes also zero, becoming incapable of retaining the camber angle of the wheels 9002. Accordingly, the wheels 9002 are now capable of swinging.

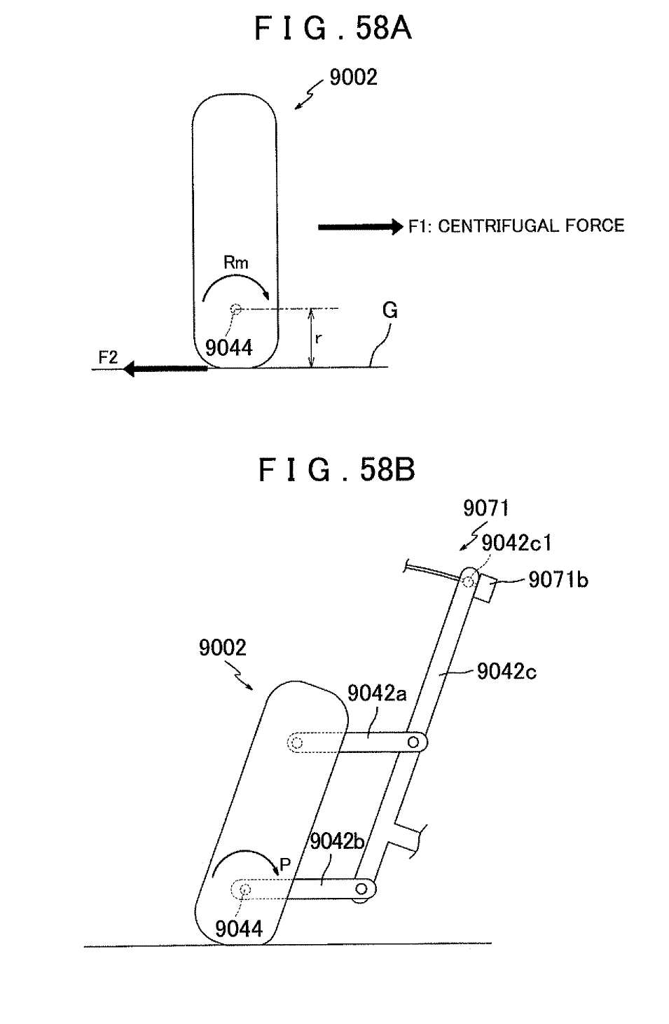

Here, referring to FIG. 58, a description is given of the behavior of the wheels 9002 after the process in step S9017. FIG. 58A is a schematic diagram describing the moment generated at the camber axis of the wheels 9002 in accordance with the generation of the centrifugal force. FIG. 58B is a schematic diagram describing the behavior of the wheels 9002 after the process in step S9017.

As shown in FIG. 58A, a centrifugal force F1[N] generated at the vehicle 9001 by making a turn or the like is represented as F1=mv2/R (m: weight, v: speed [m/s], R: turning radius [m]), whereas, according to the equation of motion, F1=ma (m: weight [N], acceleration [m/s2]). Therefore, a gravity in the lateral direction (lateral G) applied to the vehicle 9001 during the turn is represented as lateral G=(v2/R)/9.8.

On the other hand, a force in the turning center direction (lateral force) F2[N] withstanding the centrifugal force F1 is generated at the wheels 9002. The lateral force F2 is represented as F2=lateral G×9.8×tire load.

Because the generated centrifugal force F1 produces the lateral force F2 at the wheels 9002, a moment Rm [N·m] corresponding to F2×r (r: the distance from the road surface G to the camber axis 9044 [m]) is generated at the camber axis 9044.

As the control of the actuators 9043FL to 9043RR is turned off as a result of the process in step S9017, the wheels 9002 are now capable of swinging. Here, the wheels 9002 naturally rotates in an arrow P direction by the moment Rm generated at the camber axis 9044, and accordingly, the camber angle in the positive direction or in the negative direction (in FIG. 58B, the camber angle in the negative direction) is applied to the wheels 9002.

As in the foregoing description, the wheels 9002 of the present embodiment are each provided with the first tread 9021 and the third tread 9023 arranged respectively on opposite sides in the width direction (refer to FIG. 53), and being structured to have higher gripping force property as compared to the second tread 9022 arranged between the treads 9021 and 9023. Accordingly, owing to the camber angle applied to the wheels 9002 in the negative or positive direction, the ground contact ratio of the first tread 9021 or the third tread 9023 can be increased as compared to the second tread 9022. Thus, the high gripping force property of the first tread 9021 or the third tread 9023 can be exerted.

As the lateral force F2 generated at the wheels 9002 is greater, that is, as the moment generated at the camber axis 9044 is greater, the capacity required for the actuators controlling the camber angle becomes greater. However, according to the vehicle 9001 of the present embodiment, the control of the actuators 9043FL to 9043RR is turned off when the lateral acceleration of the vehicle 9001 is beyond the range controllable by the actuators 9043FL to 9043RR, and in such a case, the camber angle at which the high gripping force property can passively be exerted can be applied using the moment generated at the camber axis 9044 and the stoppers 9071a and 9071b.

That is, according to the vehicle 9001 of the present embodiment, in a state where the lateral force F2 equal to or higher that a prescribed level is generated (for example, in a sharp turning mode) at the wheels 9002, the camber angle can be retained by mechanically limiting the camber angle changeable range for the wheels 9002 by the stoppers 9071a and 9071b that are the changeable range limiting means. Therefore, without necessity of using the driving force of the actuators, it becomes possible to continuously apply the camber angle at which the high gripping force can be exerted to the wheels 9002 (that is, to retain the camber angle of the wheels 9002), which allows use of low capacity actuators.

It is to be noted that, the capacity of the actuators 9043FL to 9043RR (that is, the controllable range) is suitably set to the amount being capable of withstanding up to the lateral force being substantially equal to the maximum gripping force of the second tread 9022 that is lower in rolling resistance as compared to the first tread 9021 and the third tread 9023. For example, if the maximum gripping force of the second tread 9022 is 0.3 G, then it is suitable to set the capacity of the actuators 9043FL to 9043RR to approximately 0.3 G.

When the lateral force greater than the maximum gripping force of the second tread 9022 is generated at the wheels, it is desirable to apply the camber angle at which the ground contact ratio of the first tread 9021 or the third tread 9023 being higher in the gripping force than the second tread 9022 so as to avoid slipping of the wheels 9002. Any structure in which such a camber angle is continuously applied, that is, retained, using the actuators, necessitates high-output actuators.

In contrast, by setting the capacity of the actuators 9043FL to 9043RR (that is, the controllable range) to the amount being capable of withstanding up to the lateral force being substantially equal to the maximum gripping force of the second tread 9022 that is lower in rolling resistance as compared to the first tread 9021 and the third tread 9023, it becomes possible to reduce the capacity of the actuators while establishing compatibility between the traveling performance and the fuel-saving performance.

That is, when the lateral force not greater than the maximum gripping force of the second tread 9022 is generated at the wheels 9002, the camber angle at which the fuel-saving performance or the gripping force is improved can be applied as appropriate by the control exerted by the actuators 9043FL to 9043RR. On the other hand, when the lateral force greater than the maximum gripping force of the second tread 9022 is generated at the wheels 9002, the moment generated at the camber axis 9044, instead of actuation of the actuators 9043FL to 9043RR, can passively apply the camber angle at which the ground contact ratio of the first tread 9021 or the third tread 9023 higher in the gripping force than the second tread 9022 can be increased. Therefore, the traveling performance can also be ensured.

Further, according to the vehicle 9001 of the present embodiment, even when the control of the actuators 9043FL to 9043RR is turned off and the application of the camber angle to the wheels 9002 is passively performed, the stopper 9071b of the slider 9071 functions to limit the camber angle that can be applied to the wheels 9002 (for example, about ±3°). Accordingly, an unduly increase in the camber angle can be avoided, which will otherwise result in unstable traveling of the vehicle 9001.

As has been described above, according to the vehicle 9001 of the present embodiment, in a low load mode (when the lateral force F2 is small), control of the camber angle for the wheels 9002 is exerted by the actuators 9043FL to 9043RR, and in a high load mode (when the lateral force F2 is great), the control of the actuators 9043FL to 9043RR is turned off (that is, stopped) and the stoppers 9071a and 9071b, which are the changeable range limiting means that mechanically limits the camber angle changeable range, are caused to retain the camber angle of the wheels 9002. In this manner, in a high load mode, the camber angle control is passively exerted using the lateral force F2 (that is, the moment generated at the camber axis 9044) and, therefore, the control enabling selective use of the treads of the wheels 9002 corresponding to the traveling mode can be realized by using low capacity (low output) actuators being excellent in cost effectiveness and suitability for installation.

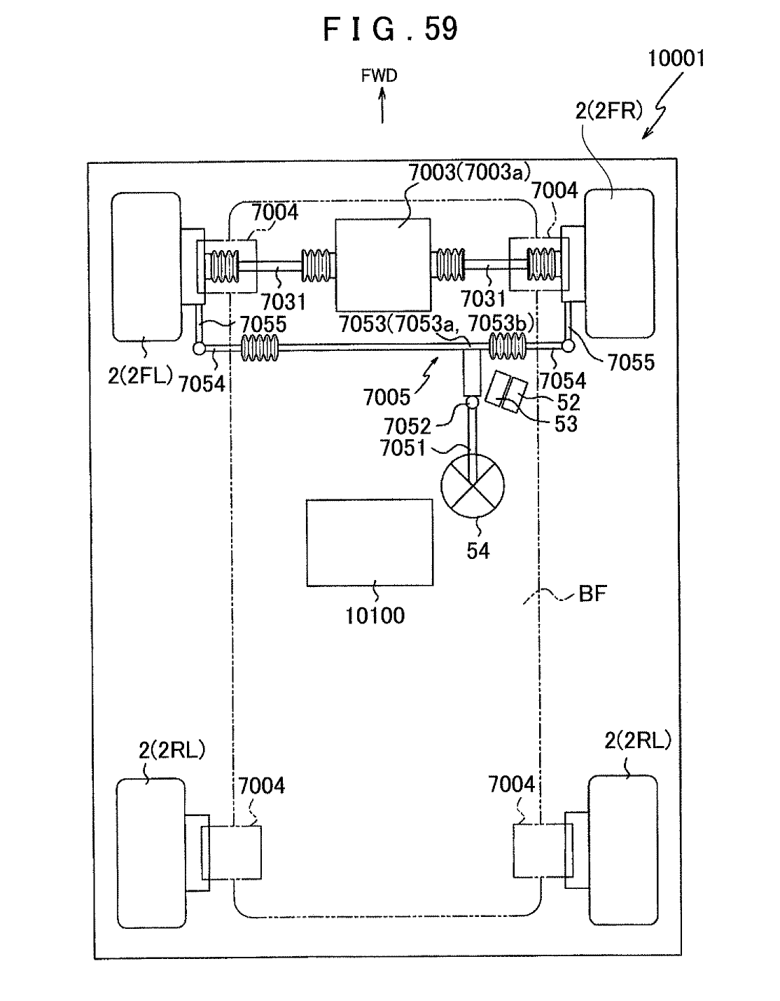

Next, referring to FIGS. 59 to 61, a description is given of a tenth embodiment. The same reference numerals are used for the same parts as in the foregoing embodiments, and the description thereof is not repeated. FIG. 59 is a schematic diagram schematically showing a top view of a vehicle 10001 in which a control device 10100 according to the tenth embodiment of the present invention is installed. In FIG. 59, an arrow FWD represents the forward direction of the vehicle 10001.

First, a description is given of the schematic structure of the vehicle 10001. As shown in FIG. 59, the vehicle 10001 principally includes the body frame BF, a plurality of (four in the present embodiment) wheels 2 supported by the body frame BF, the wheel driving mechanism 7003 that rotates part of the wheels 2 (in the present embodiment, the right and left front wheels 2FR and 2FL), the suspension devices 7004 that suspend the wheels 2 on the body frame BF and adjust the camber angle of the respective wheels 2 independently of one another, and the steering device 7005 that steers part of the wheels 2 (in the present embodiment, the right and left front wheels 2FR and 2FL) according to the operation of the steering 54. The vehicle 10001 is structured to be capable of, when any fault occurs in the vehicle 10001, improving the braking performance by adjusting the camber angle of the wheels 2 so as to allow the wheels 2 to exert its performance.

In the present embodiment, the wheels 2, the wheel driving mechanism 7003, the suspension devices 7004, and the steering device 7005 are similarly structured as in the seventh embodiment (refer to FIG. 37). Therefore, the same reference numerals are used for the same parts and the description thereof is not repeated.

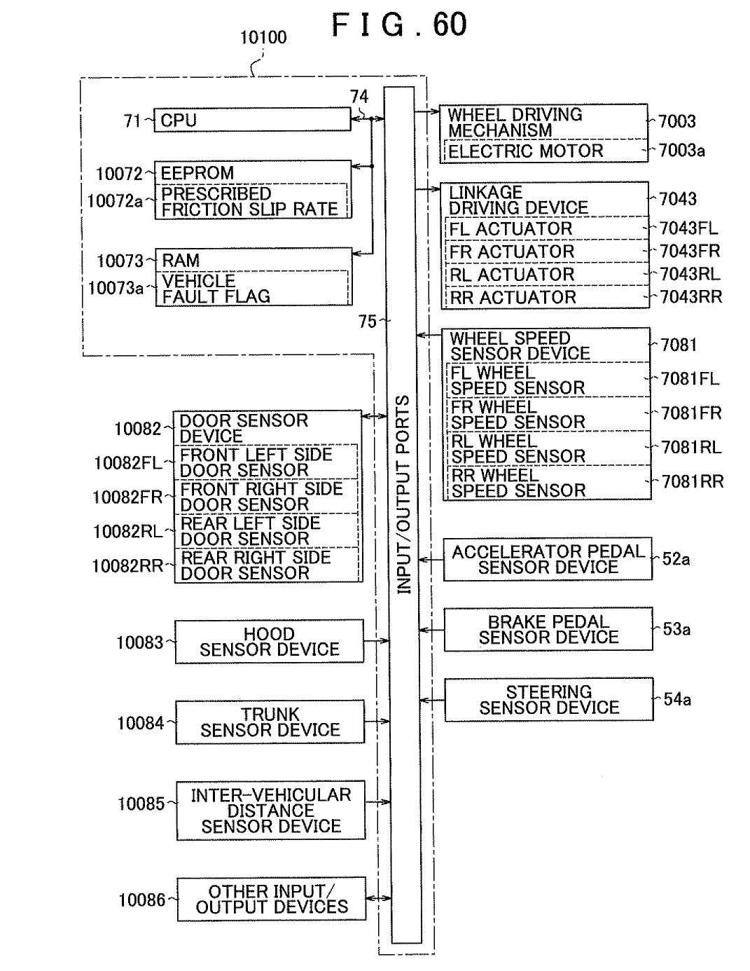

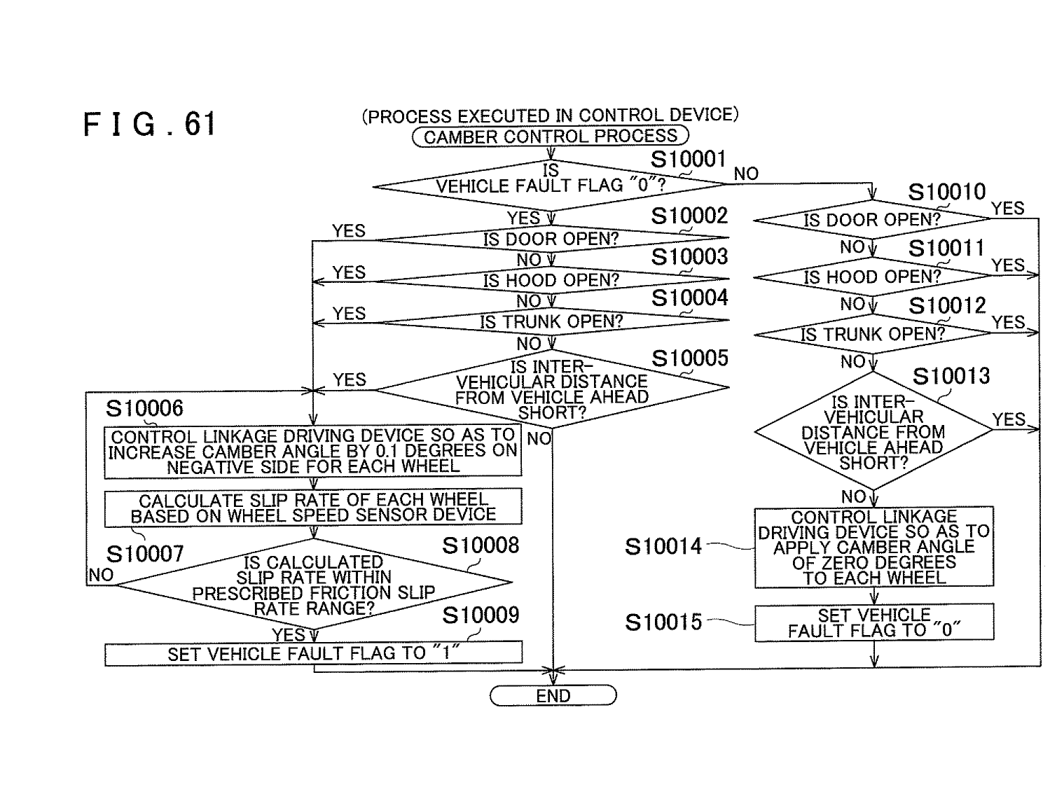

The control device 10100 is a device for controlling the constituents of the vehicle 10001. For example, the control device 10100 detects the depressing state of the pedals 52 and 53 and controls the wheel driving mechanism 7003 according to the detection result, and thereby rotates the wheels 2. Alternatively, when a fault occurring at the vehicle 10001 is detected in a camber control process (refer to FIG. 61), which will be described later, the control device 10100 controls the linkage driving device 7043 (the FL actuator 7043FL to the RR actuator 7043RR, refer to FIG. 60). The detailed structure of the control device 10100 will be described later referring to FIG. 60.

Next, referring to FIG. 60, a description is given of the detailed structure of the control device 10100. FIG. 60 is a block diagram showing the electrical structure of the control device 10100. As shown in FIG. 60, the control device 10100 includes the CPU (Central Processing Unit) 71, EEPROM (Electronically Erasable and Programmable Read Only Memory) 10072 and RAM (Random Access Memory) 10073 that are connected to the input/output ports 75 via the bus line 74. To the input/output ports 75, the wheel driving mechanism 7003, the linkage driving device 7043, the wheel speed sensor device 7081, the accelerator pedal sensor device 52a, the brake pedal sensor device 53a, the steering sensor device 54a, a door sensor device 10082, a hood sensor device 10083, a trunk sensor device 10084, an inter-vehicular distance sensor device 10085, and other input/output devices 10036 are connected.

The CPU 71 is a computing device that controls those constituents connected by the bus line 74. The EEPROM 10072 is non-volatile memory that rewritably stores any control program executed by the CPU 71 (for example, a program shown in the flow chart of FIG. 61), fixed value data and the like, and that can retain the contents after power-off. The RAM 10073 is memory for rewritably storing various data when the control programs are executed. In the EEPROM 10072, a prescribed friction slip rate 10072a is stored. In the RAM 10073, a vehicle fault flag 10073a is stored.

The prescribed friction slip rate 10072a is memory for storing a slip rate range for the wheels 2 within which the coefficient of friction between the wheels 2 and the road surface G (refer to FIG. 4) becomes equal to or higher than a prescribed level. In the camber control process (refer to FIG. 61) described later, whether or not the coefficient of friction between the wheels 2 and the road surface G is equal to or higher than a prescribed level is determined based on the slip rate of the wheels 2 and the prescribed friction slip rate 10072a. In the prescribed friction slip rate 10072a, a numerical value that is preset in the design phase is stored.

When the slip rate for each of the wheels 2FL to 2RR calculated based on the detection result (wheel speed for each of the wheels 2FL to 2RR) of the wheel speed sensor device 7081 (FL wheel speed sensor 7081FL to RR wheel speed sensor 7081RR), which will be described later, falls within a slip rate range indicated by the prescribed friction slip rate 10072a, the CPU 71 can determine that the coefficient of friction between the wheels 2FL to 2RR and the road surface G is equal to or higher than a prescribed level. Thus, in adjusting the camber angle of the wheels 2FL to 2RR in the negative side, the camber angle of the wheels 2FL to 2RR can be increased so that the ground contact ratio of the inner tread 21 increases until the coefficient of friction between the wheels 2FL to 2RR and the road surface G becomes equal to or higher than a prescribed level.

The vehicle fault flag 10073a is a flag for indicating whether or not the vehicle 10001 is in a prescribed fault state. In the camber control process (refer to FIG. 61) described later, when it is determined that a prescribed fault state is occurring at the vehicle 10001 based on the detection result of the various sensor devices 10082 to 10085 (condition of the vehicle 10001), the vehicle fault flag 10073a is set to “1”, and set to “0” when it is determined that the prescribed fault state is resolved.

The CPU 71 can determine whether or not the vehicle 10001 is in a prescribed fault state, based on the contents of the vehicle fault flag 10073a. Thus, when the value of the vehicle fault flag 10073a is “0”, that is, when it is determined that the vehicle 10001 of the vehicle fault flag 10073a is not in a prescribed fault state, if it is determined that a prescribed fault state is occurring at the vehicle 10001 based on the detection result of various sensor devices 10082 to 10085 (the condition of the vehicle 10001), the camber angle of the wheels 2FL to 2RR can be adjusted in the negative direction, so as to enhance the gripping force of the wheel 2.

When the value of the vehicle fault flag 10073a is “1”, that is, when it is determined that the vehicle 10001 is in a prescribed fault state, if the CPU 71 determines that the prescribed fault state is resolved based on the detection result of the various sensor devices 10082 to 10085 (the condition of the vehicle 10001), the CPU 71 adjusts the camber angle of the wheels 2FL to 2RR to 0 degrees, so as to avoid an increase in the rolling resistance of the wheels 2 despite the absence of a fault state.

When the ignition switch (not shown) is turned on, the camber angle of the wheels 2 is adjusted to 0 degrees, and in synchronization therewith, the vehicle fault flag 10073a is set to “0”. Thus, in the camber control process described later, when the vehicle 10001 is not in a prescribed fault state, the camber angle of the wheels 2 can be adjusted to 0 degrees. Also, when a prescribed fault state occurs in the vehicle 10001, a camber angle in the negative direction can be applied to the wheels 2.

The door sensor device 10082 is a device for detecting an open/closed state of the doors (not shown) installed on the vehicle 10001, and for providing the detection result to the CPU 71. The door sensor device 10082 includes a front left side door sensor 10082FL, a front right side door sensor 10082FR, a rear left side door sensor 10082RL, a rear right side door sensor 10082RR, and processing circuitry (not shown) that processes the detection result of the door sensors 10082FL to 10082RR and provides the processed result to the CPU 71.

The front left side door sensor 10082FL is a sensor that detects the open/closed state of a front left side door (not shown) arranged on the left side on the front side (the side pointed by the arrow FWD in FIG. 59) of the vehicle 10001. The front right side door sensor 10082FR is a sensor that detects the open/closed state (not shown) of a front right side door arranged on the right side on the front side (the side pointed by the arrow FWD in FIG. 59) of the vehicle 10001. The rear left side door sensor 10082RL is a sensor that detects the open/closed state of a rear left side door (not shown) arranged on the left side on the rear side (the side opposite to the arrow FWD in FIG. 59) of the vehicle 10001. The rear right side door sensor 10082RR is a sensor that detects the open/closed state of a rear right side door (not shown) arranged on the right side on the rear side (the side opposite to the arrow FWD in FIG. 59) of the vehicle

In the present embodiment, the door sensors 10082FL to 10082RR are each structured as a contact type sensor that detects a closed state of the door upon contact between a first contact on the door side and a second contact on the vehicle 10001 side.

The processing circuitry of the door sensor device 10082 operates, when any door is indicated to be in an open state based on the detection result of the door sensors 10082FL to 10082RL, to provide a signal reporting the open state as the detection result of the door sensor device 10082 to the CPU 71; and when every door is in a closed state, to provide a signal reporting the closed state as the detection result of the door sensor device 10082 to the CPU 71.

Thus, the CPU 71 can determine whether or not the doors installed on the vehicle 10001 is in an open state based on the detection result received from the door sensor device 10082. Then, when the door installed on the vehicle 10001 is in an open state, it can be determined that a prescribed fault state is occurring at the vehicle 10001.

The hood sensor device 10083 is a device for detecting an open/closed state of a hood (not shown) installed on the vehicle 10001 and providing the detection result to the CPU 71. The hood sensor device 10083 includes an open/closed sensor (not shown) that detects an open/closed state of the hood, and processing circuitry (not shown) that processes the detection result of the open/closed sensor and providing the processed result to the CPU 71.

The trunk sensor device 10084 is a device for detecting an open/closed state of a trunk (not shown) installed on the vehicle 10001 and providing the detection result to the CPU 71. The trunk sensor device 10084 includes an open/closed sensor (not shown) that detects an open/closed state of the hood, and processing circuitry (not shown) that processes the output result of the open/closed sensor and providing the processed result to the CPU 71.

In the present embodiment, the open/closed sensors of the hood sensor device 10083 and the trunk sensor device 10084 are each structured as a contact type sensor that can detect a closed state of the hood/trunk upon contact between a first contact on the hood/trunk side and a second contact on the vehicle 10001 side.

The CPU 71 can determine whether or not the hood/trunk installed on the vehicle 10001 is in an open state based on the detection result of the open/closed sensors received from the hood sensor device 10083 and the trunk sensor device 10084. Then, when the hood or the trunk installed on the vehicle 10001 is in an open state, it can be determined that a prescribed fault state is occurring at the vehicle 10001.

The inter-vehicular distance sensor device 10085 is a device for detecting an inter-vehicular distance between the vehicle 10001 and other vehicle traveling ahead (the side pointed by the arrow FWD in FIG. 59) (vehicle ahead), and providing the detection result to the CPU 71. The inter-vehicular distance sensor device 10085 includes an inter-vehicular distance sensor (not shown) that detects the inter-vehicular distance between the vehicle 10001 and the other vehicle (vehicle ahead), and processing circuitry (not shown) that processes the detection result of the inter-vehicular distance sensor and providing the processed result to the CPU 71.

In the present embodiment, the inter-vehicular distance sensor is structured with a radar that detects an inter-vehicular distance between the vehicle 10001 and other vehicle (vehicle ahead) by transmitting a millimeter wave or laser and measuring the reflected wave from the other vehicle (vehicle ahead), and is installed on the front side (the side pointed by the arrow FWD in FIG. 59) of the vehicle 10001.

Based on the detection result (inter-vehicular distance) of the inter-vehicular distance sensor received from the inter-vehicular distance sensor device 10085, the CPU 71 can determine whether or not an inter-vehicular distance between the vehicle 10001 and other vehicle (vehicle ahead) traveling ahead (the side pointed by the arrow FWD in FIG. 59) is short (whether or not it is equal to or shorter than a prescribed distance). When the inter-vehicular distance between the vehicle 10001 and the other vehicle (vehicle ahead) is short (it is shorter than a prescribed distance), it can be determined that a prescribed fault state is occurring at the vehicle 10001.

An example of other input/output devices 10036 shown in FIG. 60 is an optical sensor that measures an attitude (such as inclination) of the vehicle 10001 (body frame BF) relative to the road surface in a noncontact manner.

Next, referring to FIG. 61, a description is given of the camber control process. FIG. 61 is a flow chart showing the camber control process. The process is intended to adjust the camber angle of the wheels 2FL to 2RR in the negative direction when a fault occurs at the vehicle 10001, and to adjust the camber angle of the wheels 2FL to 2RR to 0 degrees when the fault occurs at the vehicle 10001 is resolved. The process is repeatedly executed by the CPU 71 (for example, at 0.2 ins intervals) while the control device 10100 is powered on.

In connection with the camber control process, the CPU 71 first determines whether or not the vehicle fault flag 10073a stored in the RAM 10073 is “0” (S10001). As a result, when it is determined that the vehicle fault flag 10073a is “0” (S10001: Yes), it means that the vehicle 10001 is not in a prescribed fault state. Accordingly, the control proceeds to the process in step S10002, and whether or not a prescribed fault state is occurring at the vehicle 10001 is determined in the processes in steps S10002 to S10005.

In the process in step S10002, whether or not any one of the doors installed on the vehicle 10001 is in an open state is determined, based on the detection result of the door sensor device 10082 (the door sensors 10082FL to 10082RR) (S10002). As a result, when it is determined that any door is in an open state (S10002: Yes), it is determined that a prescribed fault state is occurring at the vehicle 10001, and the control proceeds to the process in step S10006.

On the other hand, when the process in step S10002 results in a determination that none of the doors is in an open state (S10002: No), subsequently, whether or not the hood installed on the vehicle 10001 is in an open state based on the detection result of the hood sensor device 10083 (S10003). As a result, when it is determined that the hood is in an open state (S10003: Yes), it is determined that a prescribed fault state is occurring at the vehicle 10001, and the control proceeds to the process in step S10006.

On the other hand, when the process in step S10003 results in a determination that the hood is not in an open state (S10003: No), subsequently, whether or not the trunk installed on the vehicle 10001 is in an open state is determined based on the detection result of the trunk sensor device 10084 (S10004). As a result, when it is determined that the trunk is in an open state (S10004: Yes), it is determined that a prescribed fault state is occurring at the vehicle 10001, and the control proceeds to the process in step S10006.

On the other hand, when the process in step S10004 results in a determination that the trunk is not in an open state (S10004: No), subsequently, whether or not an inter-vehicular distance between the vehicle 10001 and other vehicle (vehicle ahead) traveling ahead (the side pointed by the arrow FWD in FIG. 59) is short (shorter than a prescribed distance) is determined based on the detection result (the inter-vehicular distance from the other vehicle (vehicle ahead)) of the inter-vehicular distance sensor device 10085 (S10005). As a result, when it is determined that the inter-vehicular distance from the other vehicle (vehicle ahead) is short (shorter than a prescribed distance) (S10005: Yes), it is determined that a prescribed fault state is occurring at the vehicle 10001, and the control proceeds to the process in step S10006.

In the process in step S10006, the linkage driving device 7043 (the FL actuator 7043FL to RR actuator 7043RR) is controlled so that the camber angle is increased by 0.1 degrees in the negative direction for the wheels 2FL to 2RR (S10006). Thus, the camber angle is increased by 0.1 degrees in the negative direction for each of the wheels 2FL to 2RR, and therefore the ground contact ratio of the inner tread 21 is increased, whereas the ground contact ratio of the outer tread 22 is reduced. Accordingly, the wheels 2FL to 2RR are allowed to exert the high gripping performance derived from the soft property (low rubber hardness property) of the inner tread 21.

Subsequently, based on the detection result (wheel speed for each of wheels 2FL to 2RR) of the wheel speed sensor device 7081 (the FL wheel speed sensor 7081FL to the RR wheel speed sensor 7081RR), the slip rate for each of the wheels 2FL to 2RR is calculated (S10007). Then, whether every calculated slip rate for each of the wheels 2FL to 2RR falls within the slip rate range indicated by the prescribed friction slip rate 10072a of the EEPROM 10072 is determined (S10008).

As a result, when it is determined that not every calculated slip rate for each of the wheels 2FL to 2RR falls within the slip rate range indicated by the prescribed friction slip rate 10072a (S10008: No), it can be determined that the coefficient of friction between the road surface G and at least one of the wheels 2 is not equal to or higher than a prescribed level. Therefore, the control returns to the process in step S10006, and the linkage driving device 7043 (the FL actuator 7043FL to the RR actuator 7043RR) is controlled so that the camber angle of the wheels 2FL to 2RR is further increased by 0.1 degrees in the negative direction.

Thus, the ground contact ratio of the inner tread 21 of the wheels 2FL to 2RR is further increased, whereas the ground contact ratio of the outer tread 22 is further reduced. Accordingly, the wheels 2FL to 2RR are allowed to further exert the high gripping performance derived from the soft property (low rubber hardness property) of the inner tread 21.

Then, the processes in steps S10007 and S10008 are again performed. Until it is determined in the process in step S10008 that every slip rate for each of the wheels 2FL to 2RR calculated in the process in step S10007 falls within the slip rate range indicated by the prescribed friction slip rate 10072a (S10008: Yes), the processes in steps S10006 to S10008 are repeatedly performed.

In this manner, as the camber angle is adjusted for each of the wheels 2FL to 2RR so that the ground contact ratio of the inner tread 21 is increased, the effect of the soft property (low rubber hardness property) of the inner tread 21 can be increased, so as to allow the wheels 2FL to 2RR to exert the performance derived from the characteristic of the inner tread 21. As a result, the wheels 2FL to 2RR can attain high gripping performance, which serves to increase the braking performance of the vehicle 10001 when a fault occurs at the vehicle 10001.

Further, the coefficient of friction between the wheels 2FL to 2RR and the road surface G can surely be set to be equal to or higher than a prescribed level, because the camber angle at which the coefficient of friction between the road surface G and each of the wheels 2FL to 2RR becomes equal to or higher than a prescribed level is adjusted for each of the wheels 2FL to 2RR. Accordingly, the wheels 2FL to 2RR can attain the high gripping performance equal to or greater than a prescribed level, and the braking performance of the vehicle 10001 when a fault occurs at the vehicle 10001 can surely be enhanced.

When the process in step S10008 results in a determination that every slip rate for each of the wheels 2FL to 2RR calculated in the process in step S10007 falls within the slip rate range indicated by the prescribed friction slip rate 10072a (S10008: Yes), the vehicle fault flag 10073a in the RAM 10073 is set to “1” (S10009), and the camber control process ends. This allows the CPU 71 to determine that the vehicle 10001 is in a prescribed fault state when it executes the camber control process next time.

On the other hand, when the process in step S10005 results in a determination that the inter-vehicular distance from the other vehicle (vehicle ahead) is sufficient (equal to or longer than the prescribed distance) (S10005: No), which means that a prescribed fault state is not occurring at the vehicle 10001 and, accordingly, the processes in steps S10006 to S10009 are skipped, and the camber control process ends. Thus, because the camber angle is not applied in the negative direction to the wheels 2 (held at 0 degrees), it becomes possible to prevent an increase in the soft property (low rubber hardness property) of the inner tread 21 which will otherwise increase the rolling resistance and impair the fuel efficiency.

On the other hand, when the process in step S10001 results in a determination that the vehicle fault flag 10073a is not “0”, that is, it is “1” (S10001: No), which means that the vehicle 10001 is in a prescribed fault state and, accordingly, the control proceeds to the process in step S10010. In the processes in steps S10010 to S10013, whether or not the prescribed fault state occurred at the vehicle 10001 is resolved is determined.

In the process in step S10010, whether or not any one of the doors installed the vehicle 10001 is in an open state is determined based on the detection result of the door sensor device (the door sensors 10082FL to 10082RR) (S10010). As a result, when it is determined that any door is in an open state (S10010: Yes), it is determined that the prescribed fault state at the vehicle 10001 has not been resolved, and the camber control process ends.

In this manner, the camber angle applied to the wheels 2FL to 2RR in the processes in steps S10006 to S10008 is retained, and therefore, the wheels 2FL to 2RR is held in a state where the ground contact ratio of the inner tread 21 is high. Accordingly, the wheels 2FL to 2RR can retain the high gripping performance derived from the soft property (low rubber hardness property) of the inner tread 21.

On the other hand, when the process in step S10010 results in a determination that none of the doors are in an open state (S10010: No), subsequently, whether or not the hood installed on the vehicle 10001 is in an open state is determined based on the detection result of the hood sensor device 10083 (S10011). As a result, when it is determined that the hood is in an open state (S10011: Yes), it is determined that the prescribed fault state at the vehicle 10001 has not been resolved, and the camber control process ends.

In this manner, the camber angle applied to the wheels 2FL to 2RR is retained, and therefore, the wheels 2FL to 2RR can retain the high gripping performance derived from the soft property (low rubber hardness property) of the inner tread 21.

On the other hand, when the process in step S10011 results in a determination that the hood is not in an open state (S10011: No), subsequently, whether or not the trunk installed on the vehicle 10001 is in an open state is determined based on the detection result of the trunk sensor device 10084 (S10012). As a result, when it is determined that the trunk is in an open state (S10012: Yes), it is determined that the prescribed fault state at the vehicle 10001 has not been resolved, and the camber control process ends.

In this manner, the camber angle applied to the wheels 2FL to 2RR is retained, and therefore, the wheels 2FL to 2RR can retain the high gripping performance derived from the soft property (low rubber hardness property) of the inner tread 21.

On the other hand, when the process in step S10012 results in a determination that the trunk is not in an open state (S10012: No), subsequently, whether an inter-vehicular distance between the vehicle 10001 and other vehicle (vehicle ahead) traveling ahead (the side pointed by the arrow FWD in FIG. 59) the vehicle 10001 is short (shorter than a prescribed distance) is determined based on the detection result (the inter-vehicular distance from the other vehicle (vehicle ahead)) of the inter-vehicular distance sensor device 10085 (S10013). As a result, when it is determined that the inter-vehicular distance from the other vehicle (vehicle ahead) is short (shorter than a prescribed distance) (S10013: Yes), it is determined that the prescribed fault state at the vehicle 10001 has not been resolved, and the camber control process ends.

In this manner, the camber angle applied to the wheels 2FL to 2RR is retained, and therefore, the wheels 2FL to 2RR can retain the high gripping performance derived from the soft property (low rubber hardness property) of the inner tread 21.

On the other hand, when the process in step S10013 results in a determination that the inter-vehicular distance from the other vehicle (vehicle ahead) is sufficient (equal to or longer than the prescribed distance) (S10013: No), it is determined that the prescribed fault state at the vehicle 10001 has been resolved based on the results of the processes in steps S10010 to S10013, and the linkage driving device 7043 (7043FL to 7043RR) is controlled so that the camber angle is set to 0 degrees for each of the wheels 2FL to 2RR (S10014).

In this manner, as the camber angle of the wheels 2FL to 2RR can be set to 0 degrees, the ground contact ratio of the inner tread 21 can be reduced. Accordingly, because the effect of the soft property (low rubber hardness property) of the inner tread 21 can be reduced, the rolling resistance of the wheels 2FL to 2RR can be reduced. As a result, when there are no fault states, it becomes possible to suppress a reduction in the fuel efficiency to improve the fuel efficiency performance. Further, the camber thrust is not generated at the wheels 2FL to 2RR because the camber angle of the wheels 2 is adjusted to 0 degrees, and therefore, a commensurate further improvement in the fuel efficiency performance can be achieved.

Next, the vehicle fault flag 10073a in the RAM 10073 is set to “0” (S10015), and the camber control process ends. This allows the CPU 71 to determine that the condition of the vehicle 10001 is not in a prescribed fault state when it executes the camber control process next time.

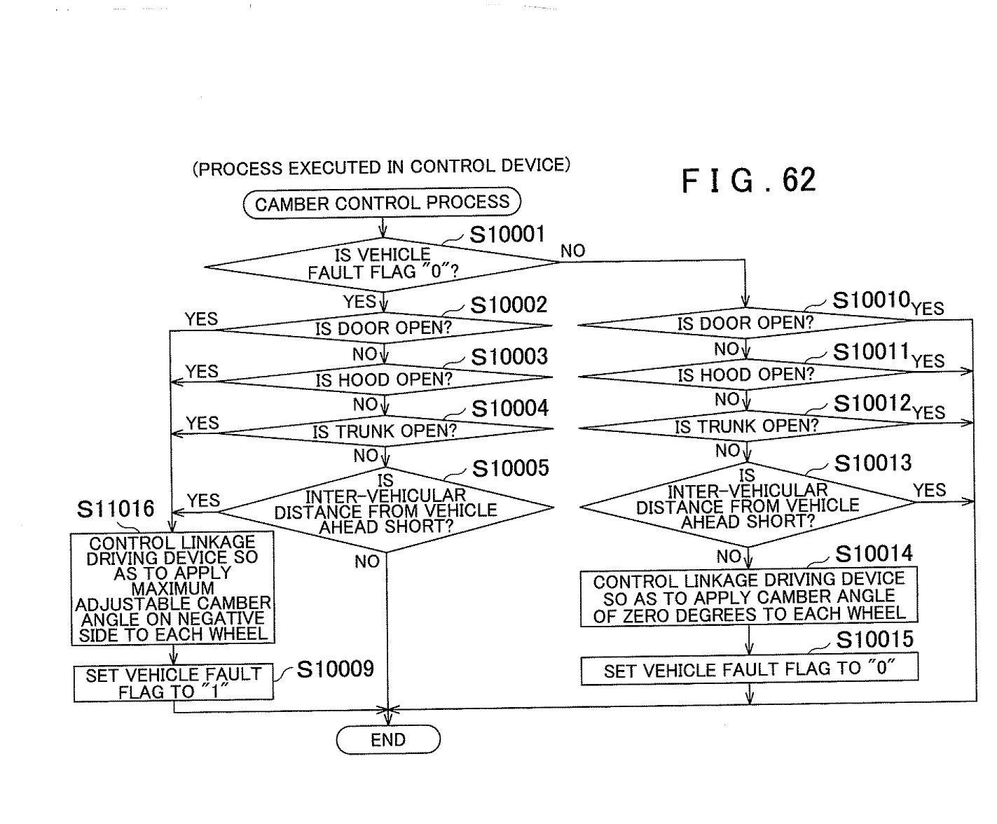

Next, referring to FIG. 62, a description is given of an eleventh embodiment. In the tenth embodiment, the description has been given of a case in which, when a prescribed fault state is occurring at the vehicle 10001, the camber angle for each of the wheels 2FL to 2RR is adjusted so that the coefficient of friction between every one of the wheels 2FL to 2RR and the road surface G becomes equal to or higher than a prescribed level. Whereas in the eleventh embodiment, the camber angle of the wheels 2FL to 2RR is adjusted so as to be the maximum adjustable angle in the negative direction.

In the present embodiment, the description is given on the precondition that the vehicle 10001 (refer to FIG. 59), the suspension device 7004 (refer to FIGS. 2 and 3), the wheels 2 (refer to FIGS. 4 to 6), and the control device 10100 (refer to FIG. 60) are similarly structured as in the tenth embodiment. The same reference numerals are used for the same parts, and the description thereof is not repeated.

The present embodiment is different from the tenth embodiment in that, in the EEPROM 10072 of the control device 10100 (refer to FIG. 60), a program for executing a camber control process (refer to FIG. 62) according to the eleventh embodiment is stored, in place of the camber control process (refer to FIG. 61) of the tenth embodiment. It is to be noted that, in the EEPROM 10072, the prescribed friction slip rate 10072a may not necessarily be stored.

FIG. 62 is a flow chart showing the camber control process of the eleventh embodiment. The process is, similarly to the camber control process of the tenth embodiment (refer to FIG. 61), repeatedly executed by the CPU 71 (for example, at 0.2 ins intervals) while the control device 10100 is powered on.

The camber control process is different from the camber control device of the tenth embodiment (refer to FIG. 61) in that, when it is determined that the vehicle fault flag 10073a is “0” (S10001: Yes), that is, when the vehicle 10001 is not in a prescribed fault state, if: it is determined that any door installed on the vehicle 10001 is in an open state (S10002: Yes); it is determined that the hood is in an open state (S10003: Yes); it is determined that the trunk is in an open state (S10004: Yes); or it is determined that inter-vehicular distance from other vehicle (vehicle ahead) is short (shorter than a prescribed distance) (S10005: Yes), then it is determined that a prescribed fault state is occurring at the vehicle 10001. Accordingly, the linkage control device 7043 (the FL actuator 7043FL to the RR actuator 7043RR) is controlled so that the camber angle for each of the wheels 2FL to 2RR becomes the maximum adjustable angle in the negative direction (S11016), and the control proceeds to the process in step S10010.

In this manner, the adjustment of the camber angle is carried out so as to attain the camber angle in the negative direction applied to each of the wheels 2FL to 2RR, and therefore, the ground contact ratio of the inner tread 21 is increased. Accordingly, the effect of the soft property (low rubber hardness property) of the inner tread 21 can be increased, so as to allow the wheels 2FL to 2RR to exert the performance derived by the characteristic of the inner tread 21. As a result, the wheels 2FL to 2RR can attain high gripping performance, which serves to increase the braking performance of the vehicle 10001 when a fault occurs at the vehicle 10001.

Further, the ground contact ratio of the inner tread 21 of each of the wheels 2FL to 2RR is as maximized as possible, because the camber angle is adjusted to be the maximum adjustable angle in the negative direction for each of the wheels 2FL to 2RR. In this manner, owing to the effect of soft property (low rubber hardness property) of the second tread, the wheels 2FL to 2RR can attain the highest possible gripping performance. Accordingly, the braking performance of the vehicle 10001 when a fault occurs at the vehicle 10001 is as maximized as possible.

Still further, the control can be simplified because the linkage driving device is just controlled so that the camber angle for each of the wheels 2FL to 2RR becomes the maximum adjustable angle. Accordingly, the control load can be reduced.

The rest of the processes (the processes in steps S10001 to S10005, S10009 to S10015) can be carried out similarly as in the camber control process of the tenth embodiment, and the same result and effect can be obtained.

While the present invention has been described based on the embodiments above, the present invention is not limited in any way by the embodiments described above, and it will be appreciated that various modifications and alterations can be made without departing from the spirit and scope of the present invention.

For example, all the values mentioned in the embodiments described above are only exemplary, and other values may obviously be adopted. Further, it will be understood that a part or the whole of the structure of one embodiment described above may obviously be combined with a part or the whole of the structure of another embodiment.

In the embodiments, the parameter of the coefficient of friction map 72a (horizontal axis) is exemplified with the depression amount of the acceleration pedal 52 or the brake pedal 53. The present invention is not limited thereto, and other quantity of state may be used as the parameter. As for the other quantity of state, for example, an operating velocity of the acceleration pedal 52 or the brake pedal 53 may be used.

In the embodiments, on the coefficient of friction map 72a, the changes of the required fore-and-aft coefficient of friction with respect to the depression amount of the acceleration pedal 52 and the changes of the required fore-and-aft coefficient of friction with respect to the depression amount of the brake pedal 53 are configured to change in the same manner (refer to FIG. 4). Such configuration is merely an example, and other configuration may obviously be utilized.

For example, the maximum value of the required fore-and-aft coefficient of friction at 100% of the depression amount of the acceleration pedal 52 and the maximum value of the required fore-and-aft coefficient of friction at 100% of the depression amount of the brake pedal 53 may be different. Further, while the required fore-and-aft coefficient of friction is illustrated to change linearly with respect to the changes of the depression amount of each of the pedals 52 and 53, such changes may change in a curve.

In the embodiments, the vehicular control device 100 has a single coefficient of friction map 72a. The present invention is not limited thereto, and a plurality of coefficient of friction maps may be provided.

For example, with a plurality of coefficient of friction maps with different contents corresponding to conditions of the road surface (e.g., three maps of a dry paved road map, an unpaved road map, and a wet paved road map corresponding to the operating state of the road surface condition switch 55) prepared, in step S3 shown in FIG. 9A, it may be configured to read out the required fore-and-aft coefficient of friction from the map corresponding to the operating state of the road surface condition switch 55.

In the embodiments, the parameter of the coefficient of friction map 4072a (horizontal axis) is exemplified with the depression amount of the acceleration pedal 52 or the brake pedal 53. The present invention is not limited thereto, and other quantity of state may be used for the parameter. As for the other quantity of state, for example, an operating velocity of the acceleration pedal 52 or the brake pedal 53 may be used.

In the embodiments, on the coefficient of friction map 4072a, the changes of the required fore-and-aft coefficient of friction with respect to the depression amount of the acceleration pedal 52 and the changes of the required fore-and-aft coefficient of friction with respect to the depression amount of the brake pedal 53 are configured to change in the same manner (refer to FIG. 4). Such configuration is merely an example, and other configuration may obviously be utilized.

For example, the maximum value of the required fore-and-aft coefficient of friction at 100% of the depression amount of the acceleration pedal 52 and the maximum value of the required fore-and-aft coefficient of friction at 100% of the depression amount of the brake pedal 53 may be different. Further, while the required fore-and-aft coefficient of friction is described to change linearly with respect to the changes of the depression amount of each of the pedals 52 and 53, such changes may change in a curve.

In the embodiments, the vehicular control device has a single coefficient of friction map 4072a. The present invention is not limited thereto, and a plurality of coefficient of friction maps may be provided.

For example, with a plurality of coefficient of friction maps with different contents corresponding to the conditions of the road surface (e.g., three maps of a dry paved road map, an unpaved road map, and a wet paved road map corresponding to the operating state of the road surface condition switch 55) prepared, in step S4003 shown in FIG. 22, it may be configured to read out the required fore-and-aft coefficient of friction from the map corresponding to the operating state of the road surface condition switch 55.

In the embodiments, the first tread 21 or 5221 is arranged on the inner side of the vehicle 4001 or 5201, and the second tread 22 or the third tread 5223 is arranged on the outer side of the vehicle 4001 or 5201. However, the present invention is not limited to this positional relationship, and it may appropriately be changed for each of the wheels 2.

For example, the first tread 21 or 5221 may be arranged on the outer side of the vehicle 4001 or 5201, and the second tread 22 or the third tread 5223 may be arranged on the inner side of the vehicle 4001 or 5201; the first tread 21 or 5221 may be arranged on the outer side of the vehicle 4001 or 5201 for the front wheels, and the second tread 22 or the third tread 5223 may be arranged on the outer side of the vehicle 4001 or 5201 for the rear wheels; or the positional relationship may be different for each of the wheels 2.

In the embodiments, while the wheel 2 or 5202 is exemplified as one with two kinds of tread and one with three kinds of tread, these wheels 2 and 5202 may be combined. For example, the wheel 2 provided with two kinds of tread may be used for front wheels and the wheel 5202 provided with three kinds of tread may be used for rear wheels, and vice versa.

In the embodiments, the camber angles OL and OR applied to the left and right wheels 2 respectively are exemplified as the same (OL=OR). The present invention is not limited thereto, and the camber angles OL and OR of different angles may be given to the left and right wheels 2 (OR<OL or OL<OR).

In the embodiments, the first tread 21 or 221 is arranged on the inner side of the vehicle and the second tread 22 is arranged on the outer side of the vehicle. The present invention is not limited to this positional relationship, and it may be appropriately changed for each of the wheels 2.

For example, the first tread 21 or 221 may be arranged on the outer side of the vehicle while the second tread 22 is arranged on the inner side of the vehicle, the first tread 21 or 221 may be arranged on the outer side of the vehicle for the front wheels while the second tread 22 is arranged on the inner side of the vehicle for the rear wheels, or the positional relationship may be different for each of the wheels 2.

In the embodiments, while a single wheel has two kinds of tread, the present invention is not limited thereto; and other configuration may be adopted. For example, two wheels each having a tread of different characteristics may be used combined in parallel (i.e., as so-called double tires).

In the embodiments, on the coefficient of friction map 6072a, it is described that the required fore-and-aft coefficient of friction changes linearly with respect to the operating amount of the brake (refer to FIG. 33). Such configuration is merely an example, and other configuration may be utilized. For example, such changes may obviously be in a curve.

In the embodiments, the vehicular control device 6100 has a single coefficient of friction map 6072a. The present invention is not limited thereto, and a plurality of coefficient of friction maps may be provided.

For example, with a plurality of coefficient of friction maps with different contents corresponding to the conditions of the road surface (e.g., three maps of a dry paved road map, an unpaved road map, and a wet paved road map corresponding to the operating ranges of the road surface condition switch) prepared, in step S6053 shown in FIG. 36A, it may be configured to read out the required fore-and-aft coefficient of friction from the map corresponding to the operating state of the road surface condition switch.

In the embodiments, the wheel driving mechanism 3 for rotary driving the wheel 2 is structured by the motor device. The drive source of the wheel 2 is not limited thereto, and other drive sources may be adopted. As for the other drive sources, for example, gasoline engines and diesel engines can be named. In these cases, the regenerative device (for regenerating the rotational energy of the wheel 2 to an electrical energy) according to claim 1 of the present invention corresponds to a so-called alternator.

In the embodiments, the left and right front wheels 2FL and 2FR are drive wheels and the left and right rear wheels 2RL and 2RR are trailing wheels. The present invention is not limited to this arrangement, and a reversed arrangement may be used.

In the embodiments, the inner tread 21 of the wheel 2 has a softer (lower rubber hardness) property than that of the outer tread 22. The present invention is not limited thereto, and the outer tread 22 may have a softer (lower rubber hardness) property than that of the inner tread 21. In this case, when it is judged that the vehicle 7001 is in a quick acceleration state, a quick braking state, or a quick turning state, or when it is judged that at least one of the wheels 2 is in a predetermined slip condition, by adjusting the camber angle in the positive direction for the wheel 2, the performance (high gripping performance) achieved by the soft (low rubber hardness) property of the outer tread 22 can be achieved.

In the embodiments, the wheel 2 is structured to have two kinds of tread, i.e., the inner tread 21 and the outer tread 22. The present invention is not limited thereto, and in addition to the inner tread 21 and the outer tread 22, a third tread that has different characteristics from those of the inner tread 21 and the outer tread 22 may be provided. In this case, with the third tread structured to have a softer property than that of the inner tread 21, by arranging the third tread on the inner side of the vehicle 7001 than the inner tread 21, when it is judged that at least one of the wheels 2 is in a predetermined slip condition, the wheel 2 that is judged to be in the predetermined slip condition can further achieve a higher gripping performance.

In the embodiments, when it is judged that the vehicle 7001 is in a quick acceleration state, a quick braking state, or a quick turning state, or when it is judged that at least one of the wheels 2 is in a predetermined slip condition, the linkage driving device 7043 (FL-RR actuators 7043FL to 7043RR) is controlled such that a predetermined camber angle in the negative direction is applied to all or any of the wheels 2. In this case, however, the linkage driving device 7043 (FL-RR actuators 7043FL to 7043RR) may be controlled such that a maximum camber angle adjustable in the negative direction is applied to all or any of the wheels 2. Consequently, the ground contact ratio of the inner tread 21 can be maximized and the wheel 2 that is applied with the maximum camber angle adjustable in the negative direction can obtain the highest gripping performance possible. Furthermore, the maximum camber thrust is generated on the wheel 2, thereby further enhancing its gripping force.

In the embodiments, when it is judged that a predetermined slip condition of the wheel 2 is suppressed (or resolved), the linkage driving device 7043 (FL-RR actuators 7043FL to 7043RR) is controlled such that the camber angle of each of the wheels 2FL to 2RR comes to 0 degrees. The present invention is not limited thereto, and the linkage driving device 7043 (FL-RR actuators 7043FL to 7043RR) may be controlled such that the camber angle comes to a predetermined default value on the side where the ground contact ratio of the inner tread 21 is lowered.

For example, the linkage driving device 7043 (FL-RR actuators 7043FL to 7043RR) may be controlled such that the camber angle of each of the wheels 2FL to 2RR adjusted in the negative direction is reduced to a predetermined angle (default value). Further, the linkage driving device 7043 may be controlled such that the camber angle of each of the wheels 2FL to 2RR is adjusted to a camber angle (default value) in the positive direction. Accordingly, when the predetermined slip condition of the wheel 2 is suppressed (or resolved), the influence of the soft property (low rubber hardness property) of the inner tread 21 can be reduced. Consequently, the camber angle of each of the wheels 2FL to 2RR can make the rolling resistance of the wheel 2 small, thereby enhancing fuel efficiency.

In the seventh embodiment, while the linkage driving device 7043 (FL-RR actuators 7043FL to 7043RR) is controlled such that the predetermined camber angle in the negative direction is applied to the wheels 2 in the predetermined slip condition, the present invention is not limited thereto. For example, when the predetermined slip condition occurs with either one of the left and right front wheels 2FL and 2RR, the linkage driving device 7043 (FL and FR actuators 7043FL and 7043FR) may be controlled such that a predetermined camber angle in the negative direction is applied to both the left and right front wheels 2FL and 2RR.

Further, when the predetermined slip condition occurs with either one of the left or right rear wheels 2RL and 2RR, the linkage driving device 7043 (RL and RR actuators 7043RL and 7043RR) may be controlled such that a predetermined camber angle in the negative direction is applied to both the left and right rear wheels 2RL and 2RR.

Furthermore, when the predetermined slip condition occurs with any of the wheels 2FL to 2RR, the linkage driving device 7043 (FL-RR actuators 7043FL to 7043RR) may be controlled such that a predetermined camber angle in the negative direction is applied to all of the wheels 2FL to 2RR. Accordingly, the straight-line stability of the vehicle 7001 can be maintained because the camber thrust generated on the wheels 2 balances out between the left wheels 2FL and 2RL and the right wheels 2FR and 2RR.

In the seventh embodiment, the estimated vehicle body speed (vehicle speed) of the vehicle 7001 is calculated from the detection results (wheel speed of each of the wheels 2FL to 2RR) of the wheel speed sensor device 7081 (wheel speed sensors 7081 FL to 7081 RR), the respective slip ratios of each of the wheels 2FL to 2RR is calculated based on the estimated wheel speed and the wheel speed of each of the wheels 2FL to 2RR, and the slip ratios of the respective wheels 2FL to 2RR are then compared with each other so as to judge whether or not the wheel 2 that is in the predetermined slip condition exists. The present invention is not limited thereto, and for example, when the wheel speed of each of the wheels 2FL to 2RR based on the detection results (wheel speed of each of the wheels 2FL to 2RR) of the wheel speed sensor device 7081 (wheel speed sensors 7081 FL to 7081 RR) is compared with each other and there exists a wheel of an abnormally large wheel speed, it may be judged that a predetermined slip condition occurs with that wheel. Consequently, it can simplify the control, thereby reducing the control load.

In the eighth embodiment, the estimated speed of the vehicle 7001 (vehicle speed) is calculated from the detection results (wheel speed of each of the wheels 2FL to 2RR) of the wheel speed sensor device 7081 (wheel speed sensors 7081FL to 7081RR) and the estimated values of yaw rate and lateral acceleration are then calculated. The present invention is not limited thereto, and the estimated values of yaw rate and lateral acceleration may be calculated by obtaining the respective speeds in two directions (fore-and-aft direction and side-to-side direction) by time integrating the detection results (acceleration) of the acceleration sensor device 31 (fore-and-aft acceleration sensor 31a and side-to-side acceleration sensor 31b), and then by calculating the estimated speed of the vehicle 7001 (vehicle speed) by combining those velocity components in two directions.

In the ninth embodiment, when it is judged that the lateral acceleration of the vehicle 9001 exceeds the controllable range of each of the actuators 9043FL to 9043RR, the control of each of the actuators 9043FL to 9043RR is turned off. The criterion of turning off the control of each of the actuators 9043FL to 9043RR is not limited to the lateral acceleration, and the values indicative of the moment generated on the camber axis 9044, such as a centrifugal force F1 and a lateral force F2, or the moment estimated by those values may be used. Alternatively, by measuring the moment generated on the camber axis 9044, the measured value may be used.

In the ninth embodiment, the camber angle applied to the wheel 9002 is restricted by using the stoppers 9071a and 9071b of the slider 9071. The structure to restrict the variable range of the camber angle may be structured by restricting the amount of expansion and contraction of the actuators 9043FL to 9043RR, or by mechanically restricting the movable angle between the first arm 9042a and the third arm 9042c of the link mechanism. Furthermore, while the stoppers 9071a and 9071b is exemplified to restrict the movable range of the third arm 9042c of the link mechanism, the installation position thereof can appropriately be changed.

In the ninth embodiment, the camber angle is applied to the wheel 9002 by the link mechanism (camber changeable mechanism) of the suspension system 9004. It may be configured to apply the camber angle by other mechanism that includes an actuator as an operating source.

Additionally, in the ninth embodiment, because of the structure of the link mechanism, the camber axis 9044 is eccentrically located on the road surface G side of the wheel 9002. However, the location of the camber axis is not limited thereto, and it the camber axis located, for example, in the center of the wheel 9002 in its height direction is also applicable.

In the ninth embodiment, the left and right front wheels (9002FL and 9002FR) are rotary driven by the wheel driving mechanism 7003. However, the present invention is applicable to vehicles regardless of the structure of their wheel driving mechanisms as long as the vehicles are capable of applying a camber angle to their wheels. For example, the present invention is applicable to a vehicle having a wheel motor or an engine as a wheel driving mechanism as long as the vehicle is capable of applying a camber angle to their wheels.

In the tenth embodiment and the eleventh embodiment, the presence or absence of a predetermined abnormal condition is judged according to the open-close conditions of the door, the hood and the trunk installed on the vehicle 10001 and the inter-vehicle distance to another vehicle (a vehicle ahead). The present invention is not limited thereto, and for example, various conditions of the vehicle 10001 that are detectable by the vehicle 10001, such as the temperature of engine coolant and the temperature of exhaust gas, may be used to judge the presence or absence of an abnormal condition.

In the tenth embodiment and the eleventh embodiment, the inner tread 21 of the wheel 2 has a softer (lower rubber hardness) property than that of the outer tread 22. The present invention is not limited thereto, and the outer tread 22 may have a softer (lower rubber hardness) property than that of the inner tread 21. In this case, when a predetermined abnormal condition occurs with the vehicle 10001, by adjusting the camber angle in the positive direction for the wheel 2, the performance (high gripping performance) achieved by the soft (low rubber hardness) property of the outer tread 22 can be achieved.

In the tenth embodiment and the eleventh embodiment, the wheel 2 is structured to have two kinds of tread, i.e., the inner tread 21 and the outer tread 22. The present invention is not limited thereto, and in addition to the inner tread 21 and the outer tread 22, the wheel 2 may be provided with a third tread that has different characteristics from those of the inner tread 21 and the outer tread 22. In this case, when the third tread is structured to have a softer property than that of the inner tread 21, by arranging such third tread on the inner side of the vehicle 10001 than the inner tread 21, the braking performance of the vehicle 10001 can be enhanced when the abnormality occurs with the vehicle 10001.

In the tenth embodiment, in the predetermined friction slip ratio 10072a, the range of the slip ratio of the wheel 2 that makes the coefficient of friction between the wheel 2 and the road surface G equal to or higher than a predetermined level is stored. The present invention is not limited thereto, and the range of the slip ratio of the wheel 2 that makes the coefficient of friction between the wheel 2 and the road surface G higher than the predetermined level may be stored.

Further, in the predetermined friction slip ratio 10072a, it may be configured to store the range of the slip ratio of the wheel 2 that makes the coefficient of friction between the wheel 2 and the road surface G becomes a practical maximum coefficient of friction. Here, the coefficient of friction that becomes the practical maximum coefficient of friction means, for example, a coefficient of friction whose difference from the maximum coefficient of friction is within 5%. Accordingly, because the coefficient of friction between the wheel 2 and the road surface G can be ensured to be the maximum coefficient of friction (i.e., a coefficient of friction whose difference from the maximum coefficient of friction is within 5%), the wheel 2 can obtain the highest gripping performance. Consequently, the braking performance of the vehicle 10001 can be maximized when an abnormality occurs with the vehicle 10001.

In the tenth embodiment, the linkage driving device 7043 (FL-RR actuators 7043FL to 7043RR) is controlled to increase the camber angle in the negative direction by the amount of 0.1 degrees for each of the wheels 2FL to 2RR until all of the slip ratios of the wheels 2FL to 2RR are judged to be within the range of slip ratio indicated in the predetermined friction slip ratio 10072a (refer to steps S10006 to S10008 shown in FIG. 61). However, the present invention is not limited thereto, and the linkage driving device 7043 (FL-RR actuators 7043FL to 7043RR) may be controlled to increase the camber angle in the negative direction by the amount of 0.1 degrees for each of the wheels 2FL to 2RR until the slip ratio of the wheel 2 of at least one of the wheels 2FL to 2RR is judged to be within the range of slip ratio indicated in the predetermined friction slip ratio 10072a. Alternatively, the linkage driving device 7043 (FL-RR actuators 7043FL to 7043RR) may be controlled to increase the camber angle in the negative direction by the amount of 0.1 degrees for each of the wheels 2FL to 2RR until the slip ratios of the left and right front wheels 2FL and 2RR (or left and right rear wheels 2RL and 2RR) are both judged to be within the range of slip ratio indicated in the predetermined friction slip ratio 10072a.

In the eleventh embodiment, when it is judged that a predetermined abnormal condition occurs from the detection results of each of the sensor devices 10082 to 10085 (condition of the vehicle 10001) while being judged that the vehicle 10001 is not in the predetermined abnormal condition, the linkage driving device 7043 is controlled to make the camber angle of each of the wheels 2FL to 2RR set to the maximum adjustable angle in the negative direction. The present invention is not limited thereto, and for example, the linkage driving device 7043 may be controlled to make the camber angle of each of the wheels 2FL to 2RR set to a predetermined angle in the negative direction. In this case, the predetermined angle may be designed at designing stage and stored in the EEPROM 10072 in advance so that the ground contact ratio of the inner tread 21 comes to a desired ground contact ratio when a predetermined abnormal condition occurs with the vehicle 10001. Accordingly, when the predetermined abnormal condition occurs with the vehicle 10001, the ground contact ratio of the inner tread 21 can be set to a desired ground contact ratio. Consequently, by the effect of the soft property (low rubber hardness property) of the inner tread 21, the wheel 2 can obtain a desired gripping performance, thereby making the braking performance of the vehicle 10001 to a desired level when the abnormality occurs with the vehicle 10001. Further, because the linkage driving device 7043 is merely controlled such that the camber angle of the wheel 2 comes to a predetermined angle, the control can be simplified, whereby the control load can be reduced.

In the tenth embodiment and the eleventh embodiment, when it is judged that the predetermined abnormal condition is resolved from the detection results of each of the sensor devices 10082 to 10085 (condition of the vehicle 10001) while being judged that the vehicle 10001 is in the predetermined abnormal condition, the linkage driving device 7043 is controlled such that the camber angle of each of the wheels 2FL to 2RR comes to 0 degrees. The present invention is not limited thereto, and for example, the linkage driving device 7043 may be controlled such that the ground contact ratio of the inner tread 21 of each of the wheels 2FL to 2RR is reduced. In this case, the linkage driving device 7043 may be controlled such that the camber angle of each of the wheels 2FL to 2RR adjusted in the negative direction is reduced, or the linkage driving device 7043 may be controlled to set the camber angle of each of the wheels 2FL to 2RR in the positive direction. Accordingly, when the predetermined abnormal condition is resolved, the influence of the soft property (low rubber hardness property) of the inner tread 21 can be made small. Consequently, the camber angle of each of the wheels 2FL to 2RR can make the rolling resistance small and improve fuel efficiency.

In addition, it will be appreciated that a modification example of one embodiment out of the above-described embodiments can be applied to another embodiment of the above-described embodiments. In this case, a plurality of modification examples of the embodiments may be combined.

Modification examples D according to the present invention will be described below. Patent Document 1D discloses a technology in that, by setting the camber angle of the wheel (the angle made by the center line of the wheel and the road surface of travel) in the negative direction (on the negative camber side), the performance of a tire is fully brought out so as to ensure the turning performance of the vehicle. This is because, when the camber angle is set, for example, at 0 degrees, the wheel floats above the road surface as the vehicle body rolls while it is turning, and the gripping force of the tire cannot be fully achieved. Therefore, by setting the camber angle in the negative direction in advance to prevent the wheel from floating, the gripping force of the tire can be fully achieved, thereby ensuring the turning performance of the vehicle.

When the camber angle of the wheel is set in the negative direction, as the ground contact of the inner side of the wheel increases while traveling straight, it is not economical because the tire wears out unevenly. Therefore, Patent Document 2D discloses a technology in that, as a structure of the tire that is advantageous when setting the camber angle in the negative direction, one side of the side portion of the tire is reinforced to be stronger than the other side of the side portion and, by dividing the tread rubber into two, the hardness of one side of the tread rubber is made lower than that of the other in order to ensure wear resistance and high gripping property. Patent Document 1D: Japanese Patent Application Publication No. JP-A-5-65010, Patent Document 2D: Japanese Patent Application Publication No. JP-A-2-185802

However, in the former technology, when the camber angle of the wheel is set in the negative direction, there have been problems in that, while ensuring the turning performance, the rolling resistance of the wheel becomes large and the fuel efficiency of the vehicle is lowered. In the latter technology, while the wear resistance of the wheel and the turning performance of the vehicle can be ensured, there has been a problem in that it is inadequate to achieve fuel saving with the vehicle.

In view of the problems, an object of the modification examples D of the present invention is to provide a camber angle controlling device that can achieve fuel saving performance while ensuring the turning performance of the vehicle.

A camber angle controlling device D1 used for a vehicle provided with a wheel structured to have at least a first tread and a second tread provided in parallel in the width direction thereof with the first tread having a higher gripping force property than that of the second tread and with the second tread having a lower rolling resistance property than that of the first tread, and a camber angle applying device for applying a camber angle to the wheel, is characterized by including turn request detecting means used for detecting a turn request of a driver, and camber angle changing means that controls the camber angle applying device to apply a camber angle to the wheel so as to change ground contact ratios of the first tread and the second tread of the wheel when the turn request is detected by the turn request detecting means, in which the camber angle changing means changes the respective ground contact ratios of an outer wheel during turning and an inner wheel during turning.

With the camber angle controlling device D1, when the camber angle applying device is controlled by the camber angle changing means such that a camber angle in the negative direction (on the negative camber side) is applied to the wheel, the ground contact (contact pressure or contact area) of the tread arranged on the inner side of the vehicle (first tread or second tread) is increased, while the ground contact (contact pressure or contact area) of the tread arranged on the outer side of the vehicle (second tread or first tread) is decreased.

By contrast, when a camber angle in the positive direction (on the positive camber side) is applied to the wheel, the ground contact (contact pressure or contact area) of the tread arranged on the inner side of the vehicle (first tread or second tread) is decreased, while the ground contact (contact pressure or contact area) of the tread arranged on the outer side of the vehicle (second tread or first tread) is increased.

Therefore, with the camber angle controlling device of the present invention, by applying the camber angle to the wheel with the camber angle applying device controlled by the camber angle changing means, the ground contact ratios of the first tread and the second tread of the wheel can be changed and the performance achieved by the characteristics of the first tread and the performance achieved by the characteristics of the second tread can selectively be utilized.

The wheel of the vehicle in which, the camber angle controlling device of the present invention is used is structured with the first tread having a higher gripping force property (high gripping property) than that of the second tread and with the second tread having a smaller rolling resistance property (a low rolling resistance) than that of the first tread. Accordingly, by changing the ground contact ratios of the first tread and the second tread of the wheel, the high gripping property of the first tread and the low rolling resistance of the second tread can selectively be used so as to ensure the running performance (such as turning performance, acceleration performance, and braking performance) of the vehicle while achieving the fuel saving performance.

Further, with the camber angle controlling device of the present invention, because the turn request of the driver is detected by the turn request detecting means and, when the turn request is detected, the ground contact ratios of the first tread and the second tread are changed, the high gripping property of the first tread can be obtained in line with the timing of the turn. Accordingly, the turning performance can surely be ensured.

Furthermore, with the camber angle controlling device of the present invention, because the camber angle changing means changes the ground contact ratio of the outer wheel during turning and the ground contact ratio of the inner wheel during turning, the ground contact ratio of the outer wheel during turning and the ground contact ratio of the inner wheel during turning can be changed appropriately corresponding to the degree of the turn compared with a case where the ground contact ratios of the outer wheel during turning and the inner wheel during turning are constant. Accordingly, the turning performance and the fuel saving performance can be improved.

A camber angle controlling device D2 is characterized in that the camber angle controlling device D1 further includes required coefficient of friction calculating means that calculates a required coefficient of friction necessary between the wheel and the road surface based on the running condition of the vehicle, in which the camber angle changing means changes the ground contact ratio based on the required coefficient of friction.

With the camber angle controlling device D2, in addition to the advantages of the camber angle controlling device D1, because the required coefficient of friction calculating means that calculates the required coefficient of friction necessary between the wheel and the road surface based on the running condition of the vehicle is provided and the camber angle changing means changes the ground contact ratio based on the required coefficient of friction calculated by the required coefficient of friction calculating means, the wheel can be prevented from slipping. Consequently, the deterioration of fuel efficiency associated with the slip of the wheel can be suppressed and the fuel saving performance can be enhanced. At the same time, the turning performance can be improved.

A camber angle controlling device D3 is characterized in that the camber angle controlling device D2 further includes road surface condition detecting means used for detecting road surface condition, in which the required coefficient of friction calculating means calculates the required coefficient of friction based on the road surface condition.

With the camber angle controlling device D3, in addition to the advantages of the camber angle controlling device D2, because the road surface condition detecting means used for detecting road surface condition is provided and the required coefficient of friction calculating means calculates the required coefficient of friction based on the road surface condition determined by the road surface condition detecting means, the ground contact ratio can be changed corresponding to the road surface condition. Consequently, the slip of the wheel can surely be prevented and the fuel saving performance can further be enhanced. At the same time, the turning performance can further be improved.

A camber angle controlling device D4 is characterized in that the camber angle controlling device D2 or D3 further includes storing means that stores relationships of the camber angle with the coefficient of friction and rolling resistance of the wheel, in which the camber angle changing means obtains from the storing means a minimum coefficient of friction that is the minimum coefficient of friction the wheel can achieve and, when the required coefficient of friction is smaller than the minimum coefficient of friction, changes the ground contact ratios of the outer wheel during turning and the inner wheel during turning by obtaining from the storing means the camber angle that minimizes the rolling resistance and by applying the camber angle obtained to the outer wheel during turning and the inner wheel during turning.

With the camber angle controlling device D4, in addition to the advantages of the camber angle controlling device D3, because the storing means that stores the relationships of the camber angle with the coefficient of friction and rolling resistance of the wheel is provided, and the camber angle changing means obtains from the storing means the minimum coefficient of friction that is the minimum coefficient of friction the wheel can achieve and, when the required coefficient of friction is smaller than the minimum coefficient of friction, changes the ground contact ratios of the outer wheel during turning and the inner wheel during turning by obtaining from the storing means the camber angle that minimizes the rolling resistance and by applying the camber angle obtained to the outer wheel during turning and the inner wheel during turning, the running resistance can be reduced. Accordingly, the fuel saving performance can be improved.

A camber angle controlling device D5 is characterized in that, in the camber angle controlling device D4, the camber angle changing means obtains from the storing means a maximum coefficient of friction that is the maximum coefficient of friction the wheel can achieve and, when the required coefficient of friction is larger than the maximum coefficient of friction, changes the ground contact ratios of the outer wheel during turning and the inner wheel during turning by obtaining from the storing means the camber angle that makes the rolling resistance smaller while retaining the maximum coefficient of friction and by applying the camber angle obtained to the outer wheel during turning and the inner wheel during turning.

With the camber angle controlling device D5, in addition to the advantages of the camber angle controlling device D4, because the camber angle changing means obtains from the storing means the maximum coefficient of friction that is the maximum coefficient of friction the wheel can achieve and, when the required coefficient of friction is larger than the maximum coefficient of friction, changes the ground contact ratios of the outer wheel during turning and the inner wheel during turning by obtaining from the storing means the camber angle that makes the rolling resistance smaller while retaining the maximum coefficient of friction and by applying the camber angle obtained to the outer wheel during turning and the inner wheel during turning, the running resistance can be reduced while preventing the rolling resistance of the wheel from becoming unnecessarily large. Accordingly, the fuel saving performance can be improved.

A camber angle controlling device D6 is characterized in that, in the camber angle controlling device D4 or D5, when the required coefficient of friction is equal to or larger than the minimum coefficient of friction and equal to or smaller than the maximum coefficient of friction, the camber angle changing means changes the ground contact ratio of the outer wheel during turning by obtaining from the storing means the camber angle that ensures the required coefficient of friction and by applying the camber angle obtained to the outer wheel during turning, and changes the ground contact ratio of the inner wheel during turning by obtaining from the storing means the camber angle that minimizes the rolling resistance and by applying the camber angle obtained to the inner wheel during turning.

With the camber angle controlling device D6, in addition to the advantages of the camber angle controlling device D4 or D5, the camber angle changing means changes, when the required coefficient of friction is equal to or larger than the minimum coefficient of friction and equal to or smaller than the maximum coefficient of friction, the ground contact ratio of the outer wheel during turning by obtaining from the storing means the camber angle that ensures the required coefficient of friction and by applying the camber angle obtained to the outer wheel during turning, and changes the ground contact ratio of the inner wheel during turning by obtaining from the storing means the camber angle that minimizes the rolling resistance and by applying the camber angle obtained to the inner wheel during turning This configuration makes the outer wheel during turning achieve a minimum required coefficient of friction, and prevents it from slipping while reducing the running resistance of the inner wheel during turning.

Consequently, the running resistances of the outer wheel during turning and the inner wheel during turning can be reduced while adequately ensuring the turning performance of the vehicle. Accordingly, the fuel saving performance can be improved.

More specifically, because the vehicle rolls while turning, in general, the required coefficient of friction necessary for the inner wheel during turning becomes extremely small compared with the required coefficient of friction necessary for the outer wheel during turning. Therefore, when the ground contact ratio of the inner wheel during turning and the ground contact ratio of the outer wheel during turning are equal, the coefficient of friction achieved by the inner wheel during turning becomes unnecessarily large, thereby increasing the running resistance accordingly and deteriorating fuel efficiency.

By contrast, with the camber angle controlling device of the present invention, when the required coefficient of friction is equal to or larger than the minimum coefficient of friction and equal to or smaller than the maximum coefficient of friction, assuming the required coefficient of friction necessary for the inner wheel during turning is not as large as the required coefficient of friction necessary for the outer wheel during turning, by changing the ground contact ratio of the outer wheel during turning and the ground contact ratio of the inner wheel during turning as described above, the fuel saving performance can be improved.

A camber angle controlling device D7 is characterized in that, in any one of the camber angle controlling devices D4 to D6, the wheel is arranged with the second tread at the outermost side of the vehicle and, when the required coefficient of friction is equal to or larger than the minimum coefficient of friction and equal to or smaller than the maximum coefficient of friction, and the required coefficient of friction is larger than a predetermined value, the camber angle changing means changes the ground contact ratio of the outer wheel during turning by obtaining from the storing means the camber angle that ensures the required coefficient of friction and by applying the camber angle obtained to the outer wheel during turning, and changes the ground contact ratio of the inner wheel during turning by applying a camber angle in the positive direction to the inner wheel during turning.

With the camber angle controlling device D7, in addition to the advantages of the camber angle controlling device D6, the wheel is arranged with the second tread at the outermost side of the vehicle and, when the required coefficient of friction is equal to or larger than the minimum coefficient of friction and equal to or smaller than the maximum coefficient of friction and the required coefficient of friction is larger than the predetermined value, the camber angle changing means changes the ground contact ratio of the outer wheel during turning by obtaining from the storing means the camber angle that ensures the required coefficient of friction and by applying the camber angle obtained to the outer wheel during turning, and changes the ground contact ratio of the inner wheel during turning by applying the camber angle in the positive direction to the inner wheel during turning. This configuration makes the outer wheel during turning achieve the minimum required coefficient of friction and prevents it from slipping while reducing the running resistance of the inner wheel during turning and canting the inner wheel during turning towards inside of the turn.

Consequently, while ensuring an adequate turning performance of the vehicle, the running resistances of the outer wheel during turning and the inner wheel during turning can be reduced. Accordingly, the fuel saving performance can be improved. Further, by generating a camber thrust on the inner wheel during turning and utilizing such camber thrust as a turning force, the turning performance can be improved.

More specifically, with the camber angle controlling device of the present invention, when the required coefficient of friction is equal to larger than the minimum coefficient of friction and equal to or smaller than the maximum coefficient of friction and the required coefficient of friction is larger than the predetermined value, assuming the required coefficient of friction necessary for the inner wheel during turning is not as large as the required coefficient of friction necessary for the outer wheel during turning, by changing the ground contact ratio of the outer wheel during turning and the ground contact ratio of the inner wheel during turning as described above, the fuel saving performance can be improved.

Further, because the wheel is arranged with the second tread at the outermost side of the vehicle, by applying the camber angle in the positive direction (on the positive camber side) to the inner wheel during turning so as to change the ground contact ratio of the inner wheel during turning, the inner wheel during turning can be canted towards inside of the turn. Consequently, when it can be assumed that the required coefficient of friction necessary for the inner wheel during turning is not as large as the required coefficient of friction necessary for the outer wheel during turning while the required coefficient of friction is larger than the predetermined value and the degree of turn is great, the turning performance can be improved by utilizing the camber thrust as a turning force.

Additionally, in the flow chart (camber control process) of FIG. 22, the process in step S4004 represents the turn request detecting means and the process in step S4001 represents the road surface condition detecting means included in the camber angle controlling device D1. In the flow chart (turn control process) of FIG. 23, the processes in steps S4027, S4029, S4031 and S4032 represent the camber angle changing means and the process in step S4023 represents the required coefficient of friction calculating means included in the camber angle controlling device DI.

In the flow chart (camber control process) of FIG. 28, the process in step S5204 represents the turn request means and the process in step S5201 represents the road surface condition detecting means included in the camber angle controlling device D1. In the flow chart (turn control process) of FIG. 29, the processes in steps S5226, S5228 and S5229 represent the camber angle changing means and the process in step S5223 represents the required coefficient of friction calculating means included in the camber angle controlling device D1.

Modification examples F of the present invention will be described below. In a so-called electric vehicle or hybrid electric vehicle having an electric motor as a driving source, when decelerating, in general, the electric motor is operated in regenerative operation (operation of the electric motor being operated as a generator while the energy generated is being used to recharge a secondary battery (battery) that is the power supply of the electric motor). Accordingly, the kinetic energy of the vehicle in traveling is converted to an electric energy, and regenerative braking is performed utilizing the braking force obtained from the resistance incurred in this operation.

It is preferable that such regenerative braking be utilized preferentially because the regenerative braking is advantageous in enhancing fuel efficiency as the regenerative energy is recoverable. Therefore, Patent Document 1F, for example, discloses a technology in that, when the required braking force that is set according to an operating state of the brake pedal is smaller than a predetermined value, the regenerative braking alone is performed and, when the required braking force is larger than the predetermined value, a friction braking utilizing frictional force in combination is performed.

With the friction brake, if not used reasonably constantly, its friction engagement surface may rust and may lower the braking performance and cause vibrations and noises when the brake is applied. Therefore, Patent Document 2F, for example, discloses a technology in that, in order to maintain the friction engagement surface in a good condition, the friction braking is used reasonably while preferentially using the regenerative braking. Patent Document 1F: Japanese Patent Application Publication No. JP-A-10-264793, Patent Document 2F: Japanese Patent Application Publication No. JP-A-2006-224768

Meanwhile, in terms of improvement of fuel efficiency, it is preferable that all of the kinetic energy of the vehicle in travel be converted to the electric energy when the regenerative braking is performed. However, in the related-art technologies described above, there have been problems in that the recovery efficiency of the regenerative energy is poor and fuel efficiency is inadequate because a conversion loss occurs due to the air resistance of the vehicle and the rolling resistance of the wheel while traveling.

In view of the problems described above, an object of the modification examples F of the present invention is to provide a vehicular control device that can improve the recovery efficiency of the regenerative energy and achieve fuel saving performance.

A vehicular control device F1 used for a vehicle provided with a regenerative device capable of being operative as a regenerative brake for decelerating the vehicle speed and regenerating a rotational energy of a wheel to an electrical energy and provided with an electric storage device capable of storing the electrical energy, and a camber angle changing device for adjusting a camber angle of the wheel, is characterized by including camber angle control means that adjusts the camber angle changing device so as to adjust the camber angle of the wheel to a predetermined camber angle, in which the camber angle control means controls the camber angle changing device such that a rolling resistance of the wheel becomes smaller when the regenerative device performs regeneration.

With the vehicular control device F1, when the camber angle changing device is operated and the camber angle of the wheel is adjusted while the vehicle is traveling, the characteristics of the wheel (e.g., gripping property and rolling resistance) is changed corresponding to such adjustment of the camber angle. In this case, as the wheel is rotated when the vehicle travels, the rotational energy of the wheel is regenerated to the electrical energy and stored in the electric storage device by the regenerative device.

According to the present invention, with the camber angle adjusting means provided, when regenerating is performed by the regenerative device, the camber angle of the wheel can be adjusted such that the rolling resistance of the wheel becomes smaller

Accordingly, when converting the kinetic energy of the vehicle in travel to the electrical energy, by making the conversion loss incurred in conversion (deformation hysteresis loss of the wheel) small, the conversion loss can be reduced. Consequently, by utilizing the energy corresponding to the amount of conversion loss reduced, more electrical energy can be regenerated by the regenerative device, and the recovery efficiency of the regenerative energy is enhanced accordingly and the fuel saving performance is achieved.

A vehicular control device F2 is characterized in that the vehicular control device F1 further includes deceleration request detecting means used for detecting a deceleration request of a driver, road surface detecting means used for detecting a condition of road surface where the vehicle is traveling, and required coefficient of friction calculating means that calculates a required coefficient of friction based on the deceleration request detected by the deceleration request detecting means and the condition of road surface detected by the road surface detecting means, in which the camber angle adjusting means adjusts the camber angle of the wheel to a predetermined camber angle corresponding to the required coefficient of friction and the deceleration request.

With the vehicular control device F2, in addition to the advantages of the vehicular control device F1, because the camber adjusting means adjusts the camber angle of the wheel corresponding to the required coefficient of friction calculated by the required coefficient of friction calculating means, the wheel can be prevented from slipping (slipping or locking). Consequently, when converting the kinetic energy of the vehicle in travel to the electrical energy, as the wheel is prevented from slipping, the kinetic (rotational) energy of the wheel can surely be converted to the electrical energy, and the recovery efficiency of the recovery energy can be prevented from dropping in association with the slip of the wheel, whereby the fuel saving performance is enhanced. At the same time, the braking performance can be ensured.

Further, according to the present invention, because the road surface detecting means used for detecting road surface condition of the road where the vehicle is traveling is provided and the required coefficient of friction is calculated by the required coefficient of friction calculating means based on the road surface condition detected by the road surface detecting means, the controls can be changed corresponding to the road surface condition. Accordingly, the wheel can be prevented from slipping (slipping or locking) more surely and the kinetic (rotational) energy of the wheel can surely be converted to the electrical energy.

A vehicular control device F3 is characterized in that the vehicular control device F2 further includes required braking force calculating means that calculates a required braking force necessary to decelerate the vehicle according to the deceleration request, and a camber angle map for storing relationships of the camber angle with the coefficient of friction and the rolling resistance of the wheel, in which the camber angle adjusting means calculates a minimum coefficient of friction that is the minimum coefficient of friction the wheel can achieve based on the camber angle map and, when the required braking force is achieved simply with the regenerative brake and the required coefficient of friction is smaller than the minimum coefficient of friction, calculates the camber angle that minimizes the rolling resistance based on the camber angle map, and adjusts the camber angle of the wheel to the camber angle calculated as a predetermined camber angle.

With the vehicular control device F3, in addition to the advantages of the vehicular control device F2, because the camber angle adjusting means calculates the camber angle that minimizes the rolling resistance based on the camber angle map and adjusts the camber angle of the wheel to the camber angle calculated as the predetermined camber angle when the required braking force is achieved simply with the regenerative brake and the required coefficient of friction is smaller than the minimum coefficient of friction, the conversion loss (deformation hysteresis loss of the wheel) incurred during the conversion can be minimized when converting the kinetic energy of the vehicle in travel to the electrical energy. Consequently, the reduction of the conversion loss is enhanced and, by utilizing the energy corresponding to the amount of the conversion loss reduced, more electrical energy can be regenerated by the regenerative device, and the recovery efficiency of the regenerative energy is improved accordingly and the fuel saving performance is achieved.

A vehicular control device F4 is characterized in that the vehicular control device F2 further includes a camber angle map storing relationships of the camber angle with the coefficient of friction and the rolling resistance of the wheel, in which the vehicle is provided with a mechanical brake system for applying braking force to the wheel, the camber angle adjusting means calculates a minimum coefficient of friction and a maximum coefficient of friction that the wheel can achieve based on the camber angle map and, when the required braking force is achieved with the regenerative brake and the mechanical brake system, and the required coefficient of friction is larger than the minimum coefficient of friction and smaller than the maximum coefficient of friction, calculates the camber angle corresponding to the required coefficient of friction based on the camber angle map and adjusts the camber angle of the wheel to the camber angle calculated as a predetermined camber angle.

With the vehicular control device F4, in addition to the advantages of the vehicular control device F2, the camber angle adjusting means calculates the minimum coefficient of friction and the maximum coefficient of friction that the wheel can achieve based on the camber angle map and, when the required braking force is achieved with the regenerative brake and the mechanical brake system, and the required coefficient of friction is larger than the minimum coefficient of friction and smaller than the maximum coefficient of friction, calculates the camber angle corresponding to the required coefficient of friction based on the camber angle map and adjusts the camber angle of the wheel to the camber angle calculated as the predetermined camber angle. This configuration makes the wheel achieve a minimum required coefficient of friction and prevents it from slipping (slipping or locking).

Consequently, when converting the kinetic energy of the vehicle in travel to the electrical energy, the kinetic (rotational) energy of the wheel can surely be converted to the electrical energy because the wheel is prevented from slipping, and the recovery efficiency of the recovery energy can be prevented from dropping in association with the slip of the wheel, whereby the fuel saving performance is enhanced. At the same time, the braking performance can be ensured.

Further, because the camber angle of the wheel is adjusted such that the rolling resistance of the wheel becomes smaller while preventing the wheel from slipping (slipping or locking), the conversion loss (deformation hysteresis loss of the wheel) in conversion of the kinetic energy to the electrical energy can be reduced, and the recovery efficiency of the regenerative energy can be improved, and the fuel saving performance is enhanced accordingly.

A vehicular control device F4 is characterized in that, in the vehicular control device P3, the vehicle is further provided with a mechanical brake system for applying braking force to the wheel, and the camber angle adjusting means calculates a maximum coefficient of friction that the wheel can achieve based on the camber angle map and, when the required braking force is achieved with the regenerative brake and the mechanical brake system and the required coefficient of friction is larger than the minimum coefficient of friction and smaller than the maximum coefficient of friction, calculates the camber angle corresponding to the required coefficient of friction based on the camber angle map and adjusts the camber angle of the wheel to the camber angle calculated as a predetermined camber angle.

With the vehicular control device F5, in addition to the advantages of the vehicular control device F3, the camber angle adjusting means calculates the maximum coefficient of friction that the wheel can achieve based on the camber angle map and, when the required braking force is achieved with the regenerative brake and the mechanical brake system, and the required coefficient of friction is larger than the minimum coefficient of friction and smaller than the maximum coefficient of friction, calculates the camber angle corresponding to the required coefficient of friction based on the camber angle map and adjusts the camber angle of the wheel to the camber angle calculated as the predetermined camber angle. This configuration makes the wheel achieve the minimum required coefficient of friction and prevents it from slipping (slipping or locking).

Consequently, when converting the kinetic energy of the vehicle in travel to the electrical energy, the kinetic (rotational) energy of the wheel can surely be converted to the electrical energy because the wheel is prevented from slipping. Therefore, the recovery efficiency of the recovery energy is prevented from dropping in association with the slip of the wheel, whereby the fuel saving performance is enhanced. At the same time, the braking performance can be ensured.

Further, because the camber angle of the wheel is adjusted such that the rolling resistance of the wheel becomes smaller while preventing the wheel from slipping (slipping or locking), the conversion loss (deformation hysteresis loss of the wheel) in conversion of the kinetic energy to the electrical energy can be reduced and the recovery efficiency of the regenerative energy can be improved, and the fuel saving performance is enhanced accordingly.

A vehicular control device F6 is characterized in that, in any one of the vehicular control devices F3 to F5, the wheel includes a trailing wheel and a drive wheel rotary driven by the regenerative device, and the camber angle adjusting means adjusts the camber angles of the drive wheel and the trailing wheel to a predetermined camber angle corresponding to the required coefficient of friction and the deceleration request.

With the vehicular control device F6, in addition to the advantages of any one of the vehicular control devices F3 to F5, because the wheel includes the trailing wheel and the drive wheel rotary driven by the regenerative device, and the camber angle adjusting means adjusts the camber angles of the drive wheel and the trailing wheel to the predetermined camber angle corresponding to the required coefficient of friction and the deceleration request, the wheels (the trailing wheel and the drive wheel) can be prevented from slipping (slipping or locking). Consequently, when converting the kinetic energy of the vehicle in travel to the electrical energy, as the wheel is prevented from slipping, the kinetic (rotational) energy of the wheel can surely be converted to the electrical energy and the recovery efficiency of the recovery energy can be prevented from dropping in association with the slip of the wheel, whereby the fuel saving performance is enhanced. At the same time, the braking performance can be ensured.

A vehicular control device F7 is characterized in that the vehicular control device F2 further includes deceleration request detecting means used for detecting a deceleration request of a driver, required braking force calculating means that calculates a required braking force necessary to decelerate the vehicle corresponding to the deceleration request, and a camber angle map for storing relationships of the camber angle with the coefficient of friction and the rolling resistance of the wheel, in which the wheel includes a trailing wheel and a drive wheel rotary driven by the regenerative device, the vehicle is provided with a mechanical brake system for applying a braking force to the wheel, and the camber angle adjusting means calculates a minimum coefficient of friction and a maximum coefficient of friction the wheel can achieve based on the camber angle map and, when the required braking force is achieved with the regenerative brake and the mechanical brake system, and the required coefficient of friction is larger than the minimum coefficient of friction and smaller than the maximum coefficient of friction, calculates the camber angle corresponding to the required coefficient of friction based on the camber angle map, adjusts the camber angle of the drive wheel to the camber angle calculated as a predetermined camber angle, calculates the camber angle that minimizes the rolling resistance based on the camber angle map, and adjusts the camber angle of the trailing wheel to the camber angle calculated as a predetermined camber angle.

With the vehicular control device F7, in addition to the advantages of the vehicular control device F2, because the camber angle adjusting means calculates the minimum coefficient of friction and the maximum coefficient of friction the wheel can achieve based on the camber angle map and, when the required braking force is achieved with the regenerative brake and the mechanical brake system and the required coefficient of friction is larger than the minimum coefficient of friction and smaller than the maximum coefficient of friction, calculates the camber angle corresponding to the required coefficient of friction based on the camber angle map and adjusts the camber angle of the drive wheel to the camber angle calculated as the predetermined camber angle, the drive wheel can be prevented from slipping (slipping or locking). Consequently, because the rotation of the drive wheel is surely transmitted to the motor device and the kinetic (rotational) energy of the wheel can efficiently be converted to the electrical energy, the recovery efficiency of the recovery energy can be prevented from dropping in association with the slip of the drive wheel, and the fuel saving performance can be enhanced. At the same time, the braking performance can be ensured.

On the other hand, the trailing wheel is not required to transmit its rotation to the motor device for regeneration and is sufficient to trail as the vehicle travels. According to the present invention, however, because the camber angle changing device calculates the camber angle that minimizes the rolling resistance based on the camber angle map and adjusts the camber angle of the trailing wheel to the camber angle calculated as the predetermined camber angle, when converting the kinetic energy of the vehicle to the electrical energy, the conversion loss (deformation hysteresis loss of the wheel) incurred during the conversion can be minimized and the conversion loss is effectively reduced. Consequently, the recovery efficiency of the regenerative energy can be improved and the fuel saving performance can further be achieved.

A vehicular control device F8 is characterized in that, in to the vehicular control device F1, the camber angle adjusting means further includes required coefficient of friction calculating means that calculates a coefficient of friction necessary for the wheel not to cause any slip against a traveling road surface based on the running condition of the vehicle, and adjusts the camber angle of the wheel such that the wheel can achieve a coefficient of friction equivalent to the coefficient of friction calculated by the required coefficient of friction calculating means and that the rolling resistance of the wheel becomes smaller.

With the vehicular control device F8, in addition to the advantages of the vehicular control device F1, a good balance between ensuring the acceleration, the braking and the turning performance and obtaining the fuel saving performance can be achieved.

More specifically, there is a correlation between the rolling resistance and coefficient of friction of the wheel. While a smaller rolling resistance (i.e., hysteresis loss) of the wheel can achieve fuel saving, as the gripping performance becomes difficult to be ensured, the performance of acceleration, the braking, or the turning is lowered. On the other hand, while a higher gripping property can enhance the acceleration, braking or turning performance, the increased rolling resistance deteriorates fuel efficiency.

By contrast, according to the present invention, during regeneration, because the camber adjusting means adjusts the camber angle of the wheel such that the wheel can achieve the coefficient of friction equivalent to the coefficient of friction calculated by the required coefficient of friction calculating means, the wheel can be prevented from slipping (slipping or locking). Consequently, because the kinetic (rotational) energy of the wheel can surely be converted to the electrical energy, the recovery efficiency of the recovery energy can be prevented from dropping in association with the slip of the wheel, whereby the fuel saving performance is enhanced. At the same time, the acceleration, the braking and the turning performance can be ensured.

Further, during regeneration, because the camber adjusting means adjusts the camber angle of the wheel such that the rolling resistance of the wheel becomes smaller while preventing the wheel from slipping (slipping or locking), the conversion loss (deformation hysteresis loss of the wheel) in conversion of the kinetic energy to the electrical energy can be reduced, whereby the fuel saving performance is improved.

During regeneration, it is preferable that, when the coefficient of friction calculated by the required coefficient of friction calculating means exceeds the maximum coefficient of friction the wheel can achieve, the camber angle of the wheel be adjusted to the camber angle that maximizes the coefficient of friction of the wheel.

In this case, it is more preferable that the camber angle be the smallest angle (closer to 0 degrees) within the range that the wheel can achieve the maximum coefficient of friction. In this range, while the rolling resistance increases as the camber angle increases, the coefficient of friction converges to a constant value and the gripping performance can not be expected to go any higher even though the camber angle is increased. Therefore, by setting it to the minimum angle, while reducing the conversion loss (deformation hysteresis loss) due to the rolling resistance and obtaining the fuel saving performance, the camber angle can be prevented from becoming unnecessarily large, the running stability of the vehicle is ensured.

Further, in this case, it is preferable that notification means that notifies the driver that the coefficient of friction exceeds the maximum coefficient of friction the wheel can achieve (for example, sounding an alarm and displaying a warning on a monitor) or means that reduces the vehicle speed (for example, braking by the brake mechanism or reducing engine output or the like) be provided. Accordingly, the driver can be notified that the vehicle is driven exceeding the limit performance (acceleration, braking and turning performance), or the vehicle speed can be reduced mechanically without relying on the operation of the driver, which contributes to the safety of the vehicle.

Further, during regeneration, it is preferable that, when the coefficient of friction calculated by the required coefficient of friction calculating means falls below the minimum coefficient of friction the wheel can achieve, the camber angle adjusting means adjust the camber angle to the angle that minimizes the rolling resistance of the wheel (closer to 0 degrees, for example) within the range where the wheel can achieve the minimum coefficient of friction. Therefore, while ensuring the running stability of the vehicle by preventing the camber angle from becoming unnecessarily large, the conversion loss (deformation hysteresis loss) due to the rolling resistance can be minimized, whereby the fuel saving performance is further enhanced.

A vehicular control device F9 is characterized in that, in the vehicular control device F8, the vehicle is provided with a motor device configured as the regenerative device, the wheel includes a drive wheel rotary driven by the motor device and a trailing wheel trailing as the vehicle travels, and the camber angle adjusting means includes drive wheel adjusting means that adjusts the camber angle of the drive wheel and trailing wheel adjusting means that adjusts the camber angle of the trailing wheel, in which the drive wheel adjusting means adjusts a camber angle of the drive wheel such that the drive wheel can achieve a coefficient of friction equivalent to the coefficient of friction calculated by the required coefficient of friction calculating means and that a rolling resistance of the drive wheel becomes smaller, and the trailing wheel adjusting means adjusts a camber angle of the trailing wheel such that a rolling resistance of the trailing wheel becomes minimum.

With the vehicular control device F9, in addition to the advantages of the vehicular control device F8, because the drive wheel adjusting means adjusts the camber angle of the wheel such that the drive wheel can achieve the coefficient of friction equivalent to the coefficient of friction calculated by the required coefficient of friction calculating means, the drive wheel can be prevented from slipping (slipping or locking). Consequently, because the rotation of the drive wheel is surely transmitted to the motor device and the kinetic (rotational) energy can efficiently be converted to the electrical energy, the recovery efficiency of the recovery energy can be prevented from dropping in association with the slip of the drive wheel, whereby the fuel saving performance is enhanced. At the same time, the accelerating, the braking and the turning performance can be ensured.

Further, because the drive wheel adjusting means adjusts the camber angle of the drive wheel such that the rolling resistance of such drive wheel becomes smaller while preventing the drive wheel from slipping (slipping or locking), the conversion loss (deformation hysteresis loss of the wheel) in conversion of the kinetic energy to the electrical energy can be reduced while ensuring the above-described advantages, and the fuel saving performance can also be enhanced.

On the other hand, the trailing wheel is not required to transmit its rotation to the motor device for regeneration and is sufficient to trail as the vehicle travels. According to the present invention, however, because the trailing wheel adjusting means adjusts the camber angle of the trailing wheel such that the rolling resistance thereof becomes minimum, when converting the kinetic energy of the vehicle to the electrical energy, the conversion loss (deformation hysteresis loss of the wheel) incurred during the conversion can be minimized and the conversion loss can effectively be reduced. Consequently, the recovery efficiency of the regenerative energy is improved and the fuel saving performance can further be achieved.

In the flow chart (camber control process) of FIGS. 36A and 36B, the processes in steps S6059, S6062 and S6063 represent the camber angle control means included in the vehicular control device F1, the process in step S6052 represents the deceleration request detecting means, the process in step S6051 represents the road surface detecting means and the process in step S6056 represents the required coefficient of friction calculating means included in the vehicular control device F2, and the process in step S6052 represents the deceleration request detecting means included in the vehicular control device F7.

In the flow chart (camber control process) of FIGS. 36A and 36B, the process in step S6056 represents the required coefficient of friction calculating means included in the vehicular control device F8, and the process in step S6059 represents the drive wheel adjusting means and the process in step S6059 represents the trailing wheel adjusting means included in the vehicular control device F9. The wheel driving mechanism 3 (FL and FR motor 3FL and 3FR) represents the motor device included in the vehicular control device F2.

Modification examples G of the present invention will be described below. In the related art, when mounting a wheel to a vehicle with a large camber angle in the negative direction, there is known a technology, for example, Patent Document 1G, that ensures wear resistance, heat resistance, and high gripping property by reinforcing one side of a tire to be more rigid than the other and, by dividing tread rubber into two, and then lowering the hardness of one side of the tread rubber compared with the other or by increasing the thickness of tread edge portion. Further, Patent Document 2G discloses a suspension system that actively controls the camber angle of the wheel by a driving force of an actuator. Patent Document 1G: Japanese Patent Application Publication No. JP-A-2-185802, Patent Document 2G: U.S. Pat. No. 6,347,802

There is a desire to actively control the camber angle of the wheel that is provided with the tire having two tread of different hardness as disclosed in Patent Document 1G with the suspension system disclosed in Patent Document 2G and adjust the camber angle of the wheel corresponding to the running condition of the vehicle. Accordingly, the ground contact ratios of the treads of high hardness and low hardness can be changed corresponding to the running condition of the vehicle and it can be expected to achieve a good balance between high gripping property and high fuel efficiency.

However, when the ground contact ratio of the tread of the high hardness is made high to enhance fuel efficiency, the wheel becomes likely to slip because the gripping performance of the wheel is lowered. Consequently, every time the wheel slips, a control system that prevents the slip of the wheel by controlling a braking force or a driving force applied to the wheel such as an anti-lock brake system (hereinafter referred to as the ABS), a traction control system, and an anti-skid system is frequently activated. Accordingly, there have been problems in that the driver senses a feeling of strangeness or a feeling of discomfort by vibrations and noises caused when the ABS is activated, a lack of acceleration when the traction control system is activated, or the like.

In view of the problems described above, an object of the modification examples F of the present invention is to provide a control device capable of preventing the feeling of strangeness or discomfort caused by the activation of the control system that controls the braking force or the driving force applied to the wheel when the slip of the wheel occurs, while preventing the wheel from slipping.

A control device G1 used for a vehicle provided with a wheel, and a camber angle adjusting device for adjusting a camber angle of the wheel, the wheel having at least a first tread and a second tread provided in parallel with the first tread in a width direction of the wheel, arranged inside or outside of the vehicle, and having a softer property than that of the first tread, is characterized by including camber control means that controls the camber angle adjusting device, slip occurrence judging means that judges whether or not a predetermined slip condition occurs with the wheel, and slip suppression control means that controls a braking force or a driving force applied to the wheel to suppress the slip condition when the slip occurrence judging means judges that the predetermined slip condition occurs with the wheel, in which when the slip occurrence judging means judges that the predetermined slip condition occurs with at least one of the wheels, the camber control means controls the camber angle adjusting device such that the ground contact ratio of the second tread is increased at least for the wheel that is judged by the slip occurrence means that the predetermined slip condition occurs before the slip suppression control means controls the braking force or the driving force applied to the wheel.

With the control device G1, when the camber angle adjusting device is controlled by the camber control means, and the camber angle of the wheel is adjusted in the positive direction, the ground contact ratio of the tread that is arranged on the outer side of the vehicle (first tread or second tread) is increased while the ground contact ratio of the tread arranged on the inner side of the vehicle (second tread or first tread) is decreased.

By contrast, when the camber angle of the wheel is adjusted in the negative direction, the ground contact ratio of the tread that is arranged on the outer side of the vehicle (first tread or second tread) is decreased while the ground contact ratio of the tread arranged on the inner side of the vehicle (second tread or first tread) is increased.

Therefore, with the control devices of the present invention, because the ground contact ratios of the first tread and the second tread can be changed by controlling the camber angle adjusting device by the camber control means, by enhancing the effect of the characteristics of the tread of a high ground contact ratio, the wheel can achieve the performance achieved by the characteristics of such tread.

According to the present invention, because the second tread of the wheel is configured to have a softer property (low rubber hardness property) than that of the first tread, when the ground contact ratio of the second tread is increased, by the soft property of the second tread, more specifically, the characteristics of good elasticity and being easily deformable under external force, a high gripping performance can be obtained.

With the control devices of the present invention, when the slip occurrence judging means judges that the predetermined slip condition occurs with at least one of the wheels, the camber control means is configured to control the camber angle adjusting device such that the ground contact ratio of the second tread is increased at least for the wheel that is judged by the slip occurrence means that the predetermined slip condition occurs before the slip suppression control means controls the braking force or the driving force applied to the wheel. Therefore, when it is judged that the predetermined slip condition occurs with at least one of the wheels, the ground contact ratio of the second tread can be increased first for at least that one of the wheels that is judged that the predetermined slip condition occurs.

Accordingly, for the wheel of which the ground contact ratio of the second tread is increased, by enhancing the effect of the soft property of the second tread, the wheel can achieve the performance achieved by the characteristics of the second tread, i.e., high gripping performance. Consequently, by this high gripping performance, the slip occurring with the wheel can be suppressed.

Further, when the camber angle adjusting device is controlled such that the ground contact ratio of the second tread is increased at least for the wheel that is judged that the predetermined slip condition occurs, and thereafter the predetermined slip condition occurring with that wheel is resolved, because the controls of the driving force or the braking force applied to the wheel by the slip suppression control means can be prevented, the number of controls by the slip suppression control means can be reduced.

Generally, the controls of the driving force or the braking force by the slip suppression control means becomes the cause of the feelings of strangeness and discomfort the driver senses by the lack of acceleration, vibrations, noises or the like. According to the present invention, as described in the foregoing, because the number of the controls by the slip suppressing means can be reduced when the slip of the wheel occurs, the feelings of strangeness and discomfort caused by the slip suppression control means that controls the driving force and the braking force applied to the wheel can be suppressed. Consequently, when the slip occurs with the wheel, the feelings of strangeness and discomfort by the slip control means can be suppressed while suppressing that slip.

A control device G2 is characterized in that the control device G1 further includes vehicle condition judging means that judges whether or not the vehicle is in a quick braking condition, a quick acceleration condition, or a quick turning condition based on a braking force, a driving force or a steer angle applied to the wheel, in which when the vehicle condition judging means judges that the vehicle is in the quick braking condition, the quick acceleration condition, or the quick turning condition, the camber control means controls the camber angle adjusting device such that the ground contact ratio of the second tread is increased, regardless of the judgment made by the slip occurrence judging means.

With the control device G2, in addition to the advantages of the control device G1, because the camber control means controls the camber angle adjusting device, when the vehicle condition judging means judges that the vehicle is in a quick braking condition, a quick acceleration condition, or a quick turning condition based on the braking force, the driving force or the steer angle applied to the wheel, such that the ground contact ratio of the second tread is increased regardless of the judgment made by the slip occurrence judging means, the ground contact ratio of the second tread for the wheel can immediately be increased when the vehicle is assumed to be in the quick braking condition, the quick acceleration condition, or the quick turning condition, regardless of the wheel being in the predetermined slip condition or not. Accordingly, in the condition where the possibility of the wheel being in the predetermined slip condition is extremely high such as a quick braking condition, a quick acceleration condition, or a quick turning condition, the gripping performance of the wheel can immediately and surely be enhanced.

Further, when the occurrence of the predetermined slip condition to the wheel can be prevented by the high gripping performance of the wheel, the controls of the driving force or the baking force applied to the wheel by the slip suppression control means can be prevented. Consequently, even when the possibility of the wheel being in the predetermined slip condition is extremely high, the feelings of strangeness and discomfort caused by the slip suppression control means that controls the driving force and the braking force applied to the wheel can be suppressed, while suppressing the slip.

A control device G3 is characterized in that, in the control device G1 or G2, when the camber angle adjusting device is controlled by the camber control means such that the ground contact ratio of the second tread is increased, and thereafter the slip occurrence judging judges means that the predetermined slip condition occurs with the wheel, the slip suppression control means controls the driving force or the braking force applied to the wheel.

With the control device G3, in addition to the advantages of the control device G1 or G2, when the camber angle adjusting device is controlled by the camber control means such that the ground contact ratio of the second tread is increased and the slip occurrence judging means judges that the predetermined slip condition occurs with the wheel thereafter, because the driving force or the braking force applied to the wheel is controlled by the slip suppression control means, by controlling the driving force or the braking force applied to the wheel, when the predetermined slip condition occurs with the wheel even though the gripping performance of the wheel is enhanced by increasing the ground contact ratio of the second tread, that slip condition can be suppressed. Consequently, the safety of the vehicle can be enhanced.

A control device G4 is characterized in that any one of the control devices G1 to G3 further includes slip cancellation judging means that judges whether or not a predetermined slip condition occurring with the wheel is resolved, and timing means that counts a predetermined time set in advance when the slip cancellation judging means judges that the predetermined slip condition is resolved, in which when the slip cancellation judging means judges that the predetermined slip condition is resolved and the predetermined time is counted by the timing means, the camber control means controls the camber angle adjusting device such that the camber angle of the wheel comes to a predetermined default value on the side where the ground contact ratio of the second tread is reduced.

With the control device G4, in addition to the advantages of the control devices G1 to G3, because the camber control means controls the camber angle adjusting device such that the camber angle of the wheel comes to the predetermined default value on the side where the ground contact ratio of the second tread is reduced when the slip cancellation judging means judges that the predetermined slip condition occurring with the wheel is resolved, the influence of the soft property of the second tread can be made small when the predetermined slip condition is resolved. Consequently, because the rolling resistance of the wheel can be made small, fuel efficiency can be improved when the predetermined slip condition is resolved.

Further, because the camber angle adjusting device is controlled by the camber control means such that the camber angle of the wheel comes to the predetermined default value on the side where the ground contact ratio of the second tread is reduced when the slip cancellation judging means judges that the predetermined slip condition occurring with the wheel is resolved and the predetermined time is then counted by the timing means, the high gripping performance can be retained during that predetermined period of time even after the predetermined slip condition is resolved. Therefore, the slip ratio of the wheel can be further lowered with the gripping force generated on the wheel during the predetermined time. Consequently, when the ground contact ratio of the second tread is reduced, the predetermined slip condition due to the reduced gripping performance of the wheel can be prevented from recurring with the wheel.

A control device G5 is characterized in that any one of the control devices G1 to G4 further includes vehicle speed detecting means used for detecting a speed of the vehicle, turning radius detecting means used for detecting a turning radius of the vehicle, yaw rate measuring means that measures a yaw rate of the vehicle, and yaw rate estimating means that estimates the yaw rate of the vehicle based on the speed of the vehicle detected by the vehicle speed detecting means and the turning radius of the vehicle detected by the turning radius detecting means, in which when the yaw rate estimated by the yaw rate estimating means is larger than the yaw rate measured by the yaw rate measuring means, the slip occurrence judging means judges that the predetermined slip condition occurs with the wheel located on fore side in the traveling direction of the vehicle and, when the slip occurrence judging means judges that the predetermined slip condition occurs with the wheel located on fore side in the traveling direction of the vehicle, the camber control means controls the camber angle adjusting device such that the ground contact ratio of the second tread is increased for the wheel located on fore side in the traveling direction of the vehicle before the driving force or the braking force applied to the wheel is controlled by the slip suppression control means.

The control device G5 provides, in addition to the advantages of the control devices G1 to G4, the following advantages. The yaw rate of the vehicle is estimated by the yaw rate estimating means based on the speed of the vehicle detected by the vehicle speed detecting means and the turning radius of the vehicle detected by the turning radius detecting means. The yaw rate of the vehicle is measured by the yaw rate measuring means.

When the yaw rate estimated from the speed of the vehicle and the turning radius of the vehicle is larger than the yaw rate measured, it can be judged that the vehicle is in an understeer condition where the vehicle turns wide as the wheel located on fore side in the traveling direction of the vehicle (front wheel) slips towards outside. With the control devices of the present invention, because the slip occurrence judging means judges that the predetermined slip condition occurs with the front wheel when the yaw rate estimated by the yaw rate estimating means is larger than the yaw rate measured by the yaw rate measuring means, the slip of the front wheel that causes the understeer condition can surely be judged.

When the slip occurrence judging means judges that the predetermined slip condition occurs with the front wheel, because the camber control means controls the camber angle adjusting device such that the ground contact ratio of the second tread for the front wheel is increased before the driving force or the braking force applied to the wheel is controlled by the slip suppression control means, the ground contact ratio of the second tread for the front wheel can be increased first when it is assumed that the understeer condition occurs.

Accordingly, because the high gripping performance can be achieved for the front wheel that causes the understeer condition, the slip occurring with the front wheel can be suppressed before the driving force or the braking force applied to the wheel is controlled by the slip suppression control means. Consequently, the activation of the slip suppression control means can be suppressed while suppressing the understeer condition.

A control device G6 is characterized in that any one of the control devices G1 to G5 further includes vehicle speed detecting means used for detecting a speed of the vehicle, turning radius detecting means used for detecting a turning radius of the vehicle, yaw rate measuring means that measures a yaw rate of the vehicle, and yaw rate estimating means that estimates the yaw rate of the vehicle based on the speed of the vehicle detected by the vehicle speed detecting means and the turning radius of the vehicle detected by the turning radius detecting means, in which when the yaw rate estimated by the yaw rate estimating means is smaller than the yaw rate measured by the yaw rate measuring means, the slip occurrence judging means judges that the predetermined slip condition occurs with the wheel located on aft side in the traveling direction of the vehicle and, when the slip occurrence judging means judges that the predetermined slip condition occurs with the wheel located on aft side in the traveling direction of the vehicle, the camber control means controls the camber angle adjusting device such that the ground contact ratio of the second tread is increased for the wheel located on aft side in the traveling direction of the vehicle before the driving force or the braking force applied to the wheel is controlled by the slip suppression control means.

The control device G6 provides, in addition to the advantages of the control devices G1 to G5, the following advantages. The yaw rate of the vehicle is estimated by the yaw rate estimating means based on the speed of the vehicle detected by the vehicle speed detecting means and the turning radius of the vehicle detected by the turning radius detecting means. The yaw rate of the vehicle is measured by the yaw rate measuring means.

When the yaw rate estimated from the speed of the vehicle and the turning radius of the vehicle is smaller than the yaw rate measured, it can be judged that the vehicle is in an oversteer condition where the vehicle turns tight as the wheel located on aft side in the traveling direction of the vehicle (rear wheel) slips towards outside. With the control devices of the present invention, because the slip occurrence judging means judges that the predetermined slip condition occurs with the rear wheel when the yaw rate estimated by the yaw rate estimating means is smaller than the yaw rate measured by the yaw rate measuring means, the slip of the rear wheel that causes the oversteer condition can surely be judged.

When the slip occurrence judging means judges that the predetermined slip condition occurs with the rear wheel, because the camber control means controls the camber angle adjusting device such that the ground contact ratio of the second tread for the rear wheel is increased before the driving force or the braking force applied to the wheel is controlled by the slip suppression control means, the ground contact ratio of the second tread for the rear wheel can be increased first when it is assumed that the oversteer condition occurs.

Accordingly, because the high gripping performance can be achieved for the rear wheel that causes the oversteer condition, the slip occurring with the rear wheel can be suppressed before the driving force or the braking force applied to the wheel is controlled by the slip suppression control means. Consequently, the activation of the slip suppression control means can be suppressed while suppressing the oversteer condition.

A control device G7 is characterized in that any one of the control devices G1 to G6 further includes vehicle speed detecting means used for detecting a speed of the vehicle, turning radius detecting means used for detecting a turning radius of the vehicle, lateral acceleration measuring means that measures an acceleration of the vehicle in lateral direction, and lateral acceleration estimating means that estimates an acceleration of the vehicle in lateral direction based on the speed of the vehicle detected by the vehicle speed detecting means and the turning radius of the vehicle detected by the turning radius detecting means, in which when the lateral acceleration estimated by the lateral acceleration estimating means is larger than the lateral acceleration measured by the lateral acceleration measuring means, the slip occurrence judging means judges that the predetermined slip condition occurs with the wheel located on outside of the turning direction of the vehicle and, when the slip occurrence judging means judges that the predetermined slip condition occurs with the wheel located on outside of the turning direction of the vehicle, the camber control means controls the camber angle adjusting device such that the ground contact ratio of the second tread is increased for the wheel located on outside of the turning direction of the vehicle before the driving force or the braking force applied to the wheel is controlled by the slip suppression control means.

The control device G7 provides, in addition to the advantages of the control devices G1 to G6, the following advantages. The acceleration of the vehicle in lateral direction (lateral acceleration) is estimated by the lateral acceleration estimating means based on the speed of the vehicle detected by the vehicle speed detecting means and the turning radius of the vehicle detected by the turning radius detecting means. The acceleration of the vehicle in lateral direction (lateral acceleration) is measured by the lateral acceleration measuring means.

When the lateral acceleration estimated from the speed of the vehicle and the turning radius of the vehicle is larger than the lateral acceleration measured, it can be judged that the vehicle is in a skid condition where the vehicle skids as the wheel located on outside of the turning direction of the vehicle (outer wheel) slips to the side. With the control devices of the present invention, because the slip occurrence judging means judges that the predetermined slip condition occurs with the outer wheel when the lateral acceleration estimated by the lateral acceleration estimating means is larger than the lateral acceleration measured by the lateral acceleration measuring means, the slip of the outer wheel that causes the skid condition can surely be judged.

When the slip occurrence judging means judges that the predetermined slip condition occurs with the outer wheel, because the camber control means controls the camber angle adjusting device such that the ground contact ratio of the second tread for the outer wheel is increased before the driving force or the braking force applied to the wheel is controlled by the slip suppression control means, the ground contact ratio of the second tread for the outer wheel can be increased first when it is assumed that the skid condition occurs.

Accordingly, the high gripping performance can be achieved for the outer wheel that causes the skid condition, and the slip occurring with the outer wheel can be suppressed before the driving force or the braking force applied to the wheel is controlled by the slip suppression control means. Consequently, the activation of the slip suppression control means can be suppressed while suppressing the skid condition.

Additionally, the processes in steps S7006 and S7007 of the flow chart (slip control process) of FIGS. 43A and 43B, the process in step S7042 of the flow chart (camber release process) of FIG. 45, and the processes in steps S8057, S8059, S8061 and S8062 of the flow charts (slip control process) of FIGS. 47 and 48 represent the camber control means included in the control device G1

The processes in steps S7005 and S7009 of the flow chart (slip control process) of FIGS. 43A and 4313 and the processes in steps S8056, S8058, S8060, S8065 and S8066 of the flow charts (slip control process) of FIGS. 47 and 48 represent the slip occurrence judging means.

The process in step S7003 of the flow chart (slip control process) of FIGS. 43A and 43B and the process in step S8053 of the flow charts (slip control process) of FIGS. 47 and 48 represent the vehicle condition judging means included in the control device G2.

The process in step S7009 of the flow chart (slip control process) of FIGS. 43A and 43B, the processes in steps S7023 and S7028 of the flow chart (slip cancellation detecting process) of FIG. 44, the processes in steps S8065 and S8066 of the flow charts (slip control process) of FIGS. 47 and 48, and the processes in steps S8074 and S8075 of the flow chart (slip cancellation detecting process) of FIG. 49 represent the slip cancellation judging means included in the control device G4.

The process in step S8055 of the flow charts (slip control process) of FIGS. 47 and 48 represents the vehicle speed detecting means, the turning radius detecting means, the yaw rate estimating means, and the lateral acceleration estimating means included in the control devices G5 to G7.

Modification examples I of the present invention will be described below. By setting a camber angle (angle formed by the center line of a tire and a ground surface) of a wheel large in the negative direction, an attempt is made to fully utilize the performance of the tire so as to enhance the turning performance of the vehicle. By contrast, the stability of the vehicle traveling straight can be attained by setting the camber angle of the wheel to 0 degrees. Accordingly, by actively controlling the camber angle of the wheel, a good balance between turning performance and straight-line stability can be achieved. The U.S. Pat. No. 6,347,802B1 (Patent Document II) discloses a suspension system that actively controls the camber angle of the wheel by the driving force of an actuator. Patent Document 1I: U.S. Pat. No. 6,347,802B1

Meanwhile, because a centrifugal force is generated on the turning vehicle, a force in a direction towards the center of the turn that withstands such centrifugal force (centripetal force) is generated on the wheel. By such centripetal force, a moment is generated on the camber axis. Particularly, in a quick turn where the centrifugal force becomes great, because the moment generated on the camber axis also becomes great, an actuator of a high capacity (high output) is required to hold the camber angle with the actuator.

However, while the actuator of a higher capacity can enhance the turning performance, because the actuator becomes large, there have been problems of such as being difficult to install, being heavy, and costing high.

In view of the problems described above, an object of the modification examples I of the present invention is to provide a vehicle and a control device that can achieve the control of the camber angle with an actuator of a low capacity (small size).

A vehicle I1 is characterized by including a wheel structured to include at least a first tread arranged in two rows on both outer sides in the width direction thereof and a second tread arranged between the two rows of the first tread with the first tread having softer property than that of the second tread, a camber angle changeable mechanism for changing the camber angle of the wheel, an actuator for applying a driving force to the camber angle changeable mechanism, camber angle control means that controls the actuator to activate the camber angle changeable mechanism and change the camber angle of the wheel and for retaining the condition of the camber angle changeable mechanism to hold the camber angle of the wheel at a setting angle, changeable range limiting means that mechanically limits the changeable range of the camber angle of the wheel changed by the camber angle changeable mechanism, running condition detecting means used for detecting running condition, computing means that calculates a moment generated on a camber axis of the wheel or an index thereof based on the running condition detected by the running condition detecting means, and control stopping means that stops the control of the actuator by the camber angle control means when the moment generated on the camber axis of the wheel obtained by the computing means or the moment generated on the camber axis of the wheel estimated from the index obtained by the computing means exceeds a controllable range by the actuator.

With the vehicle I1, the camber angle of the wheel is changeable by the camber angle changeable mechanism. The camber angle of the wheel can be changed by activating the camber angle changeable mechanism by the actuator. Meanwhile, the camber angle of the wheel can be held at the setting angle by retaining the condition of the camber angle changeable mechanism by that actuator. That actuator is controlled by the camber control means. Additionally, the changeable range of the camber angle of the wheel changed by the camber angle changeable mechanism is mechanically limited by the changeable range limiting means.

Meanwhile, a single row of the first tread each is arranged on both outer sides of the wheel in the width direction, and these two rows of the first tread have a softer property than that of the second tread (i.e., a higher gripping force property than that of the second tread) that is arranged between them. Accordingly, depending on the camber angle applied to the wheel, the characteristics of the first tread and the second tread can selectively be used.

More specifically, as the camber angle of the wheel becomes larger on the positive side or negative side, the ground contact ratio of the first tread is more increased with respect to the second tread, thereby achieving a higher gripping force. By contrast, as the camber angle of the wheel becomes closer to 0 degrees, the ground contact ratio of the second tread is more increased with respect to the first tread, thereby lowering the rolling resistance of the wheel.

Accordingly, because the ground contact ratio of the first tread versus the second tread can be changed by controlling the actuator by the camber control means so as to change the camber angle of the wheel, a good balance between two performances of the running performance (e.g., turning performance and acceleration performance) and the fuel saving performance can be achieved.

Further, with the vehicle I1, when the moment generated on the camber axis of the wheel or its index is obtained by the computing means based on the running condition detected by the running condition detecting means, and the moment calculated or the moment estimated from the index calculated exceeds the controllable range by the actuator, the control of the actuator by the camber angle control means is stopped by the control stopping means.

When the control of the actuator by the camber angle control means is stopped, because the camber angle cannot be held by the actuator and the wheel becomes pivotal, the wheel swings centering around the camber axis by the moment generated on the camber axis. Therefore, without using any driving force by the actuator (i.e., passively), the camber angle can be applied to the wheel on the positive side or negative side. Consequently, the ground contact ratio of the first tread with respect to the second tread is increased and the high gripping force that is the characteristics of the first tread is achieved.

The larger the lateral force generated on the wheel is, more specifically, the larger the moment generated on the camber axis is, the larger the required capacity for the actuator controlling the camber angle becomes. With the vehicle I1, however, because the camber angle can be held by mechanically limiting the changeable range of the camber angle of the wheel by the changeable range limiting means under the condition where the lateral force equal to or higher than a predetermined level is generated on the wheel (for example, in a quick turn), the camber angle that can achieve the high gripping force can be kept applied to the wheel, i.e., the camber angle can be held, without using the driving force by the actuator. Consequently, it is possible to use an actuator of a low capacity (more specifically, a narrow changeable range) accordingly.

Further, because the changeable range of the camber angle is limited by the changeable range limiting means, even when the control of the actuator is stopped and the camber angle is passively applied, the camber angle can be prevented from becoming unnecessarily large which causes the vehicle to run unstably. Consequently, the retention force to hold the camber angle is not required, and thus the actuator of a small capacity can be used.

As described in the foregoing, with the vehicle I1, even with an actuator of a low capacity (low output) that is superior in terms of cost, installation and the like, it can be realized that the tread of the wheel is selectively used by changing the camber angle, and a good balance between two performances of the running performance and the fuel saving performance can be achieved.

A vehicle I2 is characterized in that, in the vehicle I1, the control stopping means is configured such that the controllable range by the actuator can counteract up to the lateral force of the vehicle approximately equal to the maximum gripping force of the second tread of the wheel.

The vehicle I2 provides, in addition to the advantages of the vehicle I1, the following advantages. The changeable range by the actuator is configured to counteract up to the lateral force of the vehicle that is approximately equal to the maximum gripping force of the second tread of the wheel. More specifically, with the vehicle I2, when the lateral force of the vehicle approximately equal to the maximum gripping force of the second tread that is the changeable range by the actuator is generated on the wheel, the control of the actuator by the camber angle control means is stopped by the control stopping means.

Meanwhile, when the lateral force larger than the maximum gripping force of the second tread is generated on the wheel, as an attempt to prevent the slip of the wheel, it is desirable that a camber angle that increases the ground contact ratio of the first tread that has a higher gripping force than that of the second tread be applied. When it is configured using an actuator so as to apply such camber angle continuously, more specifically, to hold such camber angle, an actuator of a high output is required.

By contrast, with the vehicle I2, when the lateral force larger than the maximum gripping force of the second tread is generated on the wheel, the camber angle can be applied to the wheel passively by the moment generated on the camber axis such that the ground contact ratio of the first tread that has higher gripping force than that of the second tread is to be increased without using the driving force by the actuator. Meanwhile, for the lateral force that falls below the maximum gripping force of the second tread, the camber angle that enhances the fuel saving performance or the camber angle that enhances the driving force can be applied appropriately.

As described above, with the vehicle I2, even when the actuator of a low capacity is used, it can be realized that the tread of the wheel is selectively used by changing the camber angle, and a good balance between two performances of the running performance and the fuel saving performance can be achieved.

A control device I3 used for a vehicle provided with a wheel structured to include at least a first tread arranged in two rows on both outer sides in the width direction thereof and a second tread arranged between the two rows of the first tread with the first tread having a softer property than that of the second tread, a camber angle changeable mechanism for changing a camber angle of the wheel, an actuator for applying a driving force to the camber angle changeable mechanism, and camber angle control means that controls the actuator to activate the camber angle changeable mechanism and change the camber angle of the wheel, and for retaining the condition of the camber angle changeable mechanism to hold the camber angle of the wheel at a setting angle, is characterized in that the vehicle is further provided with changeable range limiting means that mechanically limits a changeable range of the camber angle of the wheel changed by the camber angle changeable mechanism, and running condition detecting means used for detecting a running condition, and is characterized by including computing means that calculates a moment generated on a camber axis of the wheel or an index thereof based on the running condition detected by the running condition detecting means, and control stopping means that stops the control of the actuator by the camber angle control means when the moment generated on the camber axis of the wheel obtained by the computing means or the moment generated on the camber axis of the wheel estimated from the index obtained by the computing means exceeds a controllable range by the actuator.

With the control device I3, the camber angle of the wheel is changeable by the camber angle changeable mechanism, and the camber angle of the wheel can be changed by activating the camber angle changeable mechanism by the actuator. Meanwhile, the camber angle of the wheel can be held at the setting angle by retaining the condition of the camber angle changeable mechanism by that actuator. That actuator is controlled by the camber control means. Additionally, the changeable range of the camber angle of the wheel changed by the camber angle changeable mechanism is mechanically limited by the changeable range limiting means.

The moment generated on the camber axis of the wheel or its index is calculated by the computing means based on the running condition detected by the running condition detecting means. When the moment calculated or the moment estimated from the calculated index exceeds the controllable range by the actuator, the control of the actuator by the camber angle control means is stopped by the control stopping means.

When the control of the actuator by the camber angle control means is stopped, because the camber angle can not be held by the actuator and the wheel becomes pivotal, the wheel swings centering around the camber axis by the moment generated on the camber axis. Therefore, without using any driving force by the actuator (i.e., passively), the camber angle can be applied to the wheel on the positive side or negative side.

Meanwhile, a single row of the first tread each is arranged on both outer sides in the width direction of the wheel of the vehicle controlled by the control device I3, and these two rows of the first tread have a softer property than that of the second tread (i.e., a higher gripping force property than that of the second tread) that is arranged between them. With this configuration, the characteristics of the first tread and the second tread can be selectively used corresponding to the camber angle applied to the wheel, and a good balance between two performances of the running performance (e.g., turning performance and acceleration performance) and the fuel saving performance can be achieved.

As described in the foregoing, when the control of the actuator by the camber angle control means is stopped, a camber angle on either the positive side or negative side is applied to the wheel. Consequently, the ground contact ratio of the first tread with respect to the second tread is increased and a high gripping force can be achieved, thereby ensuring the running performance (particularly, the turning performance that generates centrifugal force).

The larger the lateral force generated on the wheel is, more specifically, the larger the moment generated on the camber axis is, the larger the required capacity for the actuator controlling the camber angle becomes. With the control device I3, however, because the camber angle can be held by mechanically limiting the changeable range of the camber angle of the wheel by the changeable range limiting means under the condition where the lateral force equal to or higher than a predetermined level is generated on the wheel (for example, in quick turn), the camber angle of the wheel that can achieve the high gripping force can be kept applied to the wheel, i.e., the camber angle can be held, without using the driving force by the actuator. Consequently, it is possible to use an actuator of a low capacity (more specifically, a narrow changeable range) accordingly.

Further, because the changeable range of the camber angle is limited by the changeable range limiting means, even when the control of the actuator is stopped and the camber angle is passively applied, the camber angle can be prevented from becoming unnecessarily large which causes the vehicle to run unstably. Consequently, the retention force to hold the camber angle is not required, and thus the actuator of a small capacity can be used.

As described in the foregoing, with the control device I3, even with an actuator of a low capacity that is superior in terms of cost, installation and the like, it can be realized that the tread of the wheel is selectively used by changing the camber angle, and a good balance between two performances of the running performance and the fuel saving performance can be achieved.

Modification examples J of the present invention will be described below. In the related art, there is known a technology that, when an abnormality occurs with a vehicle, by detecting the abnormality of the vehicle, controls the vehicle so as to avoid it automatically. For example, Patent Document 1J discloses a vehicular travel control device that controls traveling of the vehicle itself by detecting an inter-vehicle distance between the vehicle itself and other vehicle such that the detected inter-vehicle distance remains to be equal to or higher than a predetermined value. Patent Document 1J: Japanese Patent Application Publication No. JP-A-2006-315491

However, in the related-art technology described above, there has been a problem in that, for example, when a braking force is applied to the wheel in order to maintain the inter-vehicle distance to be equal to or larger than the predetermined distance, the situation may arise in that the inter-vehicle distance to the other vehicle becomes less than the predetermined distance as the vehicle is not decelerated immediately with respect to the braking force when the griping force of the wheel is weakened because of the running condition of the vehicle.

In view of the problem described above, an object of the modification examples J of the present invention is to provide a control device capable of enhancing the braking performance of the vehicle when an abnormality occurs with the vehicle.

A control device J1 used for a vehicle provided with a wheel, and a camber angle adjusting device for adjusting a camber angle of the wheel, the wheel having at least a first tread, and a second tread arranged in parallel in the width direction of the wheel and arranged on inside or outside of the vehicle with respect to the first tread having a softer property than that of the first tread, is characterized by including camber control means that controls the camber angle adjusting device, vehicle condition detecting means used for detecting conditions of the vehicle, and vehicle abnormality judging means that judges whether or not a predetermined abnormality condition occurs from the conditions of the vehicle detected by the vehicle condition detecting means, in which the camber control means controls the camber angle adjusting device such that the ground contact ratio of the second tread is increased when the vehicle abnormality judging means judges that the predetermined abnormality occurs.

With the control device J1, when the camber angle adjusting device is controlled by the camber control means and the camber angle of the wheel is adjusted in the positive direction, the ground contact ratio of the tread that is arranged on the outer side of the vehicle (first tread or second tread) is increased while the ground contact ratio of the tread arranged on the inner side of the vehicle (second tread or first tread) is decreased.

By contrast, when the camber angle of the wheel is adjusted in the negative direction, the ground contact ratio of the tread that is arranged on the outer side of the vehicle (first tread or second tread) is decreased while the ground contact ratio of the tread arranged on the inner side of the vehicle (second tread or first tread) is increased.

As described above, with the control devices of the present invention, because the ground contact ratios of the first tread and the second tread can be changed by controlling the camber angle adjusting device by the camber control means, by enhancing the effect of the characteristics of the tread of a high ground contact ratio, the wheel can achieve the performance achieved by the characteristics of such tread.

According to the present invention, because the wheel is configured such that the second tread has a softer property (low rubber hardness property) than that of the first tread, when the ground contact ratio of the second tread is increased, by the soft property of the second tread, more specifically, the characteristics of good elasticity and being easily deformable under external force, a high gripping performance can be obtained.

With the control devices of the present invention, when the vehicle abnormality judging means judges that the predetermined abnormality occurs from the conditions of the vehicle detected by the vehicle condition detecting means, because the camber control means controls the camber angle adjusting device such that the ground contact ratio of the second tread is increased, when the vehicle is assumed to be in the predetermined abnormal condition, by enhancing the effect of the soft property of the second tread, the wheel can achieve the performance achieved by the characteristics of the second tread. Consequently, when an abnormality occurs with the vehicle, the wheel can obtain the high gripping performance and, by that high gripping performance, the braking performance of the vehicle can be enhanced.

A control device J2 is characterized in that the control device J1 further includes coefficient of friction judging means that judges whether or not the coefficient of friction between the wheel and a road surface is equal to or higher than a predetermined level, in which when the vehicle abnormality judging means judges that a predetermined abnormality occurs, the camber control means controls the camber angle adjusting device to increase the ground contact ratio of the second tread until the coefficient of friction judging means judges that the coefficient of friction is equal to or higher than the predetermined level.

With the control device J2, in addition to the advantages of the control device J1, when the vehicle abnormality judging means judges that the predetermined abnormality occurs, because the camber angle control means controls the camber angle adjusting device to increase the ground contact ratio of the second tread until the coefficient of friction judging means judges that the coefficient of friction between the wheel and the road surface is equal to or higher than the predetermined level, it can be ensured that the coefficient of friction between the wheel and the road surface is equal to or higher than the predetermined level when the vehicle is in a predetermined abnormal condition. Consequently, the wheel can be provided with gripping performance equal to or higher than a predetermined level, thereby enhancing the braking performance of the vehicle to a level equal to or higher than a predetermined level when an abnormality occurs with the vehicle.

A control device J3 is characterized in that, in the control device J2, the coefficient of friction judging means judges whether or not the coefficient of friction is a maximum coefficient of friction, and when the vehicle abnormality judging means judges that a predetermined abnormality occurs, the camber control means controls the camber angle adjusting device to increase the ground contact ratio of the second tread until the coefficient of friction judging means judges that the coefficient of friction is the maximum coefficient of friction.

With the control device 33, in addition to the advantages of the control device J2, when the vehicle abnormality judging means judges that the predetermined abnormality occurs, because the camber angle control means controls the camber angle adjusting device to increase the ground contact ratio of the second tread until the coefficient of friction judging means judges that the coefficient of friction between the wheel and the road surface is the maximum coefficient of friction, it can be ensured that the coefficient of friction between the wheel and the road surface is the maximum coefficient of friction when the vehicle is in the predetermined abnormal condition. Consequently, the wheel can obtain the highest gripping performance, thereby maximizing the braking performance of the vehicle when an abnormality occurs with the vehicle.

A control device J4 is characterized in that, in the control device J1, when the vehicle abnormality judging means judges that a predetermined abnormality occurs, the camber control means controls the camber angle adjusting device such that the camber angle of the wheel comes to a predetermined angle that makes the ground contact ratio of the second tread equal to or higher than a predetermined ratio on the side where the ground contact ratio of the second tread increases.

With the control device J4, in addition to the advantages of the control device 31, when the vehicle abnormality judging means judges that the predetermined abnormality occurs, because the camber angle control means controls the camber angle adjusting device such that the camber angle of the wheel comes to the predetermined angle that makes the ground contact ratio of the second tread equal to or higher than a predetermined ratio on the side where the ground contact ratio of the second tread increases, by setting the camber angle in advance to achieve a desired ground contact ratio within the range where the ground contact ratio of the second tread is equal to or higher than the predetermined ratio, it can be ensured that the desired ground contact ratio of the second tread is set when the vehicle is in the predetermined abnormal condition. Consequently, the wheel can obtain a desired gripping performance by the effect of the soft property of the second tread, thereby enhancing the braking performance of the vehicle to a desired level when an abnormality occurs with the vehicle.

Further, because the camber angle control means merely controls the camber angle adjusting device such that the camber angle of the wheel comes to the predetermined angle, the control can be simplified, whereby the control load is reduced.

A control device J5 is characterized in that, in the control device J4, when the vehicle abnormality judging means judges that a predetermined abnormality occurs, the camber control means controls the camber angle adjusting device such that the camber angle of the wheel comes to the maximum angle adjustable for the wheel on the side where the ground contact ratio of the second tread increases.

With the control device J5, in addition to the advantages of the control device J4, when the vehicle abnormality judging means judges that the predetermined abnormality occurs, because the camber angle control means controls the camber angle adjusting device such that the camber angle of the wheel comes to the maximum angle adjustable for the wheel on the side where the ground contact ratio of the second tread increases, the ground contact ratio of the second tread can be set to the highest possible ratio when the vehicle is in the predetermined abnormal condition. Consequently, by the effect of the soft property of the second tread, the wheel can obtain the highest gripping performance possible, thereby enhancing the braking performance of the vehicle to the highest possible performance when an abnormality occurs with the vehicle.

Further, the highest camber thrust is generated on the wheel, thereby further enhancing the braking performance.

A control device J6 is characterized in that any one of the control devices J1 to J5 further includes vehicle abnormality resolution judging means that judges whether or not the predetermined abnormal condition judged by the vehicle abnormality judging means is resolved, in which when the vehicle abnormality resolution judging means judges that the predetermined abnormal condition is resolved, the camber control means controls the camber angle adjusting device such that the camber angle of the wheel comes to a predetermined default value on the side where the ground contact ratio of the second tread decreases.

With the control device J6, in addition to the advantages of the control devices J1 to J5, because the vehicle abnormality resolution judging means judges whether or not the predetermined abnormal condition judged by the vehicle abnormality judging means is resolved and, when the vehicle abnormality resolution judging means judges that the predetermined abnormal condition is resolved, the camber control means controls the camber angle adjusting device such that the camber angle of the wheel comes to a predetermined default value on the side where the ground contact ratio of the second tread decreases, the influence of the soft property of the second tread can be made small when the predetermined abnormality is resolved. Consequently, because the rolling resistance of the wheel can be made small, fuel efficiency can be improved when the vehicle is not under any abnormal condition.

A control device 37 is characterized in that, in the control device J6, when the vehicle abnormality resolution judging means judges that the predetermined abnormal condition is resolved, the camber control means controls the camber angle adjusting device such that the camber angle of the wheel comes to 0 degrees.

With the control device J7, in addition to the advantages of the J6, when the vehicle abnormality resolution judging means judges that the predetermined abnormal condition is resolved, because the camber control means controls the camber angle adjusting device such that the camber angle of the wheel comes to 0 degrees, the camber thrust is not generated on the wheel, whereby the fuel saving performance is further enhanced.

Additionally, the process in step S10006 in the flow chart of FIG. 61, the process in step S11016 in the flow chart of FIG. 62, and the process in step S10014 in the flow charts of FIGS. 61 and 62 represent the camber control means included in the control device J1. The processes in steps S10002 to S10005 in the flow charts of FIGS. 61 and 62 represent the vehicle abnormality judging means. The process in step S10008 in the flow chart of FIG. 61 represents the coefficient of friction judging means included in the control device J2. The processes in steps S10010 to S10013 in the flow charts of FIGS. 61 and 62 represent the vehicle abnormality resolution judging means included in the control device J6.

1. A camber angle controlling device that controls a camber angle of a wheel of a vehicle, the camber angle controlling device comprising:
traveling information acquiring means for acquiring traveling information of the vehicle; and
camber angle adjusting means for adjusting the camber angle of the wheel to a predetermined camber angle, and wherein:
the camber angle adjusting means controls the camber angle based on the traveling information so as to reduce the rolling resistance of the wheel.

2. The camber angle controlling device according to claim 1, further comprising:
traveling road surface judging means for judging a road surface condition of a traveled road surface on which the vehicle is currently traveling; and
required coefficient of friction calculating means for calculating a required coefficient of friction based on the road surface condition judged by the traveling road surface judging means, and wherein:
the camber angle adjusting means adjusts the camber angle of the wheel to a predetermined camber angle based on the required coefficient of friction.

3. The camber angle controlling device according to claim 2, further comprising:
coefficient of friction comparing means for comparing a coefficient of friction achievable by the wheel with the required coefficient of friction, and wherein:
the camber angle adjusting means adjusts the camber angle of the wheel to a predetermined camber angle based on a result of comparison by the coefficient of friction comparing means.

4. The camber angle controlling device according to claim 3, further comprising:
a camber angle map that stores values for the coefficient of friction and the rolling resistance of the wheel in correlation with camber angles, and wherein:
the camber angle adjusting means calculates a minimum coefficient of friction and a maximum coefficient of friction achievable by the wheel based on the camber angle map, sets a predetermined camber angle to zero degrees when the required coefficient of friction is smaller than the minimum coefficient of friction, and calculates a camber angle corresponding to the required coefficient of friction based on the camber angle map and sets the predetermined camber angle to the calculated camber angle when the required coefficient of friction is larger than the minimum coefficient of friction and smaller than the maximum coefficient of friction, and thus adjusts the camber angle of the wheel.

5. The camber angle controlling device according to claim 4, wherein:
the traveling information acquiring means acquires a roll angle of the vehicle as the traveling information, and
the camber angle adjusting means applies a camber angle of a value corresponding to the roll angle to the wheel so as to adjust the camber angle of the wheel to a predetermined camber angle.

6. The camber angle controlling device according to claim 1, further comprising:
thrust force calculating means for calculating a theoretical thrust force acting on the wheel toward outside or inside of the vehicle, and wherein:
the traveling information acquiring means acquires an actual thrust force acting on the wheel toward outside or inside of the vehicle as the traveling information, and
the camber angle adjusting means adjusts the camber angle of the wheel to a predetermined camber angle so as to reduce a gap between the theoretical thrust force and the actual thrust force.

7. The camber angle controlling device according to claim 1, further comprising:
a motor for supplying a driving force to the vehicle; and wherein:
the traveling information acquiring means acquires a value for electric current to the motor as the traveling information, and
the camber angle adjusting means adjusts the camber angle of the wheel to a predetermined camber angle so as to reduce the electric current value.

8. The camber angle controlling device according to claim 1, further comprising:
an internal combustion engine for supplying a driving force to the vehicle; and wherein,
the traveling information acquiring means acquires a feed rate of fuel fed to the internal combustion engine as the traveling information, and
the camber angle adjusting means adjusts the camber angle of the wheel to a predetermined camber angle so as to reduce the feed rate of the fuel.

9. The camber angle controlling device according to claim 1, wherein:
the traveling information acquiring means acquires a roll angle of the vehicle as the traveling information, and
the camber angle adjusting means applies a camber angle of a value corresponding to the roll angle to the wheel so as to adjust the camber angle of the wheel to a predetermined camber angle.

10. The camber angle controlling device according to claim 2, wherein:
the traveling information acquiring means acquires a roll angle of the vehicle as the traveling information, and
the camber angle adjusting means applies a camber angle of a value corresponding to the roll angle to the wheel so as to adjust the camber angle of the wheel to a predetermined camber angle.

11. The camber angle controlling device according to claim 3, wherein:
the traveling information acquiring means acquires a roll angle of the vehicle as the traveling information, and
the camber angle adjusting means applies a camber angle of a value corresponding to the roll angle to the wheel so as to adjust the camber angle of the wheel to a predetermined camber angle.
